(19) United States
(12) Patent Application Publication
(10) Pub. No.: US 2008/0298219 A1
(43) Pub. Date: Dec. 4, 2008

(54) INFORMATION STORAGE MEDIUM, INFORMATION REPRODUCING APPARATUS, INFORMATION REPRODUCING METHOD, AND NETWORK COMMUNICATION SYSTEM

(76) Inventors: Yoichiro Yamagata, Yokohama-shi (JP); Kazuhiko Taira, Yokohama-shi (JP); Hideki Mimura, Yokohama-shi (JP); Yasuhiro Ishibashi, Ome-shi (JP); Takero Kobayashi, Akishima-shi (JP); Seiichi Nakamura, Inagi-shi (JP); Eita Shuto, Tokyo (JP); Yasufumi Tsumagari, Yokohama-shi (JP); Toshimitsu Kaneko, Kawasaki-shi (JP); Tooru Kamibayashi, Chigasaki-shi (JP); Haruhiko Toyama, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/560,292

(22) Filed: Nov. 15, 2006

(30) Foreign Application Priority Data
Mar. 15, 2005 (JP) 2005-072136

(51) Int. Cl. G11B 7/24

(52) U.S. Cl. 369/275.1

(57) ABSTRACT

An information storage medium according to one embodiment of the present invention comprises a management area in which management information to manage content is recorded and a content area in which content managed on the basis of the management information is recorded. The content area includes an object area in which a plurality of objects are recorded, and a time map area in which a time map for reproducing these objects in a specified period on a timeline is recorded. The management area includes a play list area in which a play list for controlling the reproduction of a menu and a title each composed of the objects on the basis of the time map is recorded.

### CROSS REFERENCE TO RELATED APPLICATIONS

This is a Continuation application of PCT Application No. PCT/JP2006/305189, filed Mar. 9, 2006, which was published under PCT Article 21(2) in English.

This application is based upon and claims the benefit of priority from Japanese Patent Application No. 2005-072136, filed Mar. 15, 2005, the entire contents of which are incorporated herein by reference.

### BACKGROUND

1. Field

One embodiment of the invention relates to an information storage medium, such as an optical disc, an information reproducing apparatus and an information reproducing method which reproduce information from the information storage medium, and a network communication system composed of servers and players.

2. Description of the Related Art

In recent years, DVD video discs featuring high-quality pictures and high performance and video players that play back DVD video discs have been widely used and peripheral devices that play back multichannel audio have been expanding the range of consumer choices. Moreover, a home theater can be realized close at hand and an environment is being created which enables the user to watch movies, animations, and the like with high picture quality and high sound quality freely at home. In Jpn. Pat. Appln. KOKAI Publication No. 10-50036, a reproducing apparatus capable of displaying various menus in a superimposed manner by changing the colors of characters for the images reproduced from the disc has been disclosed.

As image compression technology has been improved in the past few years, both users and content providers have been wanting the realization of much higher picture quality. In addition to the realization of much higher picture quality, the content providers have been wanting a more attractive content providing environment for users as a result of the expansion of content, including more colorful menus and an improvement in interactivity, in the content including the main story of the title, menu screens, and bonus images. Furthermore, users have been wanting more and more to enjoy content freely by specifying the reproducing position, reproducing area, or reproducing time of image data on the still pictures taken by the user, the subtitle text obtained through Internet connection, or the like.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are explanatory diagrams showing the configuration of standard content and that of advanced content according to an embodiment of the invention, respectively;

FIGS. 2A to 2C are explanatory diagrams of discs in category 1, category 2, and category 3 according to the embodiment of the invention, respectively;

FIG. 3 is an explanatory diagram of an example of reference to enhanced video objects (EVOB) according to time map information (TMAPI) in the embodiment of the invention;

FIG. 4 is an explanatory diagram showing an example of the transition of playback state of a disc in the embodiment of the invention;

FIG. 5 is a diagram to help explain an example of a volume space of a disc in the embodiment of the invention;

FIG. 6 is an explanatory diagram showing an example of directories and files of a disc in the embodiment of the invention;

FIG. 7 is an explanatory diagram showing the configuration of management information (VMD) and that of video title set (VTS) in the embodiment of the invention;

FIG. 8 is a diagram to help explain the startup sequence of a player model in the embodiment of the invention;

FIG. 9 is a diagram to help explain a configuration showing a state where primary EVOB-TY2 packs are mixed in the embodiment of the invention;

FIG. 10 shows an example of an expanded system target decoder of the player model in the embodiment of the invention;

FIG. 11 is a timing chart to help explain an example of the operation of the player shown in FIG. 10 in the embodiment of the invention;

FIG. 12 is an explanatory diagram showing a peripheral environment of an advanced content player in the embodiment of the invention;

FIG. 13 is an explanatory diagram showing a model of the advanced content player of FIG. 12 in the embodiment of the invention;

FIG. 14 is an explanatory diagram showing the concept of recorded information on a disc in the embodiment of the invention;

FIG. 15 is an explanatory diagram showing an example of the configuration of a directory and that of a file in the embodiment of the invention;

FIG. 16 is an explanatory diagram showing a more detailed model of the advanced content player in the embodiment of the invention;

FIG. 17 is an explanatory diagram showing an example of the data access manager of FIG. 16 in the embodiment of the invention;

FIG. 18 is an explanatory diagram showing an example of the data cache of FIG. 16 in the embodiment of the invention;

FIG. 19 is an explanatory diagram showing an example of the navigation manager of FIG. 16 in the embodiment of the invention;

FIG. 20 is an explanatory diagram showing an example of the presentation engine of FIG. 16 in the embodiment of the invention;

FIG. 21 is an explanatory diagram showing an example of the advanced element presentation engine of FIG. 16 in the embodiment of the invention;

FIG. 22 is an explanatory diagram showing an example of the advanced subtitle player of FIG. 16 in the embodiment of the invention;

FIG. 23 is an explanatory diagram showing an example of the rendering system of FIG. 16 in the embodiment of the invention;

FIG. 24 is an explanatory diagram showing an example of the secondary video player of FIG. 16 in the embodiment of the invention;

FIG. 25 is an explanatory diagram showing an example of the primary video player of FIG. 16 in the embodiment of the invention;

FIG. 26 is an explanatory diagram showing an example of the decoder engine of FIG. 16 in the embodiment of the invention;

FIG. 27 is an explanatory diagram showing an example of the AV renderer of FIG. 16 in the embodiment of the invention;

FIG. 28 is an explanatory diagram showing an example of the video mixing model of FIG. 16 in the embodiment of the invention;

FIG. 29 is an explanatory diagram to help explain a graphic hierarchy according to the embodiment of the invention;

FIG. 30 is an explanatory diagram showing an audio mixing model according to the embodiment of the invention;

FIG. 31 is an explanatory diagram showing a user interface manager according to the embodiment of the invention;

FIG. 32 is an explanatory diagram showing a disk data supply model according to the embodiment of the invention;

FIG. 33 is an explanatory diagram showing a network and persistent storage data supply model according to the embodiment of the invention;

FIG. 34 is an explanatory diagram showing a data storage model according to the embodiment of the invention;

FIG. 35 is an explanatory diagram showing a user input handling model according to the embodiment of the invention;

FIGS. 36A and 36B are diagrams to help explain the operation when the apparatus of the invention subjects a graphic frame to an aspect ratio process in the embodiment of the invention;

FIG. 37 is a diagram to help explain the function of a play list in the embodiment of the invention;

FIG. 38 is a diagram to help explain a state where objects are mapped on a timeline according to the play list in the embodiment of the invention;

FIG. 39 is an explanatory diagram showing the cross-reference of the play list to other objects in the embodiment of the invention;

FIG. 40 is an explanatory diagram showing a playback sequence related to the apparatus of the invention in the embodiment of the invention;

FIG. 41 is an explanatory diagram showing an example of playback in trick play related to the apparatus of the invention in the embodiment of the invention;

FIG. 42 is an explanatory diagram to help explain object mapping on a timeline performed by the apparatus of the invention in a 60-Hz region in the embodiment of the invention;

FIG. 43 is an explanatory diagram to help explain object mapping on a timeline performed by the apparatus of the invention in a 50-Hz region in the embodiment of the invention;

FIG. 44 is an explanatory diagram showing an example of the contents of advanced application in the embodiment of the invention;

FIG. 45 is a diagram to help explain a model related to unsynchronized Markup Page Jump in the embodiment of the invention;

FIG. 46 is a diagram to help explain a model related to soft-synchronized Markup Page Jump in the embodiment of the invention;

FIG. 47 is a diagram to help explain a model related to hard-synchronized Markup Page Jump in the embodiment of the invention;

FIG. 48 is a diagram to help explain an example of basic graphic frame generation timing in the embodiment of the invention;

FIG. 49 is a diagram to help explain a frame drop timing model in the embodiment of the invention;

FIG. 50 is a diagram to help explain a startup sequence of advanced content in the embodiment of the invention;

FIG. 51 is a diagram to help explain an update sequence of advanced content playback in the embodiment of the invention;

FIG. 52 is a diagram to help explain a sequence of the conversion of advanced VYS into standard VTS or vice versa in the embodiment of the invention;

FIG. 53 is a diagram to help explain a resume process in the embodiment of the invention;

FIG. 54 is a diagram to help explain an example of languages (codes) for selecting a language unit on the VMG menu and on each VTS menu in the embodiment of the invention;

FIG. 55 shows an example of the validity of HLI in each PGC (codes) in the embodiment of the invention;

FIG. 56 shows the structure of navigation data in standard content in the embodiment of the invention;

FIG. 57 shows the structure of video manager information (VMGI) in the embodiment of the invention;

FIG. 58 shows the structure of video manager information (VMGI) in the embodiment of the invention;

FIG. 59 shows the structure of a video title set program chain information table (VTS_PGCIT) in the embodiment of the invention;

FIG. 60 shows the structure of program chain information (PGCI) in the embodiment of the invention;

FIGS. 61A and 61B show the structure of a program chain command table (PGC_CMDT) and that of a cell playback information table (C_PBIT) in the embodiment of the invention, respectively;

FIGS. 62A and 62B show the structure of an enhanced video object set (EVOBS) and that of a navigation pack (NV_PCK) in the embodiment of the invention, respectively;

FIGS. 63A and 63B show the structure of general control information (GCI) and the location of highlight information in the embodiment of the invention, respectively;

FIG. 64 shows the relationship between sub-pictures and HLI in the embodiment of the invention;

FIGS. 65A and 65B show a button color information table (BTN_COLIT) and an example of button information in each button group in the embodiment of the invention, respectively;

FIGS. 66A and 66B show the structure of a highlight information pack (HLI_PCK) and the relationship between the video data and the video packs in EVOBU in the embodiment of the invention, respectively;

FIG. 67 shows restrictions on MPEG-4 AVC video in the embodiment of the invention;

FIG. 68 shows the structure of video data in each EVOBU in the embodiment of the invention;

FIGS. 69A and 69B show the structure of a sub-picture unit (SPU) and the relationship between SPU and sub-picture packs (SP_PCK) in the embodiment of the invention, respectively;

FIGS. 70A and 70B show the timing of the update of sub-pictures in the embodiment of the invention;

FIG. 71 is a diagram to help explain the contents of information recorded on a disc-like information storage medium according to the embodiment of the invention;

FIGS. 72A and 72B are diagrams to help explain an example of the configuration of advanced content in the embodiment of the invention;

FIG. 73 is a diagram to help explain an example of the configuration of video title set information (VTSI) in the embodiment of the invention;

FIG. 74 is a diagram to help explain an example of the configuration of time map information (TMAPI) beginning with entry information (EVOBU_ENTI#1 to EVOBU_ENTI#i) in the or more enhanced video object units in the embodiment of the invention;

FIG. 75 is a diagram to help explain an example of the configuration of interleaved unit information (ILVUI) existing when time map information is for an interleaved block in the embodiment of the invention;

FIG. 76 shows an example of contiguous block TMAP in the embodiment of the invention;

FIG. 77 shows an example of interleaved block TMAP in the embodiment of the invention;

FIG. 78 is a diagram to help explain an example of the configuration of a primary enhanced video object (P-EVOB) in the embodiment of the invention;

FIG. 79 is a diagram to help explain an example of the configuration of VM_PCK and VS_PCK in the primary enhanced video object (P-EVOB) in the embodiment of the invention;

FIG. 80 is a diagram to help explain an example of the configuration of AS_PCK and AM_PCK in the primary enhanced video object (P-EVOB) in the embodiment of the invention;

FIGS. 81A and 81B are diagrams to help explain an example of the configuration of an advanced pack (ADV_PCK) and that of the begin pack in a video object unit/time unit (VOBU/TU) in the embodiment of the invention;

FIG. 82 is a diagram to help explain an example of the configuration of a secondary video set time map (TMAP) in the embodiment of the invention;

FIG. 83 is a diagram to help explain an example of the configuration of a secondary enhanced video object (S-EVOB) in the embodiment of the invention;

FIG. 84 is a diagram to help explain another example (another example of FIG. 83) of the secondary enhanced video object (S-EVOB) in the embodiment of the invention;

FIG. 85 is a diagram to help explain an example of the configuration of a play list in the embodiment of the invention;

FIG. 86 is a diagram to help explain the allocation of presentation objects on a timeline in the embodiment of the invention;

FIG. 87 is a diagram to help explain a case where a trick play (such as a chapter jump) of playback objects is carried out on a timeline in the embodiment of the invention;

FIG. 88 is a diagram to help explain an example of the configuration of a play list when an object includes angle information in the embodiment of the invention;

FIG. 89 is a diagram to help explain an example of the configuration of a play list when an object includes a multi-story in the embodiment of the invention;

FIG. 90 is a diagram to help explain an example of the description of object mapping information in a play list (when an object includes angle information) in the embodiment of the invention;

FIG. 91 is a diagram to help explain an example of the description of object mapping information in a play list (when an object includes a multi-story) in the embodiment of the invention;

FIG. 92 is a diagram to help explain an example of the advanced object type (here, example 4) in the embodiment of the invention;

FIG. 93 is a diagram to help explain an example of a play list in the case of a synchronized advanced object in the embodiment of the invention;

FIG. 94 is a diagram to help explain an example of the description of a play list in the case of a synchronized advanced object in the embodiment of the invention;

FIG. 95 shows an example of a network system model according to the embodiment of the invention;

FIG. 96 is a diagram to help explain an example of disk authentication in the embodiment of the invention;

FIG. 97 is a diagram to help explain a network data flow model according to the embodiment of the invention;

FIG. 98 is a diagram to help explain a completely downloaded buffer model (file cache) according to the embodiment of the invention;

FIG. 99 is a diagram to help explain a streaming buffer model (streaming buffer) according to the embodiment of the invention; and

FIG. 100 is a diagram to help explain an example of download scheduling in the embodiment of the invention.

### DETAILED DESCRIPTION

1. Structure

Various embodiments according to the invention will be described hereinafter with reference to the accompanying drawings. In general, an information storage medium according to an embodiment of the invention comprises: a management area in which management information to manage content is recorded; and a content area in which content managed on the basis of the management information is recorded, wherein the content area includes an object area in which a plurality of objects are recorded, and a time map area in which a time map for reproducing these objects in a specified period on a timeline is recorded, and the management area include a play list area in which a play list for controlling the reproduction of a menu and a title each composed of the objects on the basis of the time map is recorded.

2. Outline

In an information recording medium, an information transmission medium, an information processing apparatus, an information processing apparatus, an information reproducing method, an information reproducing apparatus, an information recording method, and an information recording apparatus according to an embodiment of the invention, new, effective improvements have been made in the data format and the data-format handling method. Therefore, of resources, such data as video, audio, and other programs can be reused in particular. In addition, the freedom of the change of combination of resources is improved. These will be explained below.

3. Introduction

3.1 Content Type

This specification defines 2 types of contents: one is Standard Content and the other is Advanced Content. Standard Content consists of Navigation data and Video object data on a disc and which are pure extensions of those in DVD-Video specification ver1.1.

On the other hand, Advanced Content consists of Advanced Navigation such as Playlist, Manifest, Markup and Script files and Advanced Data such as Primary/Secondary Video Set and Advanced Element (image, audio, text and so on). At least one Playlist file and Primary Video Set shall be located on a disc, and other data can be on a disc and also be delivered from a server.

3.1.1 Standard Content

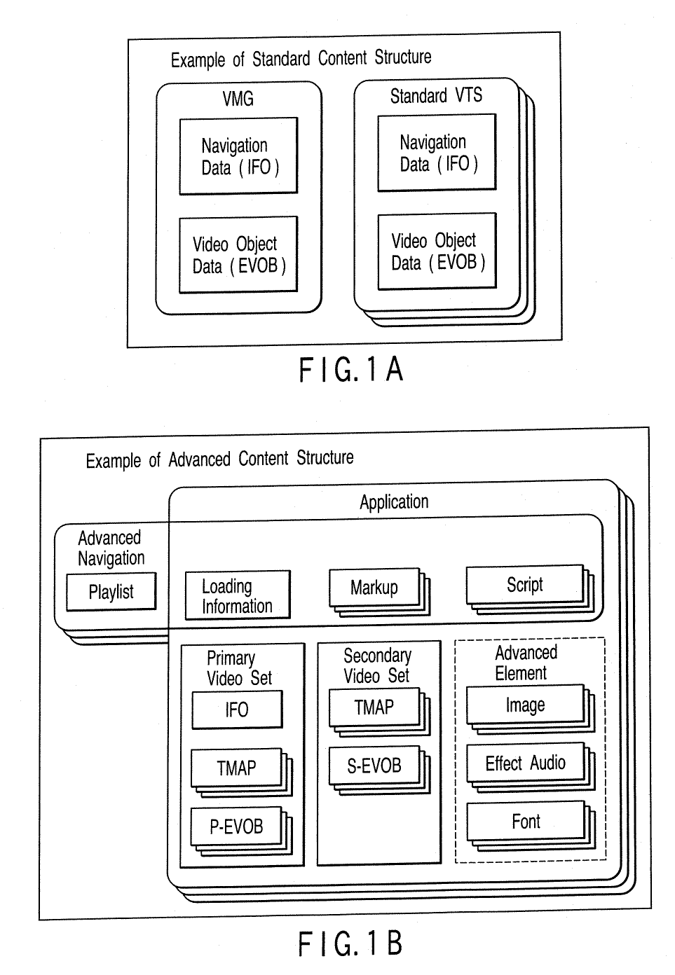

Standard Content is just extension of content defined in DVD-Video Ver1.1 especially for high-resolution video, high-quality audio and some new functions. Standard Content basically consists of one VMG space and one or more VTS spaces (which are called as “Standard VTS” or just “VTS”), as shown in FIG. 1A. For more details, see 5. Standard Content.

3.1.2 Advanced Content

Advanced Content realizes more interactivity in addition to the extension of audio and video realized by Standard Content. As described above, Advanced Content consists of Advanced Navigation such as Playlist, Manifest, Markup and Script files and Advanced Data such as Primary/Secondary Video Set and Advanced Element (image, audio, text and so on), and Advanced Navigation manages playback of Advanced Data. See FIG. 1B.

A Playlist file, described by XML, locates on a disc, and a player shall execute this file firstly if the disc has advanced content. This file gives information for:
Object Mapping Information: Info. in a Title for the presentation objects mapped on the Title Timeline
Playback Sequence: Playback information for each Title, described by Title Timeline.
Configuration Information: System configuration e.g. data buffer alignment

In accordance with the description of Playlist, the initial application is executed with referring Primary/Secondary Video Set and so on, if these exist. An application consists of Manifest, Markup (which includes content/styling/timing information), Script and Advanced Data. An initial Markup file, Script file(s) and other resources to compose the application are referred in a Manifest file. Markup initiates to play back Advanced Data such as Primary/Secondary Video Set, and Advanced Element.

Primary Video Set has the structure of a VTS space which is specialized for this content. That is, this VTS has no navigation commands, has no layered structure, but has TMAP information and so on. Also, this VTS can have a main video stream, a sub video stream, 8 main audio streams and 8 sub audio streams. This VTS is called as “Advanced VTS”.

Secondary Video Set is used for additional video/audio data to Primary Video Set and also used for additional audio data only. However, this data can be played back only when sub video/audio stream in Primary Video Set is not played back, and vice versa.

Secondary Video Set is recoded on a disc or delivered from a server as one or more files. This file shall be once stored in File Cache before playback, if the data is recorded on a disc and it is necessary to be played with Primary Video Set simultaneously. On the other hand, if Secondary Video Set is located at website, whole of this data should be once stored in File Cache and played back (“Downloading”), or a part of this data should be stored in Streaming Buffer sequentially and stored data in the buffer is played back simultaneously without buffer overflow during downloading data from a server. (“Streaming”) For more details, see 6. Advanced Content.

3.1.2.1 Advanced VTS

Advanced VTS (which is also called as Primary Video Set) is utilized Video Title Set for Advanced Navigation. That is, followings are defined corresponding to Standard VTS.

1) More enhancement for EVOB
1 main video stream, 1 sub video stream
8 main audio streams, 8 sub audio streams
32 subpicture streams
1 advanced stream

2) Integration of Enhanced VOB Set (EVOBS)
Integration of both Menu EVOBS and Title EVOBS

3) Elimination of a layered structure
No Title, no PGC, no PTT and no Cell
Cancellation of Navigation Command and UOP control

4) Introduction of new Time Map Information (TMAP)
One TMAPI corresponds to one EVOB and it is stored as a file.
Some information in a NV_PCK are simplified.

For more details, see 6.3 Primary Video Set.

3.1.2.2 Interoperable VTS

Interoperable VTS is Video Title Set supported in HD DVD-VR specifications.

In this specification, HD DVD-Video specifications, Interoperable VTS is not supported, i.e. content author cannot make a disc which contains Interoperable VTS. However, a HD DVD-Video player shall support the playback of Interoperable VTS.

3.2 Disc Type

This specification allows 3 kinds of discs (Category 1 disc/Category 2 disc/Category 3 disc) as defined below.

3.2.1 Category 1 Disc

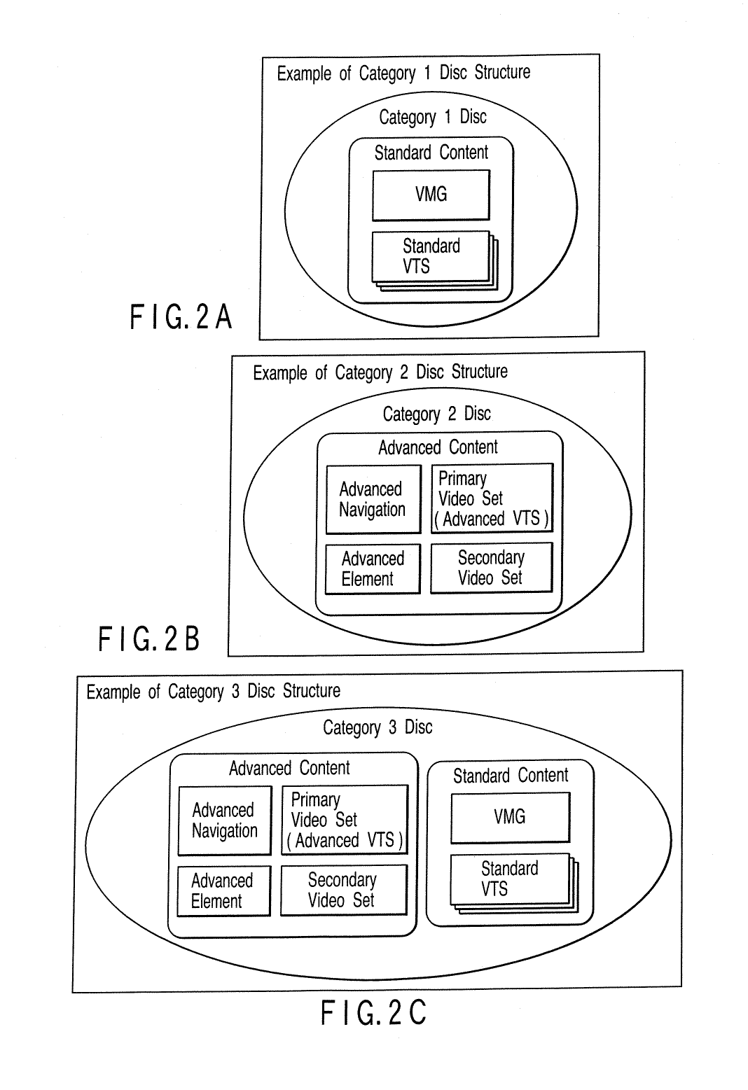

This disc contains only Standard Content which consists of one VMG and one or more Standard VTSs. That is, this disc contains no Advanced VTS and no Advanced Content. As for an example of structure, see FIG. 2A.

3.2.2 Category 2 Disc

This disc contains only Advanced Content which consists of Advanced Navigation, Primary Video Set (Advanced VTS), Secondary Video Set and Advanced Element. That is, this disc contains no Standard Content such as VMG or Standard VTS. As for an example of structure, see FIG. 2B.

3.2.3 Category 3 Disc

This disc contains both Advanced Content which consists of Advanced Navigation, Primary Video Set (Advanced VTS), Secondary Video Set and Advanced Element and Standard Content which consists of VMG and one or more Standard VTS. However neither FP_DOM nor VMGM_DOM exist in this VMG. As for an example of structure, see FIG. 2C.

Even though this disc contains Standard Content, basically this disc follows rules for the Category 2 disc, and in addition, this disc has the transition from Advanced Content Playback State to Standard Content Playback State, and vice versa.

3.2.3.1 Utilization of Standard Content by Advanced Content

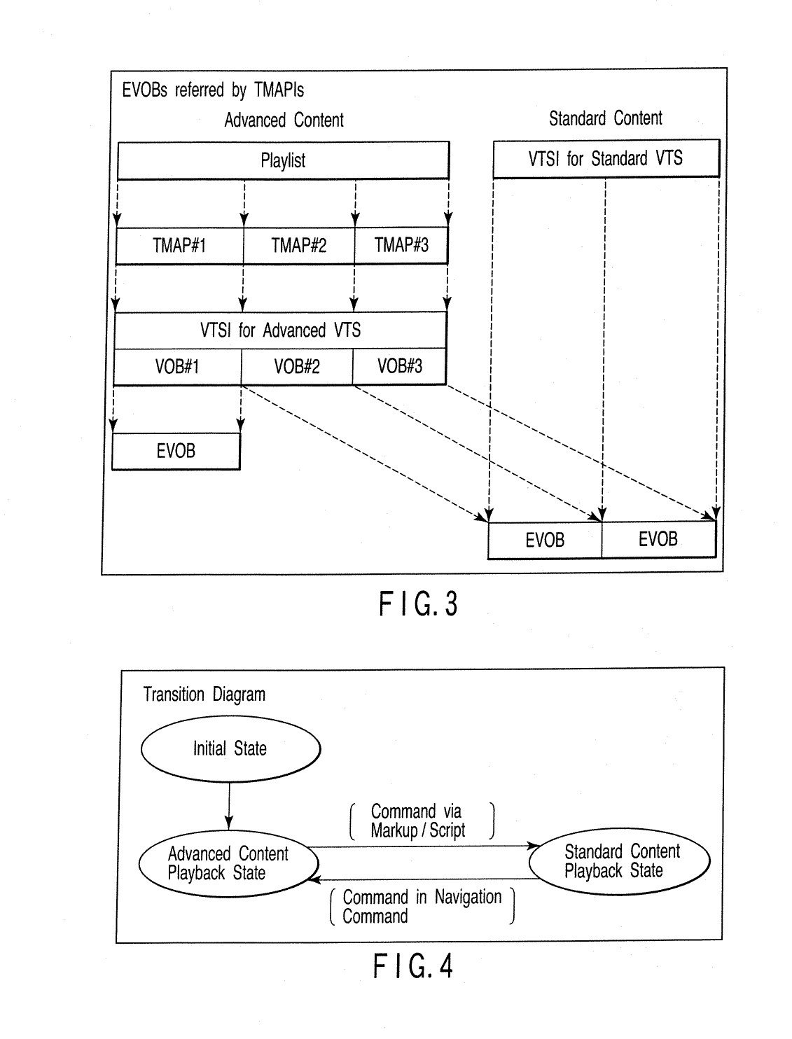

Standard Content can be utilized by Advanced Content. VTSI of Advanced VTS can refer EVOBs which is also be referred by VTSI of Standard VTS, by use of TMAP (See FIG. 3). However, the EVOB may contain HLI, PCI and so on, which are not supported in Advanced Content. In the playback of such EVOBs, for example HLI and PCI shall be ignored in Advanced Content.

3.2.3.2 Transition between Standard/Advanced Content Playback State

Regarding Category 3 disc, Advanced Content and Standard Content are played back independently. FIG. 4 shows state diagram for playback of this disc. Firstly Advanced Navigation (that is, Playlist file) is interpreted at “Initial State”, and according to the file, initial application in Advanced Content is executed at “Advanced Content Playback State”. This procedure is same as that in Category 2 disc. During the playback of Advanced Content, in this case, a player can play back Standard Content by the execution of specified commands via Script such as e.g. CallStandardContentPlayer with argues to specify the playback position. (Transition to “Standard Content Playback State”) During the playback of Standard Content, a player can return to “Advanced Content Playback State” by the execution of specified commands as Navigation Commands such as e.g. CallAdvancedContentPlayer.

In Advanced Content Playback State, Advanced Content can read/set the system parameter (SPRM(1) to SPRM(10)) for Standard Content. During transitions, the values of SPRM are kept continuously. For instance, in Advanced Content Playback State, Advanced Content sets SPRM for audio stream according to the current audio playback status for playback of the appropriate audio stream in Standard Content Playback State after the transition. Even if audio stream is changed by a user in Standard Content Playback State, after the transition Advanced Content reads SPRM for audio stream and changes audio playback status in Advanced Content Playback State.

3.3 Logical Data Structure

A disc has the logical structure of a Volume Space, a Video Manager (VMG), a Video Title Set (VTS), an Enhanced Video Object Set (EVOBS) and Advanced Content described here.

3.3.1 Structure of Volume Space

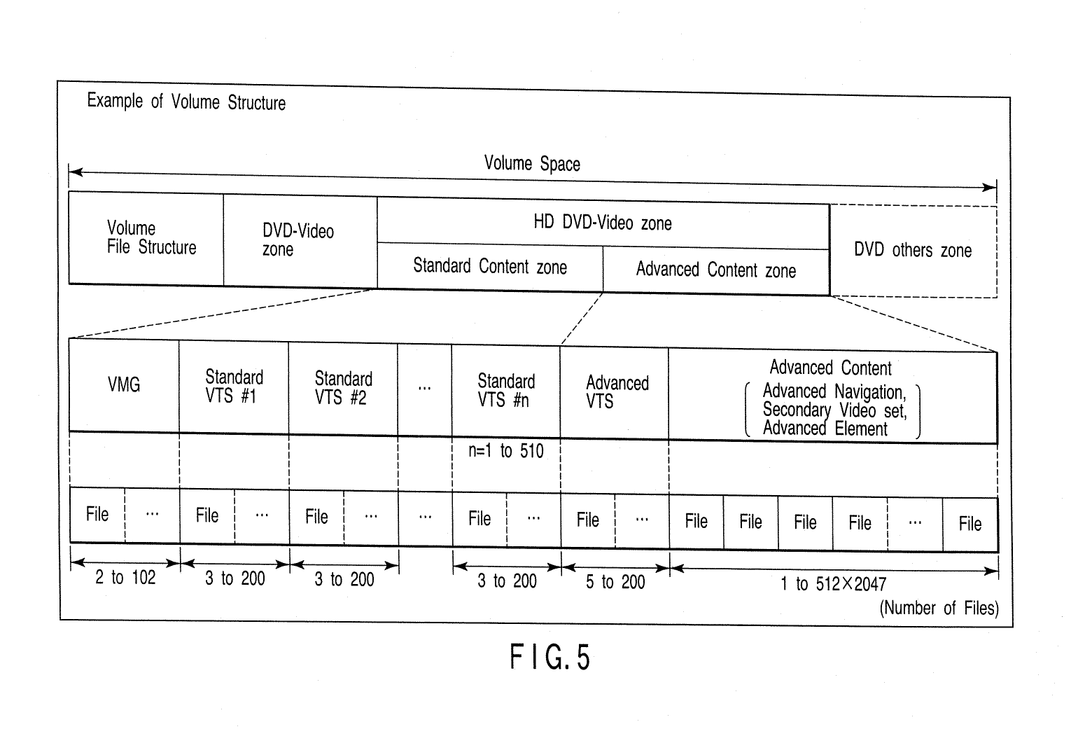

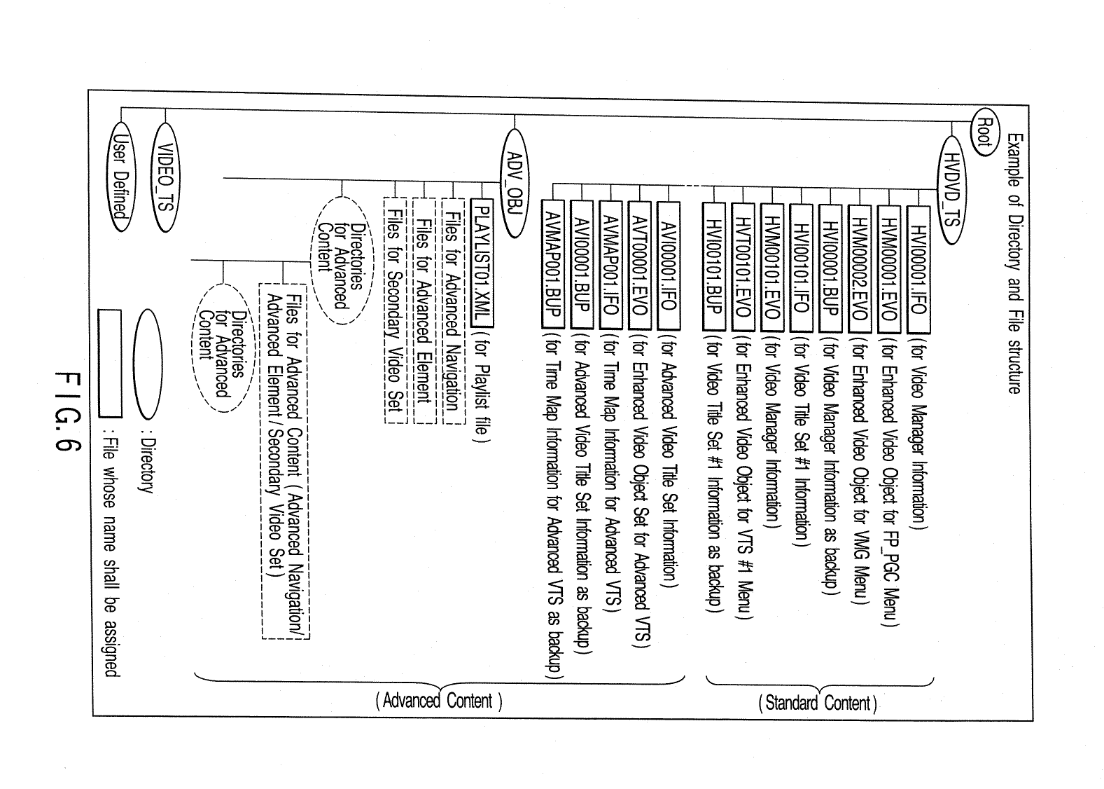

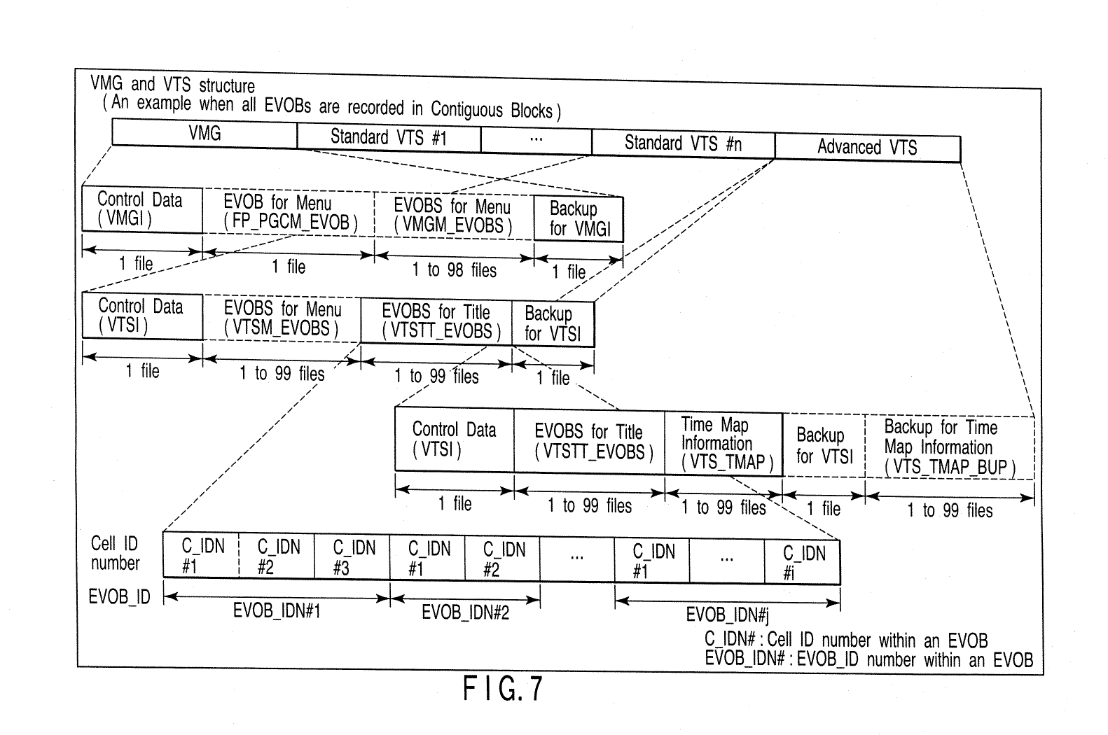

As shown in FIG. 5, the Volume Space of a HD DVD-Video disc consists of

1) The Volume and File structure, which shall be assigned for the UDF structure.

2) Single “DVD-Video zone”, which may be assigned for the data structure of DVD-Video format.

3) Single “HD DVD-Video zone”, which shall be assigned for the data structure of HD DVD-Video format. This zone consists of “Standard Content zone” and “Advanced Content zone”.

4) “DVD others zone”, which may be used for neither DVD-Video nor HD DVD-Video applications.

The following rules apply for HD DVD-Video zone.

1) “HD DVD-Video zone” shall consist of a “Standard Content zone” in Category 1 disc. “HD DVD-Video zone” shall consist of an “Advanced Content zone” in Category 2 disc. “HD DVD-Video zone” shall consist of both a “Standard Content zone” and an “Advanced Content zone” in Category 3 disc.

2) “Standard Content zone” shall consist of single Video Manager (VMG) and at least 1 with maximum 510 Video Title Set (VTS) in Category 1 disc, “Standard Content zone” should not exist in Category 2 disc and “Standard Content zone” consist of at least 1 with maximum 510 VTS in Category 3 disc.

3) VMG shall be allocated at the leading part of “HD DVD-Video zone” if it exists, that is Category 1 disc case.

4) VMG shall be composed of at least 2 with maximum 102 files.

5) Each VTS (except Advanced VTS) shall be composed of at least 3 with maximum 200 files.

6) “Advanced Content zone” shall consist of files supported in Advanced Content with an Advanced VTS. The maximum number of files for Advanced Content zone (under ADV_OBJ directory) is 512×2047.

7) Advanced VTS shall be composed of at least 5 with maximum 200 files.

Note: As for DVD-Video zone, refer to Part 3 (Video Specifications) of Ver. 1.0.

3.3.2 Directory and File Rules

The requirements for files and directories associated with a HD DVD-Video disc is described here.

HVDVD_TS directory

“HVDVD_TS” directory shall exist directly under the root directory. All files related with a VMG, Standard Video Set(s), an Advanced VTS (Primary Video Set) shall reside under this directory.

Video Manager (VMG)

A Video Manager Information (VMGI), an Enhanced Video Object for First Play Program Chain Menu (FP_PGCM_EVOB), a Video Manager Information for backup (VMGI_BUP) shall be recorded respectively as a component file under the HVDVD_TS directory. An Enhanced Video Object Set for Video Manager Menu (VMGM_EVOBS) of which size 1 GB (=230 bytes) or more should be divided into up to 98 files under the HVDVD_TS directory. For these files of a VMGM_EVOBS, every file shall be allocated contiguously.

Standard Video Title Set (Standard VTS)

A Video Title Set Information (VTSI) and a Video Title Set Information for backup (VTSI_BUP) shall be recorded respectively as a component file under the HVDVD_TS directory. An Enhanced Video Object Set for Video Title Set Menu (VTSM_EVOBS), and an Enhanced Video Object Set for Titles (VTSTT_VOBS) of which size 1 GB (=230 bytes) or more should be divided into up to 99 files so that the size of every file shall be less than 1 GB. These files shall be component files under the HVDVD_TS directory. For these files of a VTSM_EVOBS, and a VTSTT_EVOBS, every file shall be allocated contiguously.

Advanced Video Title Set (Advanced VTS)

A Video Title Set Information (VTSI) and a Video Title Set Information for backup (VTSI_BUP) may be recorded respectively as a component file under the HVDVD_TS directory. A Video Title Set Time Map Information (VTS_TMAP) and a Video Title Set Time Map Information for backup (VTS_TMAP_BUP) may be composed of up to 99 files under the HVDVD_TS directory respectively. An Enhanced Video Object Set for Titles (VTSTT_VOBS) of which size 1 GB (=230 bytes) or more should be divided into up to 99 files so that the size of every file shall be less than 1 GB. These files shall be component files under the HVDVD_TS directory. For these files of a VTSTT_EVOBS, every file shall be allocated contiguously.

The file name and directory name under the “HVDVD_TS” directory shall be applied according to the following rules.

1) Directory Name

The fixed directory name for DVD-Video shall be “HVDVD_TS”.

2) File Name for Video Manager (VMG)

The fixed file name for Video Manager Information shall be “HVI00001.IFO”.

The fixed file name for Enhanced Video Object for FP_PGC Menu shall be “HVM00001.EVO”.

The file name for Enhanced Video Object Set for VMG Menu shall be “HVM000%%.EVO”.

The fixed file name for Video Manager Information for backup shall be “HVI00001.BUP”.
“%%” shall be assigned consecutively in the ascending order from “02” to “99” for each Enhanced Video Object Set for VMG Menu.

3) File Name for Standard Video Title Set (Standard VTS)

The file name for Video Title Set Information shall be “HVI@@@01.IFO”.

The file name for Enhanced Video Object Set for VTS Menu shall be “HVM@@@##.EVO”.

The file name for Enhanced Video Object Set for Title shall be “HVT@@@##.EVO”.

The file name for Video Title Set Information for backup shall be “HVI@@@01.BUP”.
“@@@” shall be three characters of “001” to “511” to be assigned to the files of the Video Title Set number.
“##” shall be assigned consecutively in the ascending order from “01” to “99” for each Enhanced Video Object Set for VTS Menu or for each Enhanced Video Object Set for Title.

4) File Name for Advanced Video Title Set (Advanced VTS)

The file name for Video Title Set Information shall be “AVI00001.IFO”.

The file name for Enhanced Video Object Set for Title shall be “AVT000&&.EVO”.

The file name for Time Map Information shall be “AVMAP0$$.IFO”.

The file name for Video Title Set Information for backup shall be “AVI00001.BUP”.

The file name for Time Map Information for backup shall be “AVMAP0$$.BUP”.
“&&” shall be assigned consecutively in the ascending order from “01” to “99” for Enhanced Video Object Set for Title.
“$$” shall be assigned consecutively in the ascending order from “01” to “99” for Time Map Information.

ADV_OBJ Directory

“ADV_OBJ” directory shall exist directly under the root directory. All Playlist files shall reside just under this directory. Any files of Advanced Navigation, Advanced Element and Secondary Video Set can reside just under this directory. Playlist

Each Playlist files shall reside just under “ADV_OBJ” directory with having the file name “PLAYLIST %%.XML”. “%%” shall be assigned consecutively in the ascending order from “00” to “99”. The Playlist file which have the maximum number is interpreted initially (when a disc is loaded).

Directories for Advanced Content “Directories for Advanced Content” may exist only under the “ADV_OBJ” directory. Any files of Advanced Navigation, Advanced Element and Secondary Video Set can reside at this directory. The name of this directory shall be consisting of d-characters and d1-characters. The total number of “ADV_OBJ” sub-directories (excluding “ADV_OBJ” directory) shall be less than 512. Directory depth shall be equal or less than 8.

FILES for Advanced Content

The total number of files under the “ADV_OBJ” directory shall be limited to 512×2047, and the total number of files in each directory shall be less than 2048. The name of this file shall consist of d-characters or d1-characters, and the name of this file consists of body, “.” (period) and extension. An example of directory/file structure is shown in FIG. 6.

3.3.3 Structure of Video Manager (VMG)

The VMG is the table of contents for all Video Title Sets which exist in the “HD DVD-Video zone”.

As shown in FIG. 7, a VMG is composed of control data referred to as VMGI (Video Manager Information), Enhanced Video Object for First Play PGC Menu (FP_PGCM_EVOB), Enhanced Video Object Set for VMG Menu (VMGM_EVOBS) and a backup of the control data (VMGI_BUP). The control data is static information necessary to playback titles and providing information to support User Operation. The FP_PGCM_EVOB is an Enhanced Video Object (EVOB) used for the selection of menu language. The VMGM_VOBS is a collection of Enhanced Video Objects (EVOBs) used for Menus that support the volume access.

The following rules shall apply to Video Manager (VMG)

1) Each of the control data (VMGI) and the backup of control data (VMGI_BUP) shall be a single File which is less than 1 GB.

2) EVOB for FP_PGC Menu (FP_PGCM_EVOB) shall be a single File which is less than 1 GB. EVOBS for VMG Menu (VMGM_EVOBS) shall be divided into Files which are each less than 1 GB, up to a maximum of (98).

3) VMGI, FP_PGCM_EVOB (if present), VMGM_EVOBS (if present) and VMGI_BUP shall be allocated in this order.

4) VMGI and VMGI_BUP shall not be recorded in the same ECC block.

5) Files comprising VMGM_EVOBS shall be allocated contiguously.

6) The contents of VMGI_BUP shall be exactly the same as VMGI completely. Therefore, when relative address information in VMGI_BUP refers to outside of VMGI_BUP, the relative address shall be taken as a relative address of VMGI.

7) A gap may exist in the boundaries among VMGI, FP_PGCM_EVOB (if present), VMGM_EVOBS (if present) and VMGI_BUP.

8) In VMGM_EVOBS (if present), each EVOB shall be allocated contiguously.

9) VMGI and VMGI_BUP shall be recorded respectively in a logically contiguous area which is composed of consecutive LSNs.

Note: This specifications can be applied to DVD-R for General/DVD-RAM/DVD-RW as well as DVD-ROM but it shall comply with the rules of the data allocation described in Part 2 (File System Specifications) of each media.

3.3.4 Structure of Standard Video Title Set (Standard VTS)

A VTS is a collection of Titles. As shown in FIG. 7, each VTS is composed of control data referred to as VTSI (Video Title Set Information), Enhanced Video Object Set for the VTS Menu (VTSM_EVOBS), Enhanced Video Object Set for Titles in a VTS (VTSTT_EVOBS) and backup control data (VTSI_BUP).

The following rules shall apply to Video Title Set (VTS)

1) Each of the control data (VTSI) and the backup of control data (VTSI_BUP) shall be a single File which is less than 1 GB.

2) Each of the EVOBS for the VTS Menu (VTSM_EVOBS) and the EVOBS for Titles in a VTS (VTSTT_EVOBS) shall be divided into Files which are each less than 1 GB, up to a maximum of (99) respectively.

3) VTSI, VTSM_EVOBS (if present), VTSTT_EVOBS and VTSI_BUP shall be allocated in this order.

4) VTSI and VTSI_BUP shall not be recorded in the same ECC block.

5) Files comprising VTSM_EVOBS shall be allocated contiguously. Also files comprising VTSTT_EVOBS shall be allocated contiguously.

6) The contents of VTSI_BUP shall be exactly the same as VTSI completely. Therefore, when relative address information in VTSI_BUP refers to outside of VTSI_BUP, the relative address shall be taken as a relative address of VTSI.

7) VTS numbers are the consecutive numbers assigned to VTS in the Volume. VTS numbers range from ‘1’ to ‘511’ and are assigned in the order the VTS are stored on the disc (from the smallest LBN at the beginning of VTSI of each VTS).

8) In each VTS, a gap may exist in the boundaries among VTSI, VTSM_EVOBS (if present), VTSTT_EVOBS and VTSI_BUP.

9) In each VTSM_EVOBS (if present), each EVOB shall be allocated in contiguously.

10) In each VTSTT_EVOBS, each EVOB shall be allocated in contiguously.

11) VTSI and VTSI_BUP shall be recorded respectively in a logically contiguous area which is composed of consecutive LSNs

Note: This specifications can be applied to DVD-R for General/DVD-RAM/DVD-RW as well as DVD-ROM but it shall comply with the rules of the data allocation described in Part 2 (File System Specifications) of each media. As for details of the allocation, refer to Part 2 (File System Specifications) of each media.

3.3.5 Structure of Advanced Video Title Set (Advanced VTS)

This VTS consists of only one Title. As shown in FIG. 7, this VTS is composed of control data referred to as VTSI (see 6.3.1 Video Title Set Information), Enhanced Video Object Set for Titles in a VTS (VTSTT_EVOBS), Video Title Set Time Map Information (VTS_TMAP), backup control data (VTSI_BUP) and backup of Video Title Set Time Map Information (VTS_TMAP_BUP).

The following rules shall apply to Video Title Set (VTS)

1) Each of the control data (VTSI) and the backup of control data (VTSI_BUP) (if exists) shall be a single File which is less than 1 GB.

2) The EVOBS for Titles in a VTS (VTSTT_EVOBS) shall be divided into Files which are each less than 1 GB, up to a maximum of (99).

3) Each of a Video Title Set Time Map Information (VTS_TMAP) and the backup of this (VTS_TMAP_BUP) (if exists) shall be composed of files which are less than 1 GB, up to a maximum of (99).

4) VTSI and VTSI_BUP (if exists) shall not be recorded in the same ECC block.

5) VTS_TMAP and VTS_TMAP_BUP (if exists) shall not be recorded in the same ECC block.

6) Files comprising VTSTT_EVOBS shall be allocated contiguously.

7) The contents of VTSI_BUP (if exists) shall be exactly the same as VTSI completely. Therefore, when relative address information in VTSI_BUP refers to outside of VTSI_BUP, the relative address shall be taken as a relative address of VTSI.

8) In each VTSTT_EVOBS, each EVOB shall be allocated in contiguously.

Note: This specifications can be applied to DVD-R for General/DVD-RAM/DVD-RW as well as DVD-ROM but it shall comply with the rules of the data allocation described in Part 2 (File System Specifications) of each media.

As for details of the allocation, refer to Part 2 (File System Specifications) of each media.

3.3.6 Structure of Enhanced Video Object Set (EVOBS)

The EVOBS is a collection of Enhanced Video Object (refer to 5. Enhanced Video Object) which is composed of data on Video, Audio, Sub-picture and the like (See FIG. 7).

The following rules shall apply to EVOBS:

1) In an EVOBS, EVOBs are to be recorded in Contiguous Block and Interleaved Block. Refer to 3.3.12.1 Allocation of Presentation Data for Contiguous Block and Interleaved Block. In case of VMG and Standard VTS,

2) An EVOBS is composed of one or more EVOBs. EVOB_ID numbers are assigned from the EVOB with the smallest LSN in EVOBS, in ascending order starting with one (1).

3) An EVOB is composed of one or more Cells. C_ID numbers are assigned from the Cell with the smallest LSN in an EVOB, in ascending order starting with one (1).

4) Cells in EVOBS may be identified by the EVOB_ID number and the C_ID number.

3.3.7 Relation between Logical Structure and Physical Structure

The following rule shall apply to Cells for VMG and Standard VTS:

1) A Cell shall be allocated on the same layer.

3.3.8 MIME Type

The extension name and MIME Type for each resource in this specification shall be defined in Table 1.

TABLE 1
File Extension and MIME Type

| Extension | Content | MIME Type |
|---|---|---|
| XML, xml | Playlist | text/hddvd+xml |
| XML, xml | Manifest | text/hddvd+xml |
| XML, xml | Markup | text/hddvd+xml |
| XML, xml | Timing Sheet | text/hddvd+xml |
| XML, xml | Advanced | text/hddvd+xml |
| | Subtitle | |

4. System Model

4.1 Overview of System Model

4.1.1 Overall Startup Sequence

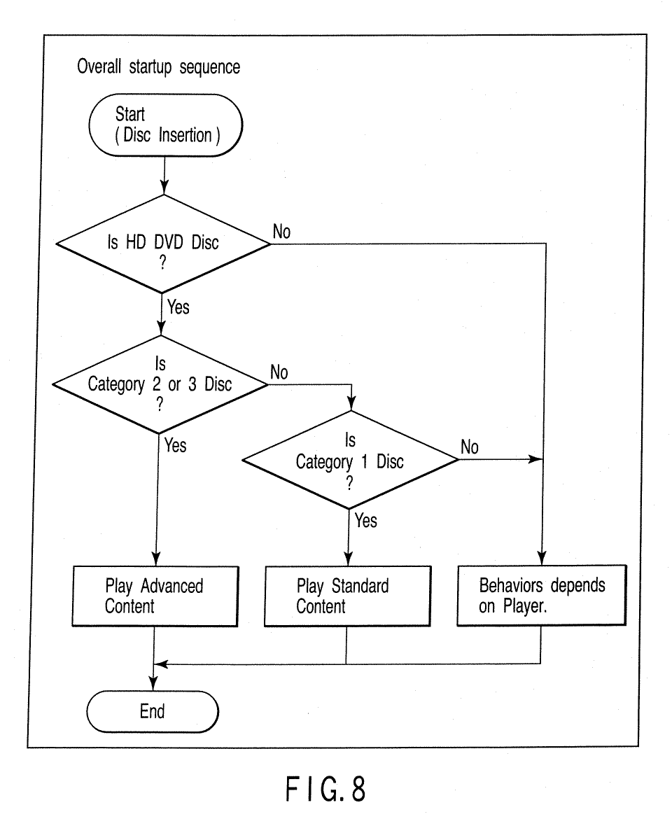

FIG. 8 is a flow chart of startup sequence of HD DVD player. After disc insertion, the player confirms whether there exists “playlist.xml (Tentative)” on “ADV_OBJ” directory under the root directory. If there is “playlist.xml (Tentative)”, HD DVD player decides the disk is Category 2 or 3. If there is no “playlist.xml (Tentative)”, HD DVD player checks disk VMG_ID value in VMGI on disc. If the disc is category 1, it shall be “HDDVD-VMG200”. [b0-b15] of VMG_CAT shall indicate Standard Contents only. If the disc does not belong any type of HD DVD categories, the behaviors depends on each player. For detail about VMGI, see [5.2.1 Video Manager Information (VMGI)].

Playback procedure between Advanced Content and Standard Content are deferent. For Advanced Content, see System Model for Advanced Content. For detail of Standard Content, see Common System Model.

4.1.2 Information Data to be Handle by Player

There are some necessary information data stored in P-EVOB (Primary Enhanced Video Object) to be handled by player in the each content (Standard Content, Advanced Content or Interoperable Content).

Such information data are GCI (General Control Information), PCI (Presentation Control Information) and DSI (Data Search Information) which are stored in Navigation pack (NV_PCK), and HLI (Highlight Information) stored in plural HLI packs.

A Player shall handle the necessary information data in the each content as shown in Table 2.

TABLE 2
Information data to be handle by player

| Infor- | | | |
|---|---|---|---|
| mation | | Advanced | Interoperable |
| data | Standard Content | Content | Content |
| GCI | Shall be handled by player | Shall be handled | Shall be |
| | | by player | handled by |
| | | | player |
| PCI | Shall be handled by player | If exist, ignored | NA |
| | | by player | |
| DSI | Shall be handled by player | Shall be handled | NA |
| | | by player | |
| HLI | If exist, player shall handle | If exist, ignored | NA |
| | HLI by “HLI availability” | by player | |
| | flag | | |
| (RDI) | NA | NA | Ignored by |
| | | | player |

NA: Not Applicable
Note:
RDI (Realtime Data Information) is defined in “DVD Specifications for High Density Rewritable Disc/Part 3: Video Recording Specifications (tentative)”

4.3 System Model for Advanced Content

This section describes system model for Advanced Content playback.

4.3.1 Data Types of Advanced Content

4.3.1.1 Advanced Navigation

Advanced Navigation is a data type of navigation data for Advanced Content which consists of following type files. As for detail of Advanced Navigation, see [6.2 Advanced Navigation].
Playlist
Loading information
Markup
Content
Styling
Timing
Script

4.3.1.2 Advanced Data

Advanced Data is a data type of presentation data for Advanced Content. Advanced data can be categorized following four types,
Primary Video Set
Secondary Video Set
Advanced Element
Others.

4.3.1.2.1 Primary Video Set

Primary Video Set is a group of data for Primary Video. The data structure of Primary Video Set is in conformity to Advanced VTS, which consists of Navigation Data (e.g. VTSI and TMAPs) and Presentation Data (e.g. P-EVOB-TY2). Primary Video Set shall be stored on Disc. Primary Video Set can include various presentation data in it. Possible presentation stream types are main video, main audio, sub video, sub audio and sub-picture. HD DVD player can simultaneously play sub video and sub audio, in addition to primary video and audio. During sub video and sub audio is being played back, sub video and sub audio of Secondary Video Set cannot be played. For detail of Primary Video Set, see [6.3 Primary Video Set].

4.3.1.2.2 Secondary Video Set

Secondary Video Set is a group of data for network streaming and pre-downloaded content on File Cache. The data structure of Secondary Video Set is a simplified structure of Advanced VTS, which consists of TMAP and Presentation Data (S-EVOB). Secondary Video Set can include sub video, sub audio, Complementary Audio and Complementary Subtitle. Complementary Audio is for alternative audio stream which is to replace Main Audio in Primary Video Set. Complementary Subtitle is for alternative subtitle stream which is to replace Sub-Picture in Primary Video Set. The data format of Complementary Subtitle is Advanced Subtitle. For detail of Advanced Subtitle, see [6.5.4 Advanced Subtitle]. Possible combinations of presentation data in Secondary Video Set are described in Table 3. As for detail of Secondary Video Set, see [6.4 Secondary Video Set].

TABLE 3
Possible Presentation Data Stream
in Secondary Video Set (Tentative)

| | | Com- | Com- | | |
|---|---|---|---|---|---|
| Sub | Sub | plementary | plementary | | Possible |
| Video | Audio | Audio | Subtitle | Typical Usage | Bit-rate |
| ◯ | ◯ | | | Secondary | T.B.D. |
| | | | | Video/Audio | |
| ◯ | | | | Secondary | T.B.D. |
| | | | | Video | |
| | ◯ | | | Background | T.B.D. |
| | | | | Music | |
| | | ◯ | | Replacement | T.B.D. |
| | | | | to Main Audio | |
| | | | | of Primary | |
| | | | | Video Set | |
| | | | ◯ | Replacement | T.B.D. |
| | | | | to Sub-picture | |
| | | | | of Primary | |
| | | | | Video Set | |

4.3.1.2.3 Advanced Element

Advanced Element is presentation material which is used for making graphic plane, effect sound and any types of files which are generated by Advanced Navigation, Presentation Engine or received from Data source. Following data formats are available. As for detail of Advanced Element, see [6.5 Advanced Element].
Image/Animation
PNG
JPEG
MNG
Audio
WAV
Text/Font
UNICODE format, UTF-8 or UTF-16
Open Font

4.3.1.3 Others

Advanced Content Player can generate data files which format are not specified in this specification. They may be a text file for game scores generated by scripts in Advanced Navigation or cookies received when Advanced Content starts accessing to specified network server. Some kind of these data files may be treated as Advanced Element, such as the image file captured by Primary Video Player instructed by Advanced Navigation.

4.3.2 Primary Enhanced Video Objects Type2 (P-EVOB-TY2)

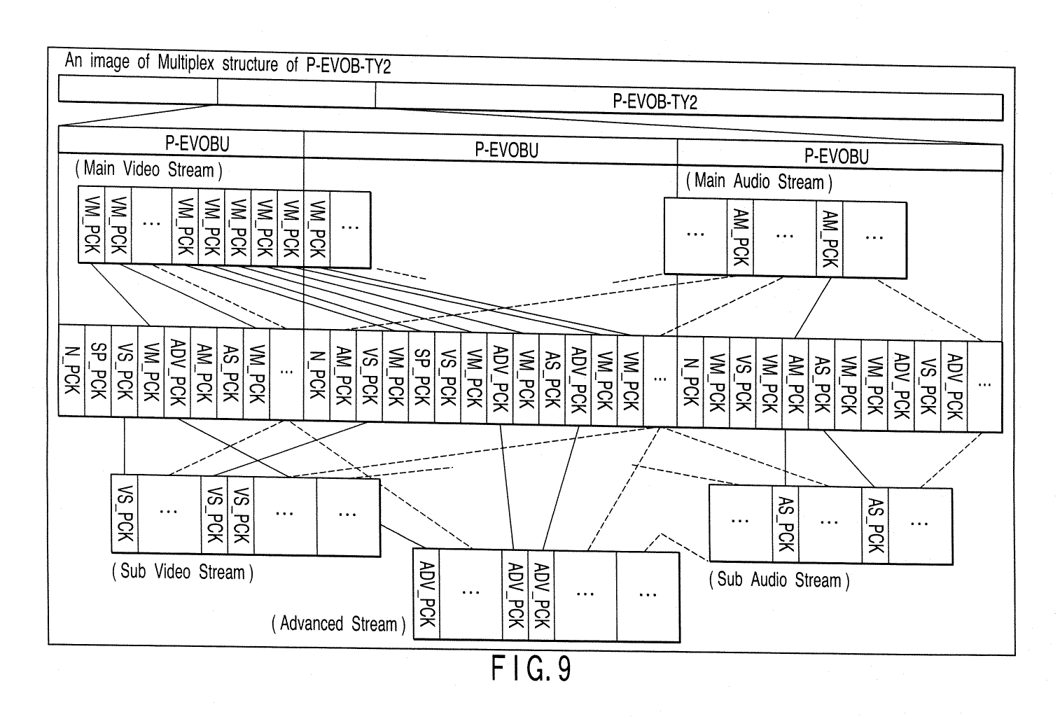

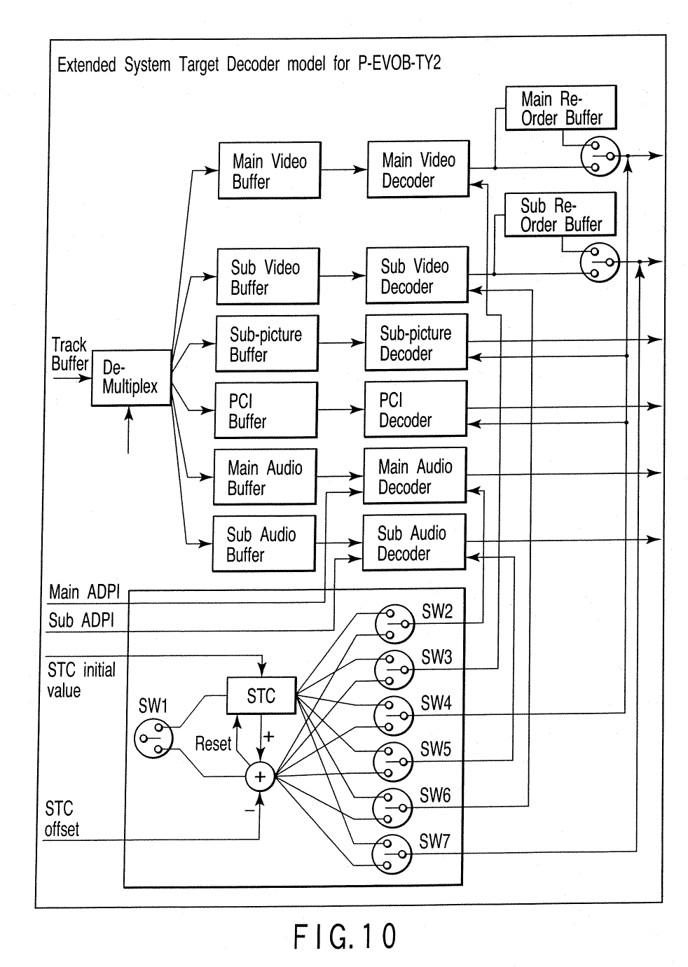

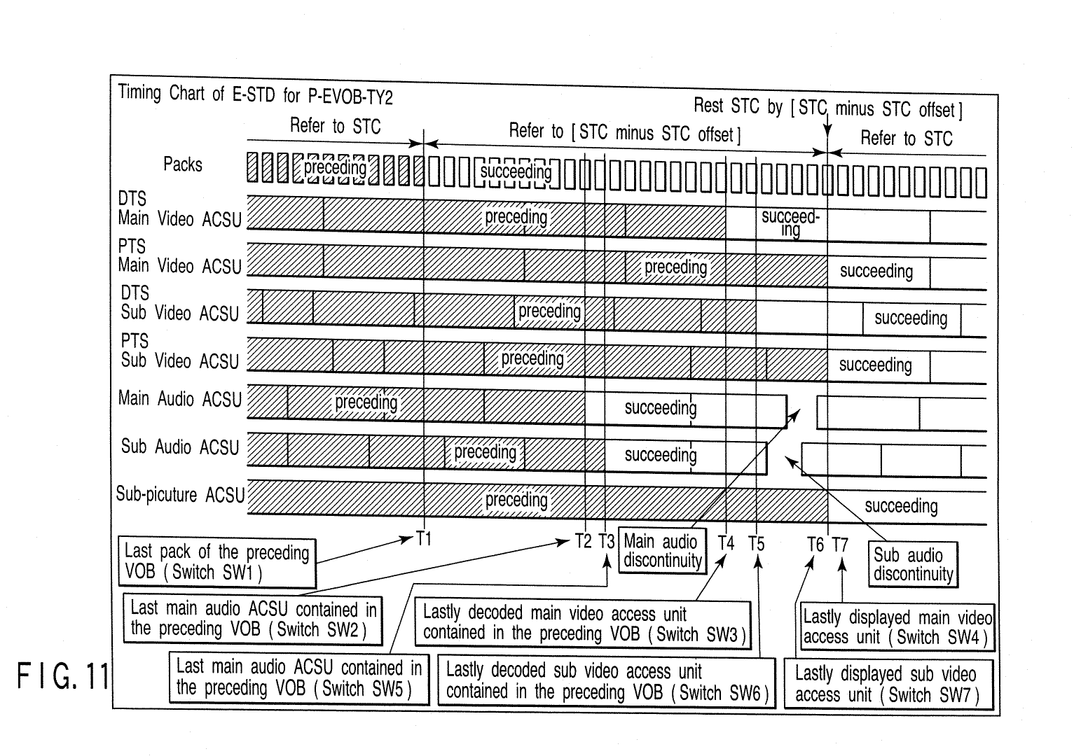

Primary Enhanced Video Object type 2 (P-EVOB-TY2) is the data stream which carries presentation data of Primary Video Set. Primary Enhanced Video Object type2 complies with program stream prescribed in “The system part of the MPEG-2 standard (ISO/IEC 13818-1)”. Types of presentation data of Primary Video Set are main video, main audio, sub video, sub audio and sub picture. Advanced Stream is also multiplexed into P-EVOB-TY2. See, FIG. 9.

Possible pack types in P-EVOB-TY2 are following,
Navigation Pack (N_PCK)
Main Video Pack (VM_PCK)
Main Audio Pack (AM_PCK)
Sub Video Pack (VS_PCK)
Sub Audio Pack (AS_PCK)
Sub Picture Pack (SP_PCK)
Advanced Stream Pack (ADV_PCK)

For detail, see [6.3.3 Primary EVOB (P-EVOB)].

Time Map (TMAP) for Primary Enhanced Video Set type 2 has entry points for each Primary Enhanced Video Object Unit (P-EVOBU). Detail of Time Map, see [6.3.2 Time Map (TMAP)].

Access Unit for Primary Video Set is based on access unit of Main Video as well as traditional Video Object (VOB) structure. The offset information for Sub Video and Sub Audio is given by Synchronous Information (SYNCI) as well as Main Audio and Sub-Picture. For detail of Synchronous Information, see [5.2.7 Synchronous Information (SYNCI)].

Advanced Stream is used for supplying various kinds of Advanced Content files to File Cache without any interruption of Primary Video Set playback. The demux module in Primary Video Player distributes Advanced Stream Pack (ADV_PCK) to File Cache Manager in Navigation Engine. For detail of File Cache Manager, see [4.3.15.2 File Cache Manager].

4.3.3 Input Buffer Model for Primary Enhanced Video Objects Type2 (P-EVOB-TY2)

4.3.4 Decoding Model for Primary Enhanced Video Object Type2 (P-EVOB-TY2)

4.3.4.1 Extended System Target Decoder (E-STD) Model for Primary Enhanced Video Object Type2

FIG. 10 shows E-STD model configuration for Primary Enhanced Video Object type 2. The figure indicates P-STD (prescribed in the MPEG-2 system standard) and the extended functionality for E-STD for Primary Enhanced Video Object type 2.

a) System Time Clock (STC) is explicitly included as an element.

b) STC offset is the offset value, which is used to change a STC value when P-EVOB-TY2s are connected together and presented seamlessly.

c) SW1 to SW7 allow switching between STC value and [STC minus STC offset] value at P-EVOB-TY2 boundary.

d) Because of the difference among the presentation duration of the Main Video access unit, Sub Video access unit, Main audio access unit and Sub audio access unit, a discontinuity between adjacent access units in time stamps may exist in some Audio streams.

Whenever Main or Sub Audio Decoder meets a discontinuity, these Audio Decoders shall be paused temporarily before resuming. For this purpose, Main Audio Decoder Pause Information (M-ADPI) and Sub Audio Decoder Pause Information (S-ADPI) shall be given externally independent and may be derived from Seamless Playback Information (SML_PBI) stored in DSI.

4.3.22.2 Operation of E-STD for Primary Enhanced Video Object Type2

(1) Operations as P-STD

The E-STD Model functions the same as the P-STD. It behaves in the following way:

(a) SW1 to SW7 are always set for STC, so STC offset is not used.

(b) As continuous presentation of an Audio stream is guaranteed, M-ADPI and S-ADPI are not to be sent to the Main and Sub Audio Decoder.

Some P-EVOBs may guarantee Seamless Play when the presentation path of Angle is changed. At all such changeable locations where the head of Interleaved Unit (ILVU) are, the P-EVOB-TY2 before and the P-EVOB-TY2 after the change shall behave under the conditions defined in P-STD.

(2) Operations as E-STD

The following describes the behavior E-STD when P-EVOB-TY2s input continuously to E-STD. Refer to FIG. 11.

<Input Timing to the E-STD for P-EVOB-TY2 (T1)>

As soon as the last pack of the preceding P-EVOB-TY2 has entered the ESTD for P-EVOB-TY2 [Timing T1 in FIG. 11, STC offset is set and SW1 is switched to [STC minus STC offset]. Then, input timing to E-STD will be determined by System Clock Reference (SCR) of the succeeding P-EVOB-TY2.

STC offset is set based on the following rules:

a) STC offset shall be set assuming continuity of Video streams contained in the preceding P-EVOB-TY2 and the succeeding P-EVOB-TY2. That is, the time which is the sum of the presentation time (Tp) of the last displayed Main Video access unit in the preceding P-EVOB-TY2 and the duration (Td) of the video presentation of the Main Video access unit shall be equal to the sum of the first presentation time (Tf) of the first displayed Main Video access unit contained in the succeeding P-EVOB-TY2 and the STC offset.

Tp+Td=Tf+STC offset

It should be noted that STC offset itself is not encoded in the data structure. Instead the presentation termination time Video End PTM in P-EVOB-TY2 and starting time Video Start PTM in P-EVOB-TY2 of P-EVOB-TY2 shall be described in NV_PCK. The STC offset is calculated as follows:

STC offset=Video End PTM in P-EVOB-TY2 (preceding)−Video Start PTM in P-EVOB-TY2 (succeeding)

b) While SW1 is set to [STC minus STC offset] and the value [STC minus STC offset] is negative, input to E-STD shall be prohibited until the value becomes 0 or positive.

<Main Audio Presentation Timing (T2)>

Let T2 be the time which is the sum of the time when the last Main audio access unit contained in the preceding P-EVOB-TY2 is presented and the presentation duration of the Main audio access unit.

At T2, SW2 is switched to [STC minus STC offset]. Then, the presentation is carried out triggered by Presentation Time Stamp (PTS) of the Main Audio packet contained in the succeeding P-EVOB-TY2. The time T2 itself does not appear in the data structure. Main audio access unit shall continue to be decoded at T2.

<Sub Audio Presentation Timing (T3)>

Let T3 be the time which is the sum of the time when the last Sub audio access unit contained in the preceding P-EVOB-TY2 is presented and the presentation duration of the Sub audio access unit.

At T3, SW5 is switched to [STC minus STC offset]. Then, the presentation is carried out triggered by PTS of the Sub Audio packet contained in the succeeding P-EVOB-TY2. The time T3 itself does not appear in the data structure. Sub Audio access unit shall continue to be decoded at T3.

<Main Video Decoding Timing (T4)>

Let T4 be the time which is the sum of the time when the lastly decoded Main video access unit contained in the preceding P-EVOB-TY2 is decoded and the decoding duration of the Main video access unit.

At T4, SW3 is switched to [STC minus STC offset]. Then, the decoding is carried out triggered by Decoding Time Stamp (DTS) of the Main video packet contained in the succeeding P-EVOB-TY2. The time T4 itself does not appear in the data structure.

<Sub Video Decoding Timing (T5)>

Let T5 be the time which is the sum of the time when the lastly decoded Sub video access unit contained in the preceding P-EVOB-TY2 is decoded and the decoding duration of the Sub video access unit.

At T5, SW6 is switched to [STC minus STC offset]. Then, the decoding is carried out triggered by DTS of the Sub video packet contained in the succeeding P-EVOB-TY2. The time T5 itself does not appear in the data structure.

<Main Video/Sub-Picture/PCI Presentation Timing (T6)>

Let T6 be the time which is the sum of the time when the lastly displayed Main video access unit contained in the preceding Program stream is presented and the presentation duration of the Main video access unit.

At T6, SW4 is switched to [STC minus STC offset]. Then, the presentation is carried out triggered by PTS of the Main Video packet contained in the succeeding P-EVOB-TY2. After T6, presentation timing of Sub-pictures and PCI are also determined by [STC minus STC offset].

<Sub Video Presentation Timing (T7)>

Let T7 be the time which is the sum of the time when the lastly displayed Sub video access unit contained in the preceding Program stream is presented and the presentation duration of the Sub video access unit.

At T7, SW7 is switched to [STC minus STC offset]. Then, the presentation is carried out triggered by PTS of the Sub Video packet contained in the succeeding P-EVOB-TY2.

(Seamless Playback Restrictions for Sub Video is Tentative)

In case of T7 (approximately) equals to T6, the presentation of Sub Video is guaranteed seamless.

In case of T7 is earlier than T6, Sub Video presentation causes some gap.

T7 shall not be after T6.

<Reset of STC>

As soon as SW1 to SW7 are all switched to [STC minus STC offset], STC is reset according to the value of [STC minus STC offset] and SW1 to SW7 are all switched to STC.

<M-ADPI: Main Audio Decoder Pause Information for Main Audio Discontinuity>

M-ADPI comprises the STC value at which pause status Main Audio Stop Presentation Time in P-EVOB-TY2 and the pause duration Main Audio Gap Length in P-EVOB-TY2. If M-ADPI with non-zero pause duration is given, the Main-audio Decoder does not decode the Main Audio access unit while the pause duration.

Main Audio discontinuity shall be allowed only in a P-EVOB-TY2 which is allocated in an Interleaved Block.

In addition, maximum two of the discontinuities are allowed in a P-EVOB-TY2.

<S-ADPI: Sub Audio Decoder Pause Information for Sub Audio Discontinuity>

S-ADPI comprises the STC value at which pause status Sub Audio Stop Presentation Time in P-EVOB-TY2 and the pause duration Sub Audio Gap Length in P-EVOB-TY2. If S-ADPI with non-zero pause duration is given, the Sub Audio Decoder does not decode the Sub Audio access unit while the pause duration.

Sub Audio discontinuity shall be allowed only in a P-EVOB-TY2 which is allocated in an Interleaved Block.

In addition, maximum two of the discontinuities are allowed in a P-EVOB-TY2.

4.3.5 Secondary Enhanced Video Object (S-EVOB)

For example, on the basis of applications, such content as graphic video or animation can be processed.

4.3.6 Input Buffer Model for Secondary Enhanced Video Object (S-EVOB)

As for the secondary enhanced video object, a medium similar to that in the main video may be used as the input buffer. Alternatively, another medium may be used as a source.

4.3.7 Environment for Advanced Content Playback

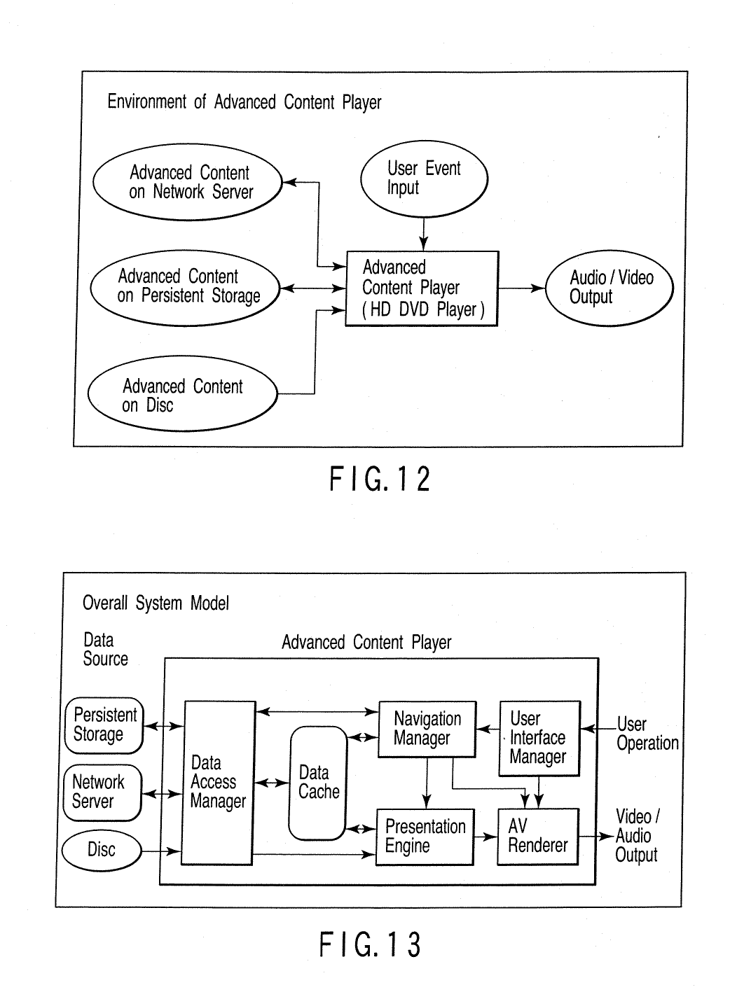

FIG. 12 shows Environment of Advanced Content Player. The advanced content player is a logical player for Advanced Content.

Data Sources of Advanced Content are disc, network server and persistent storage. For Advanced Content playback, category 2 or 3 disc shall be needed. Any data types of Advanced Content can be stored on Disc. For Persistent Storage and Network Server, any data types of Advanced Content except for Primary Video Set can be stored. As for detail of Advanced Content, see [6. Advanced Content].

The user event input originates from user input devices, such as a remote controller or front panel of HD DVD player. Advanced Content Player is responsible to input user events to Advanced Content and generate proper responses. As for detail of user input model.

The audio and video outputs are presented on speakers and display devices, respectively. Video output model is described in [4.3.17.1 Video Mixing Model]. Audio output model is described in [4.3.17.2 Audio Mixing Model].

4.3.8 Overall System Model

Advanced Content Player is a logical player for Advanced Content. A simplified Advanced Content Player is described in FIG. 13. It consists of six logical functional modules, Data Access Manager, Data Cache, Navigation Manager, User Interface Manager, Presentation Engine and AV Renderer.

Data Access Manager is responsible to exchange various kind of data among data sources and internal modules of Advanced Content Player.

Data Cache is temporal data storage for playback advanced content.

Navigation Manager is responsible to control all functional modules of Advanced Content player in accordance with descriptions in Advanced Navigation.

User Interface Manager is responsible to control user interface devices, such as remote controller or front panel of HD DVD player, and then notify User Input Event to Navigation Manager.

Presentation Engine is responsible for playback of presentation materials, such as Advanced Element, Primary Video Set and Secondary Video set.

AV Renderer is responsible to mix video/audio inputs from other modules and output to external devices such as speakers and display.

4.3.9 Data Source

This section shows what kinds of Data Sources are possible for Advanced Content playback.

4.3.9.1 Disc

Disc is a mandatory data source for Advanced Content playback. HD DVD Player shall have HD DVD disc drive. Advanced Content should be authored to be played back even if available data source is only disc and mandatory persistent storage.

4.3.9.2 Network Server

Network Server is an optional data source for Advanced Content playback, but HD DVD player must have network access capability. Network Server is usually operated by the content provider of the current disc. Network Server usually locates in the internet.

4.3.9.3 Persistent Storage

There are two categories of Persistent Storage.

One is called as “Fixed Persistent Storage”. This is a mandatory persistent storage device attached in HD DVD Player. FLASH memory is typical device for this. The minimum capacity for Fixed Persistent Storage is 64 MB.

Others are optional and called as “Additional Persistent Storage”. They may be removable storage devices, such as USB memory/HDD or memory card. NAS is one of possible Additional Persistent Storage device. Actual device implementation is not specified in this specification. They must pursuant API model for Persistent Storage. As for detail of API model for Persistent Storage.

4.3.10 Disc Data Structure

4.3.10.1 Data Types on Disc

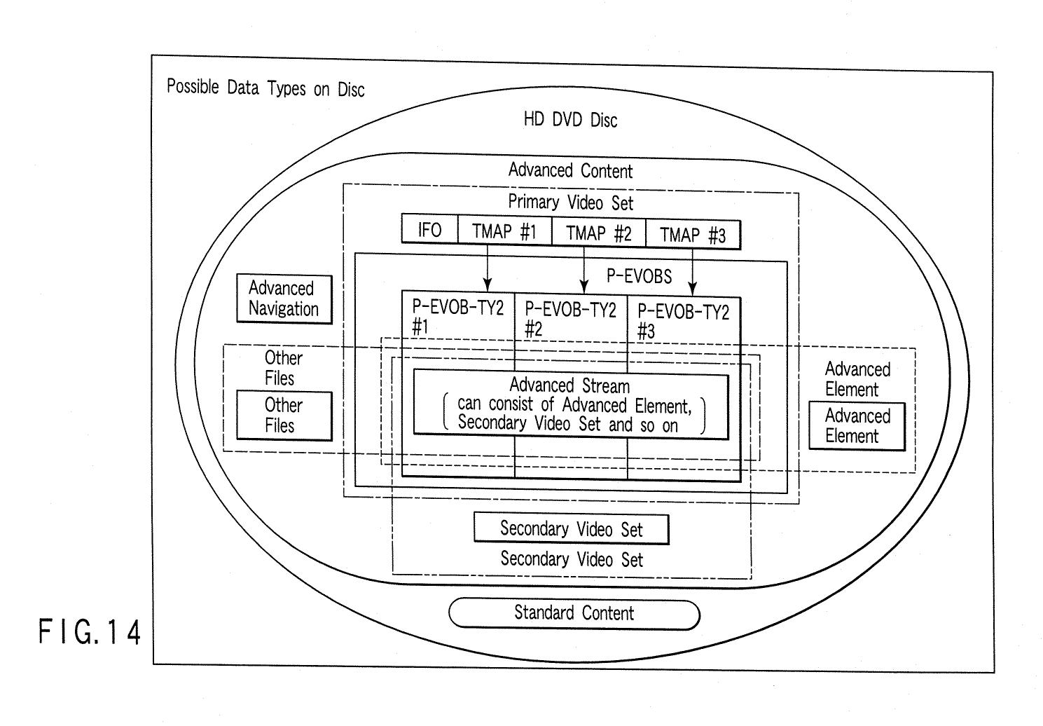

The data types which shall/may be stored on HD DVD disc is shown in FIG. 14. Disc can store both Advanced Content and Standard Content. Possible data types of Advanced Content are Advanced Navigation, Advanced Element, Primary Video Set, Secondary Video Set and others. As for detail of Standard Content, see [5. Standard Content].

Advanced Stream is a data format which is archived any type of Advanced Content files except for Primary Video Set. The format of Advanced Stream is T.B.D. without any compression. As for detail of archiving, see [6.6 archiving]. Advanced Stream is multiplexed into Primary Enhanced Video Object type2 (P-EVOBS-TY2) and pulled out with P-EVOBS-TY2 data supplying to Primary Video Player. As for detail of P-EVOBS-TY2, see [4.3.2 Primary Enhanced Video Objects type2 (P-EVOB-TY2)]. The same files which are archived in Advanced Stream and mandatory for Advanced Content playback, should be stored as files. These duplicated copies are necessary to guarantee Advanced Content playback. Because Advanced Stream supply may not be finished, when Primary Video Set playback is jumped. In this case, necessary files are directly read from disc and stored to Data Cache before re-starting playback from specified jumping position.

Advanced Navigation:

Advanced Navigation files shall be located as files. Advanced Navigation files are read during the startup sequence and interpreted for Advanced Content playback. Advanced Navigation files for startup shall be located on “ADV_OBJ” directory.

Advanced Element:

Advanced Element files may be located as files and also archived in Advanced Stream which is multiplexed in P-EVOB-TY2.

Primary Video Set:

There is only one Primary Video Set on Disc.

Secondary Video Set:

Secondary Video Set files may be located as files and also archived in Advanced Stream which is multiplexed in P-EVOB-TY2.

Other Files:

There may exist Other Files depends on Advanced Content.

4.3.10.1.1 Directory and File Configurations

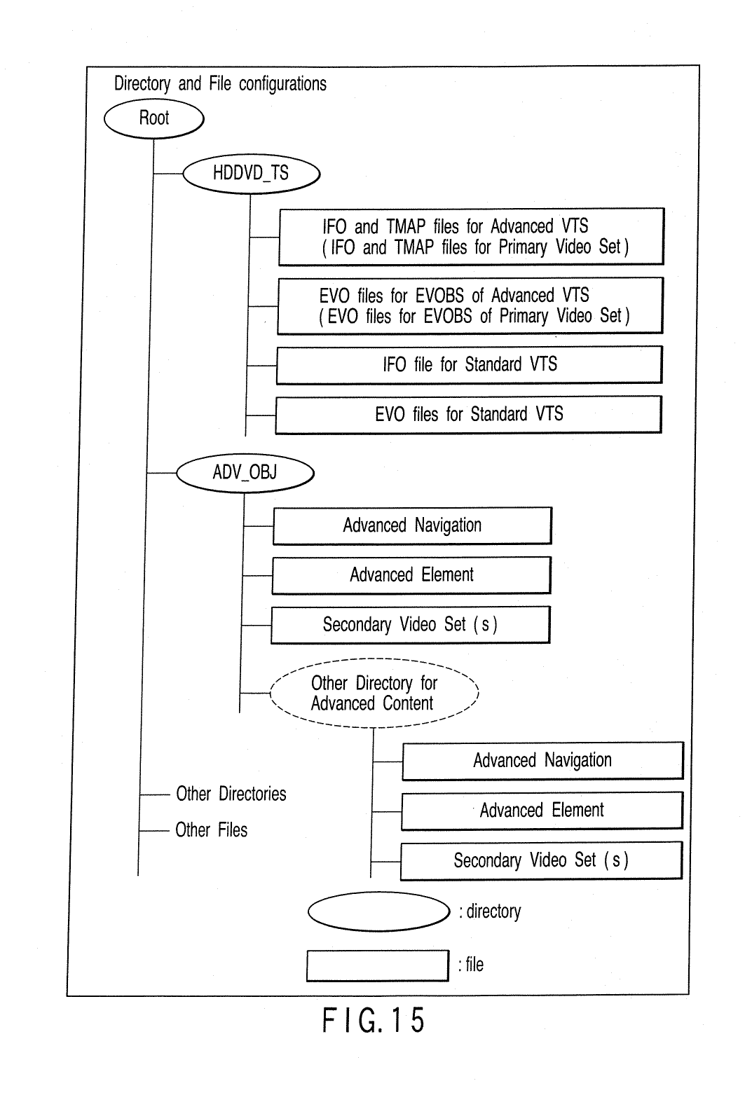

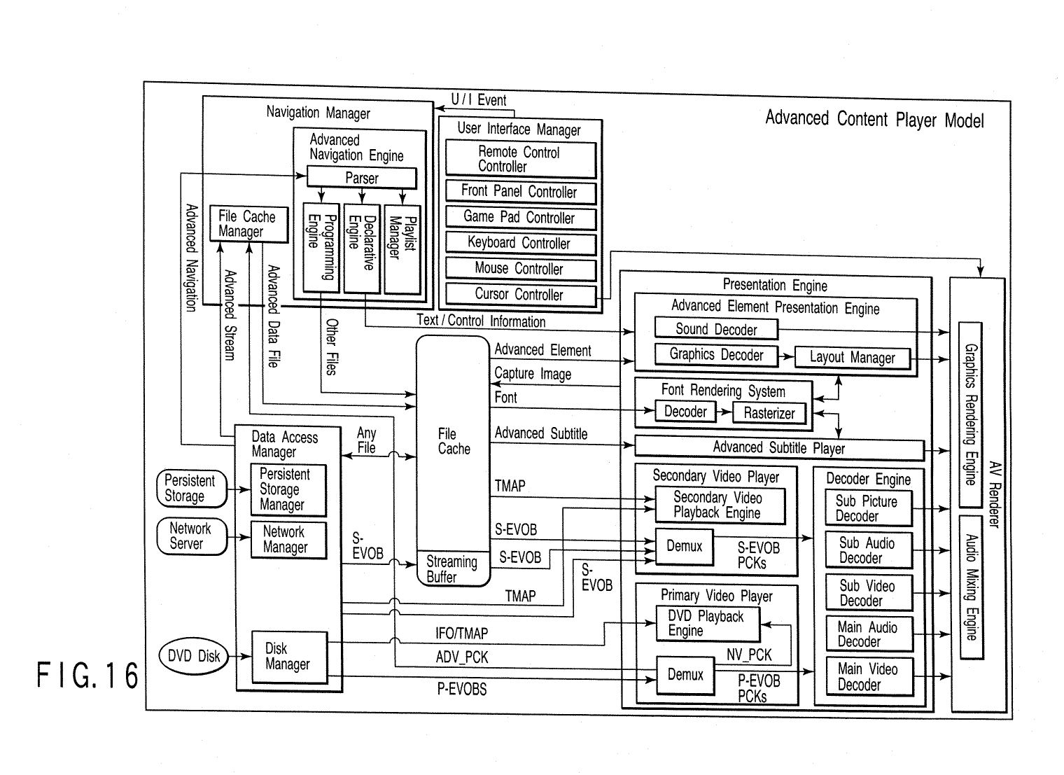

In terms of file system, files for Advanced Content shall be located in directories as shown in FIG. 15.

HDDVD_TS directory

“HDDVD_TS” directory shall exist directly under the root directory. All files of an Advanced VTS for Primary Video Set and one or plural Standard Video Set(s) shall reside at this directory.

ADV_OBJ directory

“ADV_OBJ” directory shall exist directly under the root directory. All startup files belonging to Advanced Navigation shall reside at this directory. Any files of Advanced Navigation, Advanced Element and Secondary Video Set can reside at this directory.

Other Directories for Advanced Content

“Other directories for Advanced Content” may exist only under the “ADV_OBJ” directory. Any files of Advanced Navigation, Advanced Element and Secondary Video Set can reside at this directory. The name of this directory shall be consisting of d-characters and d1-characters. The total number of “ADV_OBJ” sub-directories (excluding “ADV_OBJ” directory) shall be less than 512. Directory depth shall be equal or less than 8.

FILES for Advanced Content

The total number of files under the “ADV_OBJ” directory shall be limited to 512×2047, and the total number of files in each directory shall be less than 2048. The name of this file shall consist of d-characters or d1-characters, and the name of this file consists of body, “.” (period) and extension.

4.3.11 Data Types on Network Server and Persistent Storage

Any Advanced Content files except for Primary Video Set can exist on Network Server and Persistent Storage. Advanced Navigation can copy any files on Network Server or Persistent Storage to File Cache by using proper API(s). Secondary Video Player can read Secondary Video Set from Disc, Network Server or Persistent Storage to Streaming Buffer. For details for network architecture, see [9. Network].

Any Advanced Content files except for Primary Video Set can be stored to Persistent Storage.

4.3.12 Advanced Content Player Model

FIG. 16 shows detail system model of Advanced Content Player. There are six Major Modules, Data Access Manager, Data Cache, Navigation Manager, Presentation Engine, User Interface Manager and AV Renderer. As for detail of each function modules, see following sections.
Data Access Manager—[4.3.13 Data Access Manager]
Data Cache—[4.3.14 Data Cache].
Navigation manager—[4.3.15 Navigation Manager].
Presentation Engine—[4.3.16 Presentation Engine]
AV Renderer—[4.3.17 AV Renderer:].
User Interface Manager—[4.3.18 User Interface Manager].

4.3.13 Data Access Manager

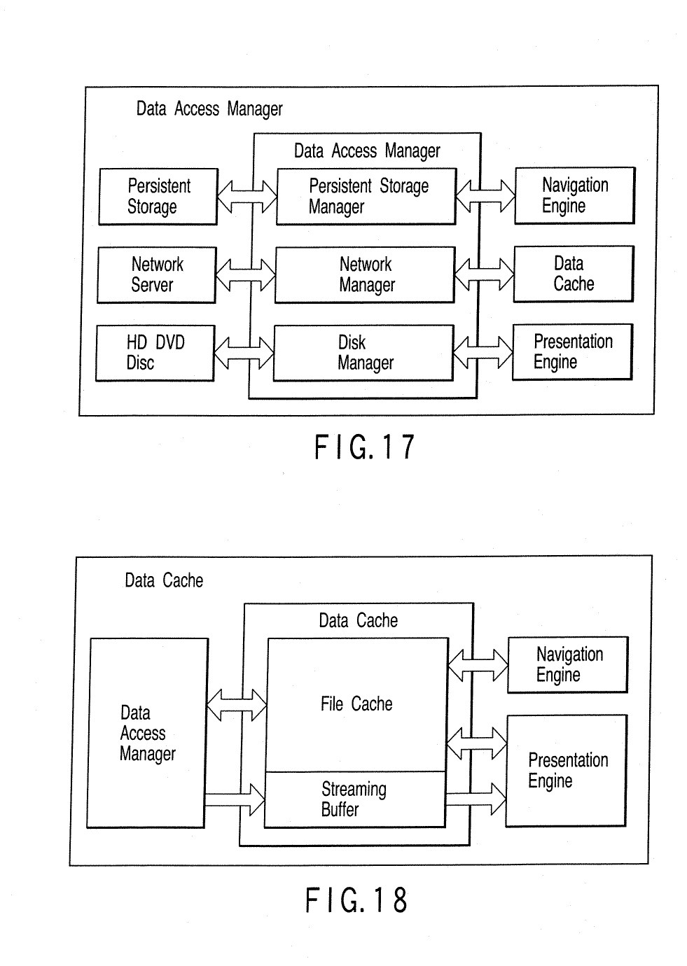

Data Access Manager consists of Disc Manger, Network Manager and Persistent Storage Manager (see FIG. 17).

Persistent Storage Manager:

Persistent Storage Manager controls data exchange between Persistent Storage Devices and internal modules of Advanced Content Player. Persistent Storage Manager is responsible to provide file access API set for Persistent Storage devices. Persistent Storage devices may support file read/write functions.

Network Manager:

Network Manager controls data exchange between Network Server and internal modules of Advanced Content Player. Network Manager is responsible to provide file access API set for Network Server. Network Server usually supports file download and some Network Servers may support file upload. Navigation Manager invokes file download/upload between Network Server and File Cache in accordance with Advanced Navigation. Network Manager also provides protocol level access functions to Presentation Engine. Secondary Video Player in Presentation Engine can utilize these API set for streaming from Network Server. As for detail of network access capability, see [9. Network].

4.3.14 Data Cache

Data Cache can be divided into two kinds of temporal data storages. One is File Cache which is temporal buffer for file data. The other is Streaming Buffer which is temporal buffer for streaming data. Data Cache quota for Streaming Buffer is described in “playlist00.xml” and Data Cache is divided during startup sequence of Advanced Content playback. Minimum size of Data Cache is 64 MB. Maximum size of Data Cache is T.B.D (See, FIG. 18).

4.3.14.1 Data Cache Initialization

Data Cache configuration is changed during startup sequence of Advanced Content playback. “playlist00.xml” can include size of Streaming Buffer. If there is no Streaming Buffer size, it indicates Streaming Buffer size equals zero. The byte size of Streaming Buffer size is calculated as follows

<streamingBuf size=“1024”/>

Streaming Buffer size=1024×2 (KByte)

=2048 (KByte)

Minimum Streaming Buffer size is zero byte. Maximum Streaming Buffer size is T.B.D. As for detail of Startup Sequence, see 4.3.28.2 Startup Sequence of Advanced Content.

4.3.14.2 File Cache

File Cache is used for temporal file cache among Data Sources, Navigation Engine and Presentation Engine. Advanced Content files, such as graphics image, effect sound, text and font, should be stored in File Cache in advance they are accessed by Navigation Manager or Advanced Presentation Engine.

4.3.14.3 Streaming Buffer

Streaming Buffer is used for temporal data buffer for Secondary Video Set by Secondary Video Presentation Engine in Secondary Video Player. Secondary Video Player requests Network Manager to get a part of S-EVOB of Secondary Video Set to Streaming Buffer. And then Secondary Video Player reads S-EVOB data from Streaming Buffer and feeds to demux module in Secondary Video Player. As for detail of Secondary Video Player, see 4.3.16.4 Secondary Video Player.

4.3.15 Navigation Manager

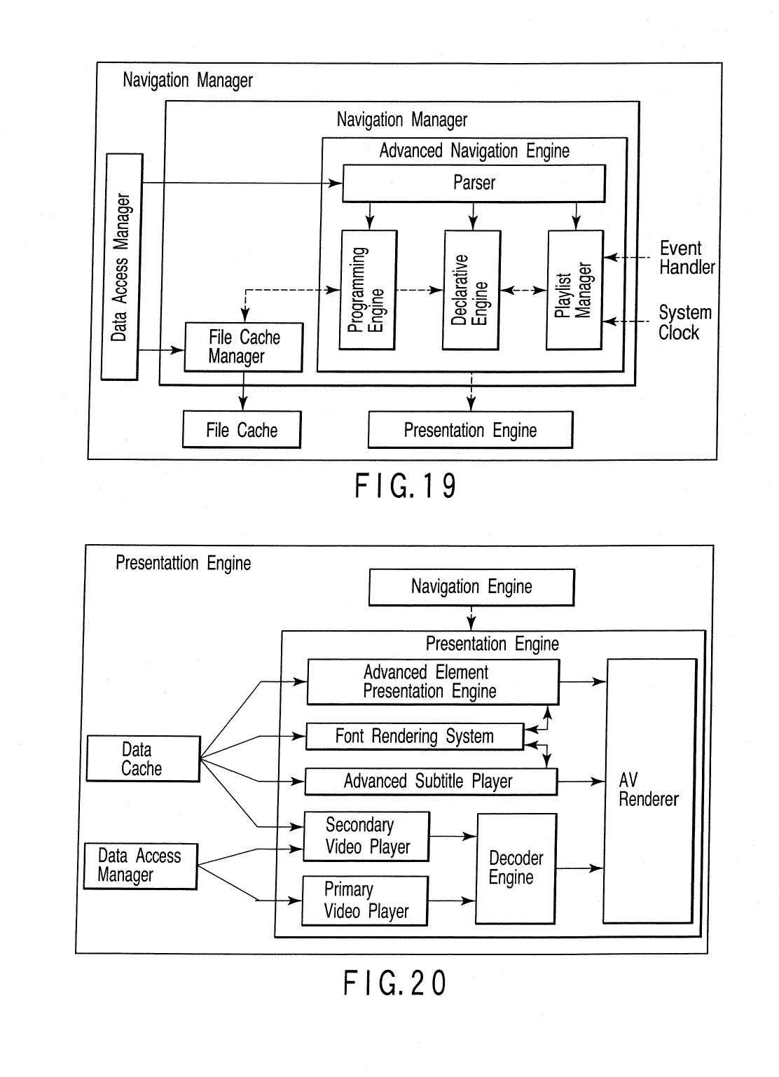

Navigation Manager Consists of two major functional modules, Advanced Navigation Engine and File Cache Manager (See, FIG. 19).

4.3.15.1 Advanced Navigation Engine

Advanced Navigation Engine controls entire playback behavior of Advanced Content and also controls Advanced Presentation Engine in accordance with Advanced Navigation. Advanced Navigation Engine consists of Parser, Declarative Engine and Programming Engine. See, FIG. 19.

4.3.15.1.1 Parser

Parser reads Advanced Navigation files then parses them. Parsed results are sent to proper modules, Declarative Engine and Programming Engine.

4.3.15.1.2 Declarative Engine

Declarative Engine manages and controls declarative behavior of Advanced Content in accordance with Advanced Navigation. Declarative Engine has following responsibilities:
Control of Advanced Presentation Engine
Layout of graphics object and advanced text
Style of graphics object and advanced text
Timing control of scheduled graphics plane behaviors and effect sound playback
Control of Primary Video Player
Configuration of Primary Video Set including registration of Title playback sequence (Title Timeline).
High level player control
Control of Secondary Video Player
Configuration of Secondary Video Set
High level player control

4.3.15.1.3 Programming Engine

Programming Engine manages event driven behaviors, API set calls, or any kind of control of Advanced Content. User Interface events are typically handled by Programming Engine and it may change the behavior of Advanced Navigation which is defined in Declarative Engine.

4.3.15.2 File Cache Manager

File Cache Manager is responsible for
supplying files archived in Advanced Stream in P-EVOBS from demux module in Primary Video Player
supplying files archived in Advanced Stream on Network Server or Persistent Storage
lifetime management of the files in File Cache
file retrieving when requested file by Advanced Navigation or Presentation Engine is not stored in File Cache

File Cache Manager consists of ADV_PCK Buffer and File Extractor.

4.3.15.2.1 ADV_PCK Buffer

File Cache Manager receives PCKs of Advanced Stream archived in P-EVOBS-TY2 from demux module in Primary Video Player. PS header of Advanced Stream PCK is removed and then stored elementary data to ADV_PCK buffer. File Cache Manager also gets Advanced Stream File on Network Server or Persistent Storage.

4.3.15.2.2 File Extractor

File Extractor extracts archived files from Advanced Stream in ADV_PCK buffer. Extracted files are stored into File Cache.

4.3.16 Presentation Engine

Presentation Engine is responsible to decode presentation data and output AV renderer in response to navigation commands from Navigation Engine. It consists of four major modules, Advanced Element Presentation Engine, Secondary Video Player, Primary Video Player and Decoder Engine. See, FIG. 20.

4.3.16.1 Advanced Element Presentation Engine

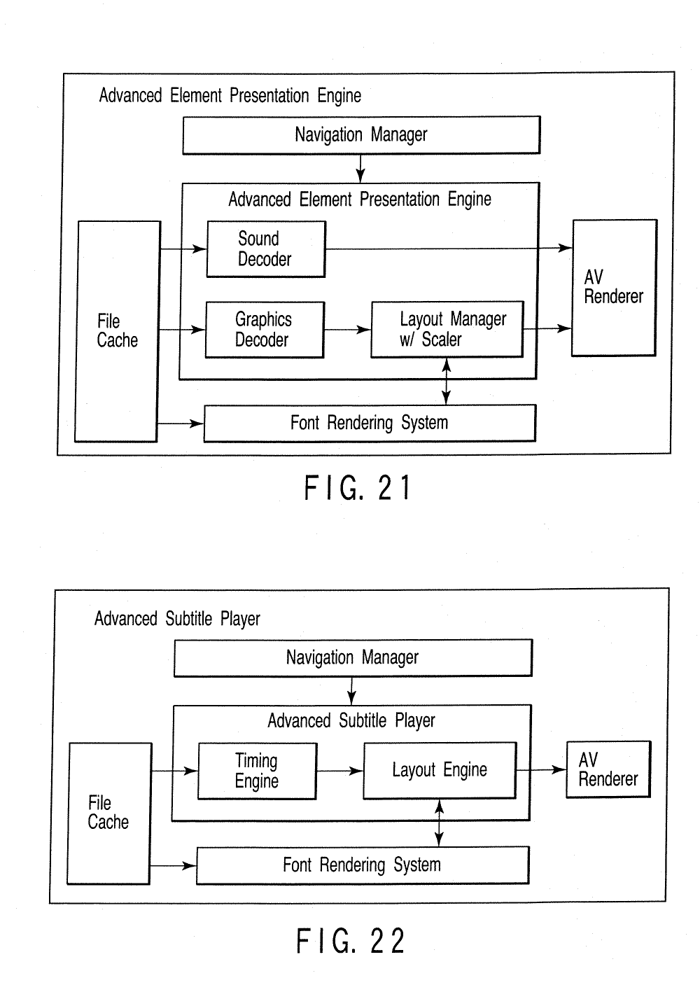

Advanced Element Presentation Engine (FIG. 21) outputs two presentation streams to AV renderer. One is frame image for Graphics Plane. The other is effect sound stream. Advanced Element Presentation Engine consists of Sound Decoder, Graphics Decoder, Text/Font Rasterizer and Layout Manager.

Sound Decoder:

Sound Decoder reads WAV file from File Cache and continuously outputs LPCM data to AV Renderer triggered by Navigation Engine.

Graphics Decoder:

Graphics Decoder retrieves graphics data, such as PNG or JPEG image from File Cache. These image files are decoded and sent to Layout Manager in response to request from Layout Manager.

Text/Font Rasterizer:

Text/Font Rasterizer retrieves font data from File Cache to generate text image. It receives text data from Navigation Manager or File Cache. Text images are generated and sent to Layout Manager in response to request from Layout Manager.

Layout Manager:

Layout Manager has responsibility to make frame image for Graphics Plane to AV Renderer. Layout information comes from Navigation Manager, when frame image is changed. Layout Manger invokes Graphics Decoder to decode specified graphics object which is to be located on frame image. Layout Manger also invokes Text/Font Rasterizer to make text image which is also to be located on frame image. Layout Manager locates graphical images on proper position from bottom layer and calculates the pixel value when the object has alpha channel/value. Then finally it sends frame image to AV Renderer.

4.3.16.2 Advanced Subtitle Player (FIG. 22)

4.3.16.3 Font Rendering System (FIG. 23)

4.3.16.4 Secondary Video Player

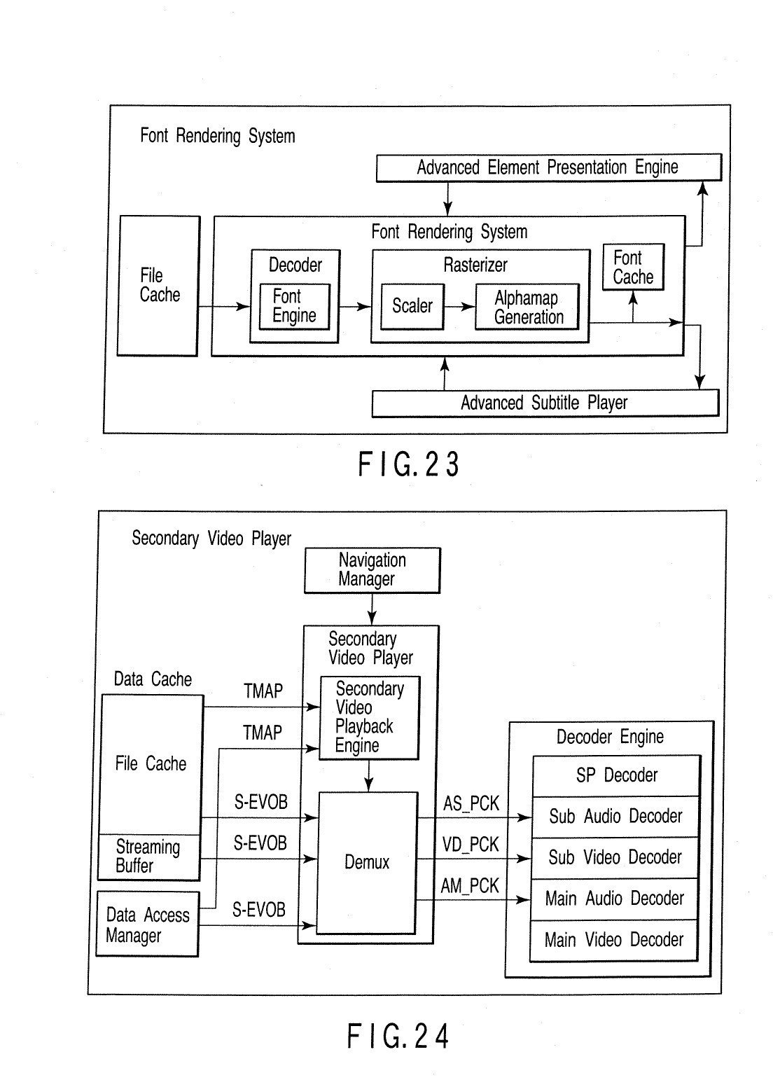

Secondary Video Player is responsible to play additional video contents, Complementary Audio and Complementary Subtitle. These additional presentation contents may be stored on Disc, Network Server and Persistent Storage. When contents on Disc, it needs to be stored into File Cache in advance to accessed by Secondary Video Player. The contents from Network Server should be stored to Streaming Buffer at once before feeding to Demux/decoders to avoid data lack because of bit rate fluctuation of network transporting path. For relatively short length contents, may be stored to File Cache at once, before being read by Secondary Video Player. Secondary Video Player consists of Secondary Video Playback Engine and Demux Secondary Video Player connects proper decoders in Decoder Engine according to stream types in Secondary Video Set (See, FIG. 24). Secondary Video Set cannot contain two audio streams in the same time, so audio decoder which is connected to Secondary Video player, is always only one.

Secondary Video Playback Engine:

Secondary Video Playback Engine is responsible to control all functional modules in Secondary Video Player in response to request from Navigation Manager. Secondary Video Playback Engine reads and analyses TMAP file to find proper reading position of S-EVOB.

Demux:

Demux reads and distributes S-EVOB stream to proper decoders, which are connected to Secondary Video Player. Demux has also responsibility to output each PCK in S-EVOB in accurate SCR timing. When S-EVOB consists of single stream of video, audio or Advanced Subtitle, Demux just supplies it to the decoder in accurate SCR timing.

4.3.16.5 Primary Video Player

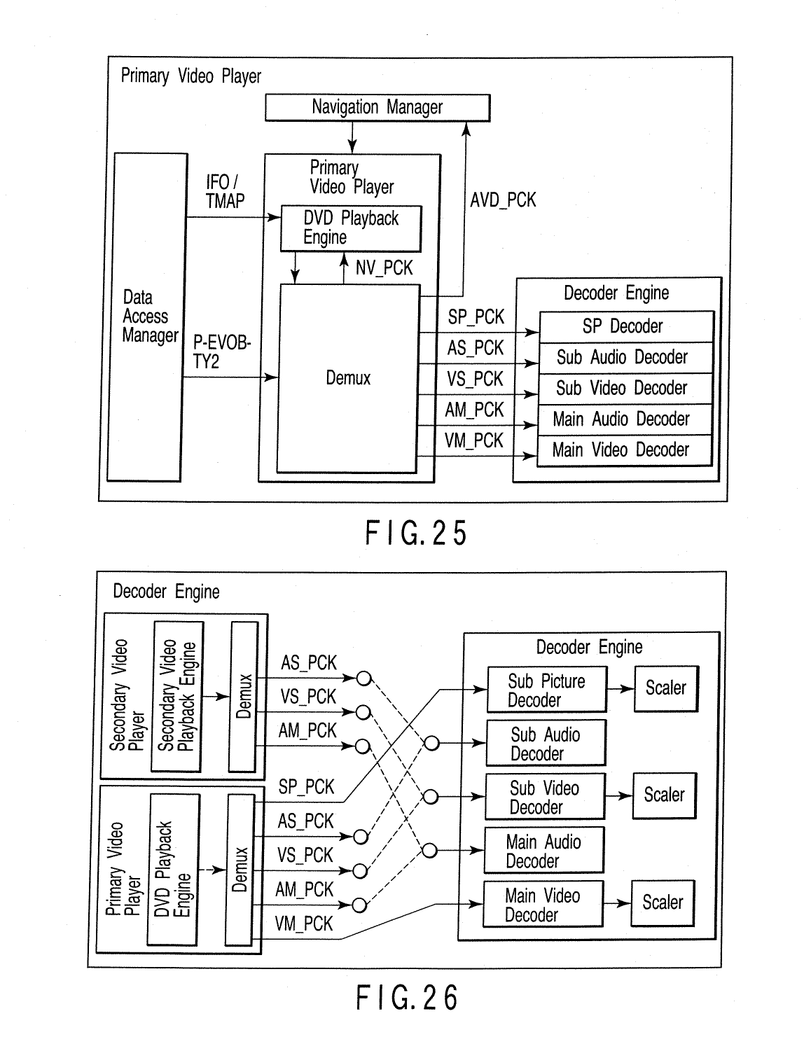

Primary Video Player is responsible to play Primary Video Set. Primary Video Set shall be stored on Disc. Primary Video Player consists of DVD Playback Engine and Demux. Primary Video Player connects proper decoders in Decoder Engine according to stream types in Primary Video Set (See, FIG. 25).

DVD Playback Engine:

DVD Playback Engine is responsible to control all functional modules in Primary Video Player in response to request from Navigation Manager. DVD Playback Engine reads and analyses IFO and TMAP(s) to find proper reading position of P-EVOBS-TY2 and controls special playback features of Primary Video Set, such as multi angle, audio/sub-picture selection and sub video/audio playback.

Demux:

Demux reads P-EVOBS-TY2 to DVD playback Engine and distributes proper decoders which are connected to Primary Video Set. Demux has also responsibility to output each PCK in P-EVOB-TY2 in accurate SCR timing to each decoder. For multi angle stream, it reads proper interleaved block of P-EVOB-TY2 on Disc in accordance with location information in TMAP(s) or navigation pack (N_PCK). Demux is responsible to provide proper number of audio pack (A_PCK) to Main Audio Decoder or Sub Audio Decoder and proper number of sub-picture pack (SP_PCK) to SP Decoder.

4.3.16.6 Decoder Engine

Decoder Engine is an aggregation of six kinds of decoders, Timed Text Decoder, Sub-Picture Decoder, Sub Audio Decoder, Sub Video Decoder, Main Audio Decoder and Main Video Decoder. Each Decoder is controlled by playback engine of connected Player. See, FIG. 26.

Timed Text Decoder:

Timed Text Decoder can be connected only to Demux module of Secondary Video Player. It is responsible to decode Advanced Subtitle which format is based on Timed Text, in response to request from DVD Playback Engine. One of the decoder between Timed Text decoder and Sub Picture decoder, can be active in the same time. The output graphic plane is called Sub-Picture plane and it is shared by the output from Timed Text decoder and Sub-Picture Decoder.

Sub Picture Decoder:

Sub Picture Decoder can be connected to Demux module of Primary Video Player. It is responsible to decode sub-picture data in response to request from DVD Playback Engine. One of the decoder between Timed Text decoder and Sub Picture decoder, can be active in the same time. The output graphic plane is called Sub-Picture plane and it is shared by the output from Timed Text decoder and Sub-Picture Decoder.

Sub Audio Decoder:

Sub Audio Decoder can be connected to Demux modules of Primary Video Player and Secondary Video Player. Sub Audio Decoder can support up to 2ch audio and up to 48 kHz sampling rate, which is called as Sub Audio. Sub Audio can be supported as sub audio stream of Primary Video Set, audio only stream of Secondary Video Set and audio/video multiplexed stream of Secondary Video Set. The output audio stream of Sub Audio Decoder is called as Sub Audio Stream.

Sub Video Decoder:

Sub Video Decoder can be connected to Demux modules of Primary Video Player and Secondary Video Player. Sub Video Decoder can support SD resolution video stream (maximum supported resolution is preliminary) which is called as Sub Video. Sub Video can be supported as video stream of Secondary Video Set and sub video stream of Primary Video Set. The output video plane of Sub Video Decode is called as Sub Video Plane.

Main Audio Decoder:

Primary Audio Decoder can be connected Demux modules of Primary Video Player and Secondary Video Player. Primary Audio Decoder can support up to 7.1ch multi channel audio and up to 96 kHz sampling rate, which is called as Main Audio. Main Audio can be supported as main audio stream of Primary Video Set and audio only stream of Secondary Video Set. The output audio stream of Main Audio Decoder is called as Main Audio Stream.

Main Video Decoder:

Main Video Decoder is only connected to Demux module of Primary Video Player. Main Video Decoder can support HD resolution video stream which is called as Main Video. Main Video is supported only in Primary Video Set. The output video plane of Main Video Decoder is called as Main Video Plane.

4.3.17 AV Renderer:

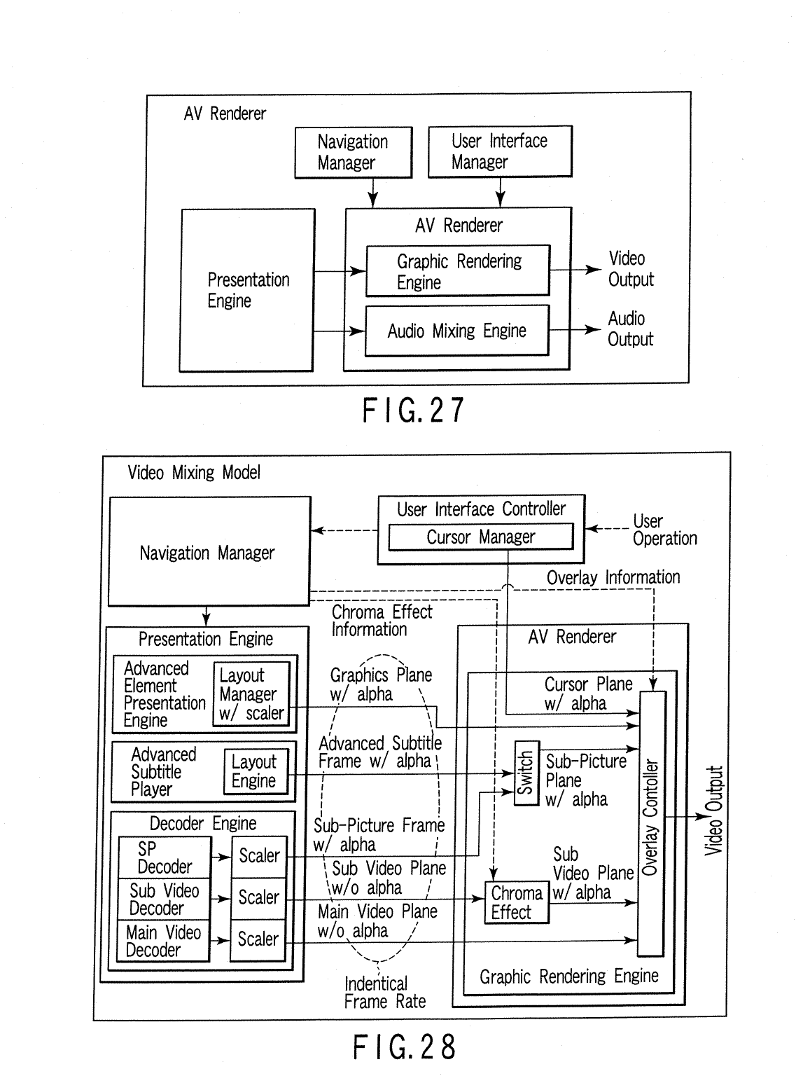

AV Renderer has two responsibilities. One is to gather graphic planes from Presentation Engine and User Interface Manager and output mixed video signal. The other is to gather PCM streams from Presentation Engine and output mixed audio signal. AV Renderer consists of Graphic Rendering Engine and Sound Mixing Engine (See, FIG. 27).

Graphic Rendering Engine:

Graphic Rendering Engine can receive four graphic planes from Presentation Engine and one graphic frame from User Interface Manager. Graphic Rendering Engine mixes these five planes in accordance with control information from Navigation Manager, then output mixed video signal. For detail of Video Mixing, see [4.3.17.1 Video Mixing Model].

Audio Mixing Engine:

Audio Mixing Engine can receive three LPCM streams from Presentation Engine. Sound Mixing Engine mixes these three LPCM streams in accordance with mixing level information from Navigation Manager, and then outputs mixed audio signal.

4.3.17.1 Video Mixing Model

Video Mixing Model in this specification is shown in FIG. 28. There are five graphic inputs in this model. They are Cursor Plane, Graphic Plane, Sub-Picture Plane, Sub Video Plane and Main Video Plane.

4.3.17.1.1 Cursor Plane

Cursor Plane is the topmost plane of five graphic inputs to Graphic Rendering Engine in this model. Cursor Plane is generated by Cursor Manager in User Interface Manager. The cursor image can be replaced by Navigation Manager in accordance with Advanced Navigation. Cursor Manager is responsible to move cursor shape on proper position in Cursor Plane and updates it to Graphic Rendering Engine. Graphics Rendering Engine receives the cursor Plane and alpha-mixes to lower planes in accordance with alpha information from Navigation Engine.

4.3.17.1.2 Graphics Plane

Graphics Plane is the second plane of five graphic inputs to Graphic Rendering Engine in this model. Graphics Plane is generated by Advanced Element Presentation Engine in accordance with Navigation Engine. Layout Manager is responsible to make Graphics Plane using with Graphic Decoder and Text/Font Rasterizer. The output frame size and rate shall be identical to video output of this model. Animation effect can be realized by the series of graphic images (Cell Animation). There is no alpha information for this plane from Navigation Manager in Overlay Controller. These values are supplied in alpha channel of Graphics Plane in itself.

4.3.17.1.3 Sub-Picture Plane

Sub-Picture Plane is the third plane of five graphic inputs to Graphic Rendering Engine in this model. Sub-Picture Plane is generated by Timed Text decoder or Sub-Picture decoder in Decoder Engine. Primary Video Set can include proper set of Sub-Picture images with output frame size. If there is a proper size of SP images, SP decoder sends generated frame image to Graphic Rendering Engine directly. If there is no prosper size of SP images, the scaler following to SP decoder shall scale the frame image to proper size and position, then sends it to Graphic Rendering Engine. As for detail of combination of Video Output and Sub-Picture Plane, see [5.2.4 Video Compositing Model] and [5.2.5 Video Output Model]. Secondary Video Set can include Advanced Subtitle for Timed Text decoder. (Scaling rules & procedures are T.B.D). Output data from Sub-Picture decoder has alpha channel information in it. (Alpha channel control for Advanced Subtitle is T.B.D).

4.3.17.1.4 Sub Video Plane

Sub Video Plane is the fourth plane of five graphic inputs to Graphic Rendering Engine in this model. Sub Video Plane is generated by Sub Video Decoder in Decoder Engine. Sub Video Plane is scaled by the scaler in Decoder Engine in accordance with the information from Navigation Manager. Output frame rate shall be identical to final video output. If there is the information to clip out object shape in Sub Video Plane, it is done by Chroma Effect module in Graphic Rendering Engine. Chroma Color (or Range) information is supplied from Navigation Manger in accordance with Advanced Navigation. Output plane from Chroma Effect module has two alpha values. One is 100% visible and the other is 100% transparent. Intermediate alpha value for overlaying to the lowest Main Video Plane, is supplied from Navigation Manager and done by Overlay Controller module in Graphic Rendering Engine.

4.3.17.1.5 Main Video Plane

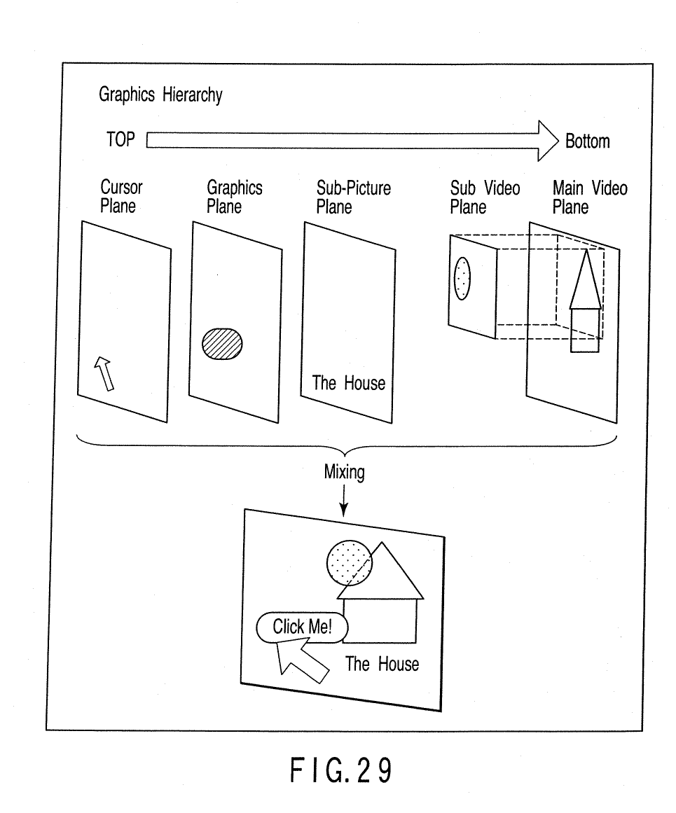

Main Video Plane is the bottom plane of five graphic inputs to Graphic Rendering Engine in this model. Main Video Plane is generated by Main Video Decoder in Decoder Engine. Main Video Plane is scaled by the scaler in Decoder Engine in accordance with the information from Navigation Manager. Output frame rate shall be identical to final video output. Main Video Plane can be set outer frame color when it is scaled by Navigation Manager in accordance with Advanced Navigation. The default color value of outer frame is “0, 0, 0” (=black). FIG. 29 shows hierarchy of graphics planes.

4.3.17.2 Audio Mixing Model

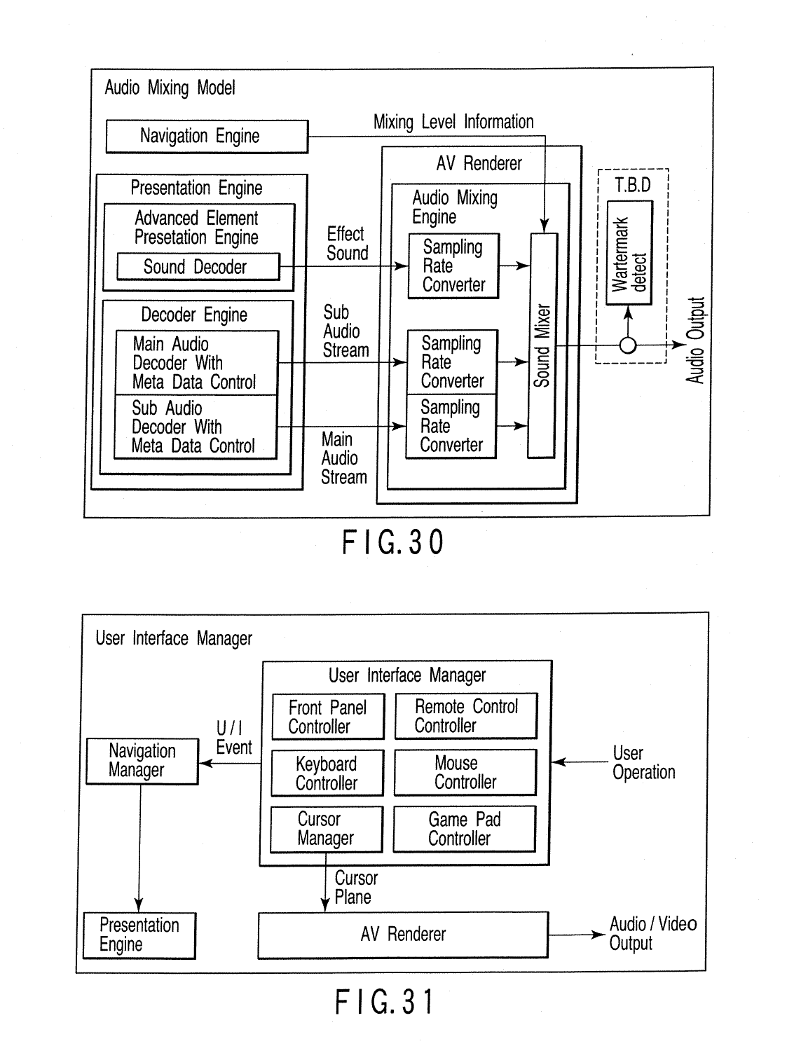

Audio Mixing Model in this specification is shown in FIG. 30. There are three audio stream inputs in this model. They are Effect Sound, Secondary Audio Stream and Primary Audio Stream. Supported Audio Types are described in Table 4.

Sampling Rate Converter adjusts audio sampling rate from the output from each sound/audio decoder to the sampling rate of final audio output. Static mixing levels among three audio streams are handled by Sound Mixer in Audio Mixing Engine in accordance with the mixing level information from Navigation Engine. Final output audio signal depends on HD DVD player.

TABLE 4
Supported Audio Type (Preliminary)

| | | Supported | |
|---|---|---|---|
| Audio | Supported | Channel | Supported |
| Type | Format | Number | Sampling Rate |
| Effect | WAV | Stereo | 8, 12, 16, |
| Sound | | | 24, 48 kHz |
| Sub | DD++ | Mono, | 8, 12, 16, |
| Audio | DTS+ | Stereo | 24, 48 kHz |
| | | 2ch | |
| Main | DD++ | Up to | Up to 96 kHz |
| Audio | DTS+ | 7.1ch | |
| | MLP | | |

Effect Sound:

Effect Sound is typically used when graphical button is clicked. Single channel (mono) and stereo channel WAV formats are supported. Sound Decoder reads WAV file from File Cache and sends LPCM stream to Audio Mixing Engine in response to request from Navigation Engine.

Sub Audio Stream:

There are two types of Sub Audio Stream. The one is Sub Audio Stream in Secondary Video set. If there are Sub Video stream in Secondary Video Set. Secondary Audio shall be synchronized with Secondary Video. If there is no Secondary Video stream in Secondary Video Set, Secondary Audio synchronizes or does not synchronize with Primary Video Set. The other is Sub Audio stream in Primary Video. It shall be synchronized with Primary Video. Meta Data control in elementary stream of Sub Audio Stream is handled by Sub Audio decoder in Decoder Engine.

Main Audio Stream:

Primary Audio Stream is an audio stream for Primary Video Set. As for detail, see. Meta Data control in elementary stream of Main Audio Stream is handled by Main Audio decoder in Decoder Engine.

4.3.18 User Interface Manager

User Interface Manager includes several user interface device controllers, such as Front Panel, Remote Control, Keyboard, Mouse and Game Pad controller, and Cursor Manager.

Each controller detects availability of the device and observes user operation events. Every event is defined in this specification. For details user input event. The user input events are notified to event handler in Navigation Manager.

Cursor Manager controls cursor shape and position. It updates Cursor Plane according to moving event from related devices, such as Mouse, Game Pad and so on. See, FIG. 31.

4.3.19 Disc Data Supply Model

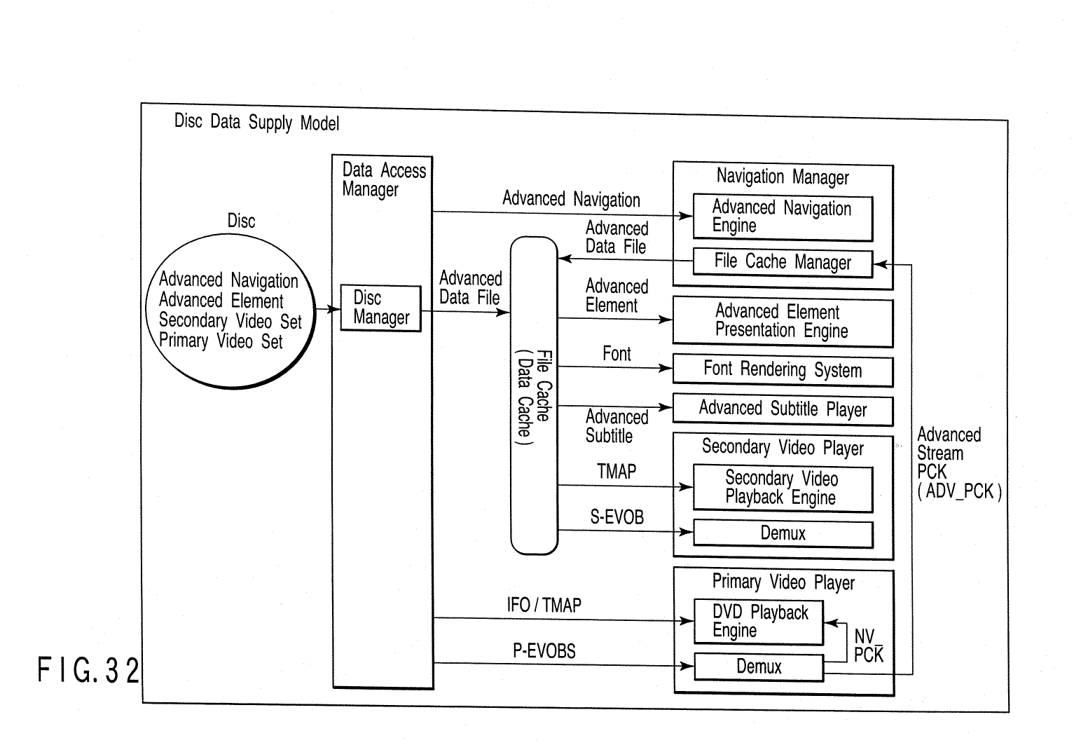

FIG. 32 shows data supply model of Advanced Content from Disc.

Disc Manager provides low level disc access functions and file access functions. Navigation Manager uses file access functions to get Advanced Navigation on startup sequence. Primary Video Player can use both functions to get IFO and TMAP files. Primary Video Player usually requests to get specified portion of P-EVOBS using with low level disc access functions. Secondary Video Player does not directly access data on Disc. The files are stored to file cache at once, and read by Secondary Video Player.

When demux module in Primary Video Decoder de-multiplexes P-EVOB-TY2, there may be Advanced Stream Pack (ADV_PCK). Advanced Stream Packs are sent to File Cache Manager. File Cache Manager extracts the files archived in Advanced Stream and stores them to File Cache.

4.3.20 Network and Persistent Storage Data Supply Model

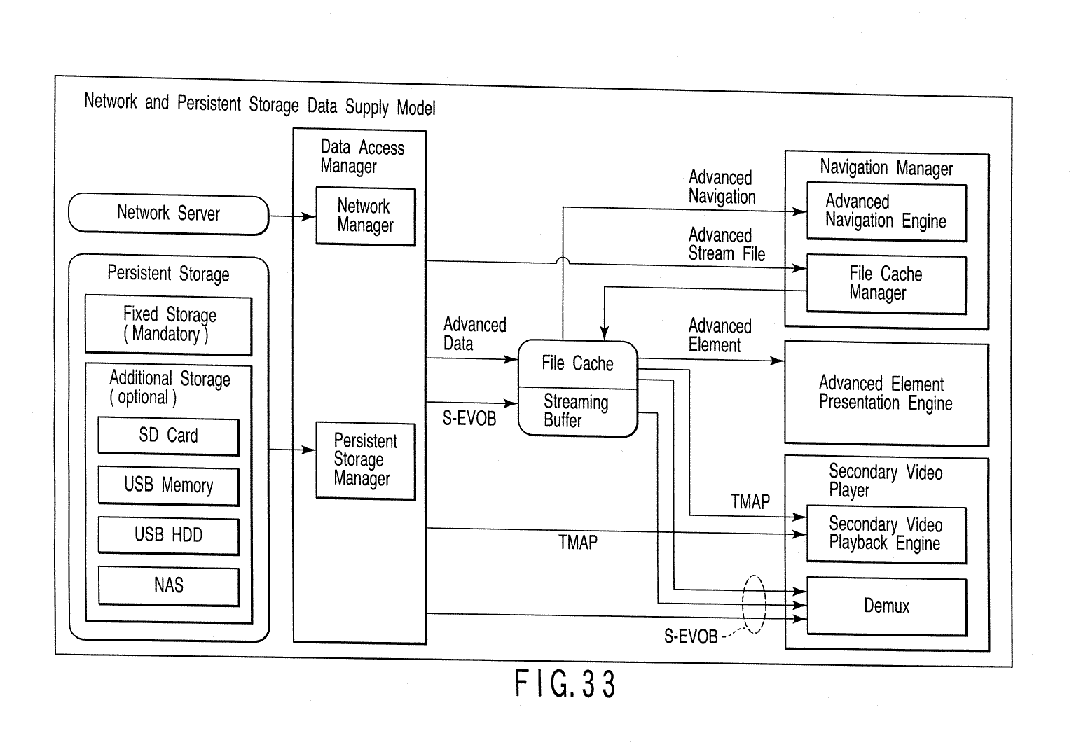

FIG. 33 shows data supply model of Advanced Content from Network Server and Persistent Storage. Network Server and Persistent Storage can store any Advanced Content files except for Primary Video Set. Network Manager and Persistent Storage Manager provide file access functions. Network Manager also provides protocol level access functions.

File Cache Manager in Navigation Manager can get Advanced Stream file directly from Network Server and Persistent Storage via Network Manager and Persistent Storage Manager.

Advanced Navigation Engine cannot directly access to Network Server and Persistent Storage. Files shall be stored to File Cache at once before being read by Advanced Navigation Engine.

Advanced Element Presentation Engine can handle the files which locates on Network Server or Persistent Storage. Advanced Element Presentation Engine invokes File Cache Manager to get the files which are not located on File Cache. File Cache Manager compares with File Cache Table whether requested file is cached on File Cache or not. The case the file exists on File Cache, File Cache Manager passes the file data to Advanced Presentation Engine directly. The case the file does not exist on File Cache, File Cache Manager get the file from its original location to File Cache, and then passes the file data to Advanced Presentation Engine.

Secondary Video Player can directly get Secondary Video Set files, such as TMAP and S-EVOB, from Network Server and Persistent Storage via Network Manager and Persistent Storage Manager as well as File Cache. Typically, Secondary Video Playback Engine uses Streaming Buffer to get S-EVOB from Network Server. It stored part of S-EVOB data to Streaming Buffer at once, and feed to it to Demux module in Secondary Video Player.

4.3.21 Data Store Model

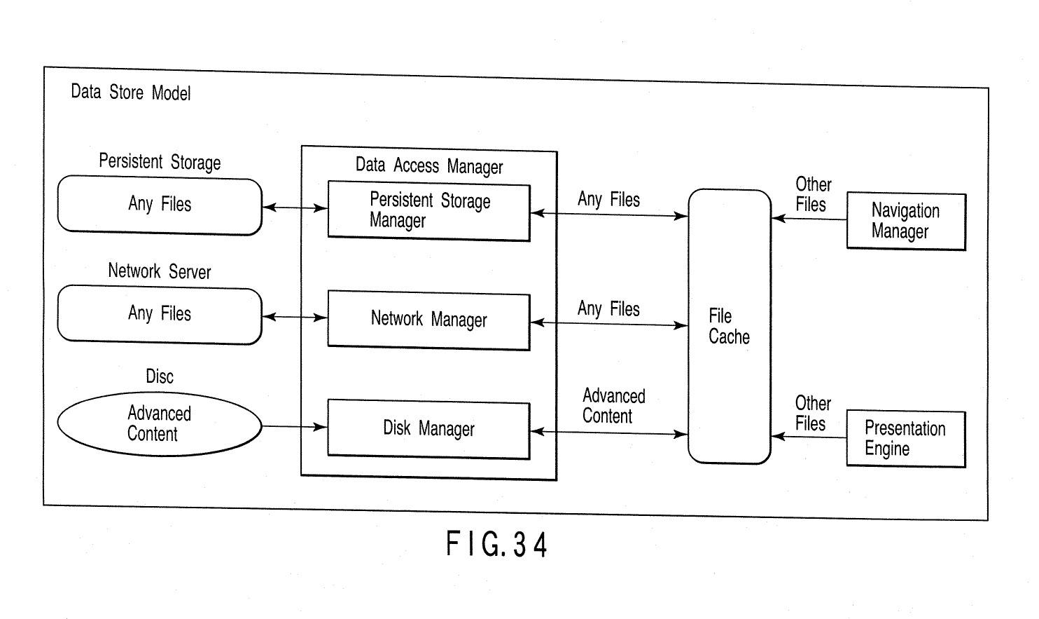

FIG. 34 describes Data Storing model in this specification. There are two types of data storage devices, Persistent Storage and Network Server. (detail of data handling between Data Sources is T.B.D).

There are two types of file are generated during Advanced Content Playback. One is proprietary type file which is generated by Programming Engine in Navigation Manager. The format depends on descriptions of Programming Engine. The other is image file which is captured by Presentation Engine.

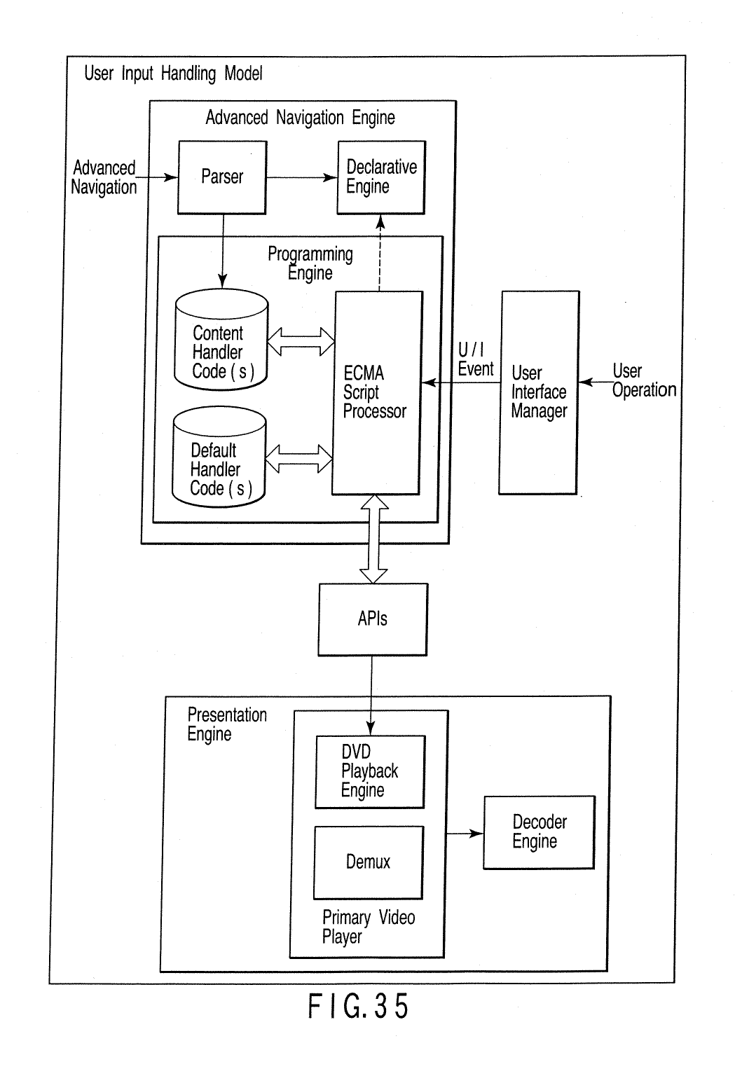

4.3.22 User Input Model (FIG. 35)

All user input events shall be handled by Programming Engine. User operations via user interface devices, such as remote controller or front panel, are inputted into User Interface Manager at first. User Interface Manager shall translate player dependent input signals to defined events, such as “UIEvent” of “Interface RemoteControllerEvent”. Translated user input events are transmitted to Programming Engine.

Programming Engine has ECMA Script Processor which is responsible for executing programmable behaviors. Programmable behaviors are defined by description of ECMA Script which is provided by script file(s) in Advanced Navigation. User event handler code(s) which is defined in script file(s), is registered into Programming Engine.

When ECMA Script Processor receives user input event, ECMA Script Processor searches whether the handler code which is corresponding to the current event in the registered Content Handler Code(s). If exists, ECMA Script Processor executes it. If not exist, ECMA Script Processor searches in default handler codes. If there exists the corresponding default handler code, ECMA Script Processor executes it. If not exist, ECMA Script Processor withdraws the event or output warning signal.

4.3.23 Vide output Timing

4.3.24 SD Conversion of Graphic Plane

Graphics Plane is generated by Layout Manager in Advanced Element Presentation Engine. If generated frame resolution does not match with the final video output resolution of HD DVD player, the graphic frame is scaled by the scaler function in Layout Manager according to the current output mode, such as SD Pan-Scan or SD Letterbox.

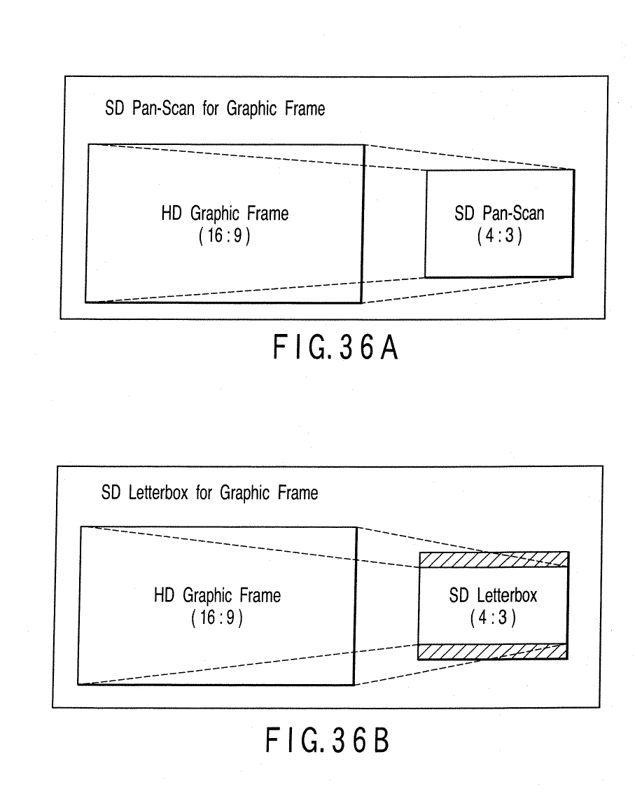

Scaling for SD Pan-Scan is shown in FIG. 36A.

Scaling for SD Letterbox is shown in FIG. 36B.

4.3.25 Network. As for detail, see chapter 9.

4.3.26 Presentation Timing Model

Advanced Content presentation is managed depending on a master time which defines presentation schedule and synchronization relationship among presentation objects. The master time is called as Title Timeline. Title Timeline is defined for each logical playback period, which is called as Title. Timing unit of Title Timeline is 90 kHz. There are five types of presentation object, Primary Video Set (PVS), Secondary Video Set (SVS), Complementary Audio, Complementary Subtitle and Advanced Application (ADV_APP).

4.3.26.1 Presentation Object

There are following five types of Presentation Object.
Primary Video Set (PVS)
Secondary Video Set (SVS)
Sub Video/Sub Audio
Sub Video
Sub Audio
Complementary Audio (for Primary Video Set)
Complementary Subtitle (for Primary Video Set)
Advanced Application (ADV_APP)

4.3.26.2 Attributes of Presentation Object

There are two kinds of attributes for Presentation Object. The one is “scheduled”, the other is “synchronized”.

4.3.26.2.1 Scheduled and Synchronized Presentation Object

Start and end time of this object type shall be pre-assigned in playlist file. The presentation timing shall be synchronized with the time on the Title Timeline. Primary Video Set, Complementary Audio and Complementary Subtitle shall be this object type. Secondary Video Set and Advanced Application can be treated as this object type. For detail behavior of Scheduled and Synchronized Presentation Object, see [4.3.26.4 Trick Play].

4.3.26.2.2 Scheduled and Non-Synchronized Presentation Object

Start and end time of this object type shall be pre-assigned in playlist file. The presentation timing shall be own time base. Secondary Video Set and Advanced Application can be treated as this object type. For detail behavior of Scheduled and Non-Synchronized Presentation Object, see [4.3.26.4 Trick Play].

4.3.26.2.3 Non-Scheduled and Synchronized Presentation Object

This object type shall not be described in playlist file. The object is triggered by user events handled by Advanced Application. The presentation timing shall be synchronized with Title Timeline.

4.3.26.2.4 Non-Scheduled and Non-Synchronized Presentation Object

This object type shall not be described in playlist file. The object is triggered by user events handled by Advanced Application. The presentation timing shall be own time base.

4.3.26.3 Playlist File

Playlist file is used for two purposes of Advanced Content playback. The one is for initial system configuration of HD DVD player. The other is for definition of how to play plural kind of presentation objects of Advanced Content. Playlist file consists of following configuration information for Advanced Content playback.
Object Mapping Information for each Title
Playback Sequence for each Title
System Configuration for Advanced Content playback

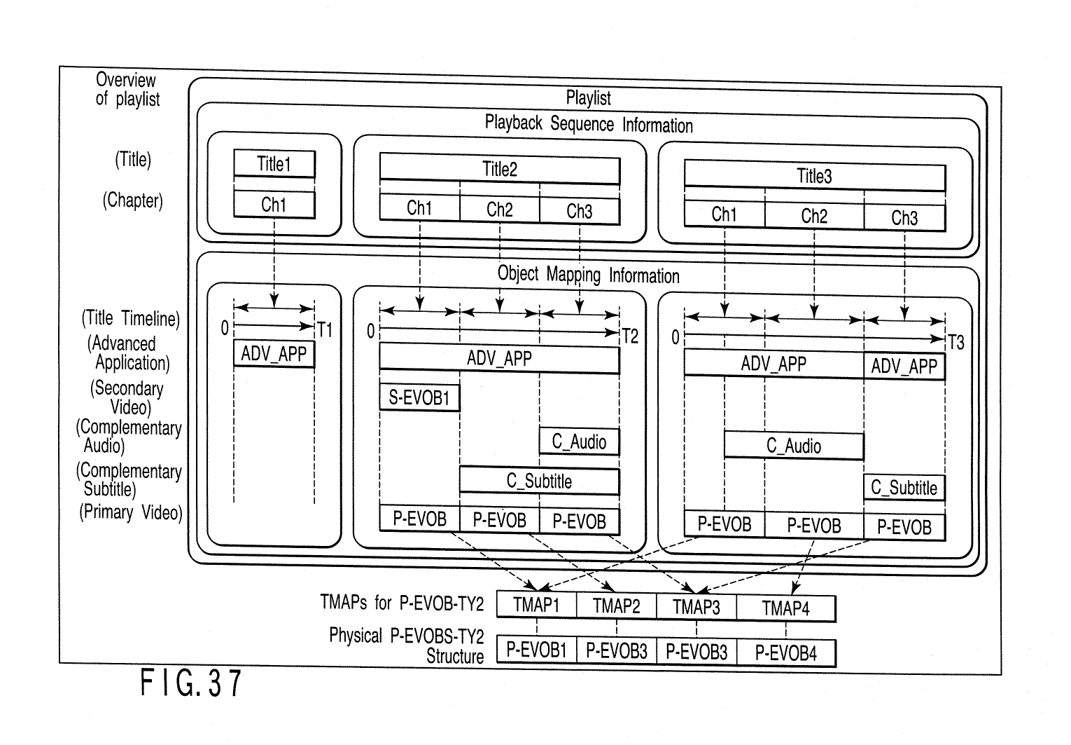

FIG. 37 shows overview of playlist except for System Configuration.

4.3.26.3.1 Object Mapping Information

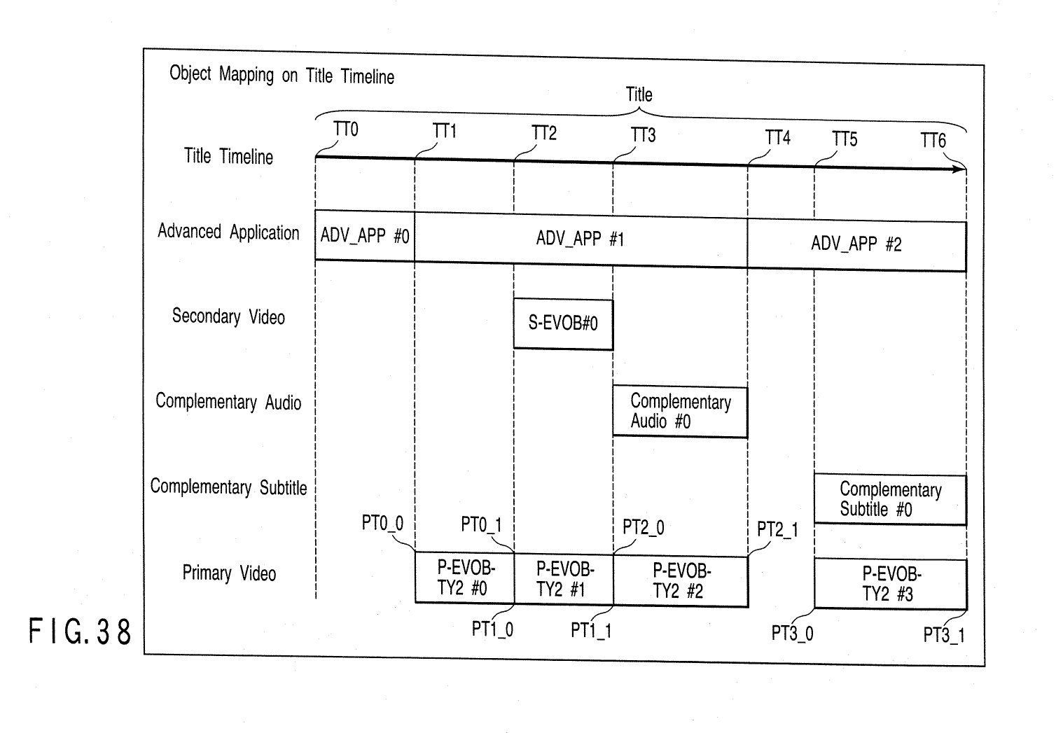

Title Timeline defines the default playback sequence and the timing relationship among Presentation Objects for each Title. Scheduled Presentation Object, such as Advanced Application, Primary Video Set or Secondary Video Set, shall be pre-assigned its life period (start time to end time) onto Title Timeline (see FIG. 38). Along with the time progress of the Title Timeline, each Presentation Object shall start and end its presentation. If the presentation object is synchronized with Title Timeline, pre-assigned life period onto Title Timeline shall be identical to its presentation period.

Ex.) TT2−TT1=PT1_{—}1−PT1_{—}0

where PT1_0 is the presentation start time of P-EVOB-TY2 #1 and PT1_1 is the presentation end time of P-EVOB-TY2 #1.

The following description is an example of Object Mapping information.

```
  <Title id=”MainTitle”>
    <PrimaryVideoTrack id=”MainTitlePVS”>
  <Clip id=”P-EVOB-TY2-0”
src=”file:///HDDVD_TS/AVMAP001.IFO”
  titleTimeBegin=”1000000”
titleTimeEnd=”2000000” clipTimeBegin=”0”/>
  <Clip id=”P-EVOB-TY2-1”
src=”file:///HDDVD_TS/AVMAP002.IFO”
  titleTimeBegin=”2000000”
titleTimeEnd=”3000000” clipTimeBegin=”0”/>
  <Clip id=”P-EVOB-TY2-2”
src=”file:///HDDVD_TS/AVMAP003.IFO”
  titleTimeBegin=”3000000”
titleTimeEnd=”4500000” clipTimeBegin=”0”/>
  <Clip id=”P-EVOB-TY2-3”
src=”file:///HDDVD_TS/AVMAP005.IFO”
  titleTimeBegin=”5000000”
titleTimeEnd=”6500000” clipTimeBegin=”0”/>
    </PrimaryVideoTrack>
    <SecondaryVideoTrack id=”CommentarySVS”>
  <Clip id=”S-EVOB-0”
src=”http://dvdforum.com/commentary/AVMAP001.TMAP”
  titleTimeBegin=”5000000”
titleTimeEnd=”6500000” clipTimeBegin=”0”/>
    </SecondaryVideoTrack>
  <Application id=”App0” Loading
information=”file:///ADV_OBJ/App0/Loading
information.xml” />
  <Application id=”App0” Loading
information=”file:///ADV_OBJ/App1/Loading
information.xml” />
  </Title>
```

There is a restriction for Object Mapping among Secondary Video Set, Complementary Audio and Complementary Subtitle. These three presentation objects are played back by Secondary Video Player, therefore it is prohibited to be mapped two or more these presentation objects on Title Timeline simultaneously.

For detail of playback behaviors, see [4.3.26.4 Trick Play].

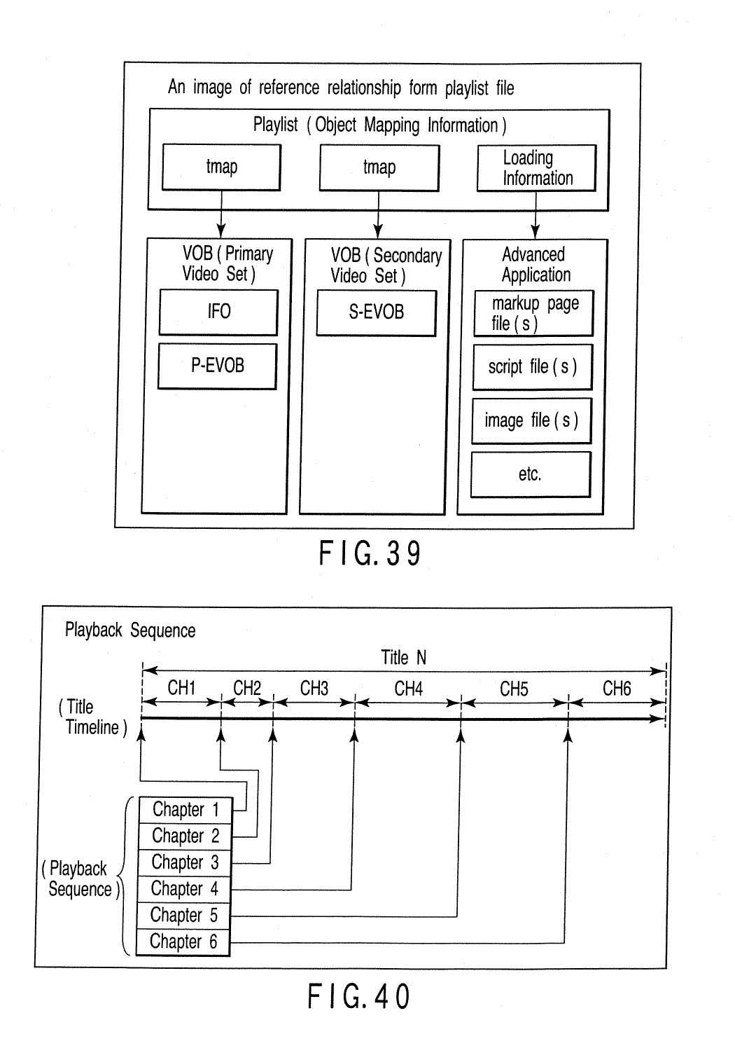

Pre-assignment of Presentation Object onto Title Timeline in playlist refers the index information file for each presentation object. For Primary Video Set and Secondary Video Set, TMAP file is referred in playlist. For Advanced Application, Loading information file is referred in playlist. See, FIG. 39.

4.3.26.3.2 Playback Sequence

Playback Sequence defines the chapter start position by the time value on the Title Timeline. Chapter end position is given as the next chapter start position or the end of the Title Timeline for the last chapter (see, FIG. 40).

The following description is an example of Playback Sequence.

```
<ChapterList>
    <Chapter titleTimeBegin=“0”/>
    <Chapter titleTimeBegin=“10000000”/>
    <Chapter titleTimeBegin=“20000000”/>
    <Chapter titleTimeBegin=“25500000”/>
    <Chapter titleTimeBegin=“30000000”/>
    <Chapter titleTimeBegin=“45555000”/>
</ChapterList>
```

4.3.26.3.3 System Configuration

For usage of System Configuration, see [4.3.28.2 Startup Sequence of Advanced Content].

4.3.26.4 Trick Play

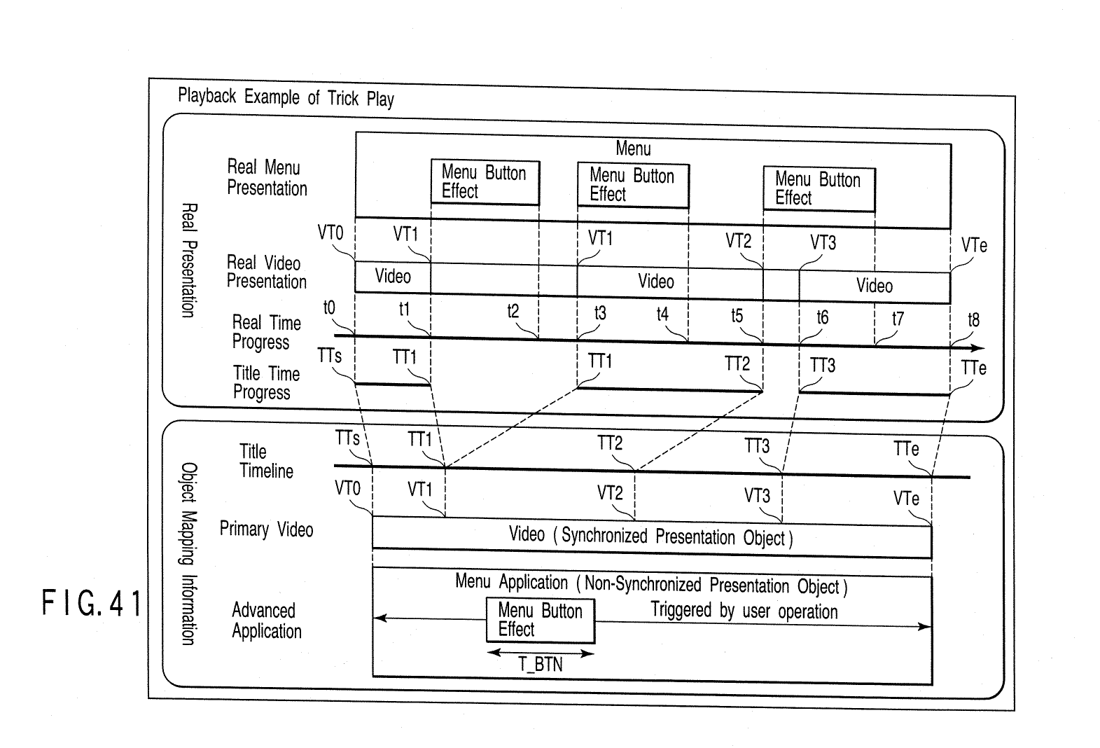

FIG. 41 shows relationship object mapping information on Title Timeline and real presentation.

There are two presentation objects. The one is Primary Video which is Synchronized Presentation Object. The other is Advanced Application for menu which is Non-Synchronized Object. Menu is assumed to provide playback control menu for Primary Video. It is assumed to be included several menu buttons which are to be clicked by user operation. Menu buttons have graphical effect which effect duration is “T_BTN”.

<Real Time Progress (t0)>

At the time ‘t0’ on Real Time Progress, Advanced Content presentation starts. Along with time progress of Title Timeline, Primary Video is played back. Menu Application also start its presentation at ‘t0’, but its presentation does not depend on time progress of Title Timeline.

<Real Time Progress (t1)>

At the time ‘t1’ on Real Time Progress, user clicks ‘pause’ button which is presented by Menu Application. At the moment, the script which is related with ‘pause’ button holds time progress on Title Timeline at TT1. By holding Title Timeline, Video presentation is also held at VT1. On the other hand, Menu Application keeps running. Therefore, menu button effect, which is related with ‘pause’ button starts from ‘t1.

<Real Time Progress (t2)>

At the time ‘t2’ on Real Time Progress, menu button effect ends. ‘t2’-‘t1’ period equals the button effect duration, ‘T_BTN’.

<Real Time Progress (t3)>

At the time ‘t3’ on Real Time Progress, user clicks ‘play’ button which is presented by Menu Application. At the moment, the script which is related with ‘play’ button restarts time progress on Title Timeline from TT1. By restarting Title Timeline, Video presentation is also restarted from VT1. Menu button effect, which is related with ‘pause’ button starts from ‘t3’

<Real Time Progress (t4)>

At the time ‘t4’ on Real Time Progress, menu button effect ends. ‘t4’-‘t3’ period equals the button effect duration, ‘T_BTN’.

<Real Time Progress (t5)>

At the time ‘t5’ on Real Time Progress, user clicks ‘jump’ button which is presented by Menu Application. At the moment, the script which is related with ‘jump’ button gets the time on Title Timeline to the certain jump destination time, TT3. However, jump operation for Video presentation needs some time period, so the time on Title Timeline is held at ‘t5’ at this moment. On the other hand, menu Application keeps running, no matter what Title Timeline progress is, so menu button effect, which is related with ‘jump’ button starts from ‘t5’.

<Real Time Progress (t6)>

At the time ‘t6’ on Real Time Progress, Video presentation ready to start from VT3. At this moment Title Timeline starts from TT3. By starting Title Timeline, Video presentation is also started from VT3.

<Real Time Progress (t7)>

At the time ‘t7’ on Real Time Progress, menu button effect ends. ‘t7’-‘t5’ period equals the button effect duration, ‘T_BTN’.

<Real Time Progress (t8)>

At the time ‘t8’ on Real Time Progress, Title Timeline reaches to the end time, TTe. Video presentation also reaches the end time, VTe, so the presentation is terminated. For Menu Application, its life period is assigned at TTe on Title Timeline, so presentation of Menu Application is also terminated at TTe.

4.3.26.5 Object Mapping Position

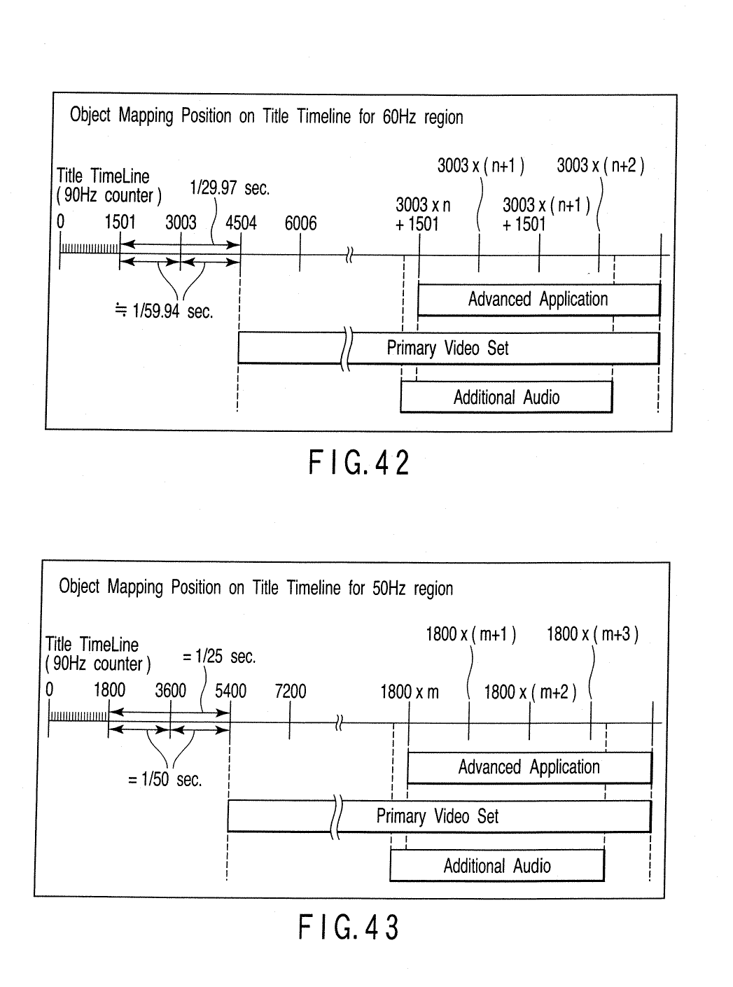

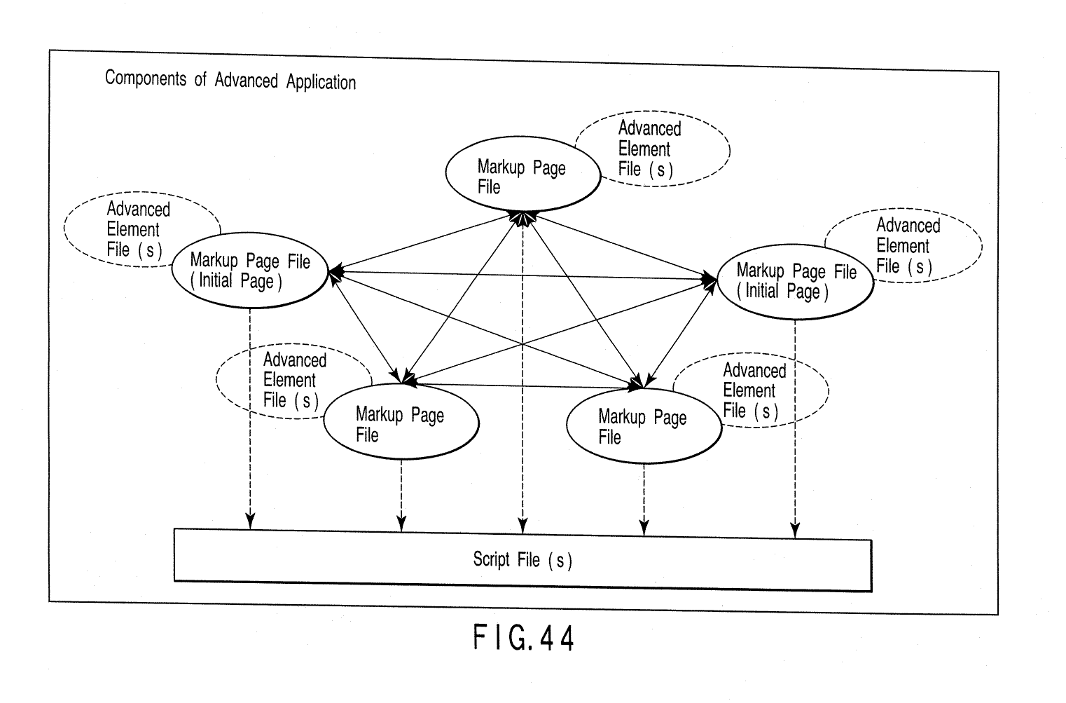

FIG. 42 and FIG. 43 show possible pre-assignment position for Presentation Objects on Title Timeline.

For Visual Presentation Object, such as Advanced Application, Secondary Video Set including Sub Video stream or Primary Video Set, there exist restriction for possible entry position on the time on Title Timeline. This is for adjust all visual presentation timing to actual output video signal.

In case of TV system with 525/60 (60 Hz region), possible entry position is restricted as following two cases;

3003×n+1501 or

3003×n

(where “n” is integer number from 0)

In case of TV system with 625/50 (59 Hz region), possible entry position is restricted as following case;

1800×m

(where “m” is integer number from 0)

For Audio Presentation Object, such as Additional Audio or Secondary Video Set only including Sub Audio, there is no restriction for possible entry position on the time on Title Timeline.

4.3.26.6 Advanced Application

Advanced Application (ADV_APP) consists of markup page files which can have one-directional or bi-directional links each other, script files which shares a name space belonging to the Advanced Application, and Advanced Element files which are used by the markup page(s) and script file(s).

During the presentation of Advanced Application, an active Markup Page is always only one. An active Markup Page jumps one to another.

4.3.26.7 Markup Page Jump

There are following three Markup Page Jump models.
Non-Synch Jump
Soft-Synch Jump
Hard-Synch Jump

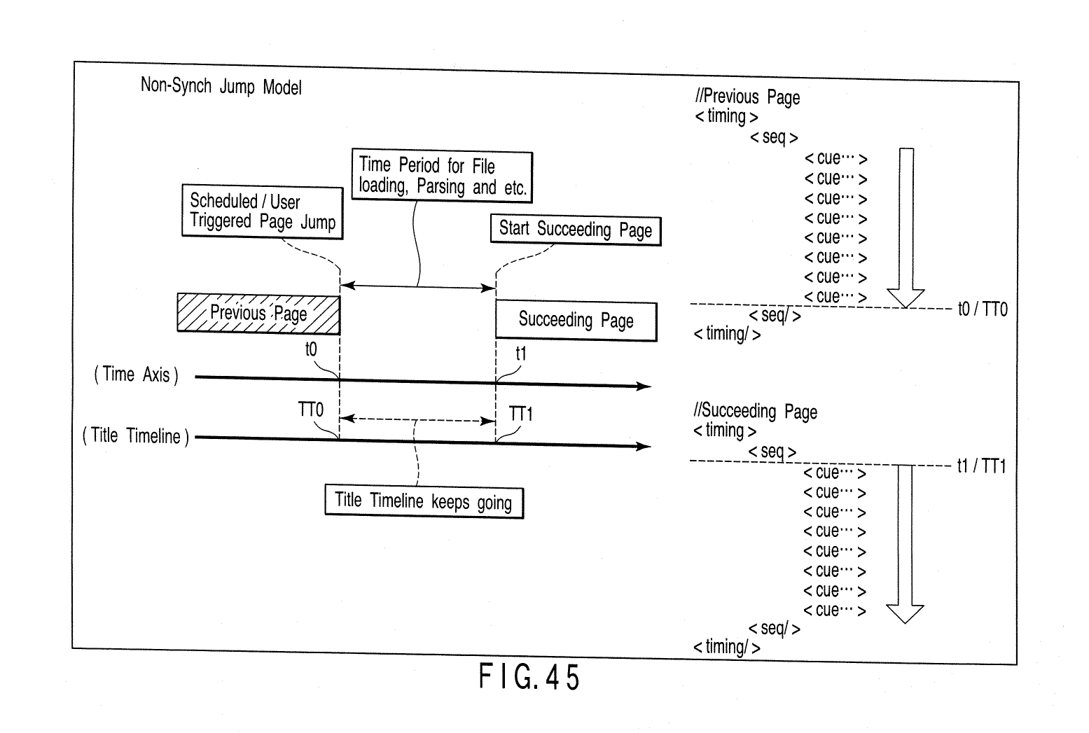

4.3.26.7.1 Non-Synch Jump (FIG. 45)

Non-Synch Jump model is a markup page jump model for Advanced Application which is Non-Synchronized Presentation Object. This model consumes some time period for the preparation to start succeeding markup page presentation. During this preparation time period, Advanced Navigation engine loads succeeding markup page, parses and reconfigures presentation modules in presentation engine, if needed. Title Timeline keeps going while this preparation period.

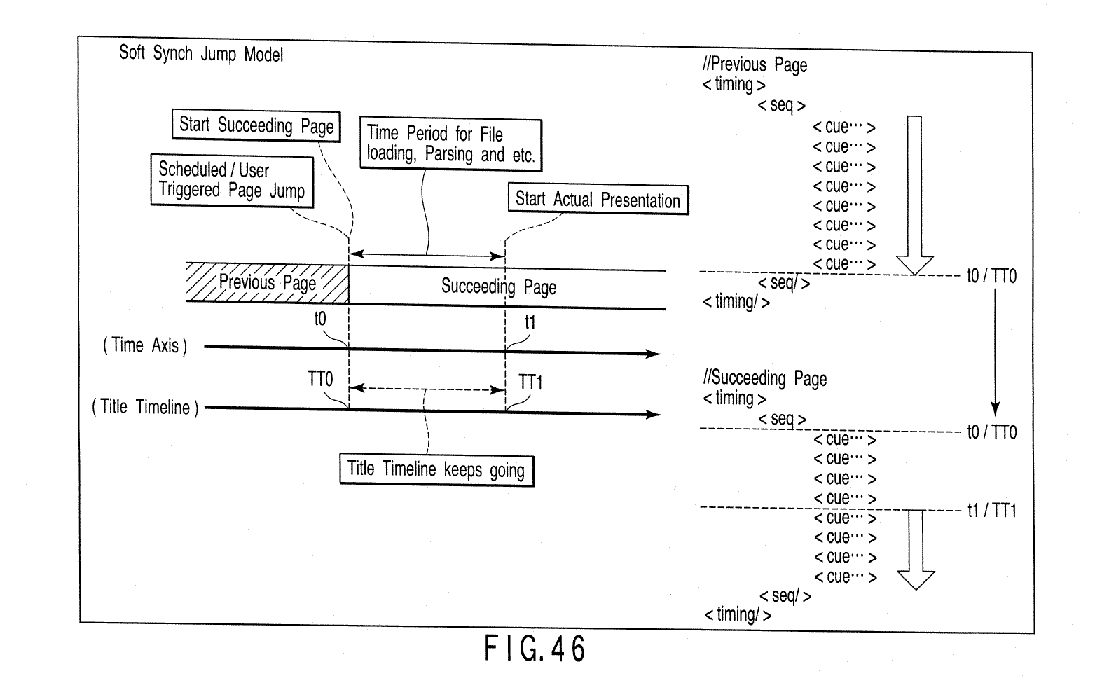

4.3.26.7.2 Soft Synch Jump (FIG. 46)

Soft-Synch Jump model is a markup page jump model for Advanced Application which is Synchronized Presentation Object. In this model, the preparation time period for succeeding markup page presentation, is included in the presentation time period of the succeeding markup page, Time progress of succeeding markup page is started from just after the presentation end time of previous markup page. While presentation preparation period, actual presentation of succeeding markup page can not be presented. After finishing the preparation, actual presentation is started.

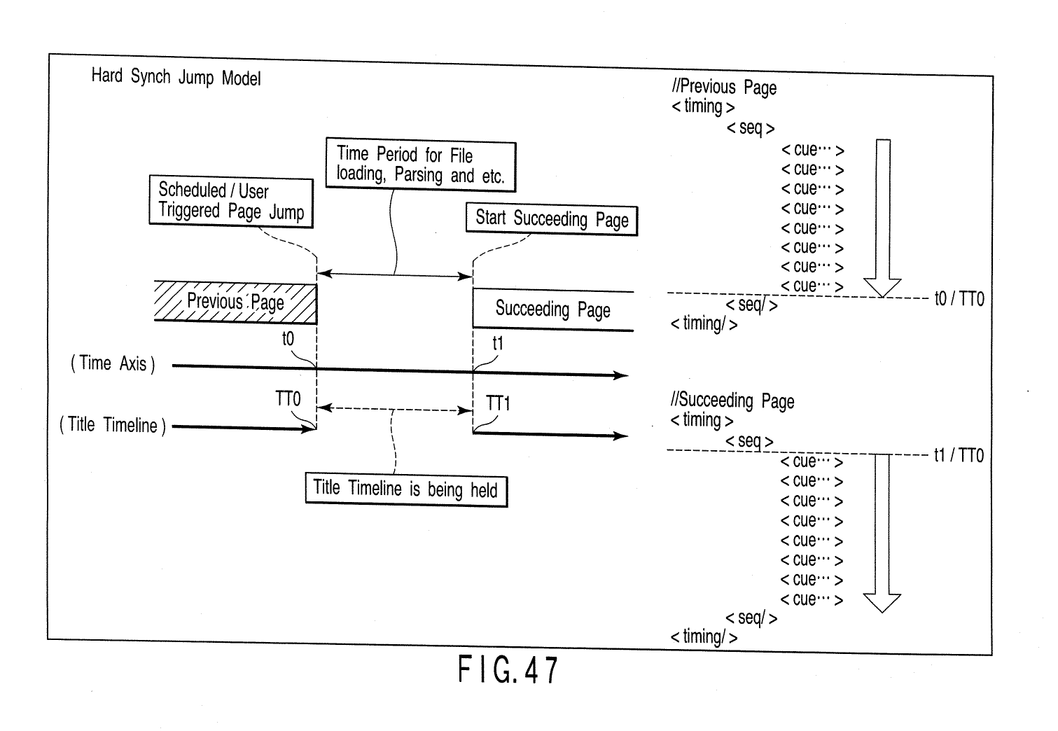

4.3.26.7.3 Hard Synch Jump (FIG. 47)

Hard-Synch Jump model is a markup page jump model for Advanced Application which is Synchronized Presentation Object. In this model, while the preparation time period for succeeding markup page presentation, Title Timeline is being held. So other presentation objects which are synchronized to Title Timeline, are also paused. After finishing the preparation for succeeding markup page presentation, Title Timeline is returned to run, then all Synchronize Presentation Object start to play. Hard-Synch Jump can be set for the initial markup page of Advanced Application.

4.3.26.8 Graphics Frame Generating Timing

4.3.26.8.1 Basic graphic frame generating model

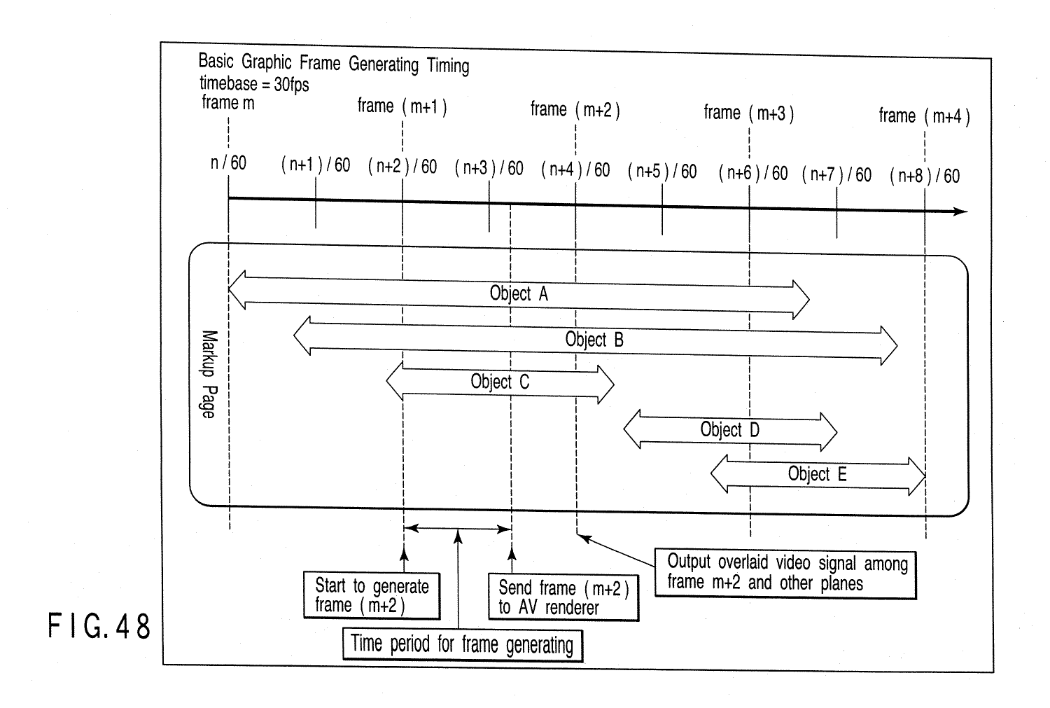

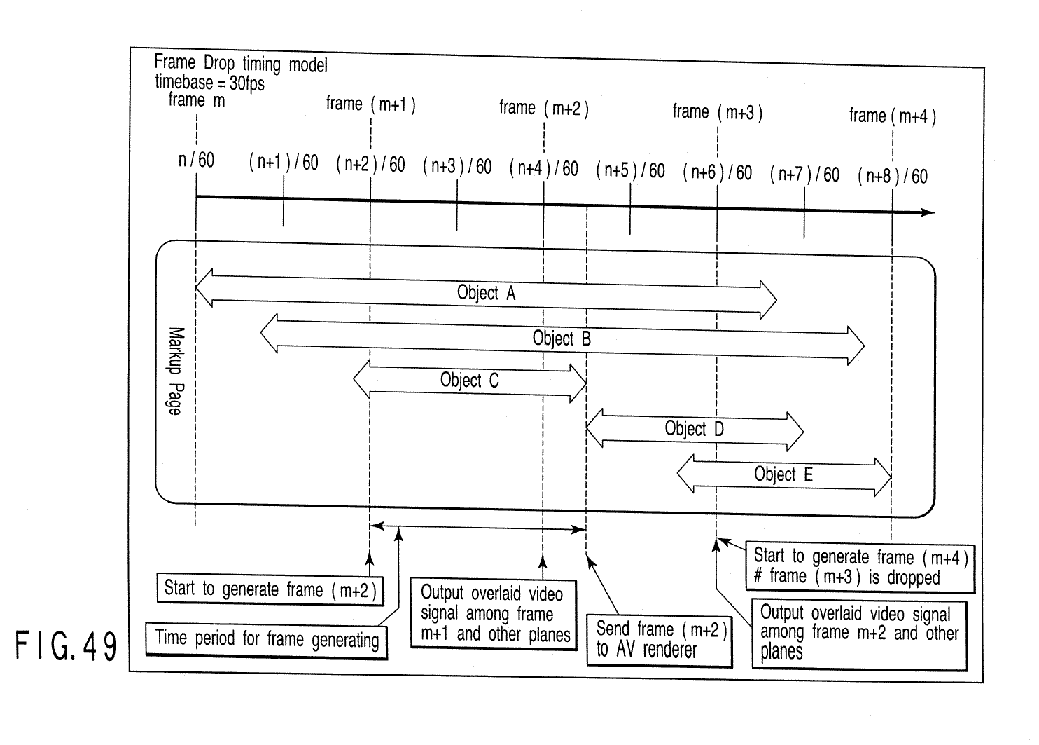

FIG. 48 shows Basic Graphic Frame Generating Timing.

4.3.26.8.2 Frame drop model

FIG. 48 shows Frame Drop timing model.

4.3.27 Seamless Playback of Advanced Content

4.3.28 Playback Sequence of Advanced Content

4.3.28.1 Scope

This section describes playback sequences of Advanced Content.

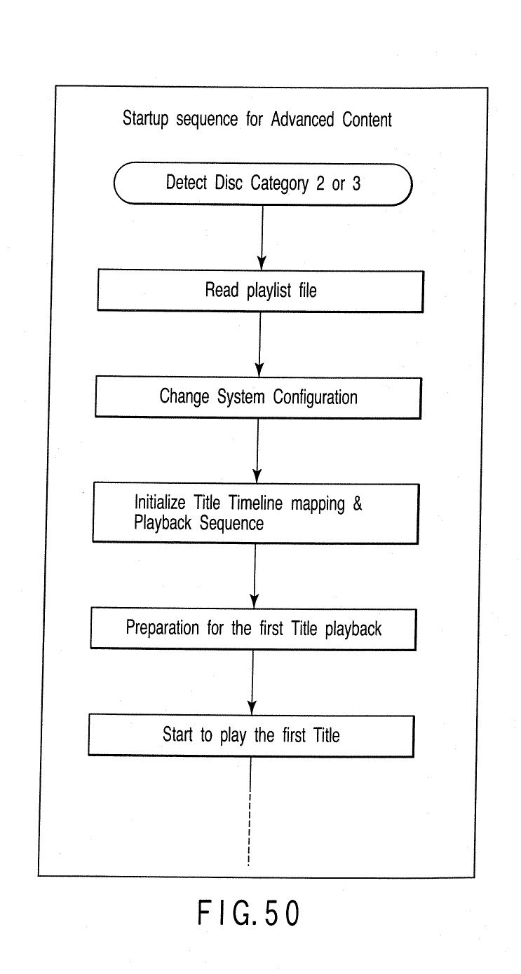

4.3.28.2 Startup Sequence of Advanced Content FIG. 50 shows a flow chart of startup sequence for Advanced Content in disc.

Read Initial Playlist File:

After detecting inserted HD DVD disc is disc category type 2 or 3, Advanced Content Player reads the initial playlist file which includes Object Mapping Information, Playback Sequence and System Configuration. (definition for the initial playlist file is T.B.D).

Change System Configuration:

The player changes system resource configuration of Advanced Content Player. Streaming Buffer size is changed in accordance with streaming buffer size described in playlist file during this phase. All files and data currently in File Cache and Streaming Buffer are withdrawn.

Initialize Title Timeline Mapping & Playback Sequence:

Navigation Manager calculates where the Presentation Object(s) to be presented on the Title Timeline of the first Title and where are the chapter entry point(s).

Preparation for the First Title Playback:—

Navigation Manager shall read and store all files which are needed to be stored in File Cache in advance to start the first Title playback. They may be Advanced Element files for Advanced Element Presentation Engine or TMAP/S-EVOB file(s) for Secondary Video Player. EngineNavigation Manager initializes presentation modules, such as Advanced Element Playback Engine, Secondary Video Player and Primary Video Player in this phase.

If there is Primary Video Set presentation in the first Title, Navigation Manager informs the presentation mapping information of Primary Video Set onto the Title Timeline of the first Title in addition to specifying navigation files for Primary Video Set, such as IFO and TMAP(s). Primary Video Player reads IFO and TMAPs from disc, and then prepares internal parameters for playback control to Primary Video Set in accordance with the informed presentation mapping information in addition to establishment the connection between Primary Video Player and required decoder modules in Decoder Engine.

If there is the presentation object which is played by Secondary Video Player, such as Secondary Video Set, Complementary Audio or Complementary Subtitle, in the first Title. Navigation Manager informs the presentation mapping information of the first presentation object of the Title Timeline in addition to specifying navigation files for the presentation object, such as TMAP. Secondary Video Player reads TMAP from data source, and then prepares internal parameters for playback control to the presentation object in accordance with the informed presentation mapping information in addition to establishment the connection between Secondary Video Player and required decode modules in Decoder Engine.

Start to Play the First Title:

After preparation for the first Title playback, Advanced Content Player starts the Title Timeline. The presentation Object mapped onto Title Timeline start presentation in accordance with its presentation schedule.

4.3.28.3 Update Sequence of Advanced Content Playback

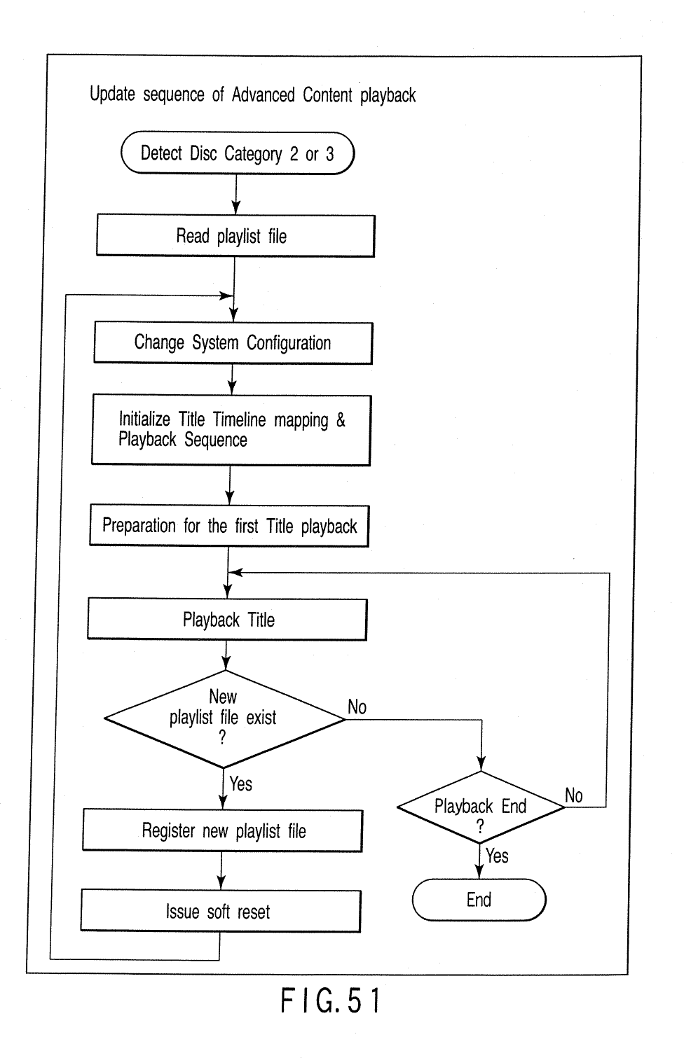

FIG. 51 shows a flow chart of update sequence of Advanced Content playback.

From “Read playlist file” to “Preparation for the first Title playback” are the same as the previous section, [4.3.28.2 Startup Sequence of Advanced Content].

Play Back Title:

Advanced Content Player plays back Title.

New Playlist File Exist?:

In order to update Advanced Content playback, it is required that Advanced Application to execute updating procedures. If the Advanced Application tries to update its presentation, Advanced Application on disc has to have the search and update script sequence in advance. Programming Script searches the specified data source(s), typically Network Server, whether there is available new playlist file.

Register Playlist File:

If there is available new playlist file, scripts which is executed by Programming Engine, downloads it to File Cache and registers to Advanced Content Player. As for detail and API definitions are T.B.D.

Issue Soft Reset:

After registration of new playlist file, Advanced Navigation shall issue soft reset API to restart Startup Sequence. Soft reset API resets all current parameters and playback configurations, then restarts startup procedures from the procedure just after “Reading playlist file”. “Change System Configuration” and following procedures are executed based on new playlist file.

4.3.28.4 Transition Sequence Between Advanced VTS and Standard VTS

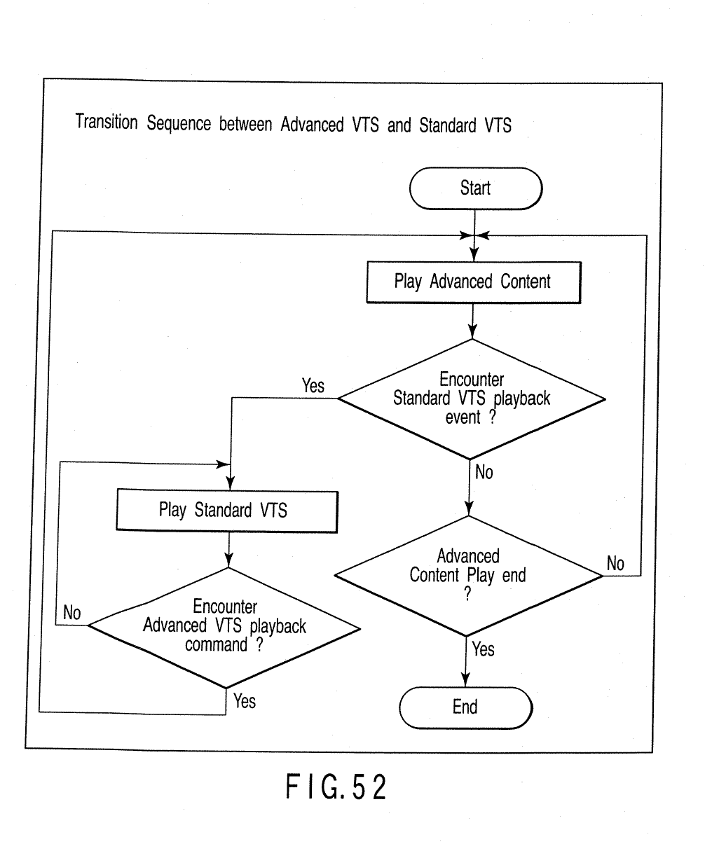

For disc category type 3 playback, it requires playback transition between Advanced VTS and Standard VTS. FIG. 52 shows a flow chart of this sequence.

Play Advanced Content:

Disc category type 3 disc playback shall start from Advanced Content playback. During this phase, user input events are handled by Navigation Manager. If any user events which should be handled by Primary Video Player, are occurred, Navigation Manager has to guarantee to transfer them to Primary Video Player.

Encounter Standard VTS Playback Event:

Advanced Content shall explicitly specify the transition from Advanced Content playback to Standard Content playback by CallStandardContentPlayer API in Advanced Navigation. CallStandardContentPlayer can have argument to specify the playback start position. When Navigation Manager encounters CallStandardContentPlayer command, Navigation Manager requests to suspend playback of Advanced VTS to Primary Video Player, and call CallStandardContentPlayer command.

Play Standard VTS:

When Navigation Manager issues CallStandardContentPlayer API, Primary Video Player jumps to start Standard VTS from specified position. During this phase, Navigation Manager is being suspended, so user event has to be inputted to Primary Video Player directly. During this phase, Primary Video Player is responsible for all playback transition among Standard VTSs based on navigation commands.

Encounter Advanced VTS Playback Command:

Standard Contend shall explicitly specify the transition from Standard Content playback to Advanced Content playback by CallAdvancedContentPlayer of Navigation Command. When Primary Video Player encounter the CallAdvancedContentPlayer command, it stops to play Standard VTS, then resumes Navigation Manager from execution point just after calling CallStandardContentPlayer command.

5.1.3.2.1.1 Resume Sequence

When the resume presentation is executed by Resume( ) of User operation or RSM Instruction of Navigation command, the Player shall check the existence of Resume commands (RSM_CMDs) of the PGC which is specified by RSM Information, before starting the playback of the PGC.

1) When the RSM_CMDs exist in the PGC, the RSM_CMDs are executed at first.
if Break Instruction is executed in the RSM_CMDs;

the execution of RSM_CMDs are terminated and then the resume presentation is re-started. But some information in RSM Information, such as SPRM(8) may be changed by RSM_CMDs.
if Instruction for branching is executed in the RSM_CMDs;

the resume presentation is terminated and the playback from new position which is specified by the Instruction for the branching is started.

2) When no RSM_CMDs exist in the PGC, the resume presentation is executed completely.

5.1.3.2.1.2 Resume Information

The Player has only one RSM Information. The RSM Information shall be updated and maintained as follows;
RSM Information shall be maintained until the RSM Information is updated by CallSS Instruction or Menu_Call( ) operation.
When Call process from TT_DOM to Menu-space is executed by CallSS Instruction or Menu_Call( ) operation, the Player shall check “RSM_permission” flag in a TT_PGC firstly.

1) If the flag is permitted, current RSM Information is updated to new RSM Information and then a menu is presented.

2) If the flag is prohibited, current RSM Information is maintained (non-updated) and then a menu is presented.

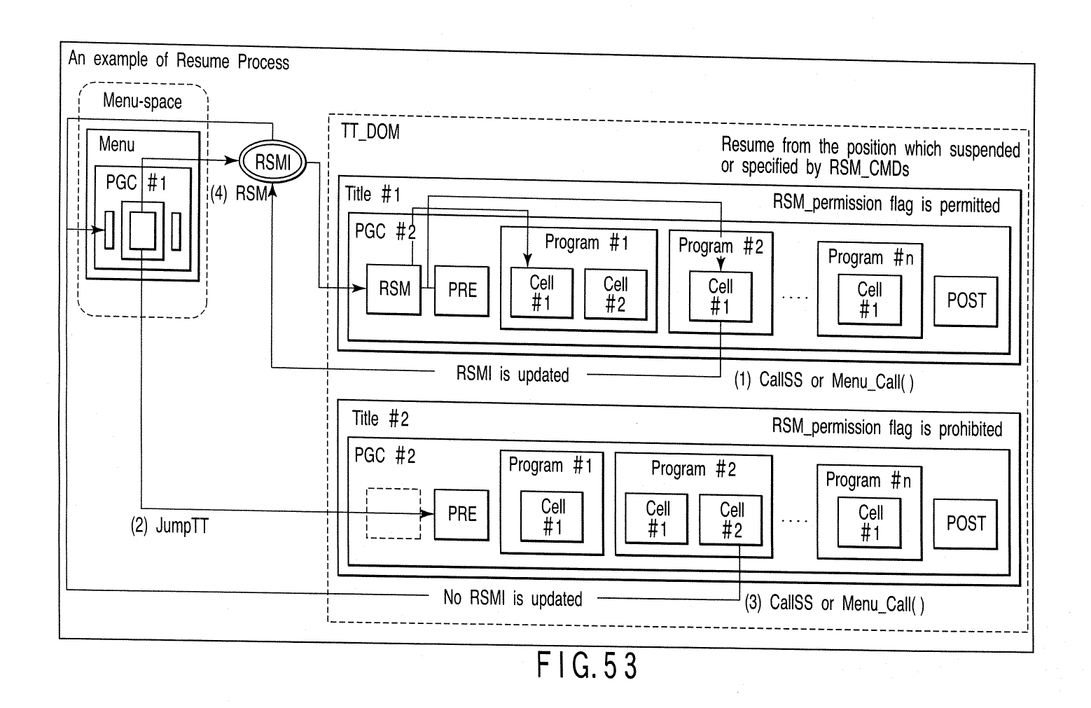

An example of Resume Process is shown in FIG. 53. In the figure, Resume Process is basically executed the following steps.

(1) execute either CallSS Instruction or Menu_Call( ) operation (in a PGC which “RSM_permission” flag is permitted)
RSMI is updated and a Menu is presented.

(2) execute JumpTT Instruction (jump to a PGC which “RSM_permission” flag is prohibited)
A PGC is presented.

(3) execute either CallSS Instruction or Menu_Call( ) operation (in a PGC which “RSM_permission” flag is prohibited)
No RSMI is updated and a Menu is presented.

(4) execute RSM Instruction
RSM_CMDs are executed by using RSMI and a PGC is resumed from the position which suspended

or specified by RSM_CMDs.

5.1.4.2.4 Structure of Menu PGC

<About Language Unit>

1) Each System Menu may be recorded for one or more Menu Description Language(s). The Menu described by specific Menu Description Language(s) may be selected by user.

2) Each Menu PGC consists of independent PGCs for the Menu Description Language(s).

<Language Menu in FP_DOM>

1) FP_PGC may have Language Menu (FP_PGCM_EVOB) to be used for Language selection only.

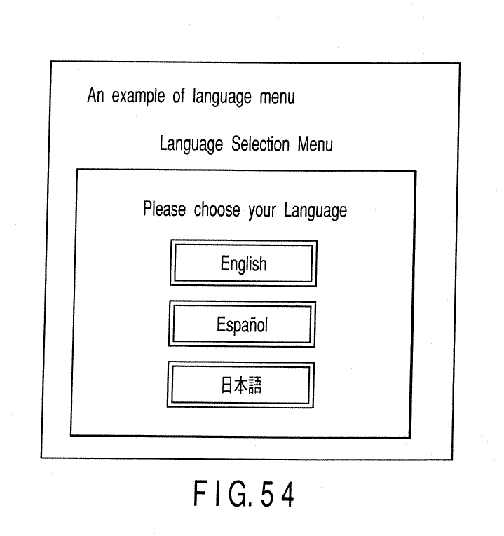

2) Once the language (code) is decided by this Language Menu, the language (code) is used to select Language Unit in VMG Menu and each VTS Menu. And an example is shown in FIG. 54.

5.1.4.3 HLI Availability in each PGC

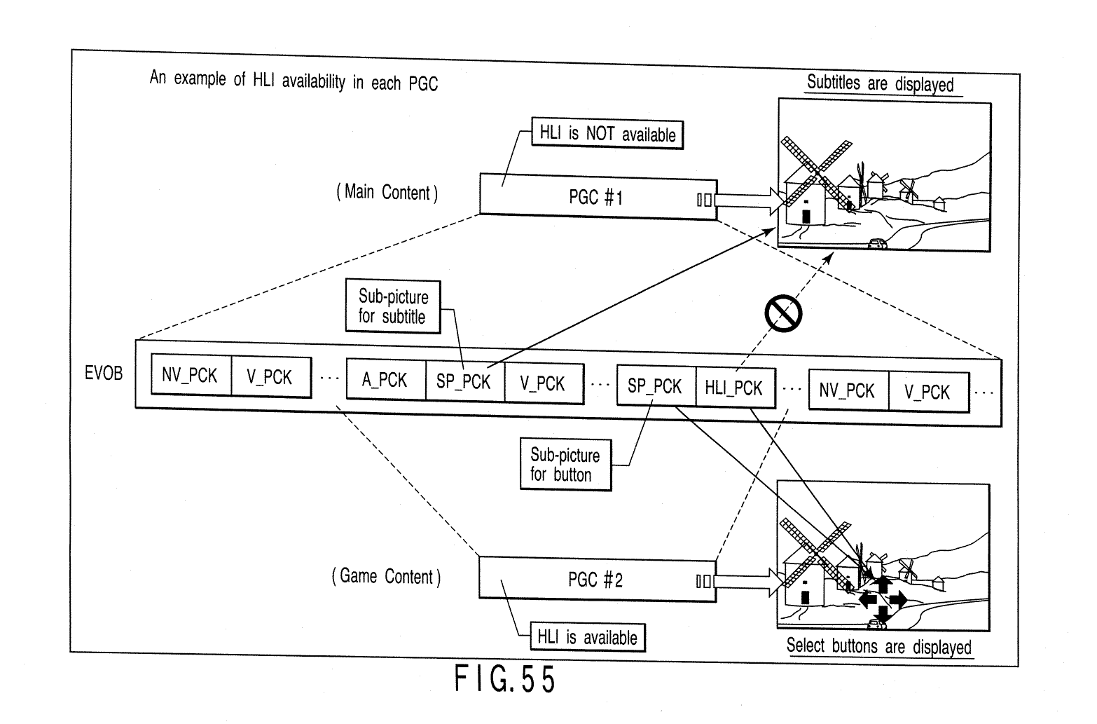

In order to use the same EVOB for both the main contents, such as a movie title, and the additional bonus contents, such as a game title with user input, “HLI availability flag” for each PGC is introduced. An example of HLI availability in each PGC is shown in FIG. 55.

In this figure, there are two kinds of Sub-picture streams; the one is for subtitle, the other is for button, in an EVOB. And furthermore, there is one HLI stream in an EVOB.

PGC#1 is for the main content and its “HLI availability flag” is NOT available. Then PGC#1 is played back, both HLI and Sub-picture for button shall not be displayed. However Sub-picture for subtitle may be displayed. On the other hand, PGC#2 is for the game content and its “HLI availability flag” is available. Then PGC#2 is played back, both HLI and Sub-picture for button shall be displayed with the forced display command. However Sub-picture for subtitle shall not be displayed.

This function would save the disc space.

5.2 Navigation for Standard Content

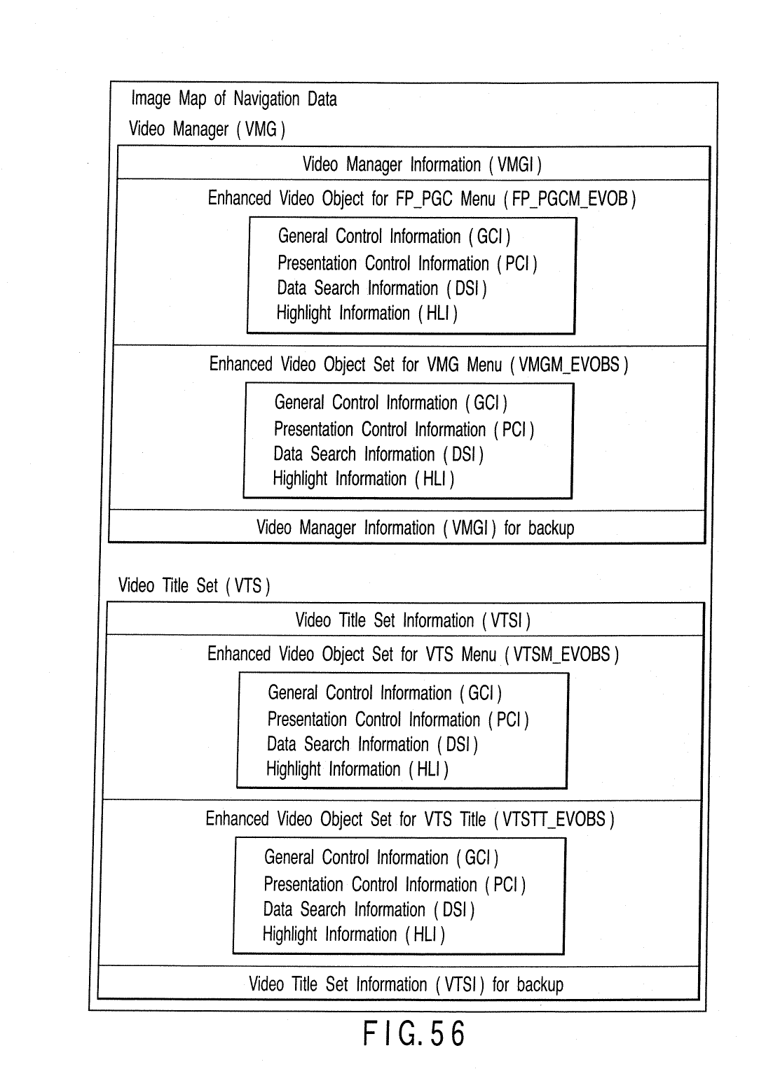

Navigation Data for Standard Content is the information on attributes and playback control for the Presentation Data. There are a total of five types namely, Video Manager Information (VMGI), Video Title Set Information (VTSI), General Control Information (GCI), Presentation Control Information (PCI), Data Search Information (DSI) and Highlight Information (HLI). VMGI is described at the beginning and the end of the Video Manager (VMG), and VTSI at the beginning and the end of the Video Title Set. GCI, PCI, DSI and HLI are dispersed in the Enhanced Video Object Set (EVOBS) along with the Presentation Data. Contents and the structure of each Navigation Data are defined as below. In particular, Program Chain Information (PGCI) described in VMGI and VTSI are defined in 5.2.3 Program Chain Information. Navigation Commands and Parameters described in PGCI and HLI are defined in 5.2.8 Navigation Commands and Navigation Parameters. FIG. 56 shows Image Map of Navigation Data.

5.2.1 Video Manager Information (VMGI)

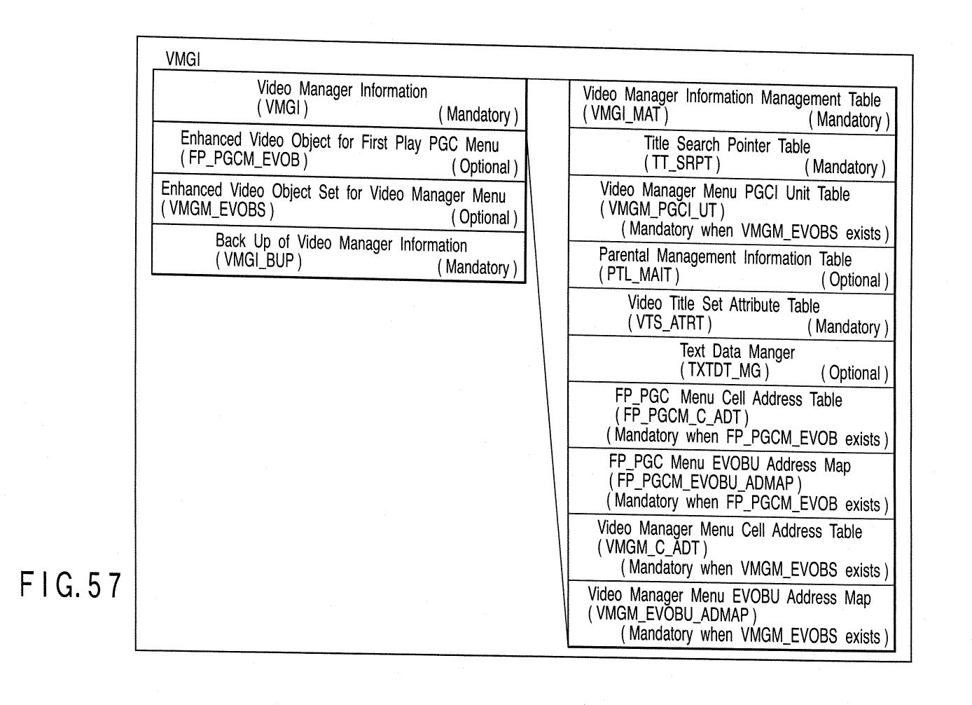

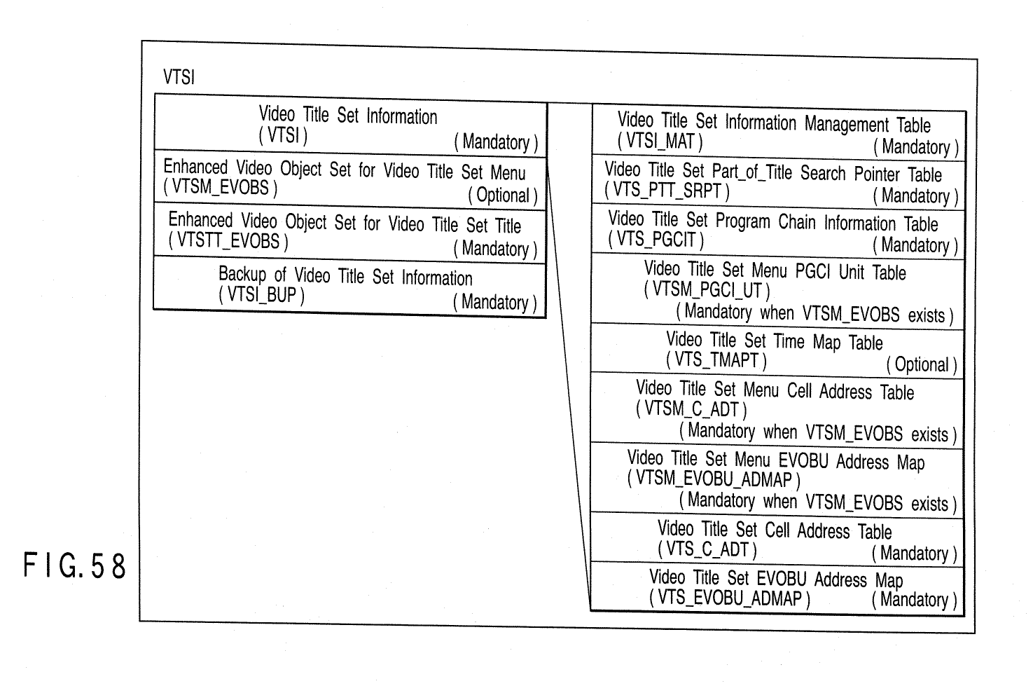

VMGI describes information on the related HVDVD_TS directory such as the information to search the Title and the information to present FP_PGC and VMGM, as well as the information on Parental Management, and on each VTS_ATR and TXTDT. The VMGI starts with Video Manager Information Management Table (VMGI_MAT), followed by Title Search Pointer Table (TT_SRPT), followed by Video Manager Menu PGCI Unit Table (VMGM_PGCI_UT), followed by Parental Management Information Table (PTL_MAIT), followed by Video Title Set Attribute Table (VTS_ATRT), followed by Text Data Manager (TXTDT_MG), followed by FP_PGC Menu Cell Address Table (FP_PGCM_C_ADT), followed by FP_PGC Menu Enhanced Video Object Unit Address Map (FP_PGCM_EVOBU_ADMAP), followed by Video Manager Menu Cell Address Table (VMGM_C_ADT), followed by Video Manager Menu Enhanced Video Object Unit Address Map (VMGM_EVOBU_ADMAP), as shown in FIG. 57. Each table shall be aligned on the boundary between Logical Blocks. For this purpose each table may be followed by up to 2047 bytes (containing (00h)).

5.2.1.1 Video Manager Information Management Table (VMGI_MAT)

A table that describes the size of VMG and VMGI, the start address of each information in VMG, attribute information on Enhanced Video Object Set for Video Manager Menu (VMGM_EVOBS) and the like is shown in Tables 5 to 9.

TABLE 5
VMGI_MAT

(Description order)

| | | | Number |
|---|---|---|---|
| RBP | | Contents | of bytes |
| 0 to 11 | VMG_ID | VMG Identifier | 12 bytes |
| 12 to 15 | VMG_EA | End address of VMG | 4 bytes |
| 16 to 27 | Reserved | Reserved | 12 bytes |
| 28 to 31 | VMGI_EA | End address of VMGI | 4 bytes |
| 32 to 33 | VERN | Version number of DVD Video Specifications | 2 bytes |
| 34 to 37 | VMG_CAT | Video Manager Category | 4 bytes |
| 38 to 45 | VLMS_ID | Volume Set Identifier | 8 bytes |
| 46 to 47 | ADP_ID | Adaptation Identifier | 2 bytes |
| 48 to 61 | Reserved | Reserved | 14 bytes |
| 62 to 63 | VTS_Ns | Number of Video Title Sets | 2 bytes |
| 64 to 95 | PVR_ID | Provider unique ID | 32 bytes |
| 96 to 103 | POS_CD | POS Code | 8 bytes |
| 104 to 127 | Reserved | Reserved | 24 bytes |
| 128 to 131 | VMGI_MAT_EA | End address of VMGI_MAT | 4 bytes |
| 132 to 135 | FP_PGCI_SA | Start address of FP_PGCI | 4 bytes |
| 136 to 183 | Reserved | reserved | 48 bytes |
| 184 to 187 | Reserved | reserved | 4 bytes |
| 188 to 191 | FP_PGCM_EVOB_SA | Start address of FP_PGCM_EVOB | 4 bytes |
| 192 to 195 | VMGM_EVOBS_SA | Start address of VMGM_EVOBS | 4 bytes |
| 196 to 199 | TT_SRPT_SA | Start address of TT_SRPT | 4 bytes |
| 200 to 203 | VMGM_PGCI_UT_SA | Start address of VMGM_PGCI_UT | 4 bytes |
| 204 to 207 | PTL_MAIT_SA | Start address of PTL_MAIT | 4 bytes |
| 208 to 211 | VTS_ATRT_SA | Start address of VTS_ATRT | 4 bytes |
| 212 to 215 | TXTDT_MG_SA | Start address of TXTDT_MG | 4 bytes |
| 216 to 219 | FP_PGCM_C_ADT_SA | Start address of FP_PGCM_C_ADT | 4 bytes |
| 220 to 223 | FP_PGCM_EVOBU_ADMAP_SA | Start address of FP_PGCM_EVOBU_ADMAP | 4 bytes |
| 224 to 227 | VMGM_C_ADT_SA | Start address of VMGM_C_ADT | 4 bytes |
| 228 to 231 | VMGM_EVOBU_ADMAP_SA | Start address of | 4 bytes |
| | | VMGM_EVOBU_ADMAP | |
| 232 to 251 | Reserved | reserved | 20 bytes |

TABLE 6
VMGI_MAT

(Description order)

| | | | Number |
|---|---|---|---|
| RBP | | Contents | of bytes |
| 252 to 253 | VMGM_AGL_Ns | Number of Angles for VMGM | 2 bytes |
| 254 to 257 | VMGM_V_ATR | Video attribute of VMGM | 4 bytes |
| 258 to 259 | VMGM_AST_Ns | Number of Audio streams of VMGM | 2 bytes |
| 260 to 323 | VMGM_AST_ATRT | Audio stream attribute table of VMGM | 64 bytes |
| 324 to 339 | Reserved | reserved | 16 bytes |
| 340 to 341 | VMGM_SPST_Ns | Number of Sub-picture streams of VMGM | 2 bytes |
| 342 to 533 | VMGM_SPST_ATRT | Sub-picture stream attribute table of VMGM | 192 bytes |
| 534 to 535 | Reserved | reserved | 2 bytes |
| 536 to 593 | Reserved | reserved | 58 bytes |
| 594 to 597 | FP_PGCM_V_ATR | Video attribute of FP_PGCM | 4 bytes |
| 598 to 599 | FP_PGCM_AST_Ns | Number of Audio streams of FP_PGCM | 2 bytes |
| 600 to 663 | FP_PGCM_AST_ATRT | Audio stream attribute table of FP_PGCM | 64 bytes |
| 664 to 665 | FP_PGCM_SPST_Ns | Number of Sub-picture streams of FP_PGCM | 2 bytes |
| 666 to 857 | FP_PGCM_SPST_ATRT | Sub-picture stream attribute table of FP_PGCM | 192 bytes |
| 858 to 859 | Reserved | reserved | 2 bytes |
| 860 to 861 | Reserved | reserved | 2 bytes |
| 862 to 865 | Reserved | reserved | 4 bytes |
| 866 to 1015 | Reserved | reserved | 150 bytes |
| 1016 to 1023 | FP_PGC_CAT | FP_PGC Category | 8 bytes |
| 1024 to 28815 | FP_PGCI | First Play PGCI | 0 or (2224 to |
| (max) | | | 28816) bytes |

TABLE 7
(RBP 32 to 33) VERN

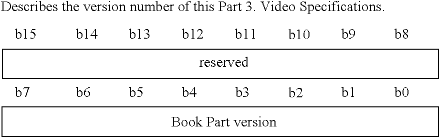

Book Part version . . . 0010 0000b: version 2.0
Others: reserved

TABLE 8
(RBP 34 to 37) VMG_CAT

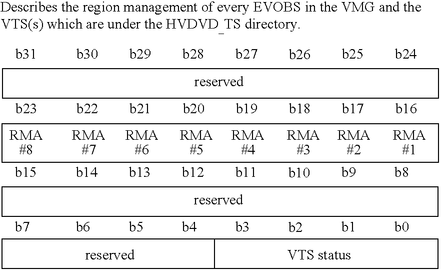

RMA #n . . . 0b: This Volume may be played in the region #n (n=1 to 8)
1b: This Volume shall not be played in the region #n (n=1 to 8)

VTS status . . . 0000b: No Advanced VTS exists

0001b: Advanced VTS exists

Others: reserved

(RBP 254 to 257) VMGM_V_ATR Describes the Video attribute of VMGM_EVOBS. The Value of each field shall be consistent with the information in the Video stream of VMGM_EVOBS. If no VMGM_EVOBS exist, enter ‘0b’ in every bit.

TABLE 9
(RBP 254 to 257) VMGM_V_ATR

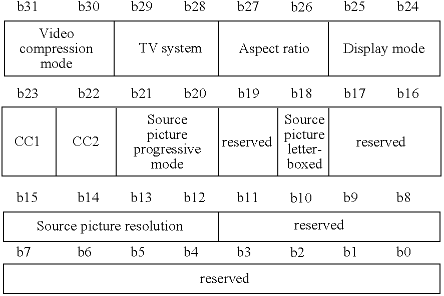

Video compression mode . . . 01b: Complies with MPEG-2
10b: Complies with MPEG-4 AVC
11b: Complies with SMPTE VC-1
Others: reserved

TV System . . . 00b: 525/60
01b: 625/50
10b: High Definition(HD)/60*
11b: High Definition(HD)/50*
*: HD/60 is used to down convert to 525/60, and HD/50 is used to down convert to 625/50.

Aspect ratio . . . 00b: 4:3
11b: 16:9
Others: reserved

Display mode . . . Describes the permitted display modes on 4:3 monitor.
When the “Aspect ratio” is ‘00b’ (4:3), enter ‘11b’.
When the “Aspect ratio” is ‘11b’ (16:9), enter ‘00b’, ‘01b’ or ‘10b’.
00b: Both Pan-scan* and Letterbox
01b: Only Pan-scan*
10b: Only Letterbox
11b: Not specified
*: Pan-scan means the 4:3 aspect ratio window taken from decoded picture.

CC1
. . . 1b: Closed caption data for Field 1 is recoded in Video stream.
0b: Closed caption data for Field 1 is not recoded in Video stream.

CC2
. . . 1b: Closed caption data for Field 2 is recoded in Video stream.
0b: Closed caption data for Field 2 is not recoded in Video stream.

Source picture resolution . . . 0000b: 352×240 (525/60 system), 352×288 (625/50 system)
0001b: 352×480 (525/60 system), 352×576 (625/50 system)
0010b: 480×480 (525/60 system), 480×576 (625/50 system)
0011b: 544×480 (525/60 system), 544×576 (625/50 system)
0100b: 704×480 (525/60 system), 704×576 (625/50 system)
0101b: 720×480 (525/60 system), 720×576 (625/50 system)
0110 to 0111b: reserved
1000b: 1280×720 (HD/60 or HD/50 system)
1001b: 960×1080 (HD/60 or HD/50 system)
1010b: 1280×1080 (HD/60 or HD/50 system)
1011b: 1440×1080 (HD/60 or HD/50 system)
1100b: 1920×1080 (HD/60 or HD/50 system)
1101b to 1111b: reserved

Source picture letterboxed
. . . Describes whether video output (after Video and Sub-picture is mixed,
   refer to [FIG. 4.2.2.1-2]) is letterboxed or not.
   When the “Aspect ratio” is ‘11b’ (16:9), enter ‘0b’.
   When the “Aspect ratio” is ‘00b’ (4:3), enter ‘0b’ or ‘1b’.
   0b: Not letterboxed
   1b: Letterboxed (Source Video picture is letterboxed and Sub-pictures (if any) are displayed
   only on active image area of Letterbox.)

Source picture progressive mode
. . . Describes whether source picture is the interlaced picture or the progressive picture.
   00b: Interlaced picture
   01b: Progressive picture
   10b: Unspecified

(RBP 342 to 533) VMGM_SPST_ATRT Describes each Sub-picture stream attribute (VMGM_SPST_ATR) for VMGM_EVOBS (Table 10). One VMGM_SPST_ATR is described for each Sub-picture stream existing. The stream numbers are assigned from ‘0’ according to the order in which VMGM_SPST_ATRs are described. When the number of Sub-picture streams are less than ‘32’, enter ‘0b’ in every bit of VMGM_SPST_ATR for unused streams.

TABLE 10
VMGM_SPST_ATRT

(Description order)

| | | Number |
|---|---|---|
| RBP | Contents | of bytes |
| 342 to 347 | VMGM_SPST_ATR of Sub-picture stream #0 | 6 bytes |
| 348 to 353 | VMGM_SPST_ATR of Sub-picture stream #1 | 6 bytes |
| 354 to 359 | VMGM_SPST_ATR of Sub-picture stream #2 | 6 bytes |
| 360 to 365 | VMGM_SPST_ATR of Sub-picture stream #3 | 6 bytes |
| 366 to 371 | VMGM_SPST_ATR of Sub-picture stream #4 | 6 bytes |
| 372 to 377 | VMGM_SPST_ATR of Sub-picture stream #5 | 6 bytes |
| 378 to 383 | VMGM_SPST_ATR of Sub-picture stream #6 | 6 bytes |
| 384 to 389 | VMGM_SPST_ATR of Sub-picture stream #7 | 6 bytes |
| 390 to 395 | VMGM_SPST_ATR of Sub-picture stream #8 | 6 bytes |
| 396 to 401 | VMGM_SPST_ATR of Sub-picture stream #9 | 6 bytes |
| 402 to 407 | VMGM_SPST_ATR of Sub-picture stream #10 | 6 bytes |
| 408 to 413 | VMGM_SPST_ATR of Sub-picture stream #11 | 6 bytes |
| 414 to 419 | VMGM_SPST_ATR of Sub-picture stream #12 | 6 bytes |
| 420 to 425 | VMGM_SPST_ATR of Sub-picture stream #13 | 6 bytes |
| 426 to 431 | VMGM_SPST_ATR of Sub-picture stream #14 | 6 bytes |
| 432 to 437 | VMGM_SPST_ATR of Sub-picture stream #15 | 6 bytes |
| 438 to 443 | VMGM_SPST_ATR of Sub-picture stream #16 | 6 bytes |
| 444 to 449 | VMGM_SPST_ATR of Sub-picture stream #17 | 6 bytes |
| 450 to 455 | VMGM_SPST_ATR of Sub-picture stream #18 | 6 bytes |
| 456 to 461 | VMGM_SPST_ATR of Sub-picture stream #19 | 6 bytes |
| 462 to 467 | VMGM_SPST_ATR of Sub-picture stream #20 | 6 bytes |
| 468 to 473 | VMGM_SPST_ATR of Sub-picture stream #21 | 6 bytes |
| 474 to 479 | VMGM_SPST_ATR of Sub-picture stream #22 | 6 bytes |
| 480 to 485 | VMGM_SPST_ATR of Sub-picture stream #23 | 6 bytes |
| 486 to 491 | VMGM_SPST_ATR of Sub-picture stream #24 | 6 bytes |
| 492 to 497 | VMGM_SPST_ATR of Sub-picture stream #25 | 6 bytes |
| 498 to 503 | VMGM_SPST_ATR of Sub-picture stream #26 | 6 bytes |
| 504 to 509 | VMGM_SPST_ATR of Sub-picture stream #27 | 6 bytes |
| 510 to 515 | VMGM_SPST_ATR of Sub-picture stream #28 | 6 bytes |
| 516 to 521 | VMGM_SPST_ATR of Sub-picture stream #29 | 6 bytes |
| 522 to 527 | VMGM_SPST_ATR of Sub-picture stream #30 | 6 bytes |
| 528 to 533 | VMGM_SPST_ATR of Sub-picture stream #31 | 6 bytes |
| | Total | 192 bytes |

The content of one VMGM_SPST_ATR is as follows:

TABLE 11
VMGM_SPST_ATR

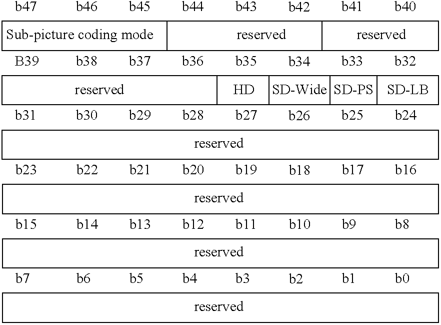

Sub-picture coding mode . . . 000b: Run-length for 2 bits/pixel defined in 5.5.3 Sub-picture Unit.

(The value of PRE_HEAD is other than (0000h))

001b: Run-length for 2 bits/pixel defined in 5.5.3 Sub-picture Unit.

(The value of PRE_HEAD is (0000h))

100b: Run-length for 8 bits/pixel defined in 5.5.4 Sub-picture Unit

for the pixel depth of 8 bits.

Others: reserved

HD . . . When “Sub-picture coding mode” is ‘001b’ or ‘100b’, this flag specifies
whether HD stream exist or not.

0b: No stream exist

1b: Stream exist

SD-Wide . . . When “Sub-picture coding mode” is ‘001b’ or ‘100b’, this flag specifies
whether SD Wide (16:9) stream exist or not.

0b: No stream exist

1b: Stream exist

SD-PS . . . When “Sub-picture coding mode” is ‘001b’ or ‘100b’, this flag specifies
whether SD Pan-Scan (4:3) stream exist or not.

0b: No stream exist

1b: Stream exist

SD-LB . . . When “Sub-picture coding mode” is ‘001b’ or ‘100b’, this flag specifies
whether SD Letterbox (4:3) stream exist or not.

0b: No stream exist

1b: Stream exist

TABLE 12
(RBP 1016 to 1023) FP_PGC_CAT

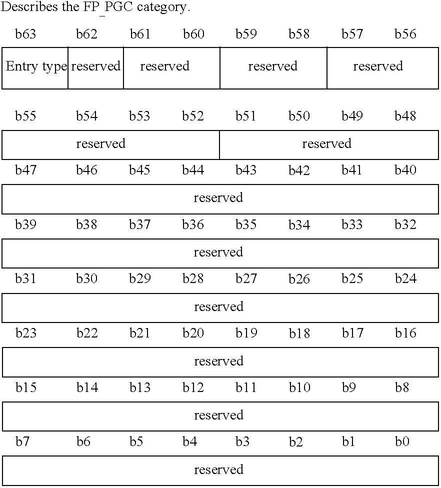

Entry type . . . 1b: Entry PGC

5.2.2 Video Title Set Information (VTSI)

VTSI describes information for one or more Video Titles and Video Title Set Menu. VTSI describes the management information of these Title(s) such as the information to search the Part_of_Title (PTT) and the information to play back Enhanced Video Object Set (EVOBS), and Video Title Set Menu (VTSM), as well as the information on attribute of EVOBS.

The VTSI starts with Video Title Set Information Management Table (VTSI_MAT), followed by Video Title Set Part_of_Title Search Pointer Table (VTS_PTT_SPRT), followed by Video Title Set Program Chain Information Table (VTS_PGCIT), followed by Video Title Set Menu PGCI Unit Table (VTSM_PGCI_UT), followed by Video Title Set Time Map Table (VTS_TMAPT), followed by Video Title Set Menu Cell Address Table (VTSM_C_ADT), followed by Video Title Set Menu Enhanced Video Object Unit Address Map (VTSM_EVOBU_ADMAP), followed by Video Title Set Cell Address Table (VTS_C_ADT), followed by Video Title Set Enhanced Video Object Unit Address Map (VTS_EVOBU_ADMAP) as shown in FIG. 58. Each table shall be aligned on the boundary between Logical Blocks. For this purpose each table may be followed by up to 2047 bytes (containing (00h)).

5.2.2.1 Video Title Set Information Management Table (VTSI_MAT)

A table on the size of VTS and VTSI, the start address of each information in the VTSI and the attribute of EVOBS in the VTS is shown in Table 13.

TABLE 13
VTSI_MAT

(Description order)

| RBP | | Contents/Number of bytes |
|---|---|---|
| 0 to 11 | VTS_ID | VTS Identifier/12 |
| 12 to 15 | VTS_EA | End address of VTS/4 |
| 16 to 27 | reserved | reserved/12 |
| 28 to 31 | VTSI_EA | End address of VTSI/4 |
| 32 to 33 | VERN | Version number of DVD Video Specification/2 |
| 34 to 37 | VTS_CAT | VTS Category/4 |
| 38 to 127 | reserved | reserved/90 |
| 128 to 131 | VTSI_MAT_EA | End address of VTSI_MAT/4 |
| 132 to 183 | reserved | reserved/52 |
| 184 to 187 | reserved | reserved/4 |
| 188 to 191 | reserved | reserved/4 |
| 192 to 195 | VTSM_EVOBS_SA | Start address of VTSM_EVOBS/4 |
| 196 to 199 | VTSTT_EVOBS_SA | Start address of VTSTT_EVOBS/4 |
| 200 to 203 | VTS_PTT_SRPT_SA | Start address of VTS_PTT_SRPT/4 |
| 204 to 207 | VTS_PGCIT_SA | Start address of VTS_PGCIT/4 |
| 208 to 211 | VTSM_PGCI_UT_SA | Start address of VTSM_PGCI_UT/4 |
| 212 to 215 | VTS_TMAPT_SA | Start address of VTS_TMAPT/4 |
| 216 to 219 | VTSM_C_ADT_SA | Start address of VTSM_C_ADT4/ |
| 220 to 223 | VTSM_EVOBU_ADMAP_{—} | Start address of VTSM_EVOBU_ADMAP/4 |
| 224 to 227 | VTS_C_ADT_SA | Start address of VTS_C_ADT/4 |
| 228 to 231 | VTS_EVOBU_ADMAP_S | Start address of VTS_EVOBU_ADMAP/4 |
| 232 to 233 | VTSM_AGL_Ns | Number of Angles for VTSM/2 |
| 234 to 237 | VTSM_V_ATR | Video attribute of VTSM/4 |
| 238 to 239 | VTSM_AST_Ns | Number of Audio streams of VTSM/2 |
| 240 to 303 | VTSM_AST_ATRT | Audio stream attribute table of VTSM/64 |
| 304 to 305 | reserved | reserved/2 |
| 306 to 307 | VTSM_SPST_Ns | Number of Sub-picture streams of VTSM/2 |
| 308 to 499 | VTSM_SPST_ATRT | Sub-picture stream attribute table of VTSM/192 |
| 500 to 501 | reserved | reserved/2 |
| 502 to 531 | reserved | reserved/30 |
| 532 to 535 | VTS_V_ATR | Video attribute of VTS/4 |
| 536 to 537 | VTS_AST_Ns | Number of Audio streams of VTS/2 |
| 538 to 601 | VTS_AST_ATRT | Audio stream attribute table of VTS/64 |
| 602 to 603 | VTS_SPST_Ns | Number of Sub-picture streams of VTS/2 |
| 604 to 795 | VTS_SPST_ATRT | Sub-picture stream attribute table of VTS/192 |
| 796 to 797 | reserved | reserved/2 |
| 798 to 861 | VTS_MU_AST_ATRT | Multichannel Audio stream attribute table of |
| 862 to 989 | reserved | reserved/128 |
| 990 to 991 | reserved | reserved/2 |
| 992 to 993 | reserved | reserved/2 |
| 994 to 1023 | reserved | reserved/30 |
| 1024 to 2047 | reserved | reserved/1024 |

(RBP 0 to 11) VTS_ID Describes “STANDARD-VTS” to identify VTSI's File with character set code of ISO646 (a-characters).

(RBP 12 to 15) VTS_EA Describes the end address of VTS with RLBN from the first LB of this VTS.

(RBP 28 to 31) VTSI_EA Describes the end address of VTSI with RLBN from the first LB of this VTSI.

(RBP 32 to 33) VERN Describes the version number of this Part 3: Video Specifications (Table 14).

TABLE 14
(RBP 32 to 33) VERN

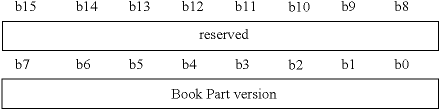

Book Part version . . . 0001 0000b: version 1.0
Others: reserved

(RBP 34 to 37) VTS_CAT Describes the Application type of this VTS (Table 15).

TABLE 15
(RBP 34 to 37) VTS_CAT

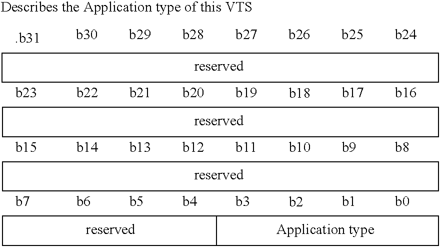

Application type . . . 0000b: Not specified
0001b: Karaoke
Others: reserved

(RBP 532 to 535) VTS_V_ATR Describes Video attribute of VTSTT_EVOBS in this VTS (Table 16). The value of each field shall be consistent with the information in the Video stream of VTSTT_EVOBS.

TABLE 16
(REP 532 to 535) VTS_V_ATR

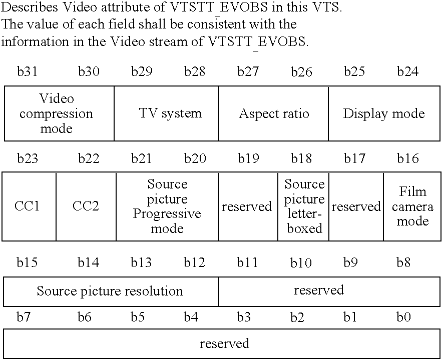

Video compression mode . . . 01b: Complies with MPEG-2
10b: Complies with MPEG-4 AVC
11b: Complies with SMPTE VC-1
Others: reserved

TV System . . . 00b: 525/60
10b: 625/50
10b: High Definition(HD)/60*
11b: High Definition(HD)/50*
*: HD/60 is used to down convert to 525/60, and HD/50 is used to down convert to 625/50.

Aspect ratio . . . 00b: 4:3
11b: 16:9
Others: reserved

Display mode . . . Describes the permitted display modes on 4:3 monitor.
When the “Aspect ratio” is ‘00b’ (4:3), enter ‘11b’.
When the “Aspect ratio” is ‘11b’ (16:9), enter ‘00b’, ‘01b’ or ‘10b’.
00b: Both Pan-scan* and Letterbox
01b: Only Pan-scan*
10b: Only Letterbox
11b: Not specified
*: Pan-scan means the 4:3 aspect ratio window taken from decoded picture.

CC1

. . . 1b: Closed caption data for Field 1 is recoded in Video stream.

0b: Closed caption data for Field 1 is not recoded in Video stream.

CC2

. . . 1b: Closed caption data for Field 2 is recoded in Video stream.

0b: Closed caption data for Field 2 is not recoded in Video stream.

Source picture resolution . . . 0000b: 352×240 (525/60 system), 352×288 (625/50 system)
0001b: 352×480 (525/60 system), 352×576 (625/50 system)
0010b: 480×480 (525/60 system), 480×576 (625/50 system)
0011b: 544×480 (525/60 system), 544×576 (625/50 system)
0100b: 704×480 (525/60 system), 704×576 (625/50 system)
0101b: 720×480 (525/60 system), 720×576 (625/50 system)
0110 to 0111b: reserved
1000b: 1280×720 (HD/60 or HD/50 system)
1001b: 960×1080 (HD/60 or HD/50 system)
1010b: 1280×1080 (HD/60 or HD/50 system)
1011b: 1440×1080 (HD/60 or HD/50 system)
1100b: 1920×1080 (HD/60 or HD/50 system)
1101b to 1111b: reserved

Source picture letterboxed

. . . Describes whether video output (after Video and Sub-picture is mixed,
refer to [FIG. 4.2.2.1-2]) is letterboxed or not.
When the “Aspect ratio” is ‘11b’ (16:9), enter ‘0b’.
When the “Aspect ratio” is ‘00b’ (4:3), enter ‘0b’ or ‘1b’.
0b: Not letterboxed
1b: Letterboxed (Source Video picture is letterboxed and Sub-pictures (if any) are displayed
only on active image area of Letterbox.)

Source picture progressive mode

. . . Describes whether source picture is the interlaced picture or the progressive picture.
00b: Interlaced picture
01b: Progressive picture
10b: Unspecified

Film camera mode

. . . Describes the source picture mode for 625/50 system.
When “TV system” is ‘00b’ (525/60), enter ‘0b’.
When “TV system” is ‘01b’ (625/50), enter ‘0b’ or ‘1b’.
When “TV system” is ‘10b’ (HD/60), enter ‘0b’.
When “TV system” is ‘11b’ (HD/50) is used to down convert to 625/50, enter ‘0b’ or ‘1b’.
   0b: camera mode
   1b: film mode

As for the definition of camera mode and film mode, refer to ETS300 294 Edition 2: 1995-12.

(RBP 536 to 537) VTS_AST_Ns Describes the number of Audio streams of VTSTT_EVOBS in this VTS (Table 17).

TABLE 17
(RBP 536 to 537) VTS_AST_Ns

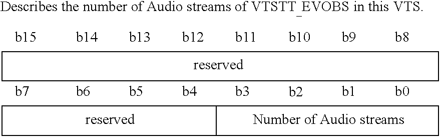

Number of Audio streams

. . . Describes the numbers between ‘0’ and ‘8’.

Others: reserved

(RBP 538 to 601) VTS_AST_ATRT Describes the each Audio stream attribute of VTSTT_EVOBS in this VTS (Table 18).

TABLE 18
VTS_AST_ATRT

(Description order)

| RBP | Contents | Number of bytes |
|---|---|---|
| 538 to 545 | VTS_AST_ATR of Audio stream #0 | 8 bytes |
| 546 to 553 | VTS_AST_ATR of Audio stream #1 | 8 bytes |
| 554 to 561 | VTS_AST_ATR of Audio stream #2 | 8 bytes |
| 562 to 569 | VTS_AST_ATR of Audio stream #3 | 8 bytes |
| 570 to 577 | VTS_AST_ATR of Audio stream #4 | 8 bytes |
| 578 to 585 | VTS_AST_ATR of Audio stream #5 | 8 bytes |
| 586 to 593 | VTS_AST_ATR of Audio stream #6 | 8 bytes |
| 594 to 601 | VTS_AST_ATR of Audio stream #7 | 8 bytes |

The value of each field shall be consistent with the information in the Audio stream of VTSTT_EVOBS. One VTS_AST_ATR is described for each Audio stream. There shall be area for eight VTS_AST_ATRs constantly. The stream numbers are assigned from ‘0’ according to the order in which VTS_AST_ATRs are described. When the number of Audio streams are less than ‘8’, enter ‘0b’ in every bit of VTS_AST_ATR for unused streams.

The content of one VTS_AST_ATR is follows:

TABLE 19
VTS_AST_ATR

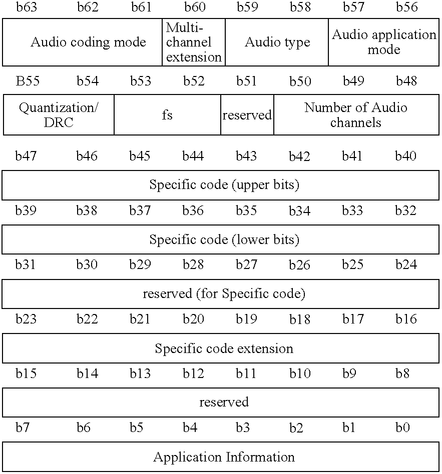

Audio coding mode . . . 000b: reserved for Dolby AC-3

001b: MLP audio

010b: MPEG-1 or MPEG-2 without extension bitstream

011b: MPEG-2 with extension bitstream

100b: reserved

101b: Linear PCM audio with sample data of 1/1200 second

110b: DTS-HD

111b: DD+

Note: For further details on requirements of “Audio coding mode”, refer to 5.5.2 Audio and Annex N.

Multichannel extension . . . 0b: Relevant VTS_MU_AST_ATR is not effective

1b: Linked to the relevant VTS_MU_AST_ATR

Note: This flag shall be set to ‘1b’ when Audio application mode is “Karaoke mode” or “Surround mode”.

Audio type . . . 00b: Not specified

01b: Language included

Others: reserved

Audio application mode . . . 00b: Not specified

01b: Karaoke mode

10b: Surround mode

11b: reserved

Note: When Application type of VTS_CAT is set to ‘0001b’ (Karaoke) in one or more VTS_AST_ATRs in the VTS, this flag shall be set to ‘01b’.

Quantization/DRC . . . When “Audio coding mode” is ‘110b’ or ‘111b’, enter ‘11b’.

When “Audio coding mode” is ‘010b’ or ‘011b’, then Quantization/DRC is defined as:

00b: Dynamic range control data do not exist in MPEG audio stream.

01b: Dynamic range control data exist in MPEG audio stream.

10b: reserved

11b: reserved

When “Audio coding mode” is ‘011b’ or ‘101b’, then Quantization/DRC is defined as:

00b: 16 bits

01b: 20 bits

10b: 24 bits

11b: reserved

fs . . . 00b: 48 kHz

01b: 96 kHz

Others: reserved

Number of Audio channels . . . 000b: 1ch (mono)

001b: 2ch (stereo)

010b: 3ch

011b: 4ch

100b: 5ch (multichannel)

101b: 6ch

110b: 7ch

111b: 8ch

Note 1: The “0.1ch” is defined as “1ch”. (e.g. In case of 5.1ch, enter ‘101b’ (6ch).)

Specific code . . . Refer to Annex B.

Application Information . . . reserved

(RBP 602 to 603) VTS_SPST_Ns Describes the number of Sub-picture streams for VTSTT_EVOBS in the VTS (Table 20).

TABLE 20
(RBP 602 to 603) VTS_SPST_Ns

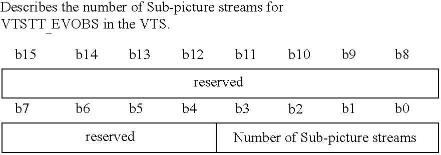

(RBP 604 to 795) VTS_SPST_ATRT Describes each Sub-picture stream attribute (VTS_SPST_ATR) for VTSTT_EVOBS in this VTS (Table 21).

TABLE 21
VTS_SPST_ATRT

(Description order)

| | | Number |
|---|---|---|
| RBP | Contents | of bytes |
| 604 to 609 | VTS_SPST_ATR of Sub-picture stream #0 | 6 bytes |
| 610 to 615 | VTS_SPST_ATR of Sub-picture stream #1 | 6 bytes |
| 616 to 621 | VTS_SPST_ATR of Sub-picture stream #2 | 6 bytes |
| 622 to 627 | VTS_SPST_ATR of Sub-picture stream #3 | 6 bytes |
| 628 to 633 | VTS_SPST_ATR of Sub-picture stream #4 | 6 bytes |
| 634 to 639 | VTS_SPST_ATR of Sub-picture stream #5 | 6 bytes |
| 640 to 645 | VTS_SPST_ATR of Sub-picture stream #6 | 6 bytes |
| 646 to 651 | VTS_SPST_ATR of Sub-picture stream #7 | 6 bytes |
| 652 to 657 | VTS_SPST_ATR of Sub-picture stream #8 | 6 bytes |
| 658 to 663 | VTS_SPST_ATR of Sub-picture stream #9 | 6 bytes |
| 664 to 669 | VTS_SPST_ATR of Sub-picture stream #10 | 6 bytes |
| 670 to 675 | VTS_SPST_ATR of Sub-picture stream #11 | 6 bytes |
| 676 to 681 | VTS_SPST_ATR of Sub-picture stream #12 | 6 bytes |
| 682 to 687 | VTS_SPST_ATR of Sub-picture stream #13 | 6 bytes |
| 688 to 693 | VTS_SPST_ATR of Sub-picture stream #14 | 6 bytes |
| 694 to 699 | VTS_SPST_ATR of Sub-picture stream #15 | 6 bytes |
| 700 to 705 | VTS_SPST_ATR of Sub-picture stream #16 | 6 bytes |
| 706 to 711 | VTS_SPST_ATR of Sub-picture stream #17 | 6 bytes |
| 712 to 717 | VTS_SPST_ATR of Sub-picture stream #18 | 6 bytes |
| 718 to 723 | VTS_SPST_ATR of Sub-picture stream #19 | 6 bytes |
| 724 to 729 | VTS_SPST_ATR of Sub-picture stream #20 | 6 bytes |
| 730 to 735 | VTS_SPST_ATR of Sub-picture stream #21 | 6 bytes |
| 736 to 741 | VTS_SPST_ATR of Sub-picture stream #22 | 6 bytes |
| 742 to 747 | VTS_SPST_ATR of Sub-picture stream #23 | 6 bytes |
| 748 to 753 | VTS_SPST_ATR of Sub-picture stream #24 | 6 bytes |
| 754 to 759 | VTS_SPST_ATR of Sub-picture stream #25 | 6 bytes |
| 760 to 765 | VTS_SPST_ATR of Sub-picture stream #26 | 6 bytes |
| 766 to 771 | VTS_SPST_ATR of Sub-picture stream #27 | 6 bytes |
| 772 to 777 | VTS_SPST_ATR of Sub-picture stream #28 | 6 bytes |
| 778 to 783 | VTS_SPST_ATR of Sub-picture stream #29 | 6 bytes |
| 784 to 789 | VTS_SPST_ATR of Sub-picture stream #30 | 6 bytes |
| 790 to 795 | VTS_SPST_ATR of Sub-picture stream #31 | 6 bytes |
| | Total | 192 bytes |

One VTS_SPST_ATR is described for each Sub-picture stream existing. The stream numbers are assigned from ‘0’ according to the order in which VTS_SPST_ATRs are described. When the number of Sub-picture streams are less than ‘32’, enter ‘0b’ in every bit of VTS_SPST_ATR for unused streams.

The content of one VTSM_SPST_ATR is as follows:

TABLE 22
VTSM_SPST_ATR

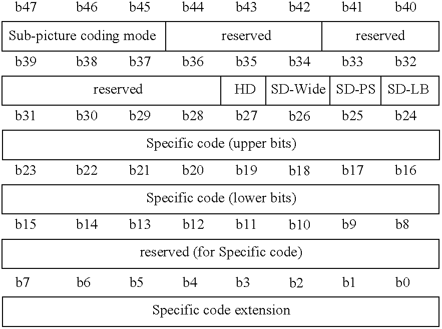

Sub-picture coding mode . . . 000b: Run-length for 2 bits/pixel defined in 5.5.3 Sub-picture Unit.

(The value of PRE_HEAD is other than (0000h))

001b: Run-length for 2 bits/pixel defined in 5.5.3 Sub-picture Unit.

(The value of PRE_HEAD is (0000h))

100b: Run-length for 8 bits/pixel defined in 5.5.4 Sub-picture Unit

for the pixel depth of 8 bits.

Others: reserved

Sub-picture type . . . 00b: Not specified

01b: Language

Others: reserved

Specific code . . . Refer to Annex B.

Specific code extension . . . Refer to Annex B.

Note 1: In a Title, there shall not be more than one Sub-picture stream which has Language Code extension (see Annex B) of Forced Caption (09h) among the Sub-picture

streams which have the same Language Code.

Note 2: The Sub-picture streams which has Language Code extension of Forced Caption (09h)

shall have larger Sub-picture stream number than all other Sub-picture streams (which

does not have Language Code extension of Forced Caption (09h)).

HD . . . When “Sub-picture coding mode” is ‘001b’ or ‘100b’, this flag specifies
whether HD stream exist or not.

0b: No stream exist

1b: Stream exist

SD-Wide . . . When “Sub-picture coding mode” is ‘001b’ or ‘100b’, this flag specifies
whether SD Wide (16:9) stream exist or not.

0b: No stream exist

1b: Stream exist

SD-PS . . . When “Sub-picture coding mode” is ‘001b’ or ‘100b’, this flag specifies
whether SD Pan-Scan (4:3) stream exist or not.

0b: No stream exist

1b: Stream exist

SD-LB . . . When “Sub-picture coding mode” is ‘001b’ or ‘100b’, this flag specifies
whether SD Letterbox (4:3) stream exist or not.

0b: No stream exist

1b: Stream exist

(RBP 798 to 861) VTS_MU_AST_ATRT Describes each Audio attribute for multichannel use (Table 23). There is one type of Audio attribute which is VTS_MU_AST_ATR. The description area for eight Audio streams starting from the stream number ‘0’ followed by consecutive numbers up to ‘7’ is constantly reserved. On the area of the Audio stream whose “Multichannel extension” in VTS_AST_ATR is ‘0b’, enter ‘0b’ in every bit.

TABLE 23
VTS_MU_AST_ATRT

(Description order)

| | | Number |
|---|---|---|
| RBP | Contents | of bytes |
| 798 to 805 | VTS_MU_AST_ATR of Audio stream #0 | 8 bytes |
| 806 to 813 | VTS_MU_AST_ATR of Audio stream #1 | 8 bytes |
| 814 to 821 | VTS_MU_AST_ATR of Audio stream #2 | 8 bytes |
| 822 to 829 | VTS_MU_AST_ATR of Audio stream #3 | 8 bytes |
| 830 to 837 | VTS_MU_AST_ATR of Audio stream #4 | 8 bytes |
| 838 to 845 | VTS_MU_AST_ATR of Audio stream #5 | 8 bytes |
| 846 to 853 | VTS_MU_AST_ATR of Audio stream #6 | 8 bytes |
| 854 to 861 | VTS_MU_AST_ATR of Audio stream #7 | 8 bytes |
| | Total | 64 bytes |

Table 24 shows VTS_MU_AST_ATR.

TABLE 24
VTS_MU_AST_ATR

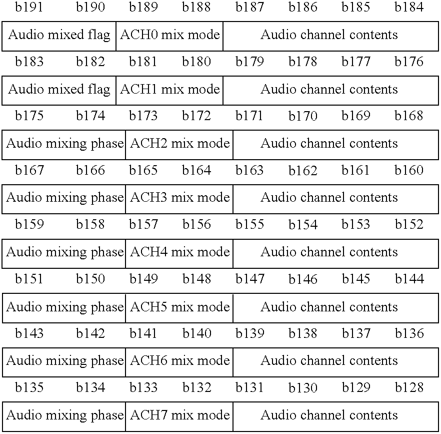

Audio channel contents . . . reserved

Audio mixing phase . . . reserved

Audio mixed flag . . . reserved

ACH0 to ACH7 mix mode . . . reserved

5.2.2.3 Video Title Set Program Chain Information Table (VTS_PGCIT)

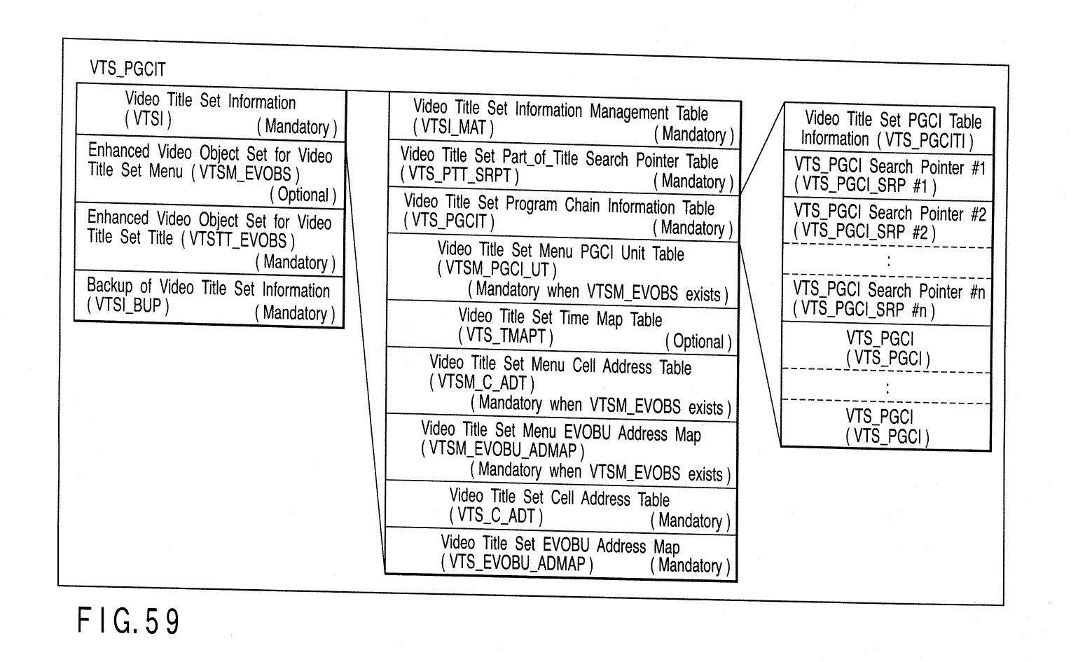

A table that describes VTS Program Chain Information (VTS_PGCI). The table VTS_PGCIT starts with VTS_PGCIT Information (VTS_PGCITI) followed by VTS_PGCI Search Pointers (VTS_PGCI_SRPs), followed by one or more VTS_PGCIs as shown in FIG. 59. VTS_PGC number is assigned from number ‘1’ in the described order of VTS_PGCI_SRP. PGCIs which form a block shall be described continuously. One or more VTS Title numbers (VTS_TTNs) are assigned in ascending order of VTS_PGCI_SRP for the Entry PGC from ‘1’. A group of more than one PGC constituting a block is called a PGC Block. In each PGC Block, VTS_PGCI_SRPs shall be described continuously. VTS_TT is defined as a group of PGCs which have the same VTS_TTN in a VTS. The contents of VTS_PGCITI and one VTS_PGCI_SRP are shown in Table 25 and Table 26 respectively. For the description of VTS_PGCI, refer to 5.2.3 Program Chain Information.

Note: The order of VTS_PGCIs has no relation to the order of VTS_PGCI Search Pointers.

Therefore it is possible that more than one VTS_PGCI Search Pointers point to the same VTS_PGCI.

TABLE 25
VTS_PGCITI

(Description order)

| | | Number of |
|---|---|---|
| | Contents | bytes |
| (1) VTS_PGCI_SRP_Ns | Number of VTS_PGCI_SRPs | 2 bytes |
| reserved | reserved | 2 bytes |
| (2) VTS_PGCIT_EA | End address of VTS_PGCIT | 4 bytes |

TABLE 26
VTS_PGCI_SRP

(Description order)

| | Contents | Number of bytes |
|---|---|---|
| (1) VTS_PGC_CAT | VTS_PGC Category | 8 bytes |
| (2) VTS_PGCI_SA | Start address of VTS_PGCI | 4 bytes |

TABLE 27
(1) VTS_PGC_CAT

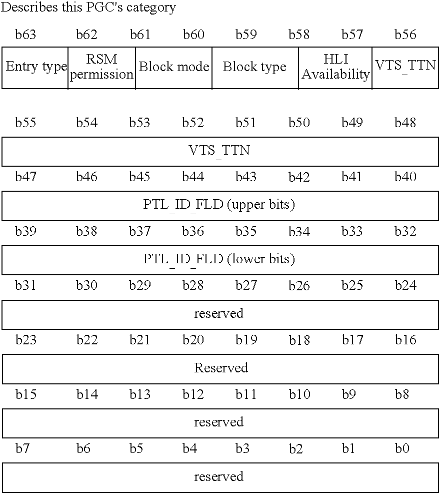

Entry type 0b: Not Entry PGC
1b: Entry PGC

RSM permission Describes whether or not the re-start of the playback by RSM Instruction or
Resume( ) function is permitted in this PGC.
0b: permitted (RSM Information is updated)
1b: prohibited (No RSM Information is updated)

Block mode When PGC Block type is ‘00b’, enter ‘00b’.
When PGC Block type is ‘01b’, enter ‘01b’, ‘10b’ or ‘11b’.
00b: Not a PGC in the block
01b: The first PGC in the block
10b: PGC in the block (except the first and the last PGC)
11b: The last PGC in the block

Block type When PTL_MAIT does not exist, enter ‘00b’.
00b: Not a part of the block
01b: Parental Block
Others: reserved

HLI Availability Describes whether HLI stored in EVOB is available or not.
When HLI does not exist in EVOB, enter ‘1b’.
0b: HLI is available in this PGC
1b: HLI is not available in this PGC
i.e. HLI and the related Sub-picture for button shall be ignored by player.

VTS_TTN ‘1’ to ‘511’: VTS Title number value
Others: reserved

5.2.3 Program Chain Information (PGCI)

PGCI is the Navigation Data to control the presentation of PGC. PGC is composed basically of PGCI and Enhanced Video Objects (EVOBs), however, a PGC without any EVOB but only with a PGCI may also exist. A PGC with PGCI only is used, for example, to decide the presentation condition and to transfer the presentation to another PGC. PGCI numbers are assigned from ‘1’ in the described order for PGCI Search Pointers in VMGM_LU, VTSM_LU and VTS_PGCIT. PGC number (PGCN) has the same value as the PGCI number. Even when PGC takes a block structure, the PGCN in the block matches the consecutive number in the PGCI Search Pointers. PGCs are divided into four types according to the Domain and the purpose as shown in Table 28. A structure with PGCI only as well as PGCI and EVOB is possible for the First Play PGC (FP_PGC), the Video Manager Menu PGC (VMGM_PGC), the Video Title Set Menu PGC (VTSM_PGC) and the Title PGC (TT_PGC).

TABLE 28
Types of PGC

| | Corresponding | described | |
|---|---|---|---|
| | EVOB | Domain | comment |
| FP_PGC | permitted | FP_DOM | only one PGC may |
| | | in VMG-space | exist |
| VMGM_PGC | permitted | VMGM_DOM | one or more PGCs |
| | | in VMG-space | exist in each Language |
| | | | Unit. |
| VTSM_PGC | permitted | VTSM_DOM | one or more PGCs |
| | | in each | exist in each Language |
| | VTS-space | Unit. | |
| TT_PGC | permitted | TT_DOM | one or more PGCs |
| | | in each | exist in each |
| | | VTS-space | TT_DOM. |

The following restrictions are applied to FP_PGC.

1) Either no Cell (no EVOB) or Cell(s) in one EVOB is allowed

2) As for PG Playback mode, only “Sequential playback of the Program” is allowed

3) No parental block is allowed

4) No language block is allowed

For the detail of the presentation of a PGC, refer to 3.3.6 PGC playback order.

5.2.3.1 Structure of PGCI

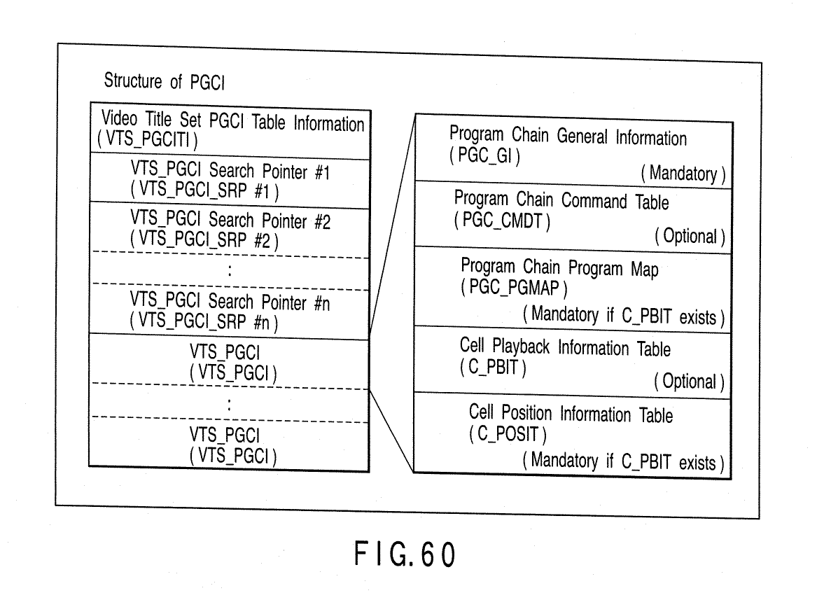

PGCI comprises Program Chain General Information (PGC_GI), Program Chain Command Table (PGC_CMDT), Program Chain Program Map (PGC_PGMAP), Cell Playback Information Table (C_PBIT) and Cell Position Information Table (C_POSIT) as shown in FIG. 60. These information shall be recorded consecutively across the LB boundary. PGC_CMDT is not necessary for PGC where Navigation Commands are not used. PGC_PGMAP, C_PBIT and C_POSIT are not necessary for PGCs where EVOB to be presented is nonexistent.

5.2.3.2 PGC General Information (PGC_GI)

PGC_GI is the information on PGC. The contents of PGC_GI are shown in Table 29.

TABLE 29
PGC_GI

(Description order)

| RBP | | Contents | Number of bytes | |
|---|---|---|---|---|
| 0 to 3 | (1) PGC_CNT | PGC Contents | 4 | bytes |
| 4 to 7 | (2) PGC_PB_TM | PGC Playback Time | 4 | bytes |
| 8 to 11 | (3) PGC_UOP_CTL | PGC User Operation | 4 | bytes |
| | | Control | | |
| 12 to 27 | (4) PGC_AST_CTLT | PGC Audio stream Control | 16 | bytes |
| | | Table | | |
| 28 to 155 | (5) PGC_SPST_CTLT | PGC Sub-picture stream | 128 | bytes |
| | | Control Table | | |
| 156 to 167 | (6) PGC_NV_CTL | PGC Navigation Control | 12 | bytes |
| 168 to 169 | (7) PGC_CMDT_SA | Start address of | 2 | bytes |
| | | PGC_CMDT | | |
| 170 to 171 | (8) PGC_PGMAP_SA | Start address of | 2 | bytes |
| | | PGC_PGMAP | | |
| 172 to 173 | (9) C_PBIT_SA | Start address of C_PBIT | 2 | bytes |
| 174 to 175 | (10) C_POSIT_SA | Start address of C_POSIT | 2 | bytes |
| 176 to 1199 | (11) PGC_SDSP_PLT | PGC Sub-picture Palette for | 4 | bytes × 256 |
| | | SD | | |
| 1200 to 2223 | (12) PGC_HDSP_PLT | PGC Sub-picture Palette for | 4 | bytes × 256 |
| | | HD | | |
| | | Total | 2224 | bytes |

PGC_SPST_CTLT (Table 30)

The Availability flag of Sub-picture stream and the conversion information from Sub-picture stream number to Decoding Sub-picture stream number is described in the following format. PGC_SPST_CTLT consists of 32 PGC_SPST_CTLs. One PGC_SPST_CTL is described for each Sub-picture stream. When the number of Sub-picture streams are less than ‘32’, enter ‘0b’ in every bit of PGC_SPST_CTL for unused streams.

TABLE 30
PGC_SPST_CTLT

(Description order)

| | | Number |
|---|---|---|
| RBP | Contents | of bytes |
| 28 to 31 | PGC_SPST_CTL of Sub-picture stream #0 | 4 bytes |
| 32 to 35 | PGC_SPST_CTL of Sub-picture stream #1 | 4 bytes |
| 36 to 39 | PGC_SPST_CTL of Sub-picture stream #2 | 4 bytes |
| 40 to 43 | PGC_SPST_CTL of Sub-picture stream #3 | 4 bytes |
| 44 to 47 | PGC_SPST_CTL of Sub-picture stream #4 | 4 bytes |
| 48 to 51 | PGC_SPST_CTL of Sub-picture stream #5 | 4 bytes |
| 52 to 55 | PGC_SPST_CTL of Sub-picture stream #6 | 4 bytes |
| 56 to 59 | PGC_SPST_CTL of Sub-picture stream #7 | 4 bytes |
| 60 to 63 | PGC_SPST_CTL of Sub-picture stream #8 | 4 bytes |
| 64 to 67 | PGC_SPST_CTL of Sub-picture stream #9 | 4 bytes |
| 68 to 71 | PGC_SPST_CTL of Sub-picture stream #10 | 4 bytes |
| 72 to 75 | PGC_SPST_CTL of Sub-picture stream #11 | 4 bytes |
| 76 to 79 | PGC_SPST_CTL of Sub-picture stream #12 | 4 bytes |
| 80 to 83 | PGC_SPST_CTL of Sub-picture stream #13 | 4 bytes |
| 84 to 87 | PGC_SPST_CTL of Sub-picture stream #14 | 4 bytes |
| 88 to 91 | PGC_SPST_CTL of Sub-picture stream #15 | 4 bytes |
| 92 to 95 | PGC_SPST_CTL of Sub-picture stream #16 | 4 bytes |
| 96 to 99 | PGC_SPST_CTL of Sub-picture stream #17 | 4 bytes |
| 100 to 103 | PGC_SPST_CTL of Sub-picture stream #18 | 4 bytes |
| 104 to 107 | PGC_SPST_CTL of Sub-picture stream #19 | 4 bytes |
| 108 to 111 | PGC_SPST_CTL of Sub-picture stream #20 | 4 bytes |
| 112 to 115 | PGC_SPST_CTL of Sub-picture stream #21 | 4 bytes |
| 116 to 119 | PGC_SPST_CTL of Sub-picture stream #22 | 4 bytes |
| 120 to 123 | PGC_SPST_CTL of Sub-picture stream #23 | 4 bytes |
| 124 to 127 | PGC_SPST_CTL of Sub-picture stream #24 | 4 bytes |
| 128 to 131 | PGC_SPST_CTL of Sub-picture stream #25 | 4 bytes |
| 132 to 135 | PGC_SPST_CTL of Sub-picture stream #26 | 4 bytes |
| 136 to 139 | PGC_SPST_CTL of Sub-picture stream #27 | 4 bytes |
| 140 to 143 | PGC_SPST_CTL of Sub-picture stream #28 | 4 bytes |
| 144 to 147 | PGC_SPST_CTL of Sub-picture stream #29 | 4 bytes |
| 148 to 151 | PGC_SPST_CTL of Sub-picture stream #30 | 4 bytes |
| 152 to 155 | PGC_SPST_CTL of Sub-picture stream #31 | 4 bytes |

The content of one PGC_SPST_CTL is as follows.

TABLE 31
PGC_SPST_CTL

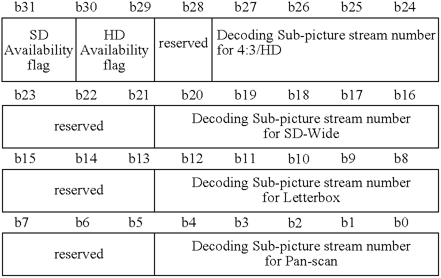

SD Availability flag

. . . 1b: The SD Sub-picture stream is available in this PGC.
0b: The SD Sub-picture stream is not available in this PGC.

Note: For each Sub-picture stream, this value shall be equal in all TT_PGCs in the same TT_DOM, all VMGM_PGCs in the same VMGM_DOM or all VTSM_PGCs in the same VTSM_DOM.

HD Availability flag

. . . 1b: The HD Sub-picture stream is available in this PGC.
0b: The HD Sub-picture stream is not available in this PGC.
When “Aspect ratio” in the current Video attribute (FP_PGCM_V_ATR, VMGM_V_ATR, VTSM_V_ATR or VTS_V_ATR) is ‘00b’, this value shall be set to ‘0b’.

Note 1: When “Aspect ratio” is ‘00b’ and “Source picture resolution” is ‘1011b’ (1440×1080), this value may be set to ‘1b’. It shall be assumed that “Aspect ratio” is ‘11b’ in the following descriptions.

Note 2: For each Sub-picture stream, this value shall be equal in all TT_PGCs in the same TT_DOM, all VMGM_PGCs in the same VMGM_DOM or all VTSM_PGCs in the same VTSM_DOM.

5.2.3.3 Program Chain Command Table (PGC_CMDT)

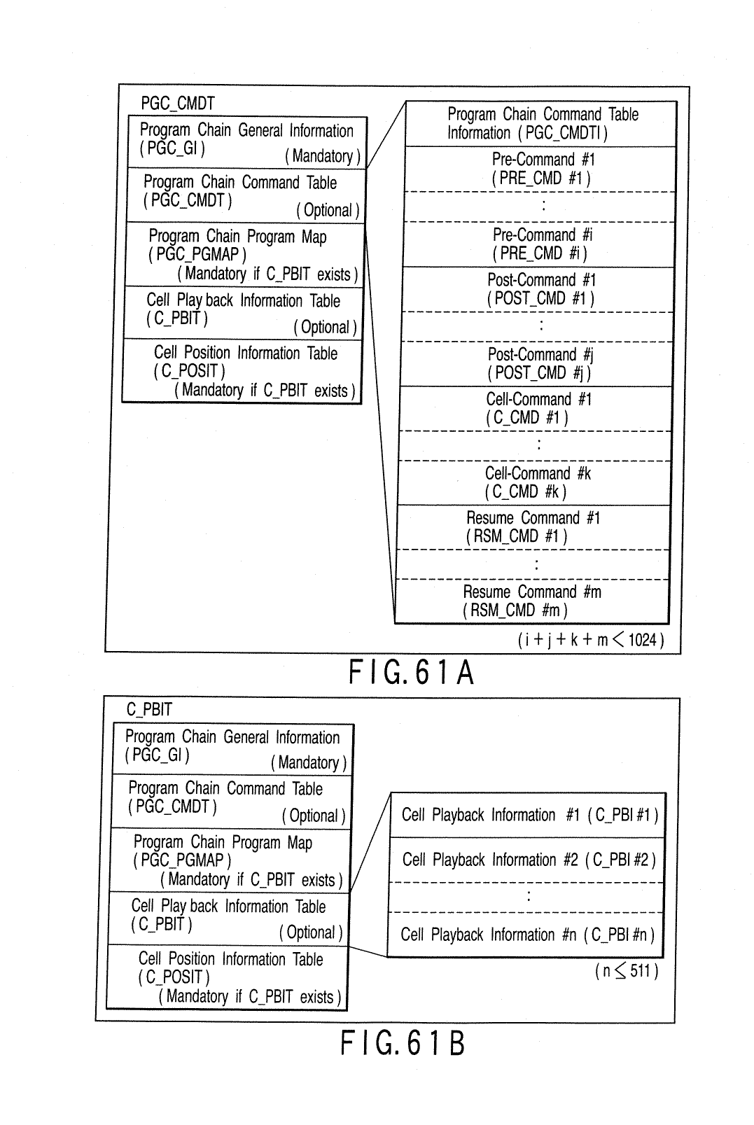

PGC_CMDT is the description area for the Pre-Command (PRE_CMD) and Post-Command (POST_CMD) of PGC, Cell Command (C_CMD) and Resume Command (RSM_CMD). As shown in FIG. 61A, PGC_CMDT comprises Program Chain Command Table Information (PGC_CMDTI), zero or more PRE_CMD, zero or more POST_CMD, zero or more C_CMD, and zero or more RSM_CMD. Command numbers are assigned from one according to the description order for each command group. A total of up to 1023 commands with any combination of PRE_CMD, POST_CMD, C_CMD and RSM_CMD may be described. It is not required to describe PRE_CMD, POST_CMD, C_CMD and RSM_CMD when unnecessary. The contents of PGC_CMDTI and RSM_CMD are shown in Table 32, and Table 33 respectively.

TABLE 32
PGC_CMDTI

(Description order)

| | Contents | Number of bytes |
|---|---|---|
| (1) PRE_CMD_Ns | Number of PRE_CMDs | 2 bytes |
| (2) POST_CMD_Ns | Number of POST_CMDs | 2 bytes |
| (3) C_CMD_Ns | Number of C_CMDs | 2 bytes |
| (4) RSM_CMD_Ns | Number of RSM_CMDs | 2 bytes |
| (5) PGC_CMDT_EA | End address of PGC_CMDT | 2 bytes |

(1) PRE_CMD_Ns Describes the number of PRE_CMDs using numbers between ‘0’ and ‘1023’.

(2) POST_CMD_Ns Describes the number of POST_CMDs using numbers between ‘0’ and ‘1023’.

(3) C_CMD_Ns Describes the number of C_CMDs using numbers between ‘0’ and ‘1023’.

(4) RSM_CMD_Ns Describes the number of RSM_CMDs using numbers between ‘0’ and ‘1023’.

Note: TT_PGC of which is “RSM permission” flag has ‘0b’ may have this command area.

TT_PGC of which is “RSM permission” flag has ‘1b’, FP_PGC, VMGM_PGC or VTSM_PGC shall not have this command area. Then this field shall be set ‘0’.

(5) PGC_CMDT_EA Describes the end address of PGC_CMDT with RBN from the first byte of this PGC_CMDT.

TABLE 33
RSM_CMD

| | Contents | Number of bytes |
|---|---|---|
| (1) RSM_CMD | Resume Command | 8 bytes |

RSM_CMD Describes the commands to be transacted before a PGC is resumed.

The last Instruction in RSM_CMDs shall be Break Instruction.

For details of commands, refer to 5.2.4 Navigation Command and Navigation Parameters.

5.2.3.5 Cell Playback Information Table (C_PBIT)

C_PBIT is a table which defines the presentation order of Cells in a PGC. Cell Playback Information (C_PBI) is to be continuously described on C_PBIT as shown in FIG. 61B. Cell numbers (CNs) are assigned from ‘1’ in the order with which C_PBI is described. Basically, Cells are presented continuously in the ascending order from CN1. A group of Cells which constitute a block is called a Cell Block. A Cell Block shall consist of more than one Cell. C_PBIs in a block shall be described continuously. One of the Cells in a Cell Block is chosen for presentation. One of the Cell Blocks is an Angle Cell Block. The presentation time of those Cells in the Angle Block shall be the same. When several Angle Blocks are set within the same TT_DOM, within the same VTSM_DOM and VMGM_DOM, the number of Angle Cells (AGL_Cs) in each block shall be the same. The presentation between the Cells before or after the Angle Block and each AGL_C shall be seamless. When the Angle Cell Blocks in which the Seamless Angle Change flag is designated as seamless exist continuously, a combination of all the AGL_Cs between Cell Blocks shall be presented seamlessly. In that case, all the connection points of the AGL_C in both of the blocks shall be the border of the Interleaved Unit. When the Angle Cell Blocks in which the Seamless Angle Change flag is designated as non-seamless exist continuously, only the presentation between AGL_Cs with the same Angle number in each block shall be seamless. An Angle Cell Block has 9 Cells at the most, where the first Cell has the number 1 (Angle Cell number 1). Rest is numbered according to the described order. The contents of one C_PBI is shown in FIG. 61B and Table 34.

TABLE 34
C_PBI

(Description order)

| | | Number of |
|---|---|---|
| | Contents | bytes |
| (1) C_CAT | Cell Category | 4 bytes |
| (2) C_PBTM | Cell Playback Time | 4 bytes |
| (3) C_FEVOBU_SA | Start address of the First | 4 bytes |
| | EVOBU in the Cell | |
| (4) C_FILVU_EA | End address of the First | 4 bytes |
| | ILVU in the Cell | |
| (5) C_LEVOBU_SA | Start address of the Last | 4 bytes |
| | EVOBU in the Cell | |
| (6) C_LEVOBU_EA | End address of the Last | 4 bytes |
| | EVOBU in the Cell | |
| (7) C_CMD_SEQ | Sequence of Cell Commands | 2 bytes |
| Reserved | reserved | 2 bytes |
| | Total | 28 bytes |

C_CMD_SEQ (Table 35)

Describe information of the sequence of Cell Commands.

TABLE 35
(7) C_CMD_SEQ

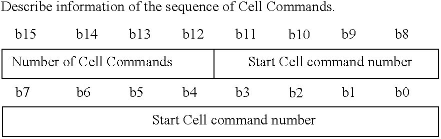

Number of Cell Commands

. . . Describe number of Cell Commands to be executed sequentially from Start Cell Command number in this Cell between ‘0’ and ‘8’.

The value ‘0’ mean there is no Cell Command to be executed in this Cell.

Start Cell Command number

. . . Describe the start number of Cell Command to be executed in this Cell between ‘0’ and ‘1023’.

The value ‘0’ mean there is no Cell Command to be executed in this Cell.

Note: If “Seamless playback flag” in C_CAT is ‘1b’ and one or more Cell Commands exist in the previous Cell, the presentation of previous Cell and this Cell shall be seamless. Then, the Command in the previous Cell shall be executed within 0.5 seconds from the start of the presentation of this Cell. If the Commands include the instruction to branch the presentation, the presentation of this Cell shall be terminated and then the new presentation shall be started in accordance with the instruction.

5.2.4 Navigation Commands and Navigation Parameters

Navigation Commands and Navigation Parameters form the basis for providers to make various Titles.

The providers may use Navigation Commands and Navigation Parameters to obtain or to change the status of the Player such as the Parental Management Information and the Audio stream number.

By combining usage of Navigation Commands and Navigation Parameters, the provider may define simple and complex branching structures in a Title.

In other words, the provider may create an interactive Title with complicated branching structure and Menu structure in addition to linear movie Titles or Karaoke Titles.

5.2.4.1 Navigation Parameters

Navigation Parameter is the general term for the information which is held by the Player. They are classified into General Parameters and System Parameters as described below.

5.2.4.1.1 General Parameters (GPRMs)

<Overview>

The provider may use these GPRMs to memorize the user's operational history and to modify Player's behavior. These parameters may be accessed by Navigation Commands.

<Contents>

GPRMs store a fixed length, two-byte numerical value.

Each parameter is treated as a 16-bit unsigned integer.

The Player has 64 GPRMs.

<For Use>

GPRMs are used in a Register mode or a Counter mode.

GPRMs used in Register mode maintain a stored value.

GPRMs used in Counter mode automatically increase the stored value every second in TT_DOM.

GPRM in Counter mode shall not be used as the first argument for arithmetic operations and bitwise operations except Mov Instruction.

<Initialize Value>

All GPRMs shall be set to zero and in Register mode in the following conditions:
At Initial Access.
When Title_Play( ), PTT_Play( ) or Time_Play( ) is executed in all Domains and Stop State.
When Menu_Call( ) is executed in Stop State.

<Domain>

The value stored in GPRMs (Table 36) is maintained, even if the presentation point is changed between Domains. Therefore, the same GPRMs are shared between all Domains.

TABLE 36
General Parameters (GPRMs)

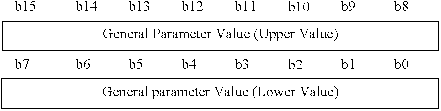

5.2.4.1.2 System Parameters (SPRMs)

<Overview>

The provider may control the Player by setting the value of SPRMs using the Navigation Commands.

These parameters may be accessed by the Navigation Commands.

<Content>

SPRMs store a fixed length, two-byte numerical value.

Each parameter is treated as a 16-bit unsigned integer.

The Player has 32 SPRMs.

<For Use>

The value of SPRMs shall not be used as the first argument for all Set Instructions nor as a second argument for arithmetic operations except Mov Instruction.

To change the value in SPRM, the SetSystem Instruction is used.

As for Initialization of SPRMs (Table 37), refer to 3.3.3.1 Initialization of Parameters.

TABLE 37
System Parameters (SPRMs)

| | SPRM | Meaning |
|---|---|---|
| (a) | 0 | Current Menu Description Language Code (CM_LCD) |
| (b) | 1 | Audio stream number (ASTN) for TT_DOM |
| (c) | 2 | Sub-picture stream number (SPSTN |
| | | ) and On/Off flag for TT_DOM |
| (d) | 3 | Angle number (AGLN) for TT_DOM |
| (e) | 4 | Title number (TTN) for TT_DOM |
| (f) | 5 | VTS Title number (VTS_TTN) for TT_DOM |
| (g) | 6 | Title PGC number (TT_PGCN) for TT_DOM |
| (h) | 7 | Part_of_Title number (PTTN) for |
| | | One_Sequential_PGC_Title |
| (i) | 8 | Highlighted Button number (HL_BTNN) for |
| | | Selection state |
| (j) | 9 | Navigation Timer (NV_TMR) |
| (k) | 10 | TT_PGCN for NV_TMR |
| (l) | 11 | Player Audio Mixing Mode (P_AMXMD) for Karaoke |
| (m) | 12 | Country Code (CTY_CD) for Parental Management |
| (n) | 13 | Parental Level (PTL_LVL) |
| (o) | 14 | Player Configuration (P_CFG) for Video |
| (p) | 15 | P_CFG for Audio |
| (q) | 16 | Initial Language Code (INI_LCD) for AST |
| (r) | 17 | Initial Language Code extension (INI_LCD_EXT) |
| | | for AST |
| (s) | 18 | INI_LCD for SPST |
| (t) | 19 | INI_LCD_EXT for SPST |
| (u) | 20 | Player Region Code |
| (v) | 21 | Initial Menu Description Language Code (INI_M_LCD) |
| (w) | 22 | reserved |
| (x) | 23 | reserved |
| (y) | 24 | reserved |
| (z) | 25 | reserved |
| (A) | 26 | Audio stream number (ASTN) for Menu-space |
| (B) | 27 | Sub-picture stream number (SPSTN) and |
| | | On/Off flag for Menu-space |
| (C) | 28 | Angle number (AGLN) for Menu-space |
| (D) | 29 | Audio stream number (ASTN) for FP_DOM |
| (E) | 30 | Sub-picture stream number (SPSTN) and |
| | | On/Off flag for FP_DOM |
| (F) | 31 | reserved |

SPRM(11), SPRM(12), SPRM(13), SPRM(14), SPRM(15) SPRM(16), SPRM(17), SPRM(18), SPRM(19), SPRM(20) and SPRM(21) are called the Player parameter.

<Initialize Value>

See 3.3.3.1 Initialization of Parameters.

<Domain>

There is only one set of System Parameters for all Domains.

(a) SPRM(0): Current Menu Description Language Code (CM_LCD)

<Purpose>

This parameter specifies the code of the language to be used as current Menu Language during the presentation.

<Contents>

The value of SPRM(0) may be changed by the Navigation Command (SetM_LCD).

Note: This parameter shall not be changed by User Operation directly.

Whenever the value of SPRM(21) is changed, the value shall be copied to SPRM(0).

TABLE 38

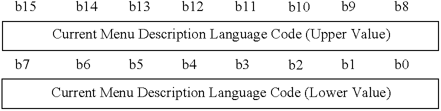

### SPRM(0)

(A) SPRM(26): Audio stream number (ASTN) for Menu-space

<Purpose>

This parameter specifies the current selected ASTN for Menu-space.

<Contents>

The value of SPRM(26) may be changed by a User Operation, a Navigation Command or [Algorithm 3] shown in 3.3.9.1.1.2 Algorithm for the selection of Audio and Sub-picture stream in Menu-space.

a) In the Menu-Space

When the value of SPRM(26) is changed, the Audio stream to be presented shall be changed.

b) In the FP_DOM or TT_DOM

The value of SPRM(26) which is set in Menu-space is maintained.

The value of SPRM(26) shall not be changed by a User Operation.

If the value of SPRM(26) is changed in either FP_DOM or TT_DOM by a Navigation Command, it becomes valid in the Menu-space.

<Default Value>

The default value is (Fh).

Note: This parameter does not specify the current Decoding Audio stream number.

For details, refer to 3.3.9.1.1.2 Algorithm for the selection of Audio and Sub-picture stream in Menu-space.

TABLE 39
SPRM(26): Audio stream number (ASTN) for Menu-space

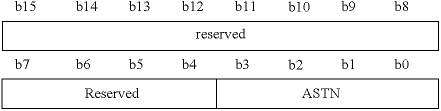

ASTN . . . 0 to 7: ASTN value
Fh: There is no available AST, nor AST is selected.
Others: reserved

(B) SPRM(27): Sub-picture stream number (SPSTN) and On/Off flag for Menu-space

<Purpose>

This parameter specifies the current selected SPSTN for Menu-space and whether the Sub-picture is displayed or not.

<Contents>

The value of SPRM(27) may be changed by a User Operation, a Navigation Command or [Algorithm 3] shown in 3.3.9.1.1.2 Algorithm for the selection of Audio and Sub-picture stream in Menu-space.

a) In the Menu-Space

When the value of SPRM(27) is changed, the Sub-picture stream to be presented and the Sub-picture display status shall be changed.

b) In the FP_DOM or TT_DOM

The value of SPRM(27) which is set in the Menu-space is maintained.

The value of SPRM(27) shall not be changed by a User Operation.

If the value of SPRM(27) is changed in either FP_DOM or TT_DOM by a Navigation Command, it becomes valid in the Menu-space.

c) The Sub-picture display status is defined as follows:

c-1) When a valid SPSTN is selected:

When the value of the SP_disp_flag is ‘1b’, the specified Sub-picture is displayed all throughout its display period.

When the value of the SP_disp_flag is ‘0b’, refer to

3.3.9.2.2 Sub-picture forcedly display in System-space.

c-2) When a invalid SPSTN is selected:

Sub-picture does not display.

<Default Value>

The default value is 62.

Note: This parameter does not specify the current Decoding Sub-picture stream number. When this parameter is changed in Menu-space, presentation of current Sub-picture is discarded. For details, refer to 3.3.9.1.1.2 Algorithm for the selection of Audio and Sub-picture stream in Menu-space.

TABLE 40
(B) SPRM(27) : Sub-picture stream number (SPSTN) and
On/Off flag for Menu-space

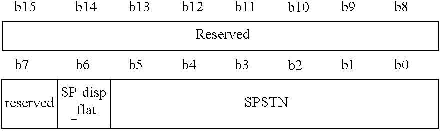

SP_disp_flag 0b: Sub-picture display is disabled.
1b: Sub-picture display is enabled.

SPSTN . . . 0 to 31: SPSTN value
62: There is no available SPST, nor SPST is selected.
Others: reserved

(C) SPRM(28): Angle number (AGLN) for Menu-space

<Purpose>

This parameter specifies the current AGLN for Menu-space.

<Contents>

The value of SPRM(28) may be changed by a User Operation or a Navigation Command.

a) In the FP_DOM

If the value of SPRM(28) is changed in the FP_DOM by a Navigation Command, it becomes valid in the Menu-space.

b) In the Menu-space

When the value of SPRM(28) is changed, the Angle to be presented is changed.

c) In the TT_DOM

The value of SPRM(28) which is set in the Menu-space is maintained.

The value of SPRM(28) shall not be changed by a User Operation.

If the value of SPRM(28) is changed in the TT_DOM by a Navigation Command, it becomes valid in the Menu-space.

<Default Value>

The default value is ‘1’.

TABLE 41
(C) SPRM(28): Angle number (AGLN) for Menu-space

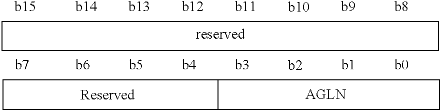

AGLN . . . 1 to 9: AGLN value
Others: reserved

(D) SPRM(29): Audio stream number (ASTN) for FP_DOM

<Purpose>

This parameter specifies the current selected ASTN for FP_DOM.

<Contents>

The value of SPRM(29) may be changed by a User Operation, a Navigation Command or [Algorithm 4] shown in 3.3.9.1.1.3 Algorithm for the selection of Audio and Sub-picture stream in FP_DOM.

a) In the FP_DOM

When the value of SPRM(29) is changed, the Audio stream to be presented shall be changed.

b) In the Menu-space or TT_DOM

The value of SPRM(29) which is set in FP_DOM is maintained.

The value of SPRM(29) shall not be changed by a User Operation.

If the value of SPRM(29) is changed in either Menu-space or TT_DOM by a Navigation Command, it becomes valid in the FP_DOM.

<Default Value>

The default value is (Fh).

Note: This parameter does not specify the current Decoding Audio stream number.

For details, refer to 3.3.9.1.1.3 Algorithm for the selection of Audio and Sub-picture stream in FP_DOM.

TABLE 42
(D) SPRM(29): Audio stream number (ASTN) for FP_DOM

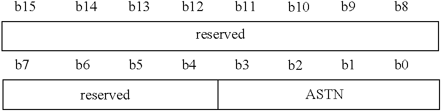

ASTN . . . 0 to 7: ASTN value
Fh: There is no available AST, nor AST is selected.
Others: reserved

(E) SPRM(30): Sub-picture stream number (SPSTN) and On/Off flag for FP_DOM

<Purpose>

This parameter specifies the current selected SPSTN for FP_DOM and whether the Sub-picture is displayed or not.

<Contents>

The value of SPRM(30) may be changed by a User Operation, a Navigation Command or [Algorithm 4] shown in 3.3.9.1.1.3 Algorithm for the selection of Audio and Sub-picture stream in FP_DOM.

a) In the FP_DOM

When the value of SPRM(30) is changed, the Sub-picture stream to be presented and the Sub-picture display status shall be changed.

b) In the Menu-space or TT_DOM

The value of SPRM(30) which is set in the FP_DOM is maintained.

The value of SPRM(30) shall not be changed by a User Operation.

If the value of SPRM(30) is changed in either Menu-space or TT_DOM by a Navigation Command, it becomes valid in the FP_DOM.

c) The Sub-picture display status is defined as follows:

c-1) When a valid SPSTN is selected:

When the value of the SP_disp_flag is ‘1b’, the specified Sub-picture is displayed all throughout its display period.

When the value of the SP_disp_flag is ‘0b’, refer to 3.3.9.2.2 Sub-picture forcedly display in System-space.

c-2) When a invalid SPSTN is selected:

Sub-picture does not display.

<Default Value>

The default value is 62.

Note: This parameter does not specify the current Decoding Sub-picture stream number.

When this parameter is changed in FP_DOM, presentation of current Sub-picture is discarded.

For details, refer to 3.3.9.1.1.3 Algorithm for the selection of Audio and Sub-picture stream in FP_DOM.

TABLE 43
(E) SPRM(30): Sub-picture stream number (SPSTN) and
On/Off flag for FP_DOM

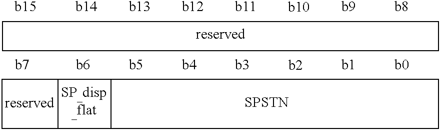

SP_disp_flag 0b: Sub-picture display is disabled.
1b: Sub-picture display is enabled.

SPSTN . . . 0 to 31: SPSTN value
62: There is no available SPST, nor SPST is selected.
Others: reserved

5.3.1 Contents of EVOB

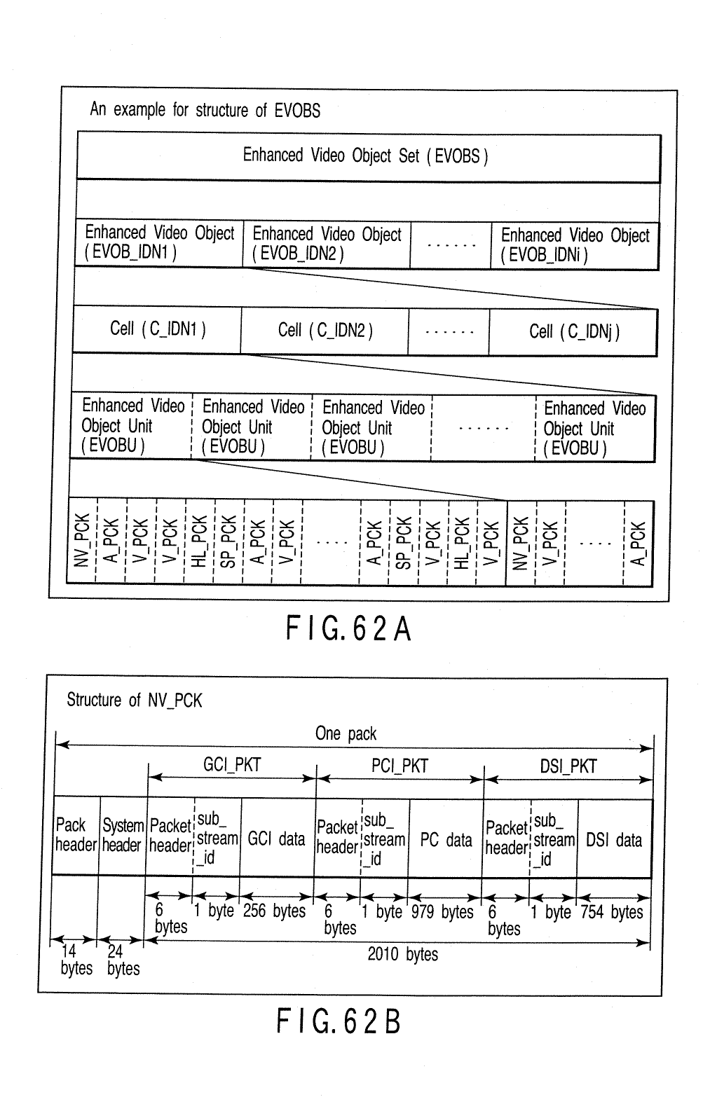

An Enhanced Video Object Set (EVOBS) is a collection of EVOBs as shown in FIG. 62. A. An EVOB may be divided into Cells made up of EVOBUs. An EVOB and each element in a Cell shall be restricted as shown in Table 44.

TABLE 44
Restriction on each element

| | EVOB | Cell |
|---|---|---|
| Video | Completed in EVOB | The first EVOBU |
| stream | The display configuration shall start from | shall have the video |
| | the top field and end at the bottom field | data |
| | when the video stream carries interlaced | |
| | video. | |
| | A Video stream may or may not be | |
| | terminated by a SEQ_END_CODE. | |
| Audio | Completed in EVOB | No restriction |
| streams | When Audio stream is for Linear | |
| | PCM, the first audio frame shall be the | |
| | beginning of the GOF. | |
| | As for GOF, refer to 5.4.2.1. | |
| Sub- | Completed in EVOB | Completed in Cell |
| picture | The last PTM of the last Sub-picture Unit | The Sub-picture |
| streams | (SPU) shall be equal to or less than the | presentation shall be |
| | time prescribed by EVOB_V_E_PTM. | valid only in the |
| | As for the last PTM of SPU, refer to | Cell where the |
| | 5.4.3.3. PTS of the first SPU shall be | SPU is recorded. |
| | equal to or more than | |
| | EVOB_V_S_PTM. | |
| | Inside each Sub-picture stream, the PTS of | |
| | any SPU shall be greater than PTS of the | |
| | preceding SPU which has same | |
| | sub_stream_id (if any). | |

Note 1: The definition of “Completed” is as follows:

1) The beginning of each stream shall start from the first data of each access unit.

2) The end of each stream shall be aligned in each access unit.

Therefore, when the pack length comprising the last data in each stream is less than 2048 bytes.

Note 2: The definition of “Sub-picture presentation is valid in the Cell” is as follows:

1) When two Cells are seamlessly presented,
The presentation of the preceding Cell shall be cleared at the Cell boundary by using STP_DSP command in SP_DCSQ or,
The presentation shall be updated by the SPU which is recorded in the succeeding Cell and whose presentation time is the same as the presentation time of the first top field of the succeeding Cell.

2) When two Cells are not seamlessly presented,
The presentation of the preceding Cell shall be cleared by the Player before the presentation time of the succeeding Cell.

5.3.1.1 Enhanced Video Object Unit (EVOBU)

An Enhanced Video Object Unit (EVOBU) is a sequence of packs in recording order. It starts with exactly one NV_PCK, encompasses all the following packs (if any), and ends either immediately before the next NV_PCK in the same EVOB or at the end of the EVOB. An EVOBU except the last EVOBU of a Cell represents a presentation period of at least 0.4 seconds and at most 1 second. The last EVOBU of a Cell represents a presentation period of at least 0.4 seconds and at most 1.2 seconds. An EVOB consists of an integer number of EVOBUs. See FIG. 62A.

The following additional rules apply:

1) The presentation period of an EVOBU is equal to an integer number of video field/frame periods. This is also the case when the EVOBU does not contain any video data.

2) The presentation start and termination time of an EVOBU are defined in 90 kHz units. The presentation start time of an EVOBU is equal to the presentation termination time of the previous EVOBU (except for the first EVOBU).

3) When the EVOBU contains video:
the presentation start time of the EVOBU is equal to the presentation start time of the first video field/frame,
the presentation period of the EVOBU is equal to or longer than the presentation period of the video data.

4) When the EVOBU contains video, the video data shall represent one or more PAU (Picture Access Unit).

5) When an EVOBU with video data is followed by an EVOBU without video data (in the same EVOB), the last coded picture shall be followed by a SEQ_END_CODE.

6) When the presentation period of the EVOBU is longer than the presentation period of the video it contains, the last coded picture shall be followed by a SEQ_END_CODE.

7) The video data in an EVOBU shall never contain more than one a SEQ_END_CODE.

8) When the EVOB which contains one or more a SEQ_END_CODE, and it is used in an ILVU,
The presentation period of an EVOBU is equal to an integer number of video field/frame periods.
The video data in an EVOBU shall have one I-Coded-Frame (refer to Annex R) for Still

picture or no video data.
The EVOBU which contains I-Coded-Frame for Still picture shall have one SEQ_END_CODE.

The first EVOBU in an ILVU shall have a video data.

Note: The presentation period of the video contained in an EVOBU is defined as the sum of:
the difference between the PTS of the last video access unit and the PTS of the first video access unit in the EVOBU (last and first in terms of display order),
the presentation duration of the last video access unit.

The presentation termination time of an EVOBU is defined as the sum of the presentation start time and the presentation duration of the EVOBU.

Each elementary stream is identified by the stream_id defined in the Program stream. Audio Presentation Data not defined by MPEG is carried in PES packets with a stream_id of private_stream_{—}1. Navigation Data (GCI, PCI and DSI) and Highlight Information (HLI) are carried in PES packets with a stream_id of private_stream_{—}2. The first byte of the data area of private_stream_{—}1 and private_stream_{—}2 packets is used to define a sub_stream_id as shown in Tables 45, 46 and 47. When the stream_id is the private_stream_{—}1 or private_stream_{—}2, the first byte in the data area of each packet is assigned as sub_stream_id. Details of the stream_id, sub_stream_id for private_stream_{—}1, and the sub_stream_id for private_stream_{—}2 are shown in Tables 45, 46 and 47.

TABLE 45
stream_id and stream_id_extension

| stream_id | stream_id_extension | Stream coding |
|---|---|---|
| 110x | NA | MPEG audio stream ***= |
| 0***b | | Decoding Audio stream number |
| 1110 0000b | NA | Video stream (MPEG-2) |
| 1110 0010b | NA | Video stream (MPEG-4 AVC) |
| 1011 1101b | NA | private_stream_1 |
| 1011 1111b | NA | private_stream_2 |
| 1111 1101b | 101 0101b | extended_stream_id (Note) |
| Others | | no use |

NA: Not Applicable

Note: The identification of VC-1 streams is based on the use of stream_id extensions defined by an amendment to MPEG-2 Systems [ISO/IEC 13818-1:2000/AMD2:2004]. When the stream_id is set to 0xFD (1111 1101b), it is the stream_id_extension field that defines the nature of the stream. The stream_id_extension field is added to the PES header using the PES extension flags present in the PES header.

For VC-1 video streams, the stream identifiers that shall be used are:

stream_id . . . 1111 1101b; extended_stream_id

stream_id_extension . . . 101 0101b; for VC-1 (video stream)

TABLE 46
sub_stream_id for private_stream_1

| sub_stream_id | Stream coding | |
|---|---|---|
| 001* ****b | Sub-picture stream | * ****= Decoding Sub- |
| | | picture stream number |
| 0100 1000b | reserved | |
| 011* ****b | reserved (for extended | |
| | Sub-picture) | |
| 1000 0***b | reserved for Dolby | ***= Decoding |
| | AC-3 audio stream | |
| | Audio stream number | |
| 1100 0***b | DD+ audio stream | ***= Decoding |
| | Audio stream number | |
| 1000 1***b | DTS-HD audio stream | ***= Decoding |
| | Audio stream number | |
| 1001 0***b | reserved | |
| 1010 0***b | Linear PCM audio stream | ***= Decoding |
| | Audio stream number | |
| 1011 0***b | MLP audio stream | ***= Decoding |
| | Audio stream number | |
| 1111 1111b | Provider defined stream | |
| Others | reserved (for future | |
| | Presentation Data) | |

Note 1: “reserved” of sub_stream_id means that the sub_stream_id is reserved for future system extension. Therefore, it is prohibited to use reserved values of sub_stream_id.

Note 2: The sub_stream_id whose value is ‘1111 1111b’ may be used for identifying a bitstream which is freely defined by the provider. However, it is not guaranteed that every player will have a feature to play that stream.

The restriction of EVOB, such as the maximum transfer rate of total streams, shall be applied, if the provider defined bitstream exists in EVOB.

TABLE 47
sub_stream_id for private_stream_2

| sub_stream_id | Stream coding |
|---|---|
| 0000 0000b | PCI stream |
| 0000 0001b | DSI stream |
| 0000 0100b | GCI stream |
| 0000 1000b | HLI stream |
| 0101 0000b | reserved |
| 1000 0000b | reserved for Advanced stream |
| 1111 1111b | Provider defined stream |
| Others | reserved (for future Navigation Data) |

Note 1: “reserved” of sub_stream_id means that the sub_stream_id is reserved for future system extension. Therefore, it is prohibited to use reserved values of sub_stream_id.

Note 2: The sub_stream_id whose value is ‘1111 1111b’ may be used for identifying a bitstream which is freely defined by the provider. However, it is not guaranteed that every player will have a feature to play that stream.

The restriction of EVOB, such as the maximum transfer rate of total streams, shall be applied, if the provider defined bitstream exists in EVOB.

5.4.2 Navigation Pack (NV_PCK)

The Navigation pack comprises a pack header, a system header, a GCI packet (GCI_PKT), a PCI packet (PCI_PKT) and a DSI packet (DSI_PKT) as shown in FIG. 62B. The NV_PCK shall be aligned to the first pack of the EVOBU.

The contents of the system header, the packet header of the GCI_PKT, the PCI_PKT and the DSI_PKT are shown in Tables 48 and 50. The stream_id of the GCI_PKT, the PCI_PKT and the DSI_PKT are as follows:

GCI_PKT . . . stream_id; 1011 1111b (private_stream_{—}2)
sub_stream_id; 0000 0100b

PCI_PKT . . . stream_id; 1011 1111b (private_stream_{—}2)
sub_stream_id; 0000 0000b

DSI_PKT . . . stream_id; 1011 1111b (private_stream_{—}2)
sub_stream_id; 0000 0001b

TABLE 48
System header

| | Number | Number | | |
|---|---|---|---|---|
| Field | of bits | of bytes | Value | Comment |
| system_header_start_code | 32 | 4 | 000001BBh | |
| header_length | 16 | 2 | | |
| marker_bit | 1 | 3 | 824EA1h | 1 |
| rate_bound | 22 | | | mux_rate = |
| | | | | 30.24 Mbps |
| marker_bit | 1 | | | 1 |
| audio_bound | 6 | 2 | 0 to 8 | Number of |
| | | | | Audio streams |
| fixed_flag | 1 | | 0 | variable bit rate |
| CSPS_flag | 1 | | 0 | (Note 1) |
| system_audio_lock_flag | 1 | | 1 | |
| system_video_lock_flag | 1 | | 1 | |
| marker_bit | 1 | | 1 | 1 |
| video_bound | 5 | | 1 | Number of |
| | | | | Video streams = 1 |
| packet_rate_restriction_flag | 1 | 1 | 0 or 1 | |
| reserved_bits | 7 | | 7Fh | |
| stream_id | 8 | 1 | 1011 1001b | all Video streams |
| ‘11’ | 2 | 2 | 11b | |
| P-STD_buf_bound_scale | 1 | | 1 | buf_size × 1024 |
| | | | | bytes |
| P-STD_buf_size_bound | 13 | | (Note 3) | (Note 3) |
| stream_id | 8 | 1 | 1011 1000b | allAudio streams |
| ‘11’ | 2 | 2 | 11b | |
| P-STD_buf_bound_scale | 1 | | 0 | buf_size × 128 bytes |
| P-STD_buf_size_bound | 13 | | 64 | buf_size = 8192 |
| | | | | bytes |
| stream_id | 8 | 1 | 1011 1101b | private_stream_1 |
| ‘11’ | 2 | 2 | 11b | |
| P-STD_buf_bound_scale | 1 | | 1 | buf_size × 1024 |
| | | | | bytes |
| P-STD_buf_size_bound | 13 | | (T.B.D.) | buf_size = (T.B.D.) |
| | | | | bytes |
| | | | | (Note 2) |
| stream_id | 8 | 1 | 1011 1111b | private_stream_2 |
| ‘11’ | 2 | 2 | 11b | |
| P-STD_buf_bound_scale | 1 | | 1 | buf_size × 1024 |
| | | | | bytes |
| P-STD_buf_size_bound | 13 | | 2 | buf_size = 2048 |
| | | | | bytes |

Note 1: Only the packet rate of the NV_PCK and the MPEG-2 audio pack may exceed the packet rate defined in the “Constrained system parameter Program stream” of the ISO/IEC 13818-1.

Note 2: The sum of the target buffers for the Presentation Data defined as private_stream_{—}1 shall be described.

Note 3: “P-STD_buf_size_bound” for MPEG-2, MPEG-4 AVC and SMPTE VC-1 Video elementary streams is defined as below.

TABLE 49

| Video stream | Quality | Value | Comment |
|---|---|---|---|
| MPEG-2 | HD | 1202 | buf_size = 1230848 bytes |
| | SD | 232 | buf_size = 237568 bytes |
| MPEG-4 AVC | HD | 1808 | buf_size = 1851392 bytes |
| | SD | 924 | buf_size = 946176 bytes |
| SMPTE VC-1 | HD | 1808 | (buf_size = 1851392 bytes) |
| | | 4848 | buf_size = 4964352 (Note 1) |
| | SD | 924 | (buf_size = 946176 bytes) |
| | | 1532 | buf_size = 1568768 bytes (Note 2) |

Note 1: For HD content, the value of video elementary stream may be increased compared to the nominal buffer size representing 0.5 second of video data delivered at 29.4 Mbits/sec. The additional memory represents the size of one additional 1920×1080 video frame (In MPEG-4 AVC, this memory space is used as an additional video frame reference). Use of the increased buffer size does not waive the constraints that upon seeking to an entry point header, decoding of the elementary stream should not start later than 0.5 seconds after the first byte of the video elementary stream has entered the buffer.

Note 2: For SD content, the value of video elementary stream may be increased compared to the nominal buffer size representing 0.5 second of video data delivered at 15 Mbits/sec. The additional memory represents the size of one additional 720×576 video frame (In MPEG-4 AVC, this memory space is used as an additional video frame reference). Use of the increased buffer size does not waive the constraints that upon seeking to an entry point header, decoding of the elementary stream should not start later than 0.5 seconds after the first byte of the video elementary stream has entered the buffer.

TABLE 50
GCI packet

| | Number | Number | | |
|---|---|---|---|---|
| Field | of bits | of bytes | Value | Comment |
| packet_start_code_prefix | 24 | 3 | 00 0001h | |
| stream_id | 8 | 1 | 1011 1111b | private_stream_2 |
| PES_packet_length | 16 | 2 | 0101h | |

Private data area

| | | | |
|---|---|---|---|
| sub_stream_id | 8 | 1 | 0000 0100b |

GCI data area

5.2.5 General Control Information (GCI)

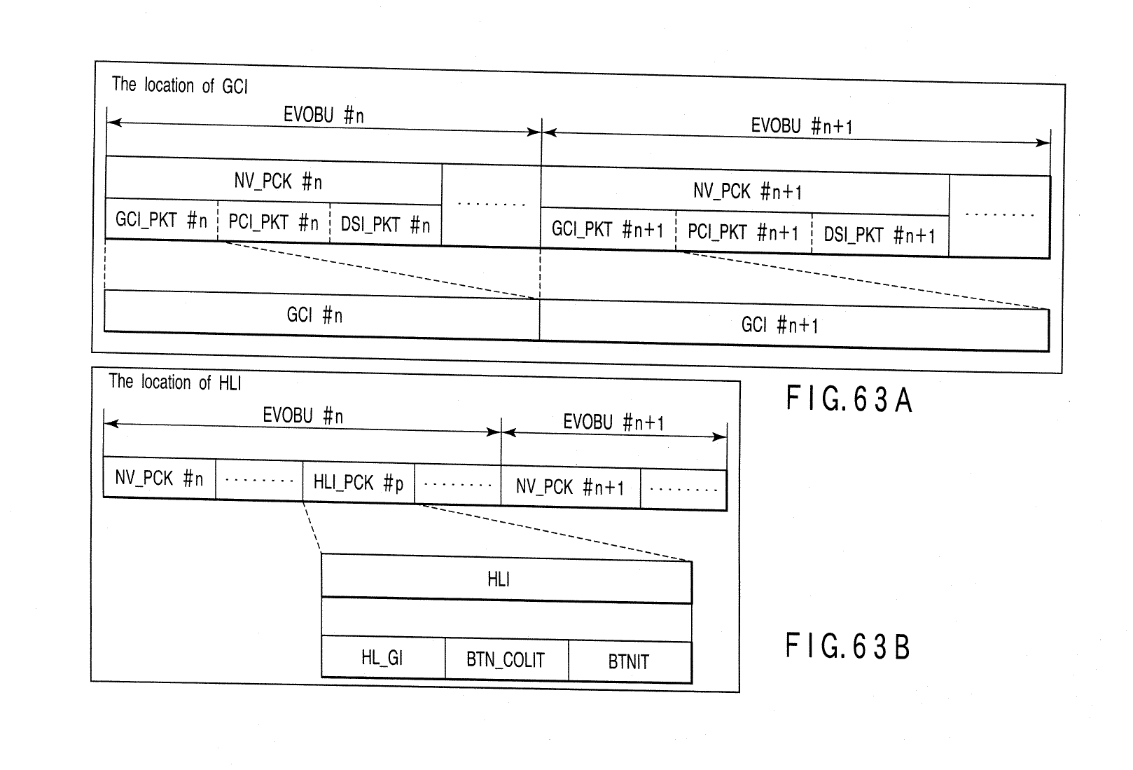

GCI is the General Information Data with respect to the data stored in an EVOB Unit (EVOBU) such as the copyright information. GCI is composed of two pieces of information as shown in Table 51. GCI is described in the GCI packet (GCI_PKT) in the Navigation pack (NV_PCK) as shown in FIG. 63A. Its content is renewed for each EVOBU. For details of EVOBU and NV_PCK, refer to 5.3 Primary Enhanced Video Object.

TABLE 51
GCI

(Description order)

| | Contents | Number of bytes |
|---|---|---|
| GCI_GI | GCI General Information | 16 bytes |
| RECI | Recording Information | 189 bytes |
| reserved | Reserved | 51 bytes |
| | Total | 256 bytes |

5.2.5.1 GCI General Information (GCI_GI)

GCI_GI is the information on GCI as shown in Table 52.

TABLE 52
GCI_GI

(Description order)

| | Contents | Number of bytes | |
|---|---|---|---|
| (1) GCI_CAT | Category of GCI | 1 | byte |
| Reserved | Reserved | 3 | bytes |
| (2) DCI_CCI_SS | Status of DCI and CCI | 2 | byte |
| (3) DCI | Display Control Information | 4 | bytes |
| (4) CCI | Copy Control Information | 4 | bytes |
| Reserved | Reserved | 2 | bytes |
| | Total | 16 | bytes |

5.2.5.2 Recording Information (RECI)

RECI is the information for video data, every audio data and the SP data which are recorded in this EVOBU as shown in Table 53. Each information is described as ISRC (International Standard Recording Code) which complies with ISO3901.

TABLE 53
RECI

(Description order)

| | | Number |
|---|---|---|
| | | of |
| | Contents | bytes |
| ISRC_V | ISRC of video data in Video stream | 10 bytes |
| ISRC_A0 | ISRC of audio data in Decoding Audio stream #0 | 10 bytes |
| ISRC_A1 | ISRC of audio data in Decoding Audio stream #1 | 10 bytes |
| ISRC_A2 | ISRC of audio data in Decoding Audio stream #2 | 10 bytes |
| ISRC_A3 | ISRC of audio data in Decoding Audio stream #3 | 10 bytes |
| ISRC_A4 | ISRC of audio data in Decoding Audio stream #4 | 10 bytes |
| ISRC_A5 | ISRC of audio data in Decoding Audio stream #5 | 10 bytes |
| ISRC_A6 | ISRC of audio data in Decoding Audio stream #6 | 10 bytes |
| ISRC_A7 | ISRC of audio data in Decoding Audio stream #7 | 10 bytes |
| ISRC_SP0 | ISRC of SP data in Decoding SP stream #0, #8, #16 or #24 | 10 bytes |
| ISRC_SP1 | ISRC of SP data in Decoding SP stream #1, #9, #17 or #25 | 10 bytes |
| ISRC_SP2 | ISRC of SP data in Decoding SP stream #2, #10, #18 or #26 | 10 bytes |
| ISRC_SP3 | ISRC of SP data in Decoding SP stream #3, #11, #19 or #27 | 10 bytes |
| ISRC_SP4 | ISRC of SP data in Decoding SP stream #4, #12, #20 or #28 | 10 bytes |
| ISRC_SP5 | ISRC of SP data in Decoding SP stream #5, #13, #21 or #29 | 10 bytes |
| ISRC_SP6 | ISRC of SP data in Decoding SP stream #6, #14, #22 or #30 | 10 bytes |
| ISRC_SP7 | ISRC of SP data in Decoding SP stream #7, #15, #23 or #31 | 10 bytes |
| ISRC_V_SEL | Selected Video stream group for ISRC | 1 byte |
| ISRC_A_SEL | Selected Audio stream group for ISRC | 1 byte |
| ISRC_SP_SEL | Selected SP stream group for ISRC | 1 byte |
| Reserved | reserved | 16 bytes |

(1) ISRC_V Describes ISRC of video data which is included in Video stream. As for the description of ISRC.

(2) ISRC_An Describes ISRC of audio data which is included in the Decoding Audio stream #n. As for the description of ISRC.

(3) ISRC_SPn Describes ISRC of SP data which is included in the Decoding Sub-picture stream #n selected by ISRC_SP_SEL. As for the description of ISRC.

(4) ISRC_V_SEL

Describes the Decoding Video stream group for ISRC_V. Whether Main or Sub Video stream is selected in each GCI. ISRC_V_SEL is the information on RECI as shown in Table 54.

TABLE 54
ISRC_V_SEL

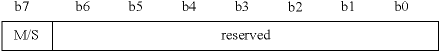

M/S . . . 0b: Main video stream is selected.

1b: Sub video stream is selected.

Note 1: In the Standard content, M/S shall be set to zero (0).

(5) ISRC_A_SEL

Describes the Decoding Audio stream group for ISRC_An. Whether Main or Sub Decoding Audio stream is selected in each GCI. ISRC_A_SEL is the information on RECI as shown in Table 55.

TABLE 55
ISRC_A_SEL

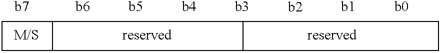

M/S . . . 0b Main Decoding Audio streams are selected. 1b: Sub Decoding Audio streams are selected.

Note 1: In the Standard content, M/S shall be set to zero (0).

(6) ISRC_SP_SEL

Describes the Decoding SP stream group for ISRC_SPn. Two or more SP_GRn shall not be set to one (1) in each GCI. ISRC_SP_SEL is the information on RECI as shown in Table 56.

TABLE 56
ISRC_SP_SEL

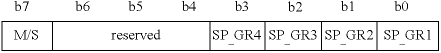

SP_GR1 . . . 0b: Decoding SP stream #0 to #7 are not selected.
1b: Decoding SP stream #0 to #7 are selected.

SP_GR2 . . . 0b: Decoding SP stream #8 to #15 are not selected.
1b: Decoding SP stream #8 to #15 are selected.

SP_GR3 . . . 0b: Decoding SP stream #16 to #23 are not selected.
1b: Decoding SP stream #16 to #23 are selected.

SP_GR4 . . . 0b: Decoding SP stream #24 to #31 are not selected.
1b: Decoding SP stream #24 to #31 are selected.

M/S . . . 0b: Main Decoding SP streams are selected.
1b: Sub Decoding SP streams are selected.

Note 1: In the Standard content, M/S shall be set to zero (0).

5.2.8 Highlight Information (HLI)

HLI is the information to highlight one rectangular area in Sub-picture display area as button and it is stored in an EVOB anywhere. HLI is composed of three pieces of information as shown in Table 57. HLI is described in the HLI packet (HLI_PKT) in the HLI pack (HLI_PCK) as shown in FIG. 63B. Its content is renewed for each HLI. For details of EVOB and HLI_PCK, refer to 5.3 Primary Enhanced Video Object.

TABLE 57
HLI

(Description order)

| | Contents | Number of bytes |
|---|---|---|
| HL_GI | Highlight General | 60 bytes |
| | Information | |
| BTN_COLIT | Button Color Information | 1024 bytes × 3 |
| | Table | |
| BTNIT | Button Information Table | 74 bytes × 48 |
| | Total | 6684 bytes |

In FIG. 63B, HLI_PCK may be located in EVOB anywhere.
HLI_PCKs shall be located after the first pack of the related SP_PCK.
Two types of HLI may be located in an EVOBU.

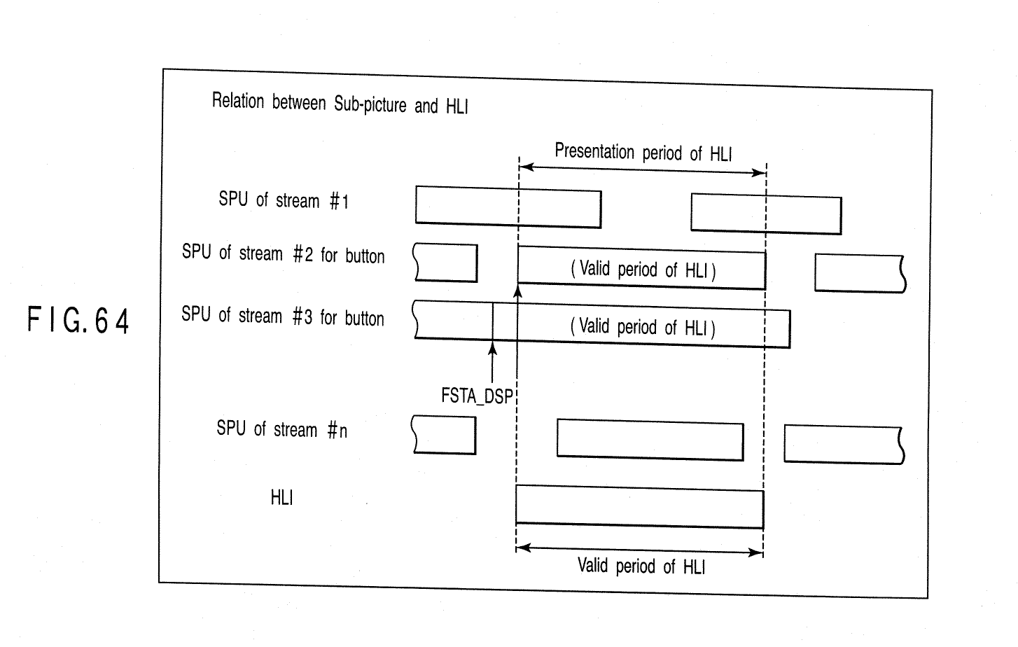

With this Highlight Information, the mixture (contrast) of the Video and Sub-picture color in the specific rectangular area may be altered. Relation between Sub-picture and HLI as shown in FIG. 64. Every presentation period of Sub-picture Unit (SPU) in each Sub-picture stream for button shall be equal to or greater than the valid period of HLI. The Sub-picture stream other than Sub-picture stream for button have no relation to HLI.

5.2.8.1 Structure of HLI

HLI consists of three pieces of information as shown in Table 57.

Button Color Information Table (BTN_COLIT) consists of three (3) Button Color Information (BTN_COLI) and 48 Button Information (BTNI).

48 BTNIs could be used as one 48 BTNIs group mode, two 18 BTNIs group mode or three 16 BTNIs group mode each described in the ascending order directed by the Button Group.

The Button Group is used to alter the size and the position of the display area for Buttons according to the display type (4:3, HD, Wide, Letterbox or Pan-scan) of Decoding Sub-picture stream. Therefore, the contents of the Buttons which share the same Button number in each Button Group shall be the same except for the display position and the size.

5.2.8.2 Highlight General Information

HL_GI is the information on HLI as a whole as shown in Table 58.

TABLE 58
HL_GI

(Description order)

| | | Number of | |
|---|---|---|---|
| | Contents | bytes | |
| (1) HLI_ID | HLI Identifier | 2 | bytes |
| (2) HLI_SS | Status of HLI | 2 | bytes |
| (3) HLI_S_PTM | Start PTM of HLI | 4 | bytes |
| (4) HLI_E_PTM | End PTM of HLI | 4 | bytes |
| (5) BTN_SL_E_PTM | End PTM of Button select | 4 | bytes |
| (6) CMD_CHG_S_PTM | Start PTM of Button command change | 4 | bytes |
| (7) BTN_MD | Button mode | 2 | bytes |
| (8) BTN_OFN | Button Offset number | 1 | byte |
| (9) BTN_Ns | Number of Buttons | 1 | byte |
| (10) NSL_BTN_Ns | Number of Numerical Select Buttons | 1 | byte |
| reserved | reserved | 1 | byte |
| (11) FOSL_BTNN | Forcedly Selected Button number | 1 | byte |
| (12) FOAC_BTNN | Forcedly Activated Button number | 1 | byte |
| (13) SP_USE | Use of Sub-picture stream | 1 | byte × 32 |
| | Total | 60 | bytes |

(6) CMD_CHG_S_PTM (Table 59)

Describes the start time of the Button command change at this HLI by the following format. The start time of the Button command change shall be equal to or later than the HLI start time (HLI_S_PTM) of this HLI, and before Button select termination time (BTN_SL_E_PTM) of this HLI.

When HLI_SS is ‘01b’ or ‘10b’, the start time of the Button command change shall be equal to HLI_S_PTM.

When HLI_SS is ‘11b’, the start time of the Button command change of HLI which is renewed after that of the previous HLI is described.

TABLE 59
CMD_CHG_S_PTM

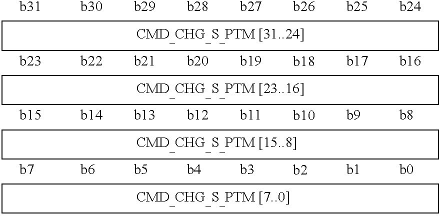

Button command change start time=CMD_CHG_S_PTM [31 . . . 0]/90000 [seconds]

(13) SP_USE (Table 60)

Describes each Sub-picture stream use. When the number of Sub-picture streams are less than ‘32’, enter ‘0b’ in every bit of SP_USE for unused streams. The content of one SP_USE is as follows:

TABLE 60
SP_USE

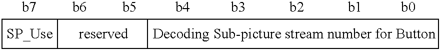

SP_Use . . . Whether this Sub-picture stream is used as Highlighted Button or not.

0b: Highlighted Button during HLI period.

1b: Other than Highlighted Button

Decoding Sub-picture stream number for Button

. . . When “SP_Use” is ‘1b’, describes the least significant 5 bits of sub_stream_id for the corresponding Sub-picture stream number for Button.

Otherwise enter ‘00000b’ but the value ‘00000b’ does not specify the Decoding Sub-picture stream number ‘0’.

5.2.8.3 Button Color Information Table (BTN_COLIT)

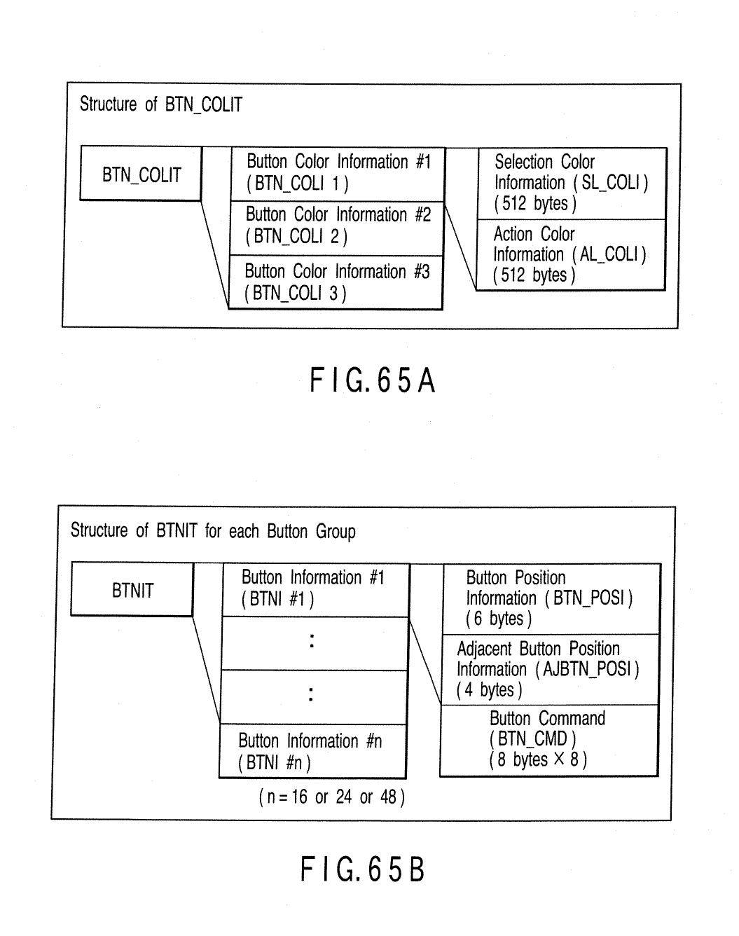

BTN_COLIT is composed of three BTN_COLIs as shown in FIG. 65A. Button color number (BTN_COLN) is assigned from ‘1’ to ‘3’ in the order with which BTN_COLI is described. BTN_COLI is composed of Selection Color Information (SL_COLI) and Action Color Information (AC_COLI) as shown in FIG. 65A. On SL_COLI, the color and the contrast to be displayed when the Button is in “Selection state” are described. Under this state, User may move the Button from the highlighted one to another. On AC_COLI, the color and the contrast to be displayed when the Button is in “Action state” are described. Under this state, User may not move the Button from the highlighted one to another.

The contents of SL_COL₁ and AC_COLI are as follows:

SL_COLI consists of 256 color codes and 256 contrast values. 256 color codes are divided into the specified four color codes for Background pixel, Pattern pixel, Emphasis pixel-1 and Emphasis pixel-2, and the other 252 color codes for Pixels. 256 contrast values are divided into the specified four contrast values for Background pixel, Pattern pixel, Emphasis pixel-1 and Emphasis pixel-2, and the other 252 contrast values for Pixels as well.

AC_COLI also consists of 256 color codes (Table 61) and 256 contrast values (Table 62). 256 color codes are divided into the specified four color codes for Background pixel, Pattern pixel, Emphasis pixel-1 and Emphasis pixel-2, and the other 252 color codes for Pixels. 256 contrast values are divided into the specified four contrast values for Background pixel, Pattern pixel, Emphasis pixel-1 and Emphasis pixel-2, and the other 252 contrast values for Pixels as well.

Note: The specified four color codes and the specified four contrast values are used for both Sub-picture of 2 bits/pixel and 8 bits/pixel. However, the other 252 color codes and the other 252 contrast values are used for only Sub-picture of 8 bits/pixel.

TABLE 61
(a) Selection Color Information (SL_COLI) for color code

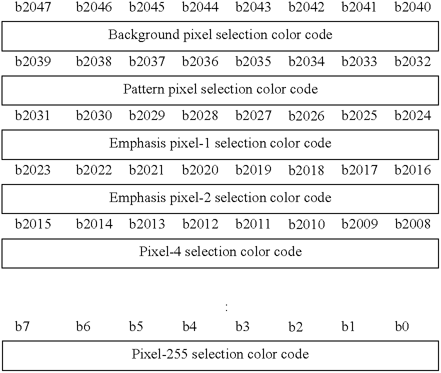

In case of the specified four pixels:

Background pixel selection color code

Describes the color code for the background pixel when the Button is selected.

If no change is required, enter the same code as the initial value.

Pattern pixel selection color code

Describes the color for the pattern pixel when the Button is selected.

If no change is required, enter the same code as the initial value.

Emphasis pixel-1 selection color code

Describes the color code for the emphasis pixel-1 when the Button is selected.

If no change is required, enter the same code as the initial value.

Emphasis pixel-2 selection color code

Describes the color code for the emphasis pixel-2 when the Button is selected.

If no change is required, enter the same code as the initial value.

In case of the other 252 pixels:

Pixel-4 to Pixel-255 selection color code

Describes the color code for the pixel when the Button is selected.

If no change is required, enter the same code as the initial value.

Note: An initial value means the color code which are defined in the Sub-picture.

TABLE 62
(b) Selection Color Information (SL_COLI) for contrast value

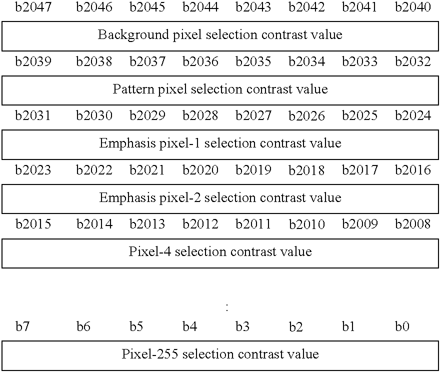

In case of the specified four pixels:

Background pixel selection contrast value

Describes the contrast value of the background pixel when the Button is selected.

If no change is required, enter the same value as the initial value.

Pattern pixel selection contrast value

Describes the contrast value of the pattern pixel when the Button is selected.

If no change is required, enter the same value as the initial value. Emphasis

pixel-1 selection contrast value

Describes the contrast value of the emphasis pixel-1 when the Button is selected.

If no change is required, enter the same value as the initial value. Emphasis pixel-2 selection contrast value

Describes the contrast value of the emphasis pixel-2 when the Button is selected.

If no change is required, enter the same value as the initial value.

In case of the other 252 pixels:

Pixel-4 to Pixel-255 selection contrast value

Describes the contrast value for the pixel when the Button is selected.

If no change is required, enter the same code as the initial value.

Note: An initial value means the contrast value which are defined in the Sub-picture.

5.2.8.4 Button Information Table (BTNIT)

BTNIT consists of 48 Button Information (BTNI) as shown in FIG. 65B. This table may be used as one-group mode made up of 48 BTNIs, two-group mode made up of 24 BTNIs or three-group mode made up of 16 BTNIs in accordance with the description content of BTNGR_Ns. The description fields of BTNI retain fixedly the maximum number set at the Button Group. Therefore, BTNI is described from the beginning of the description field of each group. Zero (0) shall be described at fields where valid BTNI do not exist. Button number (BTNN) is assigned from ‘1’ in the order with which BTNI in each Button Group is described.

Note: Buttons in the Button Group which is activated by Button_Select_and_Activate( ) function are those between BTNN #1 and the value described in NSL_BTN_Ns. The user Button number is defined as follows:

User Button number (U_BTNN)=BTNN+BTN_OFN

BTNI is composed of Button Position Information (BTN_POSI), Adjacent Button Position Information (AJBTN_POSI) and Button Command (BTN_CMD). On BTN_POSI are described the Button color number to be used by the Button, the display rectangular area and the Button action mode. On AJBTN_POSI are described Button number located above, below, to the right, and the left. On BTN_CMD is described the command executed when the Button is activated.

(c) Button Command Table (BTN_CMDT)

Describes the batch of eight commands to be executed when the Button is activated. Button Command numbers are assigned from one according to the description order. Then, the eight commands are executed from BTN_CMD #1 according to the description order. BTN_CMDT is a fixed size with 64 bytes as shown in Table 63.

TABLE 63
BTN_CMDT

| | | Number of |
|---|---|---|
| | Contents | bytes |
| BTN_CMD #1 | Button Command #1 | 8 bytes |
| BTN_CMD #2 | Button Command #2 | 8 bytes |
| BTN_CMD #3 | Button Command #3 | 8 bytes |
| BTN_CMD #4 | Button Command #4 | 8 bytes |
| BTN_CMD #5 | Button Command #5 | 8 bytes |
| BTN_CMD #6 | Button Command #6 | 8 bytes |
| BTN_CMD #7 | Button Command #7 | 8 bytes |
| BTN_CMD #8 | Button Command #8 | 8 bytes |
| | Total | 64 bytes |

BTN_CMD #1 to #8 Describes the command to be executed when the Button is activated. If eight commands are not necessary for a button, it shall be filled by one or more NOP command(s). Refer to 5.2.4 Navigation Command and Navigation Parameters.

5.4.6 Highlight Information pack (HLI_PCK)

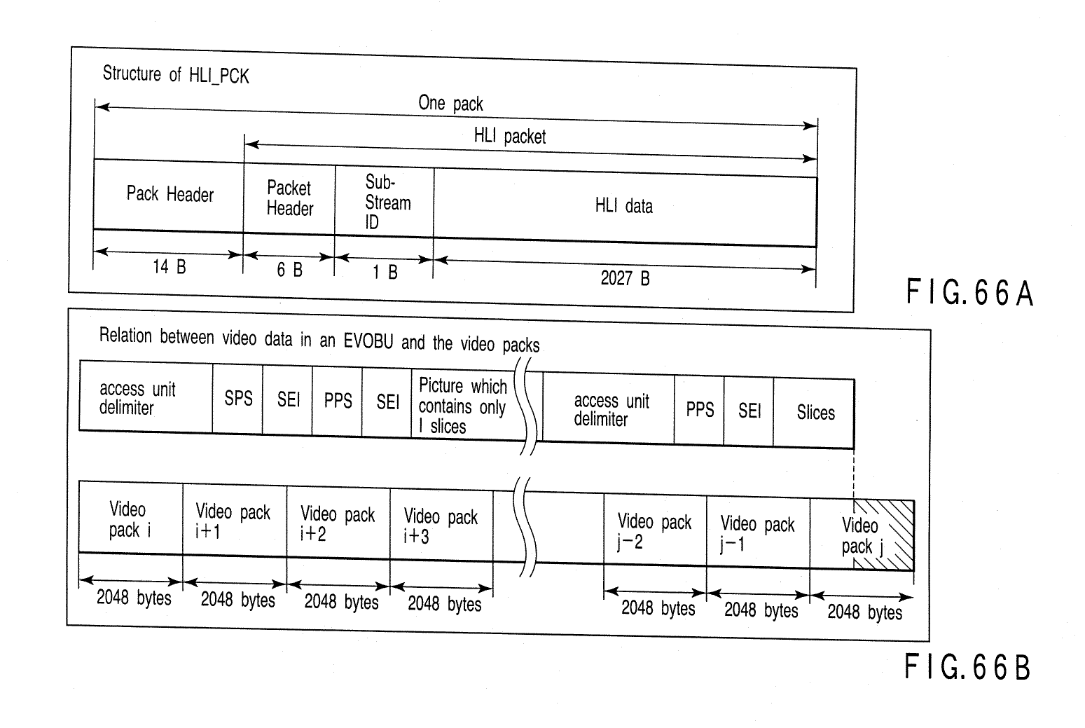

The Highlight Information pack comprises a pack header and a HLI packet (HLI_PKT) as shown in FIG. 66A. The contents of the packet header of the HLI_PKT is shown in Table 64.

The stream_id of the HLI_PKT is as follow:

HLI_PKT stream_id; 1011 1111b (private_stream_{—}2)

sub_stream_id; 0000 1000b

TABLE 64
HLI packet

| | Number | Number | | |
|---|---|---|---|---|
| Field | of bits | of bytes | Value | Comment |
| packet_start_code_prefix | 24 | 3 | 00 0001h | |
| stream_id | 8 | 1 | 1011 1111b | private_stream_2 |
| PES_packet_length | 16 | 2 | 07ECh | |

Private data area

| | | | |
|---|---|---|---|
| sub_stream_id | 8 | 1 | 0000 1000b |

HLI data area

5.5.1.2 MPEG-4 AVC Video

Encoded video data shall comply with ISO/IEC 14496-10 (MPEG-4 Advanced Video Coding standard) and be represented in byte stream format. Additional semantic constraints on Video stream for MPEG-4 AVC are specified in this section.

A GOVU (Group Of Video access Unit) consists of more than one byte stream NAL units. RBSP data carried in the payload of NAL units shall begin with an access unit delimiter followed by a sequence parameter set (SPS) followed by supplemental enhancement information (SEI) followed by a picture parameter set (PPS) followed by SEI followed by a picture, which contains only I-slices, followed by any subsequent combinations of an access unit delimiter, a PPS, an SEI and slices as shown in FIG. 66B. At the end of an access unit, filler data and end of sequence may exist. At the end of a GOVU, filler data shall exist and end of sequence may exist. The video data for each EVOBU shall be divided into an integer number of video packs and shall be recorded on the disc as shown in FIG. 66B. The access unit delimiter at the beginning of the EVOBU video data shall be aligned with the first video pack.

The detailed structure of GOVU is defined in Table 65.

TABLE 65
Detailed structure of GOVU

| | Syntax Elements defined in | Mandatory/Optional for |
|---|---|---|
| | MPEG-4AVC | Disc |
| The first | Access Unit Delimiter | Mandatory |
| picture of | Sequence Parameter Set | Mandatory |
| a GOVU | VUI Parameters | Mandatory |
| | HRD Parameters | Mandatory |
| | Supplemental Enhancement | Mandatory (Carried in |
| | Information (1) | the same NAL unit) |
| | Buffering Period | Mandatory |
| | Recovery Point | Mandatory/Optional (*1) |
| | User Data Unregistered | Optional |
| | Picture Parameter Set | Mandatory |
| | Supplemental Enhancement | Mandatory (Carried in |
| | Information (2) | the same NAL unit) |
| | Picture Timing | Mandatory |
| | Pan Scan Rectangle | Mandatory |
| | Film Grain Characteristic (*2) | Optional |
| | Slice Data | Mandatory |
| | Additional Slice Data | Optional |
| | Filler Data | Optional |
| Succeeding | Access Unit Delimiter | Mandatory |
| picture | Picture Parameter Set | Mandatory |
| of a | Supplemental Enhancement | Mandatory (Carried in |
| GOVU | Information (2) | the same NAL unit) |
| (if exists) | Picture Timing | Mandatory |
| | Pan Scan Rectangle | Mandatory |
| | Film Grain Characteristic | Optional |
| | Slice Data | Mandatory |
| | Additional Slice Data | Optional |
| | Filler Data | Optional |
| Succeeding | Same structure as the picture above | |
| pictures | | |
| (if exist) | | |
| End of | Filler Data | Mandatory |
| GOVU | End of Sequence | Optional |

(*1) If the associated picture is an IDR picture, recovery point SEI is optional. Otherwise, it is mandatory.
(*2) As for Film Grain, refer to 5.5.1.x. If nal_unit_type is one of 0 and from 24 to 31, the NAL unit shall be ignored.

Note: SEI messages not included in [Table 5.5.1.2-1] should be read and discarded in the player.

5.5.1.2.2 Further constraints on MPEG-4 AVC video

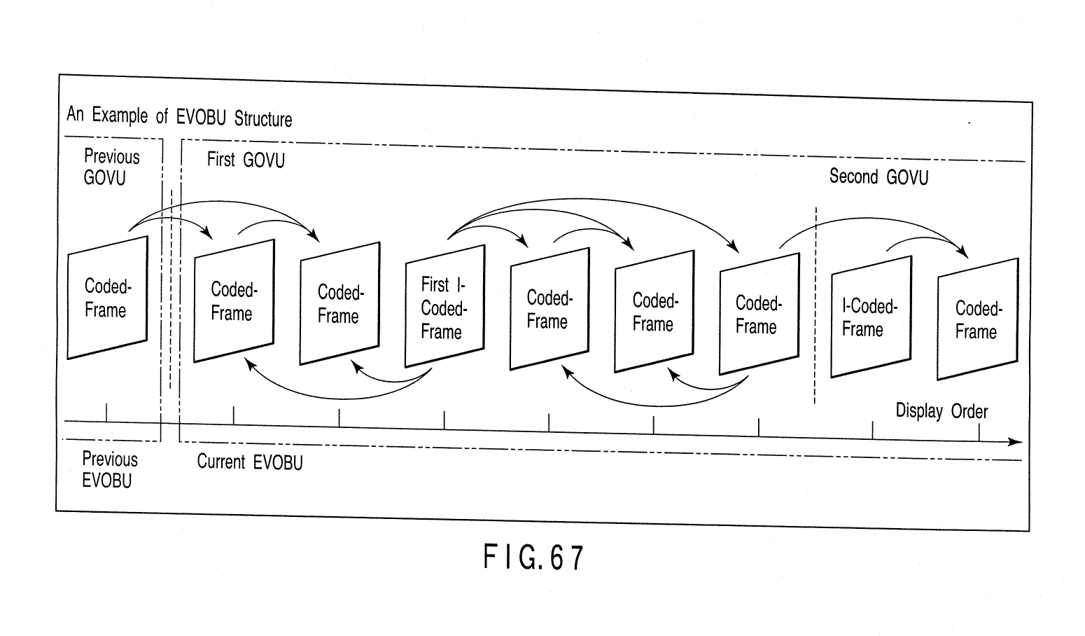

1) In an EVOBU, Coded-Frames displayed prior to the I-Coded-Frame which is the first one in coding order may refer to Coded-Frames in the preceding EVOBU. Coded-Frames displayed after the first I-Coded-Frame shall not refer to Coded-Frames preceding the first I-Coded-Frame in display order as shown in FIG. 67.

Note 1: The first picture in the first GOVU in an EVOB shall be an IDR picture.

Note 2: Picture parameter set shall refer to sequence parameter set of the same GOVU. All slices in an access unit shall refer to the picture parameter set associated with the access unit.

5.5.1.3 SMPTE VC-1

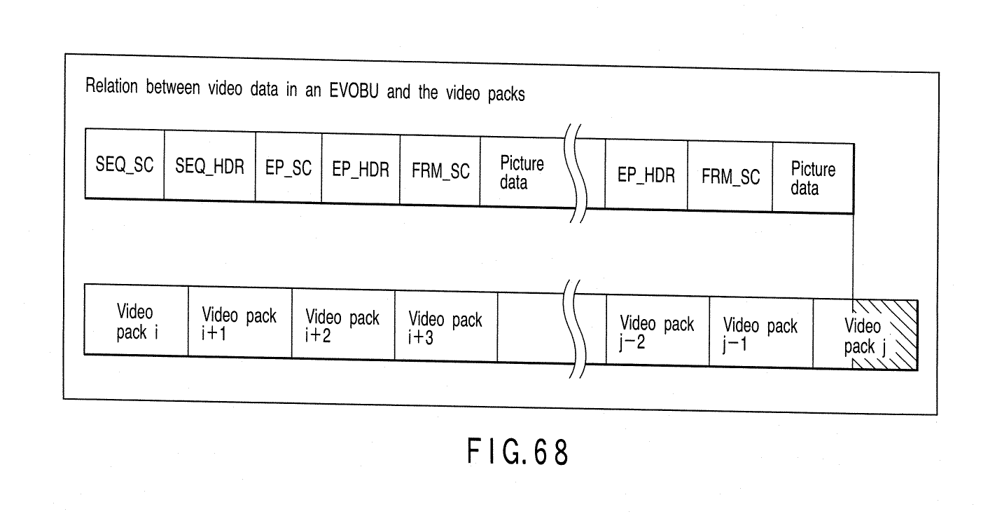

Encoded video data shall comply with VC-1 (SMPTE VC-1 Specification). Additional semantic constraints on Video stream for VC-1 are specified in this section. The video data in each EVOBU shall begin with a Sequence Start Code (SEQ_SC) followed by a Sequence Header (SEQ_HDR) followed by an Entry Point Start Code (EP_SC) followed by an Entry Point Header (EP_HDR) followed by Frame Start Code (FRM_SC) followed by Picture data of either of picture type I, I/I, P/I or I/P. The video data for each EVOBU shall be divided into an integer number of video packs and shall be recorded on the disc as shown in FIG. 68. The SEQ_SC at the beginning of the EVOBU video data shall be aligned with the first video pack.

5.5.4 Sub-Picture Unit (SPU) for the Pixel Depth of 8 Bits

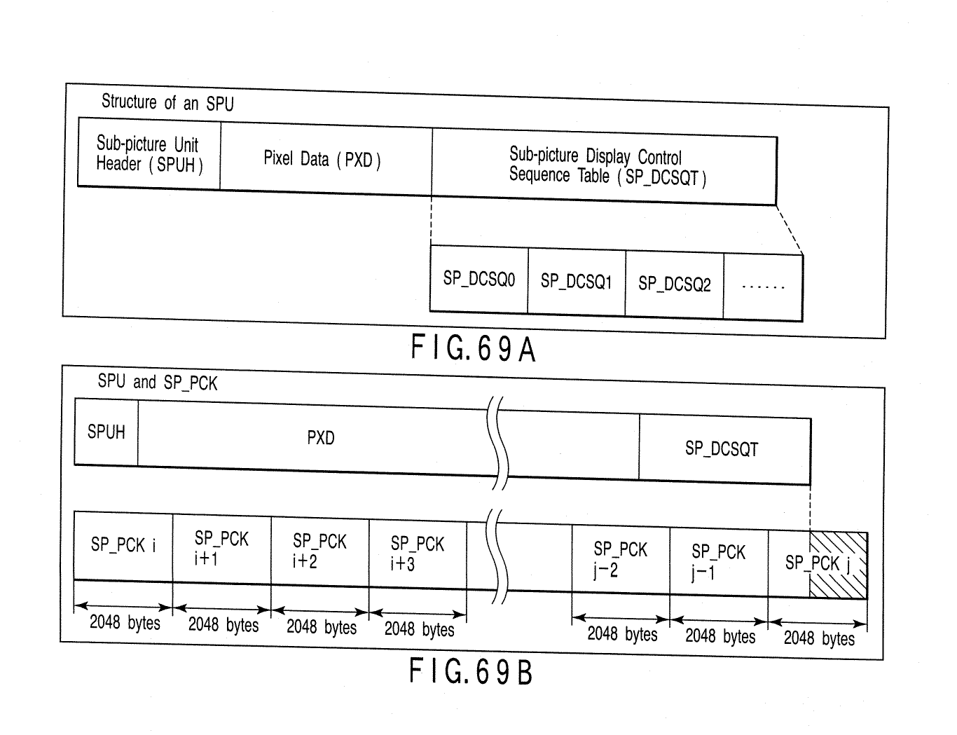

The Sub-picture Unit comprises the Sub-picture Unit Header (SPUH), Pixel Data (PXD) and Display Control Sequence Table (SP_DCSQT) which includes Sub-picture Display Control Sequences (SP_DCSQ). The size of the SP_DCSQT shall be equal to or less than the half of the size of the Sub-picture Unit. SP_DCSQ describes the content of the display control on the pixel data. Each SP_DCSQ is sequentially recorded, attached to each other as shown in FIG. 69A

The SPU is divided into integral pieces of SP_PCKs as shown in FIG. 69B and then recorded on a disc. An SP_PCK may have a padding packet or stuffing bytes, only when it is the last pack for an SPU. If the length of the SP_PCK comprising the last unit data is less than 2048 bytes, it shall be adjusted by either method. The SP_PCKs other than the last pack for an SPU shall have no padding packet.

The PTS of an SPU shall be aligned with top fields. The valid period of the SPU is from PTS of the SPU to that of the SPU to be presented next. However, when

Still happens in the Navigation Data during the valid period of the SPU, the valid period of the SPU is until the Still is terminated.

The display of the SPU is defined as follows:

1) When the display is turned on by the Display Control Command during the valid period of the SPU, the Sub-picture is displayed.

2) When the display is turned off by the Display Control Command during the valid period of the SPU, the Sub-picture is cleared.

3) The Sub-picture is forcedly cleared when the valid period of the SPU reaches the end, and the SPU is abandoned from the decoder buffer.

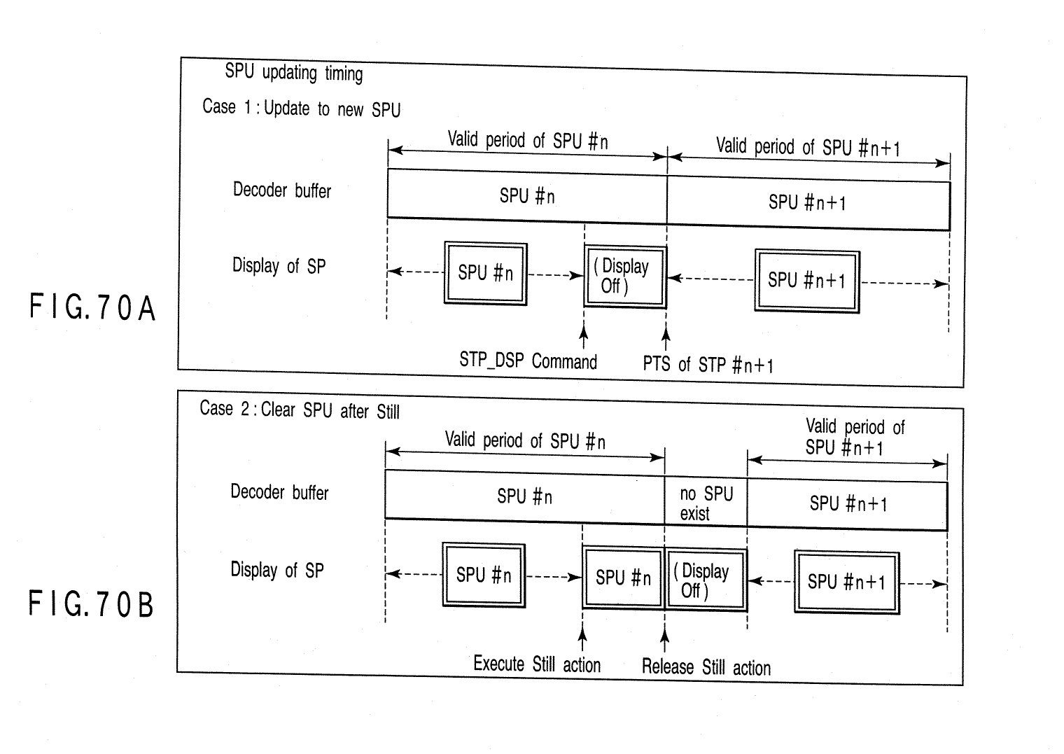

FIGS. 70A and 70B show update timing of Sub-picture Unit.

5.5.4.1 Sub-Picture Unit Header (SPUH)

SPUH comprises the identifier information, size and address information of each data in an SPU. Table 66 shows the content of SPUH.

TABLE 66
SPUH

(Description order)

| | Contents | Number of bytes |
|---|---|---|
| (1) SPU_ID | Identifier of Sub-picture | 2 bytes |
| | Unit | |
| (2) SPU_SZ | Size of Sub-picture Unit | 4 bytes |
| (3) SP_DCSQT_SA | Start address of Display | 4 bytes |
| | Control Sequence Table | |
| | Total | 10 bytes |

(1) SPU_ID The value of this field is (00 00h).
(2) SPU_SZ Describes the size of an SPU in number of bytes. The maximum SPU size is T.B.D. bytes. The size of an SPU in bytes shall be even. (When the size is odd, one (FFh) shall be added at the end of the SPU, to make the size even.)
(3) SP_DCSQT_SA Describes the start address of SP_DCSQT with RBN from the first byte of the SPU.

5.5.4.2 Pixel Data (PXD)

The PXD is the data compressed from the bitmap data in each line by the specific run-length method, described in 5.5.4.2 (a) Run-length compression rule. The number of pixels on a line in bitmap data shall be equal to that of pixels displayed on a line which is set by the command “SET_DAREA2” in SP_DCCMD. Refer to 5.5.4.4 SP Display Control Command.

For pixels of bitmap data, the pixel data are assigned as shown in Tables 67 and 68. Table 67 shows the specified four pixel data, Background, Pattern, Emphasis-1 and Emphasis-2. Table 68 shows the other 252 pixel data using gradation or grayscale, etc.

TABLE 67
Allocation of specified pixel data

| specified pixel | pixel data |
|---|---|
| Background pixel | 0 0000 0000 |
| Pattern pixel | 0 0000 0001 |
| Emphasis pixel-1 | 0 0000 0010 |
| Emphasis pixel-2 | 0 0000 0011 |

TABLE 68
Allocation of other pixel data

| pixel name | pixel data |
|---|---|
| Pixel-4 | 1 0000 0100 |
| Pixel-5 | 1 0000 0101 |
| Pixel-6 | 1 0000 0110 |
| . . . | . . . |
| Pixel-254 | 1 1111 1110 |
| Pixel-255 | 1 1111 1111 |

Note: Pixel data from “1 0000 0000b” to “1 0000 0011b” shall not be used.

PXD, i.e. run-length compressed bitmap data, is separated into fields. Within each SPU, PXD shall be organized such that every subset of PXD to be displayed during any one field shall be contiguous. A typical example is PXD for top field being recorded first (after SPUH), followed by PXD for bottom field. Other arrangements are possible.

(a) Run-Length Compression Rule

The coded data consists of the combination of eight patterns.

<In Case of the Specified Four Pixel Data, the Following Four Patterns are Applied>

2) If only 1 pixel with the same value follow, enter the run-length compression flag (Comp), and enter the pixel data (PIX2 to PIX0) in the 3 bits. Where, Comp and PIX2 are always ‘0’. The 4 bits are considered to be one unit.

TABLE 69

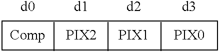

3) If 2 to 9 pixels with the same value follow, enter the run-length compression flag (Comp), and enter the pixel data (PIX2 to PIX0) in the 3 bits, and enter the length extension (LEXT) and enter the run counter (RUN2 to RUN0) in the 3 bits. Where, Comp is always ‘1’, PIX2 and LEXT are always ‘0’. The run counter is calculated by always adding 2. The 8 bits are considered to be one unit.

TABLE 70

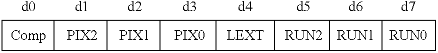

3) If 10 to 136 pixels with the same value follow, enter the run-length compression flag (Comp), and enter the pixel data (PIX2 to PIX0) in the 3 bits, and enter the length extension (LEXT) and enter the run counter (RUN6 to RUN0) in the 7 bits. Where, Comp and LEXT are always ‘1’, PIX2 is always ‘0’. The run counter is calculated by always adding 9. The 12 bits are considered to be one unit.

TABLE 71

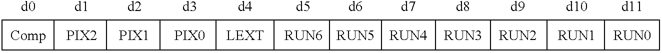

4) If the same pixels follow to the end of a line, enter the run-length compression flag (Comp), and enter the pixel data (PIX2 to PIX0) in the 3 bits, and enter the length extension (LEXT) and enter the run counter (RUN6 to RUN0) in the 7 bits. Where, Comp and LEXT are always ‘1’, PIX2 is always ‘0’. The run counter is always ‘0’. The 12 bits are considered to be one unit.

TABLE 72

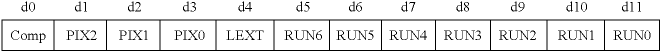

<In Case of the Other 252 Pixel Data, the Following Four Patterns are Applied>

1) If only 1 pixel with the same value follow, enter the run-length compression flag (Comp), and enter the pixel data (PIX7 to PIX0) in the 8 bits. Where, Comp is always ‘0’, PIX7 is always ‘1’. The 9 bits are considered to be one unit.

TABLE 73

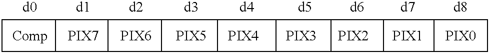

2) If 2 to 9 pixels with the same value follow, enter the run-length compression flag (Comp), and enter the pixel data (PIX7 to PIX0) in the 8 bits, and enter the length extension (LEXT) and enter the run counter (RUN2 to RUN0) in the 7 bits. Where, Comp and PIX7 are always ‘1’, LEXT is always ‘0’. The run counter is calculated by always adding 2. The 13 bits are considered to be one unit.

TABLE 74

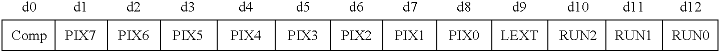

3) If 10 to 136 pixels with the same value follow, enter the run-length compression flag (Comp), and enter the pixel data (PIX7 to PIX0) in the 8 bits, and enter the length extension (LEXT) and enter the run counter (RUN6 to RUN0) in the 7 bits. Where, Comp, PIX7 and LEXT are always ‘1’. The run counter is calculated by always adding 9. The 17 bits are considered to be one unit.

TABLE 75

| d0 | d1 | d2 | d3 | d4 | d5 | d6 | d7 | d8 | d9 | D1 | D1 | d12 | d13 | d14 | d15 | d16 |
|---|---|---|---|---|---|---|---|---|---|---|---|---|---|---|---|---|
| Comp | PIX7 | PIX6 | PIX5 | PIX4 | PIX3 | PIX2 | PIX1 | PIX0 | LEXT | RUN6 | RUN5 | RUN4 | RUN3 | RUN2 | RUN1 | RUN0 |

4) If the same pixels follow to the end of a line, enter the run-length compression flag (Comp), and enter the pixel data (PIX7 to PIX0) in the 8 bits, and enter the length extension (LEXT) and enter the run counter (RUN6 to RUN0) in the 7 bits. Where, Comp, PIX7 and LEXT are always ‘1’. The run counter is always ‘0’. The 17 bits are considered to be one unit.

TABLE 76

| d0 | d1 | d2 | d3 | d4 | d5 | d6 | d7 | d8 | d9 | D1 | D1 | d12 | d13 | d14 | d15 | d16 |
|---|---|---|---|---|---|---|---|---|---|---|---|---|---|---|---|---|
| Comp | PIX7 | PIX6 | PIX5 | PIX4 | PIX3 | PIX2 | PIX1 | PIX0 | LEXT | RUN6 | RUN5 | RUN4 | RUN3 | RUN2 | RUN1 | RUN0 |

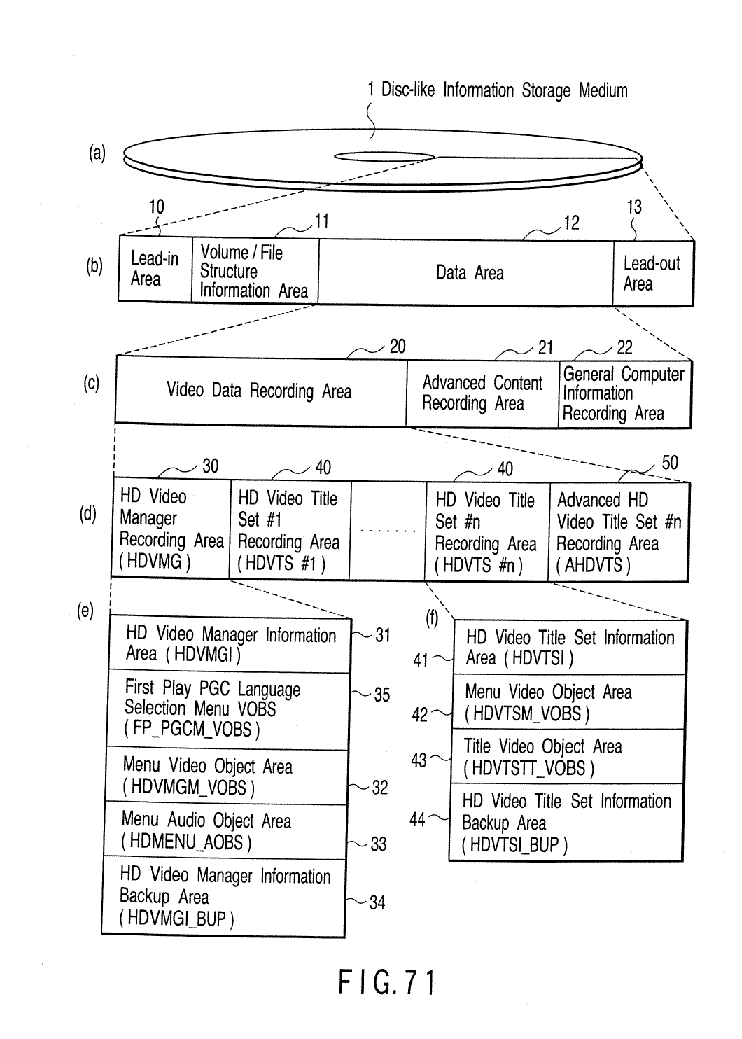

FIG. 71 is a view for explaining the information content recorded on a disc-shaped information storage medium according to the embodiment of the invention. Information storage medium 1 shown in FIG. 71(a) can be configured by a high-density optical disk (a high-density or high-definition digital versatile disc: HD_DVD for short) which uses, e.g., a red laser of a wavelength of 650 nm or a blue laser of a wavelength of 405 nm (or less).

Information storage medium 1 includes lead-in area 10, data area 12, and lead-out area 13 from the inner periphery side, as shown in FIG. 71(b). This information storage medium 1 adopts the ISO 9660 and UDF bridge structures as a file system, and has ISO 9660 and UDF volume/file structure information area 11 on the lead-in side of data area 12.

Data area 12 allows mixed allocations of video data recording area 20 used to record DVD-Video content (also called standard content or SD content), another video data recording area (advanced content recording area used to record advanced content) 21, and general computer information recording area 22, as shown in FIG. 71(c).

Video data recording area 20 includes HD video manager (High Definition-compatible Video Manager [HDVMG]) recording area 30 that records management information associated with the entire HD_DVD-Video content recorded in video data recording area 20, HD video title set (High Definition-compatible Video Title Set [HDVTS], also called standard VTS) recording area 40 which are arranged for respective titles, and record management information and video information (video objects) for respective titles together, and advanced HD video title set (advanced VTS) recording area [AHDVTS] 50, as shown in FIG. 71(d).

HD video manager (HDVMG) recording area 30 includes HD video manager information (High Definition-compatible Video Manager Information [HDVMGI]) area 31 that indicates management information associated with overall video data recording area 20, HD video manager information backup (HDVMGI_BUP) area 34 that records the same information as in HD video manager information area 31 as its backup, and menu video object (HDVMGM_VOBS) area 32 that records a top menu screen indicating whole video data recording area 20, as shown in FIG. 71(e).

In the embodiment of the invention, HD video manager recording area 30 newly includes menu audio object (HDMENU_AOBS) area 33 that records audio information to be output in parallel upon menu display. An area of first play PGC language select menu VOBS (FP_PGCM_VOBS) 35 which is executed upon first access immediately after disc (information storage medium) 1 is loaded into a disc drive is configured to record a screen that can set a menu description language code and the like.

One HD video title set (HDVTS) recording area 40 that records management information and video information (video objects) together for each title includes HD video title set information (HDVTSI) area 41 which records management information for all content in HD video title set recording area 40, HD video title set information backup (HDVTSI_BUP) area 44 which records the same information as in HD video title set information area 41 as its backup data, menu video object (HDVTSM_VOBS) area 42 which records information of menu screens for each video title set, and title video object (HDVTSTT_VOBS) area 43 which records video object data (title video information) in this video title set.

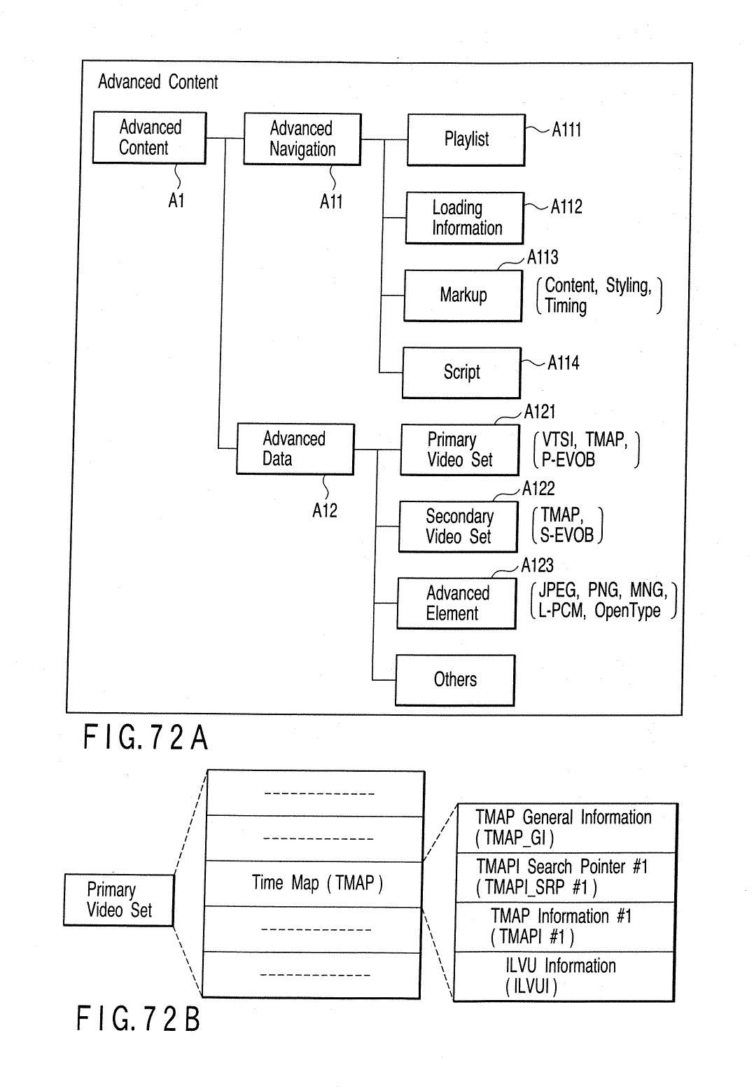

FIG. 72A is a view for explaining a configuration example of an Advanced Content in advanced content recording area 21. The Advanced Content may be recorded in the information storage medium, or provided a server via a network.

The Advanced Content recorded in Advanced Content area A1 is configured to include Advanced Navigation that manages Primary/Secondary Video Set output, text/graphic rendering, and audio output, and Advanced Data including these data managed by the Advanced Navigation. The Advanced Navigation recorded in Advanced Navigation area A11 includes Playlist files, Loading Information files, Markup files (for content, styling, timing information), and Script files. Playlist files are recorded in a Playlist files area A111. Loading Information files are recorded in a Loading Information files area A112. Markup files are recorded in a Markup files area A113. Script files are recorded in a Script files area A114.

Also, the Advanced Data recorded in Advanced Data area A12 includes a Primary Video Set (VTSI, TMAP, and P-EVOB), Secondary Video Set (TMAP and S-EVOB), Advanced Element (JPEG, PNG, MNG, L-PCM, OpenType font, etc.), and the like. The Primary Video Set is recorded in a Primary Video Set area A121. The Secondary Video Set is recorded in a Secondary Video Set area A122. Advanced Element is recorded in a Advanced Element Set area A123.

Advanced Navigation includes a Playlist file and Loading Information files, Markup files (for content, styling, timing information) and Script files. Playlist files, Loading Information files and Markup files shall be encoded in XML document. Script file shall be encoded text file in UTF-8 encoding.

XML document for Advanced Navigation shall be well-formed, and subject to the rules in this section. XML document which are not well formed XML shall be rejected by Advanced Navigation Engine.

XML document for Advanced Navigation shall be well-formed documents. But if XML document resources are not well-formed one, they may be rejected by Advanced Navigation Engine.

XML documents shall be valid according to its referenced document type definition (DTD). Advanced Navigation Engine is not required to have capability of content validation. If XML document resource has non-well formed, the behavior of Advanced Navigation Engine is not guaranteed.

The following rules on XML declaration shall be applied.
The encoding declaration shall be “UTF-8” or “ISO-8859-1”. XML file shall be encoded in one of them.
The value of the standalone document declaration in XML declaration if present shall be “no”. If the standalone document declaration doesn't present, its value shall be regarded as “no”.

Every resource available on the disc or the network has an address that encoded by a Uniform Resource Identifier defined in [URI, RFC2396].

T.B.D. Supported protocol and path to DVD disc.

file://dvdrom:/dvd_advnav/file.xml

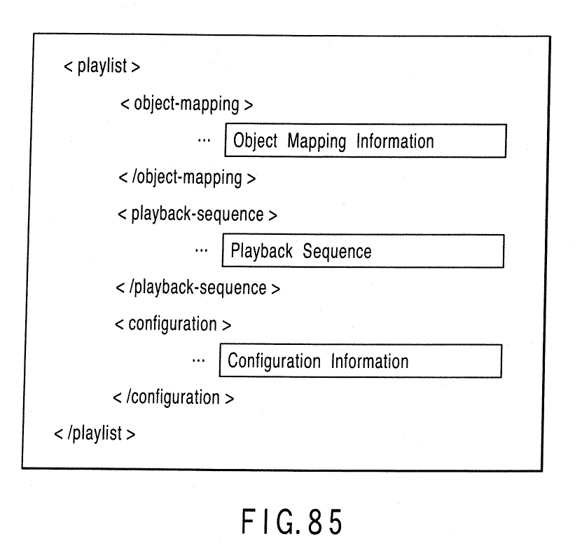

Playlist File (FIG. 85)

Playlist File describes initial system configuration of HD DVD player and information of Titles for advanced contents. For each title, a set of information of Object Mapping Information and Playback Sequence for each title shall be described in Playlist file. As for Title, Object Mapping Information and Playback Sequence, refer to Presentation Timing Model.

Playlist File shall be encoded as well-formed XML, subject to the rules in XML Document File. The document type of the Playlist file shall follow in this section.

Elements and Attributes

In this section, the syntax of Playlist file is defined using XML Syntax Representation.

1) Playlist Element

The Playlist element is the root element of the Playlist.

XML Syntax Representation of Playlist element:

<Playlist>
Configuration TitleSet

</Playlist>

A Playlist element consists of a TitleSet element for a set of the information of Titles and a Configuration element for System Configuration Information.

2) TitleSet Element

The TitleSet element describes information of a set of Titles for Advanced Contents in the Playlist.

XML Syntax Representaion of TitleSet element:

<TitleSet>
Title *

</TitleSet>

The TitleSet element consists of a list of Title element. According to the document order of Title element, the Title number for Advanced Navigation shall be assigned continuously from ‘1’. A Title element describes information of each Title.

3) Title Element

The Title element describes information of a Title for Advanced Contents, which consists of Object Mapping Information and Playback Sequence in a Title.

XML Syntax Representation of Title element:

<Title

id=ID

hidden=(true|false)

on Exit=positiveinteger>
PrimaryVideoTrack?
SecondaryVideoTrack?
ComplementaryAudioTrack?
ComplementarySubtitleTrack?
ApplicationTrack*
ChapterList?

</Title>

The content of Title element consists of element fragment for tracks and ChapterList element. The element fragment for tracks consists of a list of elements of PrimaryVideoTrack, SecondaryVideoTrack, ComplementaryAudioTrack, ComplementarySubtitleTrack, and ApplicationTrack.

Object Mapping Information for a Title is described by element fragment for tracks. The mapping of the Presentation Object on the Title Timeline shall be described by corresponding element. Primary Video Set corresponds to PrimaryVideoTrack, Secondary Video Set to SecondaryVideoTrack, Complementary Audio to ComplementaryAudioTrack, Complementary Subtitle to ComplementarySubtileTrack, and ADV_APP to ApplicationTrack.

Title Timeline is assigned for each Title.

As for Title Timeline, refer to 4.3.20 Presentation Timing Object.

The information of Playback Sequence for a Title which consists of chapter points is described by ChapterList element.

(a) Hidden Attribute

Describes whether the Title can be navigatable by User Operation, or not. If the value is “true”, the title shall not be navigated by User Operation. The value may be omitted. The default value is “false”.

(b) onExit Attribute

T.B.D. Describes the Title which Player shall play after the current Title playback. Player shall not jump if current Title playback exits before end of the Title.

4) PrimaryVideoTrack Element

PrimaryVideoTrack describes the Object Mapping Information of Primary Video Set in a Title.

XML Syntax Representation of PrimaryVideoTrack element:

<PrimaryVideoTrack

id=ID>
(Clip|ClipBlock)+

</PrimaryVideoTrack>

The content of PrimaryVideoTrack is a list of Clip element and ClipBlock element, which refer to a P-EVOB in Primary Video Set as the Presentation Object. Player shall pre-assign P-EVOB(s) on the Title Timeline using start and end time, in accordance with described in Clip element.

The P-EVOB(s) assigned on a Title Timeline shall not be overlapped each other.

5) SecondaryVideoTrack Element

SecondaryVideoTrack describes the Object Mapping Information of Secondary Video Set in a Title.

XML Syntax Representation of SecondaryVideoTrack element:

<SecondaryVideoTrack

id=ID

sync=(true|false)>
Clip+

</SecondaryVideoTrack>

The content of SecondaryVideoTrack is a list of Clip element, which refer to a S-EVOB in Secondary Video Set as the Presentation Object. Player shall pre-assign S-EVOB(s) on the Title Timeline using start and end time, in accordance with described in Clip element.

Player shall map the Clip and the ClipBlock on the Title Timeline by titleBeginTime and titleEndTime attribute of Clip element as the start and end position of the clip on the Title Timeline.

The S-EVOB(s) assigned on a Title Timeline shall not be overlapped each other.

If the sync attribute is ‘true’, Secondary Video Set shall be synchronized with time on Title Timeline.

If the sync attribute is ‘false’, Secondary Video Set shall run on own time.

(a) Sync Attribute

If sync attribute value is ‘true’ or omitted, the Presentation Object in SecondaryVideoTrack is Synchronized Object. If sync attribute value is ‘false’, it is Non-synchronized Object.

6) ComplementaryAudioTrack Element

ComplementaryAudioTrack describes the Object Mapping Information of Complementary Audio Track in a Title and the assignment to Audio Stream Number.

XML Syntax Representation of ComplementaryAudioTrack element:

<ComplementaryAudioTrack

id=ID

streamNumber=Number
languageCode=token
>
Clip+

</ComplementaryAudioTrack>

The content of ComplementaryAudioTrack element is a list of Clip element, which shall refer to Complementary Audio as the Presentation Element. Player shall pre-assign Complementary Audio on the Title Timeline according to described in Clip element.

The Complementary Audio(s) assigned on a Title Timeline shall not be overlapped each other.

Complementary Audio shall be assigned to the specified Audio Stream Number. If the Audio_stream_Change API selects the specified stream number of Complementary Audio, Player shall choose the Complementary Audio instead of the audio stream in Primary Video Set.

(a) streamNumber Attribute

Describes the Audio Stream Number for this Complementary Audio.

(b) languageCode Attribute

Describes the specific code and the specific code extension for this Complementary Audio. For specific code and specific code extension, refer to Annex B. The language code attribute value follows the following BNF scheme. The specificCode and specificCodeExt describes specific code and specific code extension, respectively.

languageCode:=specificCode ‘:’ specificCodeExtension

specificCode:=[A-Za-z] [A-Za-z0-9]

specificCodeExt:=[0-9A-F] [0-9A-F]

7) ComplementarySubtitleTrack Element

ComplementarySubtitleTrack describes the Object Mapping Information of Complemetary Subtitle in a Title and the assignment to Sub-picture Stream Number.

XML Syntax Representation of ComplementarySubtitleTrack element:

<ComplementarySubtitleTrack

id=ID

streamNumber=Number
languageCode=token
>
Clip+

</ComplementarySubtitleTrack>

The content of ComplementarySubtitleTrack element is a list of Clip element, which shall refer to Complementary Subtitle as the Presentation Element. Player shall pre-assign Complementary Subtitle on the Title Timeline according to described in Clip element.

The Complementary Subtitle(s) assigned on a Title Timeline shall not be overlapped each other.

Complementary Subtitle shall be assigned to the specified Sub-picture Stream Number. If the Sub-picture_stream_Change API selects the stream number of Complementary Subtitle, Player shall choose the Complementary Subtitle instead of the sub-picture stream in Primary Video Set.

(a) streamNumber Attribute

Describes the Sub-picture Stream Number for this Complementary Subtitle.

(b) languageCode Attribute

Describes the specific code and the specific code extension for this Complementary Subtitle. For specific code and specific code extension, refer to Amnex B. The language code attribute value follows the following BNF scheme. The specificCode and specificCodeExt describes specific code and specific code extension, respectively.

languageCode:=specificCode ‘:’ specificCodeExtension

specificCode:=[A-Za-z] [A-Za-z0-9]

specificCodeExt:=[0-9A-F] [0-9A-F]

8) ApplicationTrack Element

The ApplicationTrack element describes the Object Mapping Information of ADV_APP in a Title.

XML Syntax Representation of ApplicationTrack element:

<ApplicationTrack

id=ID

Loading Information=anyURI

sync=(true|false)

language=string/>

The ADV_APP shall be scheduled on whole Title Timeline. If Player starts the Title playback, Player shall launch the ADV_APP according to the Loading Information file specified by Loading Information attribute. If Player exits from the Title playback, the ADV_APP in the Title shall be terminated.

If the sync attribute is ‘true’, ADV_APP shall be synchronized with time on Title Timeline.

If the sync attribute is ‘false’, ADV_APP shall run on own time.

(1) Loading Information Attribute

Describes the URI for the Loading Information file which describes the initialization information of the application.

(2) Sync Attribute

If sync attribute value is ‘true’, the ADV_APP in ApplicationTrack is Synchronized Object. If sync attribute value is ‘false’, it is Non-synchronized Object.

9) Clip Element

A Clip element describes the information of the life period (start time to end time) on Title Timeline of a Presentation Object.

XML Syntax Representation of Clip element:

<Clip

id=ID

titleTimeBegin=timeExpression

clipTimeBegin=timeExpression

titleTimeEnd=timeExpression

src=anyURI

preload=timeExpression

xml:base=anyURI>
(UnavailableAudioStream|UnavailableSubpictureStream)*

</Clip>

The life period on Title Timeline of a Presentation Object is determined by start time and end time on Title Timeline. The start time and end time on Title Timeline are described by titleTimeBegin attribute and titleTimeEnd attribute, respectively. A starting position of the Presentation Object is described by clipTimeBegin attribute. At the start time on Title Timeline, the Presentation Object shall be present at the position at the start position described by clipTimeBegin.

Presentation Object is referred by the URI of the index information file. For Primary Video Set TMAP file for P-EVOB shall be referred. For Secondary Video Set, TMAP file for S-EVOB shall be referred. For Complementary Audio and Complementary Subtitle, TMAP file for S-EVOB of the Secondary Video Set including the object shall be referred.

Attribute values of titleBeginTime, titleEndTime and clipBeginTime, and the duration time of the Presentation Object shall satisfy the following relation:

titleBeginTime<titleEndTime and

clipBegintTime+titleEndTime−titleBeginTime

≦duration time of the Presentation Object.

UnavailableAudioStream and UnavailableSubpictureStream shall be presented only for the Clip element in PremininaryVideoTrack element.

(a) titleTimeBegin Attribute

Describes the start time of the continuous fragment of the Presentation Object on the Title Timeline. The value shall be described in timeExpression value.

(b) titleTimeEnd Attribute

Describes the end time of the continuous fragment of the Presentation Object on the Title Timeline. The value shall be described in timeExpression value.

(c) clipTimeBegin Attribute

Describes the starting position in a Presentation Object. The value shall be described in timeExpression value. The clipTimeBegin can be omitted. If no clipTimeBegin attribute is presented, the starting position shall be ‘0’.

(d) src Attribute

Describes the URI of the index information file of the Presentation Object to be referred.

(e) Preload Attribute

T.B.D. Describes the time, on Title Timeline, when Player shall be start prefething the Presentation Object.

10) ClipBlock Element

ClipBlock describes a group of Clip in P-EVOBS, which is called a Clip Block. One of the Clip is chosen for presentation.

XML Syntax Representation of ClipBlock Element:

<ClipBlock>
Clip+

</ClipBlock>

All of the Clip in a ClipBlock shall have the same start time and the same end time. ClipBlock shall be scheduled on Title Timeline using the start and end time of the first child Clip. ClipBlock can be used only in PrimaryVideoTrack.

ClipBlock represents an Angle Block. According to the document order of Clip element, the Angle number for Advanced Navigation shall be assigned continuously from ‘1’.

As default, Player shall select the first Clip to be presented. If the Angle_Change API selects the specified Angle number of ClipBlock, Player shall select the corresponding Clip to be presented.

11) UnavailableAudioStream

elementUnavailableAudioStream element in a Clip element describes a Decoding Audio Stream in P-EVOBS is unavailable during the presentation period of this Clip.

XML Syntax Representation of UnavailableAudioStream element:

<UnavailableAudioStream

number=integer

/>

UnavailableAudioStream element shall be used only in a Clip element for P-EVOB, which is in a PrimaryVideoTrack element. Otherwise UnavailableAudioStream shall not presented. Player shall be disable Decoding Sub-picture Stream specified the number attribute.

12) UnavailableSubpictureStream Element

UnavailableSubpictureStream element in a Clip element describes a Decoding Sub-picture Stream in P-EVOBS is unavailable during the presentation period of this Clip.

XML Syntax Representation of UnavailableSubpictureStream element:

<UnavailableSubpictureStream

number=integer

/>

UnavailableSubpictureStream element can be used only in a Clip element for P-EVOB, which is in a PrimaryVideoTrack element. Otherwise, UnavailableSubpictureStream element shall not be presented. Player shall be disable Decoding Sub-picture Stream specified the number attribute.

13) ChapterList Element

ChapterList element in a Title element describes the Playback Sequence Information for this Title. Playback Sequence defines the chapter start position by the time value on the Title Timeline.

XML Syntax Representation of ChapterList element:

<ChapterList>
Chapter+

</ChapterList>

The ChapterList element consists of a list of Chapter element. Chapter element describes the chapter start position on the Title Timeline. According to the document order of Chapter element in ChapterList, the Chapter number for Advanced Navigation shall be assigned continuously from ‘1’.

The chapter start position in a Title Timeline shall be monotonically increased according to the Chapter number.

14) Chapter Element

Chapter element describes a chapter start position on the Title Timeline in a Playback Sequence.

XML Syntax Representaion of Chapter element:

<Chapter
id=ID
titleBeginTime=timeExpression/>

Chapter element shall have a titleBeginTime attribute. A timeExpression value of titleBeginTime attribute describes a chapter start position on the Title Timeline.

(1) titleBeginTime Attribute

Describes the chapter start position on the Title Timeline in a Playback Sequence. The value shall be described in timeExpression value defined in [6.2.3.3].

Datatypes

1) timeExpression

Describes timecode value unit 90 kHz by a non negative integer value.

Loading Information File

The Loading Information File is the initialization information of the ADV_APP for a Title. Player shall launch a ADV_APP in accordance with the information in the Loading Information file. The ADV_APP consists of a presentation of Markup file and execution of Script.

The initialization information described in a Loading Information file is as follows:
Files to be stored in File Cache initially before executing the initial markup file
Initial markup file to be executed
Script file to be executed

Loading Information File shall be encoded as well-formed XML, subject to the rules in 6.2.1 XML Document File. The document type of the Playlist file shall follow in this section.

Element and Attributes

In this section, the syntax of Loading Information file is specified using XML Syntax Representation.

1) Application Element

The Application element is the root element of the Loading Information file. It contains the following elements and attributes.

XML Syntax Representation of Application element:

<Application
Id=ID
>
   Resource*Script? Markup ? Boundary?

</Application>

2) Resource Element

Describes a file which shall be stored in a File Cache before executing the initial Markup.

XML Syntax Representation of Playlist element:

<Resource
id=ID
src=anyURI
/>

(a) src Attribute

Describes the URI for the File to be stored in a File Cache.

3) Script Element

Describes the initial Script file for the ADV_APP.

XML Syntax Representation of Script element:
<Script
   id=ID
   src=anyURI
   />

At the application startup, Script Engine shall load the script file referred by URI in the src attribute, and then execute it as global code. [ECMA 10.2.10]

(b) src Attribute

Describes the URI for the initial script file.

4) Markup Element

Describes the initial Markup file for the ADV_APP.

XML Syntax Representation of Markup element:
<Markup
   id=ID
   src=anyURI
   />

In the application startup, after the initial Script file execution if it exists, Advanced Navigation shall load the Markup file referred by URI in the src attribute.

(c) src Attribute

Describes the URI for the initial Markup file.

5) Boundary Element

T.B.D. Defines valid URL list that application can refer.

Markup File

A Markup File is the information of the Presentation Object on Graphics Plane. Only one Markup file is presented in an application at the same time. A Markup file consists of a content model, styling and timing.

For more details, see 7 Declarative Language Definition [This Markup corresponds to iHD markup]

Script File

A Script File describes the Script global code. ScriptEngine execute a Script file at the startup of the ADV_APP and waits for the event in the event handler defined by the executed Script global code. Script can control Playback Sequence and Graphics on Graphics Plane by event such as User Input Event, Player playback event.

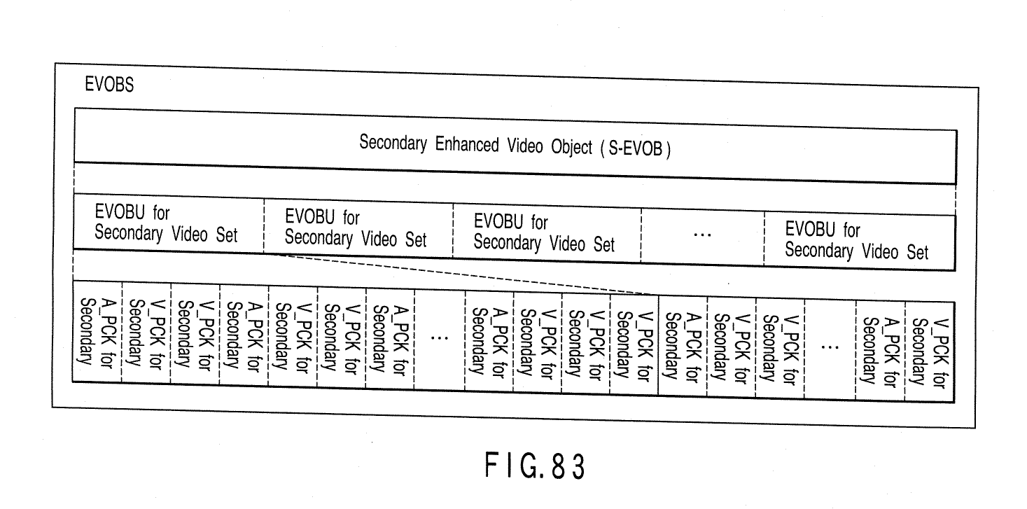

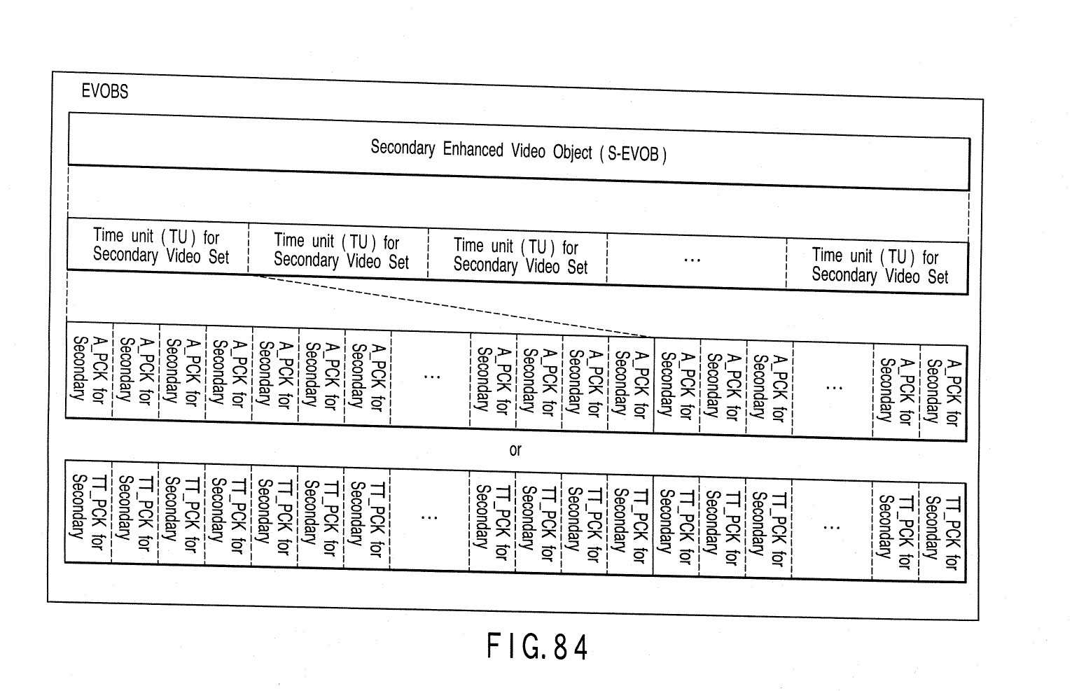

FIG. 84 is a view showing another example of a secondary enhanced video object (S-EVOB) (another example FIG. 83). In the example of FIG. 83, an S_EVOB is composed of one or more EVOBUs. However, in the example of FIG. 84, an S_EVOB is composed of one or more Time Units (TUs). Each TU may include an audio pack group for an S-EVOB (A_PCK for Secondary) or a Timed Text pack group for an S-EVOB (TT_PCK for Secondary) (for TT_PCK, refer to Table 23).

Note that a Playlist file which is described in XML (markup language) is allocated on the disc. A playback apparatus (player) of this disc is configured to play back this Playlist file first (prior to playback of the Advanced content) when that disc has the Advanced content.

This Playlist file can include the following pieces of information (see FIG. 85 to be described later):

*Object Mapping Information (information which is included in each title and is used for playback objects mapped on the timeline of this title);

*Playback Sequence (playback information for each title which is described based on the timeline of the title); and

*Configuration Information (information for system configurations such as data buffer alignment, etc.)

Note that a Primary Video Set is configured to include Video Title Set Information (VTSI), an Enhanced Video Object Set for Video Title Set (VTS_EVOBS), a Backup of Video Title Set Information (VTSI_BUP), and Video Title Set Time Map Information (VTS_TMAP).

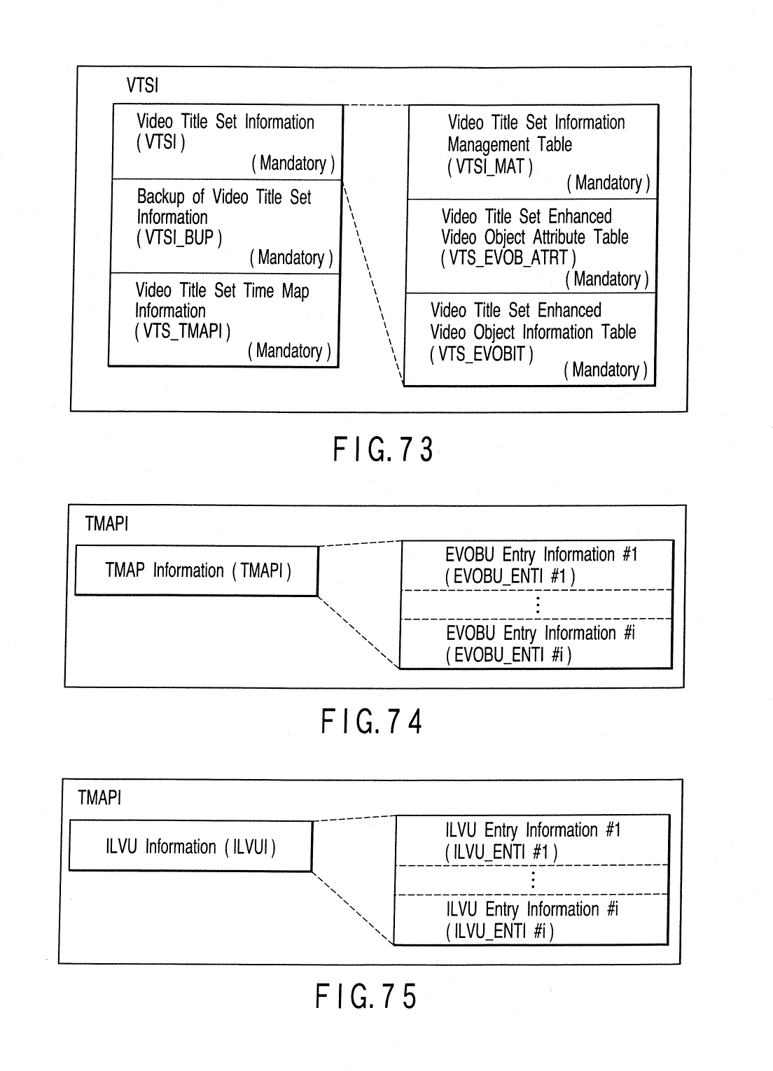

FIG. 73 is a view for explaining a configuration example of video title set information (VTSI). The VTSI describes information of one video title. This information makes it possible to describe attribute information of each EVOB. This VTSI starts from a Video Title Set Information Management Table (VTSI_MAT), and a Video Title Set Enhanced Video Object Attribute Information Table (VTS_EVOB_ATRT) and Video Title Set Enhanced Video Object Information Table (VTS_EVOBIT) follow that table. Note that each table is aligned to the boundary of neighboring logical blocks. Due to this boundary align, each table can follow up to 2047 bytes (that can include 00h).

Table 77 is a view for explaining a configuration example of the video title set information management table (VTSI_MAT).

TABLE 77
VTSI_MAT

| | | | Number | |
|---|---|---|---|---|
| RBP | | Contents | of bytes | |
| 0 to 11 | VTS_ID | VTS Identifier | 12 | bytes |
| 12 to 15 | VTS_EA | End address of VTS | 4 | bytes |
| 16 to 27 | reserved | reserved | 12 | bytes |
| 28 to 31 | VTSI_EA | End address of VTSI | 4 | bytes |
| 32 to 33 | VERN | Version number of DVD Video | 2 | bytes |
| | | Specification | | |
| 34 to 37 | VTS_CAT | VTS Category | 4 | bytes |
| 38 to 127 | reserved | reserved | 90 | bytes |
| 128 to 131 | VTSI_MAT_EA | End address of VTSI_MAT | 4 | bytes |
| 132 to 183 | reserved | reserved | 52 | bytes |
| 184 to 187 | VTS_EVOB_ATRT_SA | Start address of VTS_EVOB_ATRT | 4 | bytes |
| 188 to 191 | VTS_EVOBIT_SA | Start address of VTS_EVOBIT | 4 | bytes |
| 192 to 195 | reserved | reserved | 4 | bytes |
| 196 to 199 | VTS_EVOBS_SA | Start address of VTS_EVOBS | 4 | bytes |
| 200 to 2047 | reserved | reserved | 1848 | bytes |

In this table, a VTS_ID which is allocated first as a relative byte position (RBP) describes “ADVANCED-VTS” used to identify a VTSI file using character set codes of ISO646 (a-characters). The next VTS_EA describes the end address of a VTS of interest using a relative block number from the first logical block of that VTS. The next VTSI_EA describes the end address of VTSI of interest using a relative block number from the first logical block of that VTSI. The next VERN describes a version number of the DVD-Video specification of interest. Table 78 is a view for explaining a configuration example of a VERN.

TABLE 78

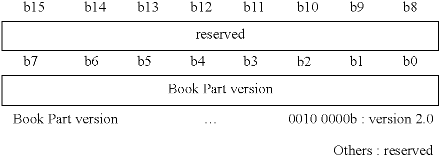

Table 79 is a view for explaining a configuration example of a video title set category (VTS_CAT). This VTS_CAT is allocated after the VERN in tables 77 and 78, and includes information bits of an Application type. With this Application type, an Advanced VTS (=0010b), Interoperable VTS (=0011b), or others can be discriminated. After the VTS_CAT in tables 77 and 78, the end address of the VTSI_MAT (VTSI_MAT_EA), the start address of the VTS_EVOB_ATRT (VTS_EVOB_ATRT_SA), the start address of the VTS_EVOBIT (VTS_EVOBIT_SA), the start address of the VTS_EVOBS (VTS_EVOBS_SA), and others (Reserved) are allocated.

TABLE 79
VTS_CAT

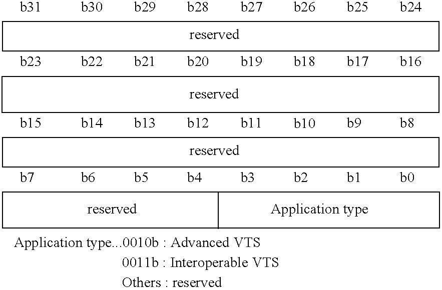

FIG. 72B is a view for explaining a configuration example of a time map (TMAP) which includes as an element time map information (TMAPI) used to convert the playback time in a primary enhanced video object (P-EVOB) into the address of an enhanced video object unit (EVOBU). This TMAP starts from TMAP General Information (TMAP_GI). A TMAPI Search pointer (TMAPI_SRP) and TMAP information (TMAPI) follow the TMAP_GI, and ILVU Information (ILVUI) is allocated at the end.

Table 80 is a view for explaining a configuration example of the time map general information (TMAP_GI).

TABLE 80
TMAP_GI

| | | Number |
|---|---|---|
| | Contents | of bytes |
| (1) TMAP_ID | TMAP Identifier | 12 bytes |
| (2) TMAP_EA | End address of TMAP | 4 bytes |
| Reserved | reserved | 2 bytes |
| (3) VERN | Version number | 2 bytes |
| (4) TMAP_TY | Attribute of TMAP | 2 bytes |
| Reserved | reserved | 28 bytes |
| Reserved | reserved for | 5 bytes |
| | VTMAP_LAST_MOD_TM | |
| (5) TMAPI_Ns | Number of TMAPIs | 2 bytes |
| (6) ILVUI_SA | Start address of ILVUI | 4 bytes |
| (7) EVOB_ATR_SA | Start address of EVOB_ATR | 4 bytes |
| reserved | reserved | 49 bytes |
| | Total | 128 bytes |

This TMAP_GI is configured to include TMAP_ID that describes “HDDVD-V_TMAP” which identifies a Time Map file by character set codes or the like of ISO/IEC 646:1983 (a-characters), TMAP_EA that describes the end address of the TMAP of interest with a relative logical block number from the first logical block of the TMAP of interest, VERN that describes the version number of the book of interest, TMAPI_Ns that describes the number of pieces of TMAPI in the TMAP of interest using numbers, ILVUI_SA that describes the start address of the ILVUI with a relative logical block number from the first logical block of the TMAP of interest, EVOB_ATR_SA that describes the start address of the EVOB_ATR of interest with a relative logical block number from the first logical block of the TMAP of interest, copy protection information (CPI), and the like. The recorded contents can be protected from illegal or unauthorized use by the copy protection information, in a time map (TMAP) basis. Here, the TMAP may be used to convert from a given presentation time inside an EVOB to the address of an EVOBU or to the address of a time unit TU (TU represents an access unit for an EVOB including no video packet).

In the TMAP for a Primary Video Set, the TMAPI_Ns is set to ‘1’. In the TMAP for a Secondary Video Set, which does not have any TMAPI (e.g., streaming of a live content), the TMAPI_Ns is set to ‘0’. If no ILVUI exists in the TMAP (that for a contiguous block), the ILVUI_SA is padded with ‘1b or FFh’ or the like. Furthermore, when the TMAP for a Primary Video Set does not include any EVOB_ATR, the EVOB_ATR is padded with ‘1b’ or the like.

Table 81 is a view for explaining a configuration example of the time map type (TMAP_TY). This TMAP_TY is configured to include information bits of ILVUI, ATR, and Angle. If the ILVUI bit in the TMAP_TY is 0b, this indicates that no ILVUI exists in the TMAP of interest, i.e., the TMAP of interest is that for a contiguous block or others. If the ILVUI bit in the TMAP_TY is 1b, this indicates that an ILVUI exists in the TMAP of interest, i.e., the TMAP of interest is that for an interleaved block.

TABLE 81
TMAP_TY

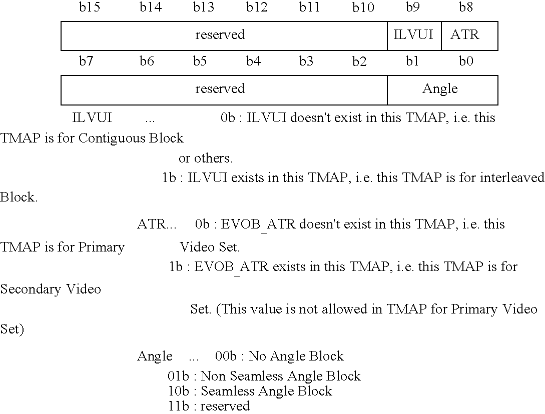

Note:
The value ‘01b’ or ‘10b’ in “Angle” may be set if the value of “Block” in ILVUI = ‘1b’.

If the ATR bit in the TMAP_TY is 0b, it specifies that no EVOB_ATR exists in the TMAP of interest, and the TMAP of interest is a time map for a Primary Video Set. If the ATR bit in the TMAP_TY is 1b, it specifies that an EVOB_ATR exists in the TMAP of interest, and the TMAP of interest is a time map for a Secondary Video Set.

If the Angle bits in the TMAP_TY are 00b, they specify no angle block; if these bits are 01b, they specify a non-seamless angle block; and if these bits are 10b, they specify a seamless angle block. The Angle bits=11b in the TMAP_TY are reserved for other purposes. Note that the value 01b or 10b in the Angle bits can be set when the ILVUI bit is 1b.

Table 82 is a view for explaining a configuration example of the time map information search pointer (TMAPI_SRP). This TMAPI_SRP is configured to include TMAPI_SA that describes the start address of the TMAPI with a relative logical block number from the first logical block of the TMAP of interest, VTS_EVOBIN that describes the number of VTS_EVOBI which is referred to by the TMAPI of interest, EVOBU_ENT_Ns that describes the number of pieces of EVOBU_ENTI for the TMAPI of interest, and ILVU_ENT_Ns that describes the number of ILVU_ENTs for the TMAPI of interest (If no ILVUI exists in the TMAP of interest (i.e., if the TMAP is for a contiguous block), the value of ILVU_ENT_Ns is ‘0’).

TABLE 82
TMAPI_SRP

| | | Number |
|---|---|---|
| | Contents | of bytes |
| (1) TMAPI_SA | Start address of the TMAPI | 4 bytes |
| (2) VTS_EVOBIN | Number of VTS_EVOBI | 2 bytes |
| (3) EVOBU_ENT_Ns | Number of EVOBU_ENT | 2 bytes |
| (4) ILVU_ENT_Ns | Number of ILVU_ENT | 2 bytes |

FIG. 74 is a view for explaining a configuration example of time map information (TMAPI of a Primary Video Set) which starts from entry information (EVOBU_ENT#1 to EVOBU_ENT#i) of one or more enhanced video object units. The TMAP information (TMAPI) as an element of a Time Map (TMAP) is used to convert the playback time in an EVOB into the address of an EVOBU. This TMAPI includes one or more EVOBU Entries. One TMAPI for a contiguous block is stored in one file, which is called TMAP. Note that one or more TMAPIs that belong to an identical interleaved block are stored in a single file. This TMAPI is configured to start from one or more EVOBU Entries (EVOBU_ENTs).

Table 83 is a view for explaining a configuration example of enhanced video object unit entry information (EVOBU_ENTI). This EVOBU_ENTI is configured to include 1STREF_SZ (Upper), 1STREF_SZ (Lower), EVOBU_PB_TM (Upper), EVOBU_PB_TM (Lower), EVOBU_SZ (Upper), and EVOBU_SZ (Lower).

TABLE 83
EVOBU Entry (EVOBU_ENT)

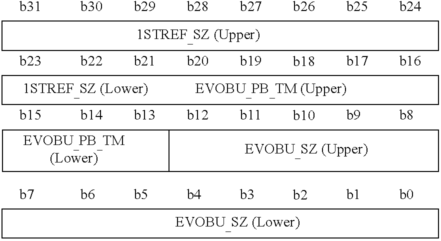

1STREF_SZ . . . Describes the size of the 1st Reference Picture of this EVOBU. The size of the 1st Reference Picture is defined as the number of packs from the first pack of this EVOBU to the pack which includes the last byte of the first encoded reference picture of this EVOBU. Note (TBD): “reference picture” is defined as one of the followings:
An I-picture which is coded as frame structure
A pair of I-pictures both of which are coded as field structure
An I-picture immediately followed by P-picture both of which are coded as field structure

EVOBU_PB_TM . . . Describes the Playback Time of this EVOBU, which is specified by the number of video fields in this EVOBU.

EVOBU_SZ . . . Describes the size of this EVOBU, which is specified by the number of packs in this EVOBU.

The 1STREF_SZ describes the size of a 1st Reference Picture of the EVOBU of interest. The size of the 1st Reference Picture can be defined as the number of packs from the first pack of the EVOBU of interest to the pack which includes the last byte of the first encoded reference picture of the EVOBU of interest. Note that “reference picture” can be defined as one of the followings:

an I-picture which is coded as a frame structure;

a pair of I-pictures which are coded as a field structure; and

an I-picture immediately followed by a P-picture, both of which are coded as a field structure.

The EVOBU_PB_TM describes the playback time of the EVOBU of interest, which can be specified by the number of video fields in the EVOBU of interest. Furthermore, the EVOBU_SZ describes the size of the EVOBU of interest, which can be specified by the number of packs in the EVOBU of interest.

FIG. 75 is a view for explaining a configuration example of the interleaved unit information (ILVUI for a Primary Video Set) which exists when time map information is for an interleaved block. This ILVUI includes one or more ILVU Entries (ILVU_ENTs). This information (ILVUI) exists when the TMAPI is for an Interleaved Block.

Table 84 is a view for explaining a configuration example of interleaved unit entry information (ILVU_ENTI). This ILVU_ENTI is configured to include ILVU_ADR that describes the start address of the ILVU of interest with a relative logical block number from the first logical block of the EVOB of interest, and ILVU_SZ that describes the size of the ILVU of interest. This size can be specified by the number of EVOBUs.

TABLE 84
ILVU_ENT

| | Contents | Number of bytes |
|---|---|---|
| (1) ILVU_ADR | Start address of the ILVU | 4 bytes |
| (2) ILVU_SZ | Size of the ILVU | 2 bytes |

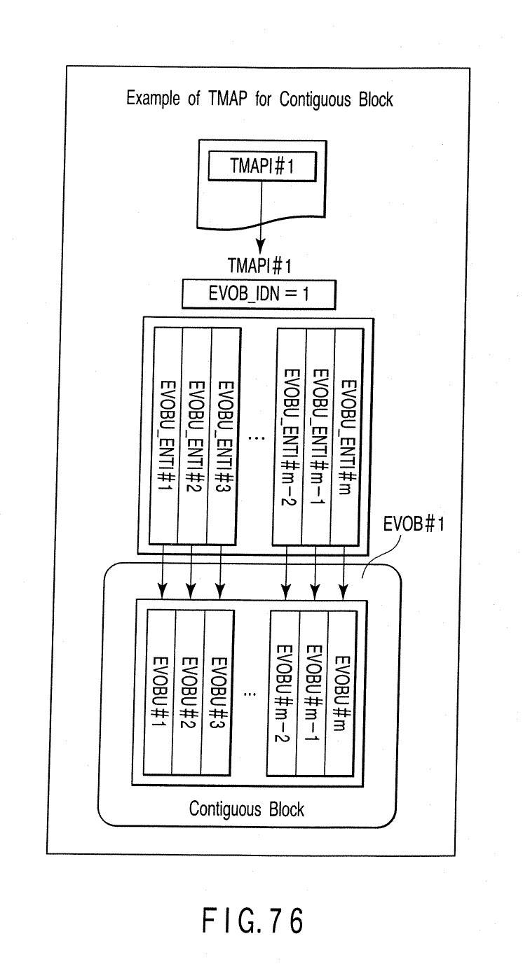

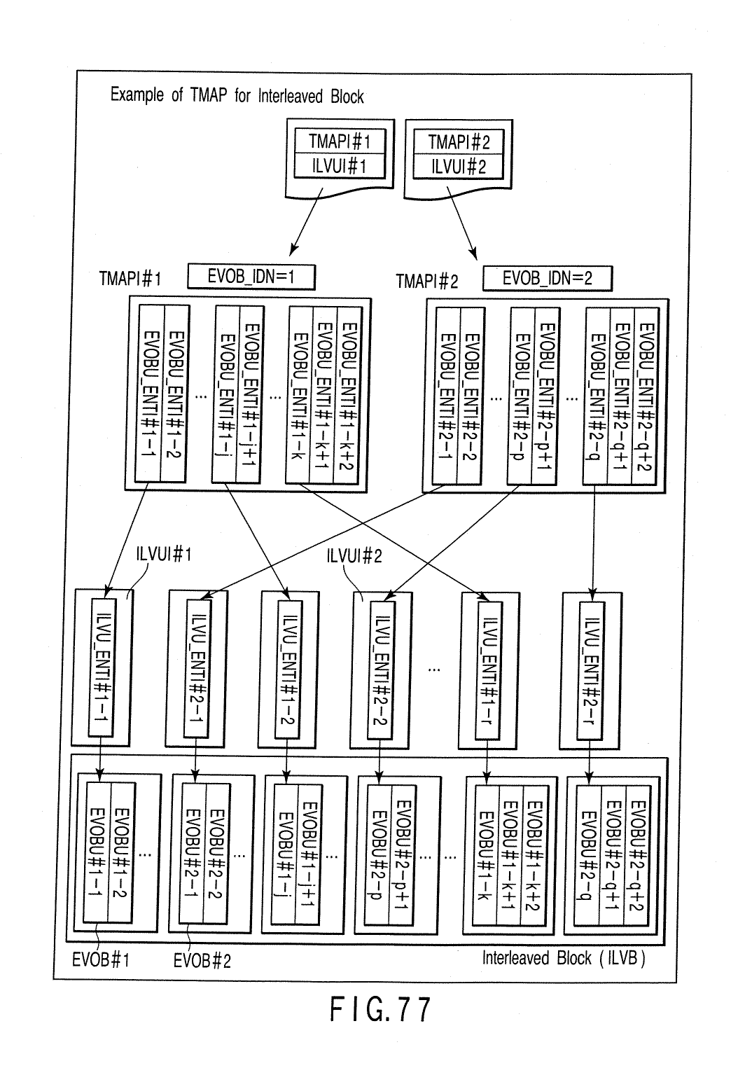

FIG. 76 is a view showing an example of a TMAP for a contiguous block. FIG. 77 is a view showing an example of a TMAP for an interleaved block. FIG. 77 shows each of a plurality of TMAP files individually has TMAPI and ILVUI.

Table 85 is a view for explaining a list of pack types in an enhanced video object. This list of pack types has a Navigation pack (NV_PCK) configured to include General Control Information (GCI) and Data Search information (DSI), a Main Video pack (VM_PCK) configured to include Video data (MPEG-2/MPEG-4 AVC/SMPTE VC-1, etc.), a Sub Video pack (VS_PCK) configured to include Video data (MPEG-2/MPEG-4 AVC/SMPTE VC-1, etc.), a Main Audio Pack (AM_PCK) configured to include Audio data (Dolby Digital Plus (DD+)/MPEG/Linear PCM/DTS-HD/Packed PCM (MLP)/SDDS (option), etc.), a Sub Audio pack (AS_PCK) configured to include Audio data (Dolby Digital Plus (DD+)/MPEG/Linear PCM/DTS-HD/Packed PCM (MLP), etc.), a Sub-picture pack (SP_PCK) configured to include Sub-picture data, and an Advanced pack (ADV_PCK) configured to include Advanced Content data.

TABLE 85
pack types

| | Data (in pack) |
|---|---|
| Navigation pack (NV_PCK) | General Control Information (GCI) and |
| | Data Search Information (DSI) |
| Main Video pack (VM_PCK) | Video data (MPEG-2/MPEG-4 |
| | AVC/SMPTE VC-1) |
| Sub Video pack (VS_PCK) | Video data (MPEG-2/MPEG-4 |
| | AVC/SMPTE VC-1) |
| Main Audio pack (AM_PCK) | Audio data (Dolby Digital Plus(DD+)/ |
| | MPEG/Linear PCM/DTS-HD/ |
| | Packed PCM (MLP)) |
| Sub Audio pack (AS_PCK) | Audio data (Dolby Digital Plus(DD+)/ |
| | MPEG/DTS-HD) |
| Sub-picture pack (SP_PCK) | Sub-picture data |
| Advanced pack (ADV_PCK) | Advanced data |

Note that the Main Video pack (VM_PCK) in the Primary Video Set follows the definition of a V_PCK in the Standard Content. The Sub Video pack in the Primary Video Set follows the definition of the V_PCK in the Standard Content, except for stream_id and P-STD_buffer_size (see FIG. 202).

Table 86 is a view for explaining a restriction example of transfer rates on streams of an enhanced video object. In this restriction example of transfer rates, an EVOB is set with a restriction of 30.24 Mbps on Total streams. A Main Video stream is set with a restriction of 29.40 Mbps (HD) or 15.00 Mbps (SD) on Total streams, and a restriction of 29.40 Mbps (HD) or 15.00 Mbps (SD) on One stream. Main Audio streams are set with a restriction of 19.60 Mbps on Total streams, and a restriction of 18.432 Mbps on One stream. Sub-picture streams are set with a restriction of 19.60 Mbps on Total streams, and a restriction of 10.08 Mbps on One stream.

TABLE 86
transfer rate

| | transfer rate | | |
|---|---|---|---|
| | Total streams | One stream | Note |
| EVOB | 30.24 Mbps | — | |
| Main Video stream | 29.40 Mbps (HD) | 29.40 Mbps (HD) | Number of streams = 1 |
| | 15.00 Mbps (SD) | 15.00 Mbps (SD) | |
| Sub Video stream | TBD | TBD | Number of streams = 1 |
| Main Audio streams | 19.60 Mbps | 18.432 Mbps | Number of streams = 8 (max) |
| Sub Audio streams | TBD | TBD | Number of streams = 8 (max) |
| Sub-picture streams | 19.60 Mbps | 10.08 Mbps*¹ | Number of streams = 32 (max) |
| Advanced stream | TBD | TBD | Number of streams = 1 (max) |

*¹The restriction on Sub-picture stream in an EVOB shall be defined by the following rule:
a) For all Sub-picture packs which have the same sub_stream_id (SP_PCK₍ᵢ₎): SCR (n) ≦ SCR (n + 100) − T_{300packs}
where
n: 1 to (number of SP_PCK₍ᵢ₎s − 100)
SCR (n): SCR of the n-th SP_PCK₍ᵢ₎
SCR (n + 100): SCR of the 100th SP_PCK₍ᵢ₎ after the n-th
SP_PCK₍ᵢ₎
T_{300packs}: value of 4388570 (= 27 × 10⁶ × 300 × 2048 × 8/30.24 × 10⁶)
b) For all Sub-picture packs (SP_PCK₍ₐₗₗ₎) in an EVOB which may be connected seamlessly with the succeeding EVOB: SCR (n) ≦ SCR (last) − T_{90packs}
where
n: 1 to (number of SP_PCK₍ₐₗₗ₎s)
SCR (n): SCR of the n-th SP_PCK₍ₐₗₗ₎
SCR (last): SCR of the last pack in the EVOB
T_{90packs}: value of 1316570 (= 27 × 10⁶ × 8 × 2048 × 90/30.24 × 10⁶)

Note: At least the first pack of the succeeding EVOB is not SP_PCK. T_{90packs} plus T_{1stpack} guarantee ten successive packs.

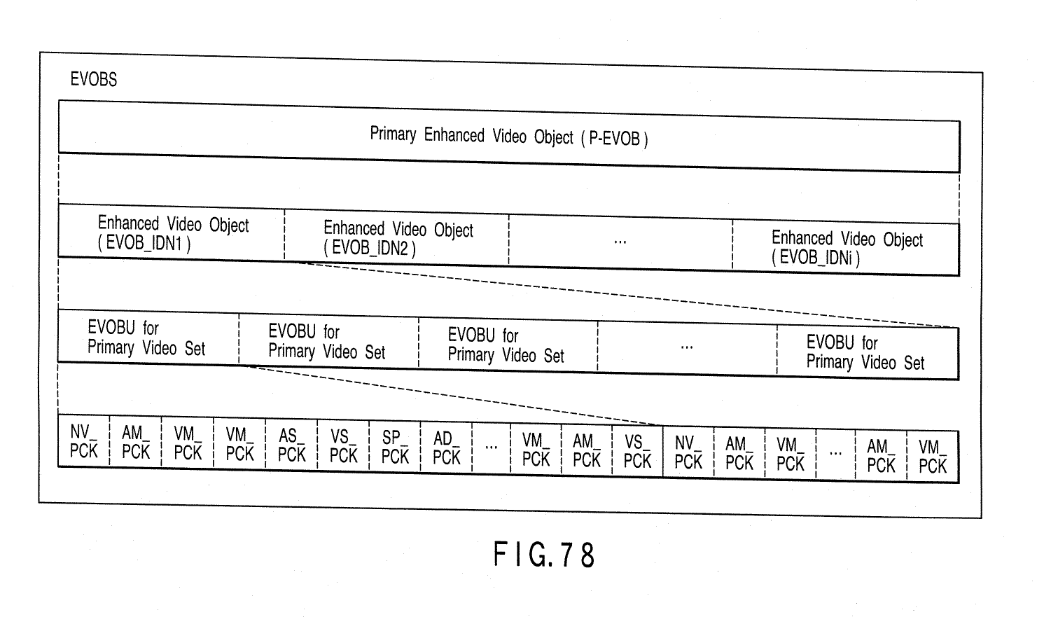

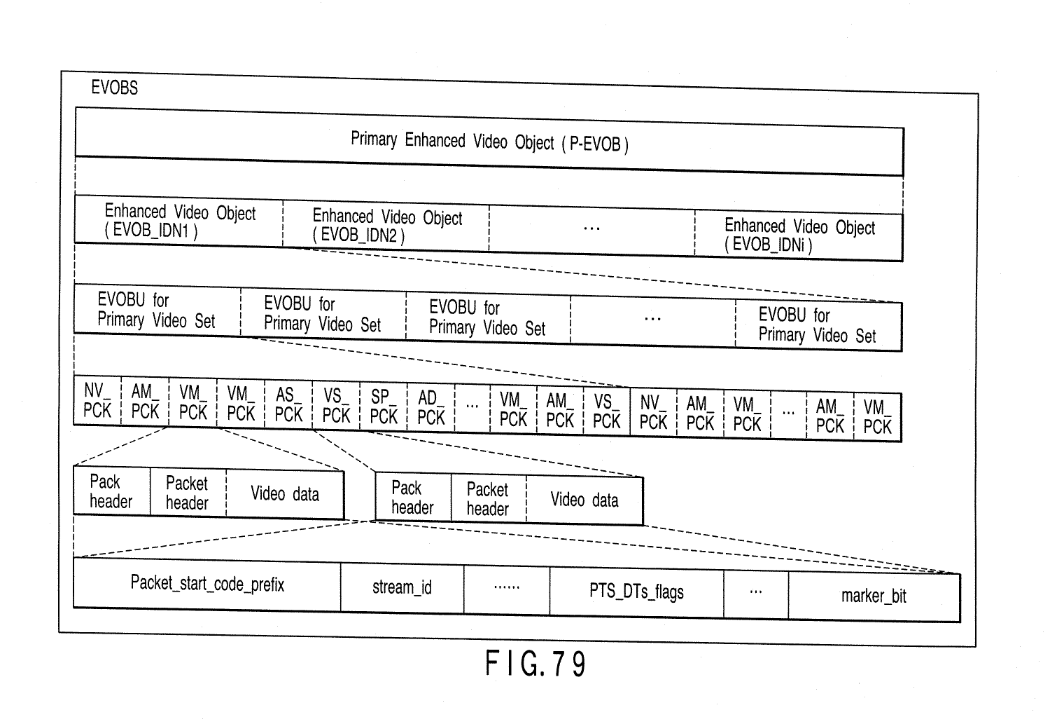

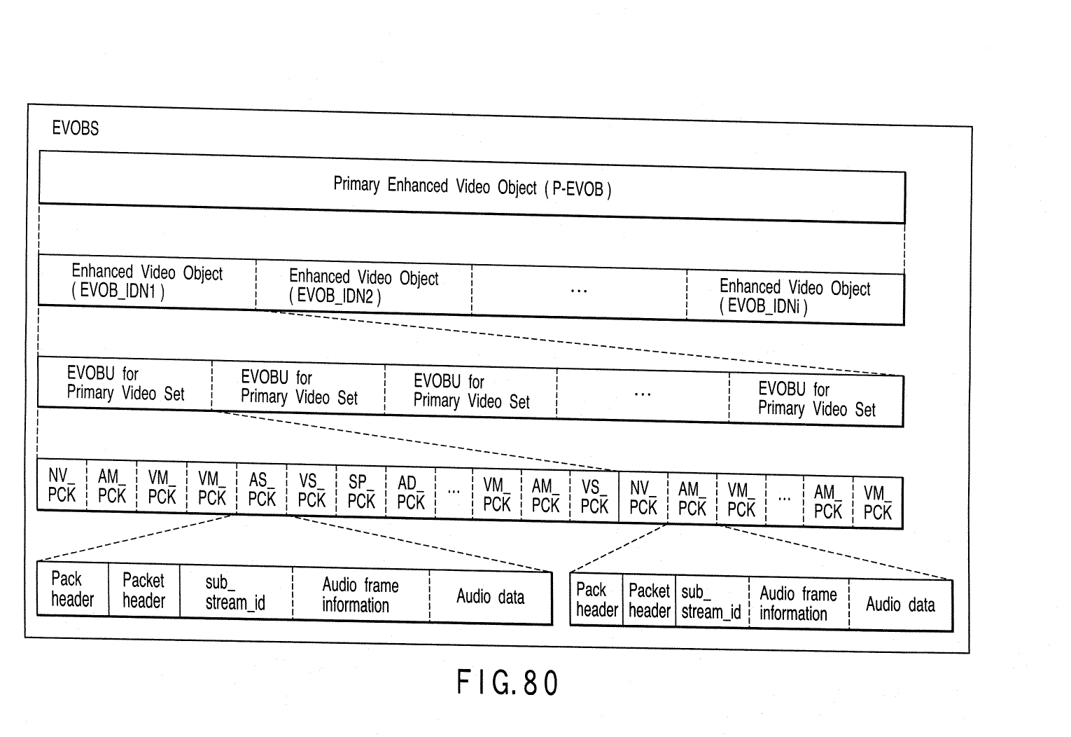

FIGS. 78, 79, and 80 are a view for explaining a configuration example of a primary enhanced video object (P-EVOB). An EVOB (this means a Primary EVOB, i.e., “P-EVOB”) includes some of Presentation Data and Navigation Data. As the Navigation Data included in the EVOB, General Control Information (GCI), Data Search Information (DSI), and the like are included. As the Presentation Data, Main/Sub video data, Main/Sub audio data, Sub-picture data, Advanced Content data, and the like are included.

An Enhanced Video Object Set (EVOBS) corresponds to a set of EVOBs, as shown in FIGS. 78, 79, and 80. The EVOB can be broken up into one or more (an integer number of) EVOBUs. Each EVOBU includes a series of packs (various kinds of packs exemplified in FIGS. 78, 79, and 80) which are arranged in the recording order. Each EVOBU starts from one NV_PCK, and is terminated at an arbitrary pack which is allocated immediately before the next NV_PCK in the identical EVOB (or the last pack of the EVOB). Except for the last EVOBU, each EVOBU corresponds to a playback time of 0.4 sec to 1.0 sec. Also, the last EVOBU corresponds to a playback time of 0.4 sec to 1.2 sec.

Furthermore, the following rules are applied to the EVOBU:

The playback time of the EVOBU is an integer multiple of video field/frame periods (even if the EVOBU does not include any video data);

The playback start and end times of the EVOBU is specified in 90-kHz units. The playback start time of the current EVOBU is set to be equal to the playback end time of the preceding EVOBU (except for the first EVOBU);

When the EVOBU includes video data, the playback start time of the EVOBU is set to be equal to the playback start time of the first video field/frame. The playback period of the EVOBU is set to be equal to or longer than that of the video data;

When the EVOBU includes video data, that video data indicates one or more PAUs (Picture Access Units);

When an EVOBU which does not include any video data follows an EVOBU which includes video data (in an identical EVOB), a sequence end code (SEQ_END_CODE) is appended after the last coded picture;

When the playback period of the EVOBU is longer than that of video data included in the EVOBU, a sequence end code (SEQ_END_CODE) is appended after the last coded picture;

Video data in the EVOBU does not have a plurality of sequence end codes (SEQ_END_CODE); and

When the EVOB includes one or more sequence end codes (SEQ_END_CODE), they are used in an ILVU. At this time, the playback period of the EVOBU is an integer multiple of video field/frame periods. Also, video data in the EVOBU has one I-picture data for a still picture, or no video data is included. The EVOBU which has one I-picture data for a still picture has one sequence end code (SEQ_END_CODE). The first EVOBU in the ILVU has video data.

Assume that the playback period of video data included in the EVOBU is the sum of the following A and B:

A. a difference between presentation time stamp PTS of the last video access unit (in the display order) in the EVOBU and presentation time stamp PTS of the first video access unit (in the display order); and

B. a presentation duration of the last video access unit (in the display order).

Each elementary stream is identified by stream_ID defined in a Program stream. Audio Presentation Data which are not defined by MPEG are stored in PES packets with stream_ID of private_stream_{—}1. Navigation Data (GCI and DSI) are stored in PES packets with stream_ID of private_stream_{—}2. The first bytes of data areas of packets of private_stream_{—}1 and private_stream_{—}2 are used to define sub_stream_ID. If stream_id is private_stream_{—}1 or private_stream_{—}2, the first byte of a data area of each packet can be assigned as sub_stream_id.

Table 87 is a view for explaining a restriction example of elements on a primary enhanced video object stream.

TABLE 87

| | EVOB |
|---|---|
| Main Video | Completed in EVOB |
| stream | The display configuration shall start from the top field and |
| | end at the bottom field when the video stream carries |
| | interlaced video. |
| | A Video stream may or may not be terminated by a |
| | SEQ_END_CODE. (refer to Annex R) |
| Sub Video | TBD |
| stream | |
| Main Audio | Completed in EVOB |
| streams | When Audio stream is for Linear PCM, the first audio |
| | frame shall be the beginning of the GOF. As for GOF, |
| | refer to 5.4.2.1 (TBD) |
| Sub Audio | TBD |
| streams | |
| Sub-picture | Completed in EVOB |
| streams | The last PTM of the last Sub-picture Unit (SPU) shall be |
| | equal to or less than the time prescribed by |
| | EVOB_V_E_PTM. As for the last PTM of SPU, refer to |
| | 5.4.3.3 (TBD) |
| | PTS of the first SPU shall be equal to or more than |
| | EVOB_V_S_PTM. |
| | Inside each Sub-picture stream, the PTS of any SPU shall |
| | be greater than PTS of the preceding SPU which has same |
| | sub_steram_id (if any). |
| Advanced | TBD |
| streams | |

Note:
The definition of “Completed” is as follows:
1) The beginning of each stream shall start from the first data of each access unit.
2) The end of each stream shall be aligned in each access unit.
Therefore, when the pack length comprising the last data in each stream is less than 2048 bytes, it shall be adjusted by either method shown in [Table 5.2.1-1] (TBD).

In this element restriction example,

as for a Main Video stream,

the Main Video stream is completed within an EVOB;

if a video stream carries interlaced video, the display configuration starts from a top field and ends at a bottom field; and

a Video stream may or may not be terminated by a sequence end code (SEQ_END_CODE).

Furthermore, as for the Main Video stream,

the first EVOBU has video data.

As for a Main Audio stream,

the Main Audio stream is completed within an EVOB; and

when an Audio stream is for Linear PCM, the first audio frame is the beginning of the GOF.

As for a Sub-picture stream,

the Sub-picture stream is completed within the EVOB;

the last playback time (PTM) of the last Sub-picture unit (SPU) is equal to or less than the time prescribed by EVOB_V_E_PTM (video end time);

the PTS of the first SPU is equal to or more than EVOB_V_S_PTM (video start time); and

in each Sub-picture stream, the PTS of any SPU is larger than that of the preceding SPU having the same sub_stream_id (if any).

Furthermore, as for the Sub-picture stream,

the Sub-picture stream is completed within a cell; and

the Sub-picture presentation is valid within the cell where the SPU is recorded.

Table 88 is a view for explaining a configuration example of a stream id and stream id extension.

TABLE 88
stream_id and stream_id_extension

| stream_id | stream_id_extension | Stream coding |
|---|---|---|
| 110x | N/A | MPEG audio stream for |
| 0***b | | Main *** = Decoding Audio |
| | | stream number |
| 110x | N/A | reserved |
| 1***b | | |
| 1110 0000b | N/A | Video stream (MPEG-2) |
| 1110 0001b | N/A | Video stream (MPEG-2) for Sub |
| 1110 0010b | N/A | Video stream (MPEG-4 AVC) |
| 1110 0011b | N/A | Video stream (MPEG-4 AVC) |
| | | for Sub |
| 1110 1000b | N/A | reserved |
| 1110 1001b | N/A | reserved |
| 1011 1101b | N/A | private_stream_1 |
| 1011 1111b | N/A | private_stream_2 |
| 1111 1101b | 101 0101b | extended_stream_id (Note) |
| | | SMPTE VC-1 video stream |
| | | for Main |
| 1111 1101b | (TBD) | extended_stream_id (Note) |
| | | SMPTE VC-1 video stream |
| | | for Sub |
| Others | | no use |

Note:
The identification of SMPTE VC-1 streams is based on the use of stream_id extensions defined by an amendment to MPEG-2 Systems [ISO/IEC 13818-1:2000/AMD2:2004]. When the stream_id is set to 0xFD (1111 1101b), it is the stream_id_extension field the one that actually defines the nature of the stream. The stream_id_extension field is added to the PES header using the PES extension flags that exist in the PES header.

In this stream_id and stream_id_extension,

stream_id=110x 0***b specifies stream_id_extension=N/A, and Stream coding=MPEG audio stream for Main ***=Decoding Audio stream number;

stream_id=110x 1***b specifies stream_id_extension=N/A, and Stream coding=MPEG audio stream for Sub;

stream_id=1110 0000b specifies stream_id_extension=N/A, and Stream coding=Video stream (MPEG-2);

stream_id=1110 0001b specifies stream_id_extension=N/A, and Stream coding=Video stream (MPEG-2) for Sub;

stream_id=1110 0010b specifies stream_id_extension=N/A, and Stream coding=Video stream (MPEG-4 AVC);

stream_id=1110 0011b specifies stream_id_extension=N/A, and Stream coding=Video stream (MPEG-4 AVC) for Sub;

stream_id=1110 1000b specifies stream_id_extension=N/A, and Stream coding=reserved;

stream_id=1110 1001b specifies stream_id_extension=N/A, and Stream coding=reserved;

stream_id=1011 1101b specifies stream_id_extension=N/A, and Stream coding=private_stream_{—}1;

stream_id=1011 1111b specifies stream_id_extension=N/A, and Stream coding=private_stream_{—}2;

stream_id=1111 1101b specifies stream_id_extension=101 0101b, and Stream coding=extended_stream_id (note) SMPTE VC-1 video stream for Main;

stream_id=1111 1101b specifies stream_id_extension=111 0101b, and Stream coding=extended_stream_id (note) SMPTE VC-1 video stream for Sub; and

stream_id=Others specifies stream coding=no use.

Note: The identification of SMPTE VC-1 streams is based on the use of stream_id extensions defined by an amendment to MPEG-2 Systems [ISO/IEC 13818-1:2000/AMD2:2004]. When the stream_ID is set to be 0xFD (1111 1101b), the stream_id_extension field is used to actually define the nature of the stream. The stream_id_extension field is added to the PES header using the PES extension flags which exist in the PES header.

Table 89 is a view for explaining a configuration example of a substream id for private stream 1.

TABLE 89
sub_stream_id for private_stream_1

| sub_stream_id | Stream coding |
|---|---|
| 001* ****b | Sub-picture stream * **** = Decoding |
| | Sub-picture stream number |
| 0100 1000b | reserved |
| 011* ****b | reserved |
| 1000 0***b | reserved |
| 1100 0***b | Dolby Digital plus (DD+) audio stream for Main *** = |
| | Decoding Audio stream number |
| 1100 1***b | Dolby Digital plus (DD+) audio stream for Sub |
| 1000 1***b | DTS-HD audio stream for Main *** = |
| | Decoding Audio stream number |
| 1001 1***b | DTS-HD audio stream for Sub |
| 1001 0***b | reserved for SDDS |
| 1010 0***b | Linear PCM audio stream for Main *** = |
| | Decoding Audio stream number |
| 1010 1***b | reserved |
| 1011 0***b | Packed PCM (MLP) audio stream for Main *** = |
| | Decoding Audio stream number |
| 1011 1***b | reserved |
| 1111 0000b | reserved |
| 1111 0001b | reserved |
| 1111 0010b | reserved |
| to 1111 0111b | |
| 1111 1111b | Provider defined stream |
| Others | reserved (for future Presentation Data) |

Note 1:
“reserved” of sub_stream_id means that the sub_stream_id is reserved for future system extension. Therefore, it is prohibited to use reserved values of sub_stream_id.
Note 2:
The sub_stream_id whose value is ‘1111 1111b’ may be used for identifying a bitstream which is freely defined by the provider. However, it is not guaranteed that every player will have a feature to play that stream. The restriction of EVOB, such as the maximum transfer rate of total streams, shall be applied, if the provider defined bitstream exists in EVOB.

In this sub_stream_id for private_stream_{—}1,

sub_stream_id=001* ****b specifies Stream coding=Sub-picture stream* ****=Decoding Sub-picture stream number;

sub_stream_id=0100 1000b specifies Stream coding=reserved;

sub_stream_id=011* ****b specifies Stream coding=reserved;

sub_stream_id=1000 0***b specifies Stream coding=reserved;

sub_stream_id=1100 0***b specifies Stream coding=Dolby Digital plus (DD+) audio stream for Main ***=Decoding Audio stream number;

sub_stream_id=1100 1***b specifies Stream coding=Dolby Digital plus (DD+) audio stream for Sub;

sub_stream_id=1000 1***b specifies Stream coding=DTS_HD audio stream for Main ***=Decoding Audio stream number;

sub_stream_id=1001 1***b specifies Stream coding=DTS_HD audio stream for Sub;

sub_stream_id=1001 0***b specifies Stream coding=reserved (SDDS);

sub_stream_id=1010 0***b specifies Stream coding=Linear PCM audio stream for Main ***=Decoding Audio stream number;

sub_stream_id=1010 1***b specifies Stream coding=Linear PCM audio stream for Sub;

sub_stream_id=1011 0***b specifies Stream coding=Packed PCM (MLP) audio stream for Main ***=Decoding Audio stream number;

sub_stream_id=1011 1***b specifies Stream coding=Packed PCM (MLP) audio stream for Sub;

sub_stream_id=1111 0000b specifies Stream coding=reserved;

sub_stream_id=1111 0001b specifies Stream coding=reserved;

sub_stream_id=1111 0010b to 1111 0111b specifies Stream coding=reserved;

sub_stream_id=1111 1111b specifies Stream coding=Provider defined stream; and

sub_stream_id=Others specifies Stream coding=reserved (for future Presentation data).

Table 90 is a view for explaining a configuration example of a substream id for private stream 2.

TABLE 90
sub_stream_id for private_stream_2

| sub_stream_id | Stream coding |
|---|---|
| 0000 0000b | reserved for PCI stream |
| 0000 0001b | DSI stream |
| 0000 0100b | GCI stream |
| 0000 1000b | reserved for HLI stream |
| 0101 0000b | Reserved |
| 1000 0000b | Advanced stream |
| 1000 1000b | Reserved |
| 1111 1111b | Provider defined stream |
| Others | reserved (for future Navigation Data) |

Note 1:
“reserved” of sub_stream_id means that the sub_stream_id is reserved for future system extension. Therefore, it is prohibited to use reserved values of sub_stream_id.
Note 2:
The sub_stream_id whose value is ‘1111 1111b’ may be used for identifying a bitstream which is freely defined by the provider. However, it is not guaranteed that every player will have a feature to play that stream. The restriction of EVOB, such as the maximum transfer rate of total streams, shall be applied, if the provider defined bitstream exists in EVOB.

In this sub_stream_id for private_stream_{—}2,

sub_stream_id=0000 0000b specifies Stream coding=reserved;

sub_stream_id=0000 0001b specifies Stream coding=DSI stream;

sub_stream_id=0000 0010b specifies Stream coding=GCI stream;

sub_stream_id=0000 1000b specifies Stream coding=reserved;

sub_stream_id=0101 0000b specifies Stream coding=reserved;

sub_stream_id=1000 0000b specifies Stream coding=Advanced stream;

sub_stream_id=1111 1111b specifies Stream coding=Provider defined stream; and

sub_stream_id=Others specifies Stream coding=reserved (for future Navigation data).

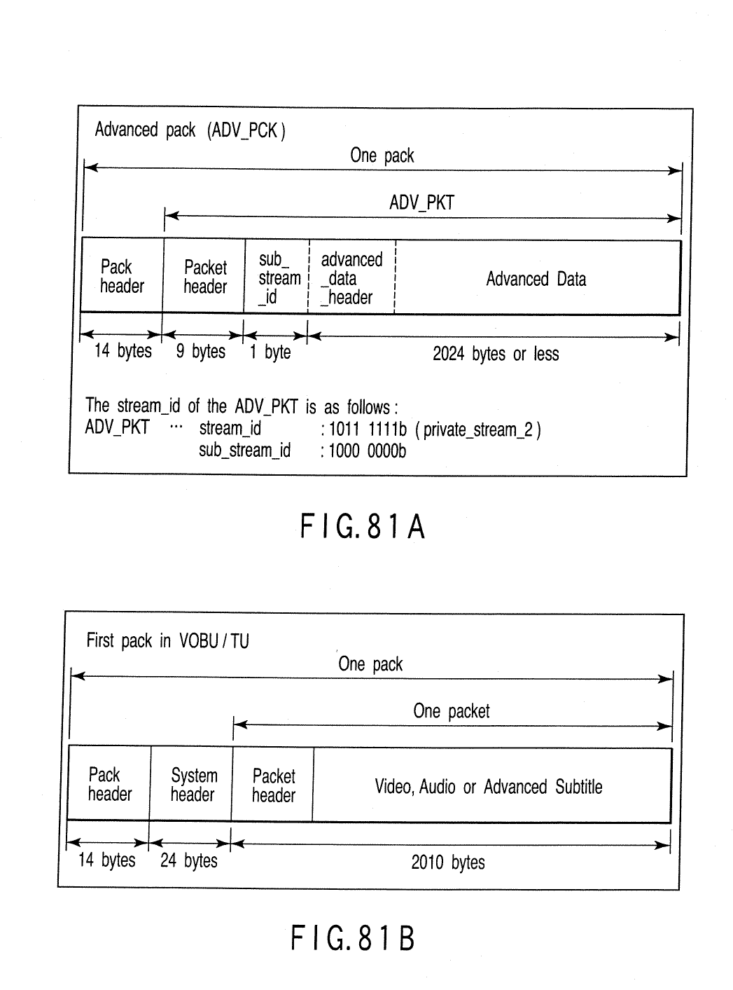

FIGS. 81A and 81B are views for explaining a configuration example of an advanced pack (ADV_PCK) and the first pack of a video object unit/time unit (VOBU/TU). An ADV_PCK in FIG. 81A comprises a pack header and Advanced packet (ADV_PKT). Advanced data (Advanced stream) is aligned to a boundary of logical blocks. Only in case of the last pack of Advanced data (Advanced stream), the ADV_PCK can have a padding packet or stuffing bytes. In this way, when the ADV_PCK length including the last data of the Advanced stream is smaller than 2048 bytes, that pack length can be adjusted to have 2048 bytes. The stream_id of this ADV_PCK is, e.g., 1011 1111b (private_stream_{—}2), and its sub_stream_id is, e.g., 1000 0000b.

A VOBU/TU in FIG. 81B comprises a pack header, System header, and VOBU/TU packet. In a Primary Video Stream, the System header (24-byte data) is carried by an NV_PCK. On the other hand, in a Secondary Video Stream, the stream does not include any NV_PCK, and the System header is carried by:

the first V_PCK in an EVOBU when an EVOB includes EVOBUs; or

the first A_PCK or first TT_PCK when an EVOB includes TUs. (TU=Time Unit will be described later using FIG. 83.)

A video pack (V_PCK) in a Secondary Video Set follows the definitions of a VS_PCK in a Primary Video Set. An audio pack (A_PCK) for a Sub Audio Stream in the Secondary Video Set follows the definition for an AS_PCK in the Primary Video Set. On the other hand, an audio pack (A_PCK) for a Complementary Audio stream in the Secondary Video Set follows the definition for an AM_PCK in the Primary Video Set.

Table 91 is a view for explaining a configuration example of an advanced packet.

TABLE 91
Advanced packet

| | | | | |
|---|---|---|---|---|
| | Number | Number | | |
| Field | of bits | of bits | Value | Comment |

Private data area

| | | | | |
|---|---|---|---|---|
| packet_start_code_prefix | 24 | 3 | 00 0001h | |
| stream_id | 8 | 1 | 1011 1111b | private_stream_2 |
| PES_packet_length | 16 | 2 | | |

Advanced data area

| | | | | |
|---|---|---|---|---|
| sub_stream_id | 8 | 1 | 1000 0000b | Advanced stream |
| PES_scrambling_control | 2 | 1 | 00b or 01b | (Note 1) |
| adv_pkt_status | 2 | | 00b, 01b, 10b | (Note 2) |
| reserved | 4 | | | |
| manifest_fname | — | 32 | | (Note 3) |

(Note 1) “PES_scrambling_control” describes the copyright state of the pack in which this packet is included. 00b: This pack has no specific data structure for copyright protection system. 01b: This pack has specific data structure for copyright protection system.
(Note 2) “advanced_pkt_status” describes position of this packet in Advanced stream. (TBD) (A) 00b: This packet is neither first packet nor last packet in Advanced stream. (B) 01b: This packet is the first packet in Advanced stream. (C) 10b: This packet is the last packet in Advanced stream. (D) 11b: reserved (E)
(Note 3) “manifest_fname” describes the filename of Manifest file which refers this advanced stream. (TBD)

In this Advanced packet, a packet_start_code_prefix field has a value “00 0001h”, a stream_id field=1011 1111b specifies private_stream_{—}2, and a PES_packet_length field is included. The Advanced packet has a Private data area, in which a sub_stream_id field=1000 0000b specifies an Advanced stream, a PES_scrambling_control field assumes a value “00b” or “01b” (Note 1), and an adv_pkt_status field assumes a value “00b”, “01b”, or “10b” (Note 2). Also, the Private data area includes a loading_info_fname field (Note 3) which describes the filename of a loading information file which refers to the advanced stream of interest.

Note 1: The “PES_scrambling_control” field describes the copyright state of the pack that includes this advanced packet: 00b specifies that the pack of interest does not have any specific data structure of a copyright protection system, and 01b specifies that the pack of interest has a specific data structure of a copyright protection system.

Note 2: The adv_pkt_status field describes the position of the packet of interest (advanced packet) in the Advanced stream: 00b specifies that the packet of interest is neither the first packet nor the last packet in the Advanced stream, 01b specifies that the packet of interest is the first packet in the Advanced stream, and 10b specifies that the packet of interest is the last packet in the Advanced stream. 11b is reserved.

Note 3: The loading_info_fname field describes the filename of loading information file that refers to the advanced stream of interest.

Table 92 is a view for explaining a restriction example of MPEG-2 video for a main video stream.

TABLE 92
MPEG-2 video for Main Video stream

| Item/TV system | 525/60 or HD/60 | 625/50 or HD/50 |
|---|---|---|
| Number of pictures in a GOP | 36 display fields/frames or less (*1) | 30 display fields/frames or less (*1) |

| | |
|---|---|
| Bit rate | Constant equal to or less than 15 Mbps (SD) or 29.40 Mbps (HD) or |
| | Variable-maximum bit rate equal to or less than 15 Mbps (SD) or |
| | 29.40 Mbps (HD) with vbv_delay coded as (FFFFh). (*2) |
| low_delay (sequence extension) | ‘0b’ (i.e “low_delay” sequences are not permitted) |
| Resolution/Frame rate/ | Same as those in Standard Content (see [Table ***]) |
| Aspect ratio | |
| Still picture | Non-support |
| Closed caption data | Support (see 5.5.1.1.4 Closed caption data) |

(*1) If frame rate is 60i or 50i, “field” is used. If frame rate is 60p or 50p, “frame” is used.
(*2) If picture resolution and frame rate are equal to or less than 720 × 480 and 29.97, respectively, it is defined as SD. If picture resolution and frame rate are equal to or less than 720 × 576 and 25, respectively, it is defined as SD. Otherwise, it is defined as HD.

In MPEG-2 video for a Main Video stream in a Primary Video Set, the number of pictures in a GOP is 36 display fields/frames or less in case of 525/60 (NTSC) or HD/60 (in this case, if the frame rate is 60 interlaced (i) or 50i, “field” is used; and if the frame rate is 60 progressive (p) or 50p, “frame” is used). On the other hand, the number of pictures in the GOP is 30 display fields/frames in case of 625/50 (PAL, etc.) or HD/50 (in this case as well, if the frame rate is 60i or 50i, “field” is used; and if the frame rate is 60p or 50p, “frame” is used).

The Bit rate in MPEG-2 video for the Main Video stream in the Primary Video Set assumes a constant value equal to or less than 15 Mbps (SD) or 29.40 Mbps (HD) in both the case of 525/60 or HD/60 and the case of 625/50 or HD/50. Alternatively, in case of a variable bit rate, a Variable-maximum bit rate is equal to or less than 15 Mbps (SD) or 29.40 Mbps (HD). In this case, dvd_delay is coded as (FFFFh). (If the picture resolution and frame rate are equal to or less than 720×480 and 29.97, respectively, SD is defined. Likewise, if the picture resolution and frame rate are equal to or less than 720×576 and 25, respectively, SD is defined. Otherwise, HD is defined.)

In MPEG-2 video for the Main Video stream in the Primary Video Set, low_delay (sequence extension) is set to ‘0b’ (i.e., “low_delay sequence” is not permitted).

In MPEG-2 video for the Main Video stream in the Primary Video Set, the Resolution (=Horizontal_size/vertical_size)/Frame rate (=frame_rate_value)/Aspect ratio are the same as those in a Standard Content. More specifically, the following variations are available if they are described in the order of Horizontal_size/vertical_size/frame_rate_value/aspect ratio_information/aspect ratio:

1920/1080/29.97/‘0011b’ or ‘0010b’/16:9;

1440/1080/29.97/‘0011b’ or ‘0010b’/16:9;

1440/1080/29.97/‘0011b’/4:3;

1280/1080/29.97/‘0011b’ or ‘0010b’/16:9;

1280/720/59.94/‘0011b’ or ‘0010b’/16:9;

960/1080/29.97/‘0011b’ or ‘0010b’/16:9;

720/480/59.94/‘0011b’ or ‘0010b’/16:9;

720/480/29.97/‘0011b’ or ‘0010b’/16:9;

720/480/29.97/‘0010b’/4:3;

704/480/59.94/‘0011b’ or ‘0010b’/16:9;

704/480/29.97/‘0011b’ or ‘0010b’/16:9;

704/480/29.97/‘0010b’/4:3;

544/480/29.97/‘0011b’ or ‘0010b’/16:9;

544/480/29.97/‘0010b’/4:3;

480/480/29.97/‘0011b’ or ‘0010b’/16:9;

480/480/29.97/‘0010b’/4:3;

352/480/29.97/‘0011b’ or ‘0010b’/16:9;

352/480/29.97/‘0010b’/4:3;

352/240 (note*1, note*2)/29.97/‘0010b’/4:3; 1920/1080/25/‘0011b’ or ‘0010b’/16:9;

1440/1080/25/‘0011b’ or ‘0010b’/16:9;

1440/1080/25/‘0011b’/4:3;

1280/1080/25/‘0011b’ or ‘0010b’/16:9;

1280/720/50/‘0011b’ or ‘0010b’/16:9;

960/1080/25/‘0011b’/16:9;

720/576/50/‘0011b’ or ‘0010b’/16:9;

720/576/25/‘0011b’ or ‘0010b’/16:9;

720/576/25/‘0010b’/4:3;

704/576/50/‘0011b’ or ‘0010b’/16:9;

704/576/25/‘0011b’ or ‘0010b’/16:9;

704/576/25/‘0010b’/4:3;

544/576/25/‘0011b’ or ‘0010b’/16:9;

544/576/25/‘0010b’/4:3;

480/576/25/‘0011b’ or ‘0010b’/16:9;

480/576/25/‘0010b’/4:3;

352/576/25/‘0011b’ or ‘0010b’/16:9;

352/576/25/‘0010b’/4:3;

352/288 (note *1)/25/‘0010b’/4:3.

Note *1: The Interlaced SIF format (352×240/288) is not adopted.

Note *2: When “vertical_size” is ‘240’, “progressive_sequence” is ‘1’. In this case, the meanings of “top_field_first” and “repeat_first_field” are different from those when “progressive_sequence” is ‘0’.

When the aspect ratio is 4:3, horizontal_size/display_horizontal_size/aspect_ratio_information are as follows (DAR=Display Aspect Ratio):

720 or 704/720/‘0010b’ (DAR=4:3);

544/540/‘0010b’ (DAR=4:3);

480/480/‘0010b’ (DAR=4:3);

352/352/‘0010b’ (DAR=4:3).

When the aspect ratio is 16:9, horizontal_size/display_horizontal_size/aspect_ratio_information/Display mode in FP_PGCM_V_ATR/VMGM_V_ATR; VTSM_V_ATR; VTS_V_ATR are as follows (DAR=Display Aspect Ratio):

1920/1920/‘0011b’ (DAR=16:9)/Only Letterbox; 1920/1440/‘0010b’ (DAR=4:3)/Only Pan-scan, or Both Letterbox and Pan-scan;

1440/1440/‘0011b’ (DAR=16:9)/Only Letterbox;

1440/1080/‘0010b’ (DAR=4:3)/Only Pan-scan, or Both Letterbox and Pan-scan;

1280/1280/‘0011b’ (DAR=16:9)/Only Letterbox;

1280/960/‘0010b’ (DAR=4:3)/Only Pan-scan, or Both Letterbox and Pan-scan;

960/960/‘0011b’ (DAR=16:9)/Only Letterbox;

960/720/‘0010b’, (DAR=4:3)/Only Pan-scan, or Both Letterbox and Pan-scan;

720 or 704/720/‘0011b’ (DAR=16:9)/Only Letterbox;

720 or 704/540/‘0010b’ (DAR=4:3)/Only Pan-scan, or Both Letterbox and Pan-scan;

544/540/‘0011b’ (DAR=16:9)/Only Letterbox;

544/405/‘0010b’ (DAR=4:3)/Only Pan-scan, or Both Letterbox and Pan-scan;

480/480/‘0011b’ (DAR=16:9)/Only Letterbox;

480/360/‘0010b’ (DAR=4:3)/Only Pan-scan, or Both Letterbox and Pan-scan;

352/352/‘0011b’ (DAR=16:9)/Only Letterbox;

352/270/‘0010b’ (DAR=4:3)/Only Pan-scan, or Both Letterbox and Pan-scan.

In Table 92, still picture data in MPEG-2 video for the Main Video stream in the Primary Video Set is not supported.

However, Closed caption data in MPEG-2 video for the Main Video stream in the Primary Video Set is supported.

Table 93 is a view for explaining a restriction example of MPEG-4 AVC video for a main video stream.

TABLE 93
MPEG-4 AVC video for Main Video stream

| | 525/60 or | 625/50 or |
|---|---|---|
| Item/TV system | HD/60 | HD/50 |
| Number of pictures | 36 display | 30 display |
| in a GOP | fields/frames or less (*1) | fields/frames or less (*1) |

| | |
|---|---|
| Bit rate | Constant equal to or less than 15 Mbps (SD) or |
| | 29.40 Mbps (HD) or |
| | Variable-maximum bit rate equal to or less than |
| | 15 Mbps (SD) or 29.40 Mbps (HD) with |
| | vbv_delay coded as (FFFFh). (*2) |
| low_delay | ‘0b’ (i.e “low_delay” sequences are not |
| (sequence | permitted) |
| extension) | |
| Resolution/Frame | Same as those in Standard Content (see [Table |
| rate/Aspect ratio | ***]) |
| Still picture | Non-support |
| Closed caption data | Support (see 5.5.1.2.4 Closed caption data) |

(*1) If frame rate is 60i or 50i, “field” is used. If frame rate is 60p or 50p, “frame” is used.
(*2) If picture resolution and frame rate are equal to or less than 720 × 480 and 29.97, respectively, it is defined as SD. If picture resolution and frame rate are equal to or less than 720 × 576 and 25, respectively, it is defined as SD. Otherwise, it is defined as HD.

In MPEG-4 AVC video for a Main Video stream in the Primary Video Set, the number of pictures in a GOP is 36 display fields/frames or less in case of 525/60 (NTSC) or HD/60. On the other hand, the number of pictures in the GOP is 30 display fields/frames or less in case of 625/50 (PAL, etc.) or HD/50.

The Bit rate in MPEG-4 AVC video for the Main Video stream in the Primary Video Set assumes a constant value equal to or less than 15 Mbps (SD) or 29.40 Mbps (HD) in both the case of 525/60 or HD/60 and the case of 625/50 or HD/50. Alternatively, in case of a variable bit rate, a Variable-maximum bit rate is equal to or less than 15 Mbps (SD) or 29.40 Mbps (HD). In this case, dvd_delay is coded as (FFFFh).

In MPEG-4 AVC video for the Main Video stream in the Primary Video Set, low_delay (sequence extension) is set to ‘0b’.

In MPEG-4 AVC video for the Main Video stream in the Primary Video Set, the Resolution/Frame rate/Aspect ratio are the same as those in a Standard Content. Note that Still picture data in MPEG-4 AVC video for the Main Video stream in the Primary Video Set is not supported. However, Closed caption data in MPEG-4 AVC video for the Main Video stream in the Primary Video Set is supported.

Table 94 is a view for explaining a restriction example of SMPTE VC-1 video for a Main Video stream.

TABLE 94
SMPTE VC-1 video for Main Video stream

| | 525/60 or | 625/50 or |
|---|---|---|
| Item/TV system | HD/60 | HD/50 |
| Number of pictures in a | 36 display | 30 display |
| GOP | fields/frames or less | fields/frames or less |

| | |
|---|---|
| Bit rate | Constant equal to or less than 15 Mbps |
| | (AP@L2) or 29.40 Mbps (AP@L3) |
| Resolution/Frame rate/ | Same as those in Standard Content (see [Table |
| Aspect ratio | ***]) |
| Still picture | Non-support |
| Closed caption data | Support (see 5.5.1.3.4 Closed caption data) |

In SMPTE VC-1 video for a Main Video stream in the Primary Video Set, the number of pictures in a GOP is 36 display fields/frames or less in case of 525/60 (NTSC) or HD/60. On the other hand, the number of pictures in the GOP is 30 display fields/frames or less in case of 625/50 (PAL, etc.) or HD/50. The Bit rate in SMPTE VC-1 video for the Main Video stream in the Primary Video Set assumes a constant value equal to or less than 15 Mbps (AP@L2) or 29.40 Mbps (AP@L3) in both the case of 525/60 or HD/60 and the case of 625/50 or HD/50.

In SMPTE VC-1 video for the Main Video stream in the Primary Video Set, the Resolution/Frame rate/Aspect ratio are the same as those in a Standard Content. Note that Still picture data in SMPTE VC-1 video for the Main Video stream in the Primary Video Set is not supported. However, Closed caption data in SMPTE VC-1 video for the Main Video stream in the Primary Video Set is supported.

Table 95 is a view for explaining a configuration example of an audio packet for DD+.

TABLE 95
Dolby Digital Plus coding

| | |
|---|---|
| Sampling frequency | 48 kHz |
| Audio coding mode | 1/0, 2/0, 3/0, 2/1, 3/1, 2/2, 3/2 Note (1) |

Note (1) All channel configurations may include an optional Low Frequency Effects (LFE) channel.
Note (1) All channel configurations may include an optional Low Frequency Effects (LFE) channel.
To support mixing of Sub Audio with the primary audio, mixing metadata shall be included in the Sub Audio stream, as defined in ETSI TS 102 366 Annex E.
The number of channels present in the Sub Audio stream shall not exceed the number of channels present in the primary audio stream.
The Sub Audio stream shall not contain channel locations that are not present in the primary audio stream.
Sub Audio with an audio coding mode of 1/0 may be panned between the Left, Center and Right, or (when primary audio does not include a center channel) the Left and Right channels of the primary audio through use of the “panmean” parameter. Valid ranges of the “panmean” value are 0 to 20 (C to R), and 220 to 239 (L to C).
Sub Audio with an audio coding mode of greater than 1/0 shall not contain panning metadata.

In this example, the sampling frequency is fixed at 48 kHz, and a plurality of audio coding modes are available. All audio channel configuration can include an optional Low Frequency Effects (LFE) channel. In order to support an environment that can mix sub audio with primary audio, mixing meta data is included in a sub audio stream. The number of channels in the sub audio stream does not exceed that in a primary audio stream. The sub audio stream does not include any channel location which does not exist in the primary audio stream. Sub audio with an audio coding mode of “1/0” may be panned between the left, center, and right channels. Alternatively, when primary audio does not include a center channel, the sub audio may be panned between the left and right channels of the primary audio through the use of a “panmean” parameter. Note that the “panmean” value has a valid range e.g., from 0 to 20 from the center to the right, and that from 220 to 239 from the center to the left. Sub audio of an audio coding mode of greater than “1/0” does not include any panning parameter.

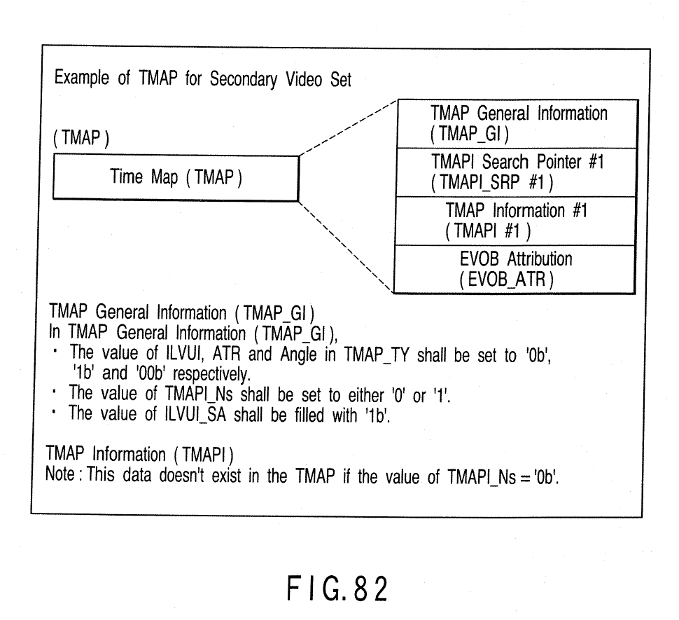

FIG. 82 is a view for explaining a configuration example of a time map (TMAP) for a Secondary Video Set. This TMAP has a configuration partially different from that for a Primary Video Set shown in FIG. 72B. More specifically, the TMAP for the Secondary Video Set has TMAP general information (TMAP_GI) at its head position, which is followed by a time map information search pointer (TMAPI_SRP#1) and corresponding time map information (TMAPI#1), and has an EVOB attribute (EVOB_ATR) at the end.

The TMAP_GI for the Secondary Video Set can have the same configuration as in Table 80. However, in this TMAP_GI, the ILVUI, ATR, and Angle values in the TMAP_TY (Table 81) respectively assume ‘0b’, ‘1b’, and ‘00b’. Also, the TMAPI_Ns value assumes ‘0’ or ‘1’. Furthermore, the ILVUI_SA value is padded with ‘1b’.

Table 96 is a view for explaining a configuration example of the TMAPI_SRP.

TABLE 96
TMAPI_SRP

| | Contents | Number of bytes |
|---|---|---|
| (1) TMAPI_SA | Start address of the TMAPI | 4 bytes |
| reserved | reserved | 2 bytes |
| (3) EVOBU_ENT_Ns | Number of EVOBU_ENT | 2 bytes |
| reserved | reserved | 2 bytes |

The TMAPI_SRP for the Secondary Video Set is configured to include TMAPI_SA that describes the start address of the TMAPI with a relative block number from the first logical block of the TMAP, EVOBU_ENT_Ns that describes the EVOBU entry number for this TMAPI, and a reserved area. If the TMAPI_Ns in the TMAP_GI (FIG. 182) is ‘0b’, no TMAPI_SRP data (FIG. 215) exists in the TMAP (FIG. 214).

Table 97 is a view for explaining a configuration example of the EVOB_ATR.

TABLE 97
TEVOB_ATR

| | Contents/Number of bytes |
|---|---|
| (1) EVOB_TY | EVOB type/1 |
| (2) EVOB_FNAME | EVOB filename/32 |
| (3) EVOB_V_ATR | Video Attribute of EVOB/4 |
| reserved | reserved/2 |
| (4) EVOB_AST_ATR | Audio stream attribute of EVOB/8 |
| (5)EVOB_MU_ASMT_ATR | Multi-channel Main Audio stream |
| | attribute of EVOB/8 |
| reserved | reserved/9 |
| | Total/64 |

The EVOB_ATR included in the TMAP (FIG. 82) for the Secondary Video Set is configured to include EVOB_TY that specifies an EVOB type, EVOB_FNAME that specifies an EVOB filename, EVOB_V_ATR that specifies an EVOB video attribute, EVOB_AST_ATR that specifies an EVOB audio stream attribute, EVOB_MU_ASMT_ATR that specifies an EVOB multi-channel main audio stream attribute, and a reserved area.

Table 98 is a view for explaining elements in the EVOB_ATR in Table 21.

TABLE 98
EVOB_TY

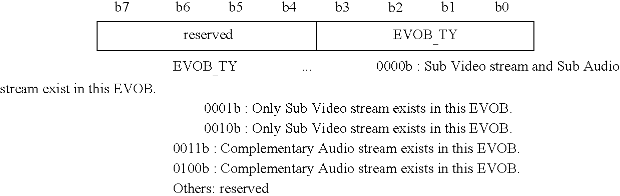

The EVOB_TY included in the EVOB_ATR in Table 97 describes existence of a Video stream, Audio streams, and Advanced stream. That is, EVOB_TY=‘0000b’ specifies that a Sub Video stream and Sub Audio stream exist in the EVOB of interest. EVOB_TY=‘0001b’ specifies that only a Sub Video stream exists in the EVOB of interest. EVOB_TY=‘0010b’ specifies that only a Sub Audio stream exists in the EVOB of interest. EVOB_TY=‘0011b’ specifies that a Complementary Audio stream exists in the EVOB of interest. EVOB_TY=‘0100b’ specifies that a Complementary Subtitle stream exists in the EVOB of interest. When the EVOB_TY assumes values other than those described above, it is reserved for other use purposes.

Note that the Sub Video/Audio stream can be used for mixing with a Main Video/Audio stream in the Primary Video Set. The Complementary Audio stream can be used for replacement with a Main Audio stream in the Primary Video Set. The Complementary Subtitle stream can be used for addition to a Sub-picture stream in the Primary Video Set.

Referring to Table 98, EVOB_FNAME is used to describe the filename of an EVOB file to which the TMAP of interest refers. The EVOB_V_ATR describes an EVOB video attribute used to define a Sub Video stream attribute in the VTS_EVOB_ATR and EVOB_VS_ATR. If the audio stream of interest is a Sub Audio stream (i.e., EVOB_TY=‘0000b’ or ‘0010b’), the EVOB_AST_ATR describes an EVOB audio attribute which is defined for the Sub Audio stream in the VTS_EVOB_ATR and EVOB_ASST_ATRT. If the audio stream of interest is a Complementary Audio stream (i.e., EVOB_TY=‘0011b’), the EVOB_AST_ATR describes an EVOB audio attribute which is defined for a Main Audio stream in the VTS_EVOB_ATR and EVOB_AMST_ATRT. The EVOB_MU_AST_ATR describes respective audio attributes for multichannel use, which are defined in the VTS_EVOB_ATR and EVOB_MU_AMST_ATRT. On the area of the Audio stream whose “Multichannel extension” in the EVOB_AST_ATR is ‘0b’, ‘0b’ is entered in every bit.

A Secondary EVOB (S-EVOB) will be summarized below. The S-EVOB includes Presentation Data configured by Video data, Audio data, Advanced Subtitle data, and the like. The Video data in the S-EVOB is mainly used to mix with that in the Primary Video Set, and can be defined according to Sub Video data in the Primary Video Set. The Audio data in the S-EVOB includes two types, i.e., Sub Audio data and Complementary Audio data. The Sub Audio data is mainly used to mix with Audio data in the Primary Video Set, and can be defined according to Sub Audio data in the Primary Video Set. On the other hand, the Complementary Audio data is mainly used to be replaced by Audio data in the Primary Video Set, and can be defined according to Main Audio data in the Primary Video Set.

Table 99 is a view for explaining a list of pack types in a secondary enhanced video object.

TABLE 99
pack types

| | Data (in pack) |
|---|---|
| Video pack | Video data (MPEG-2/MPEG-4 AVC/SMPTE VC-1) |
| (V_PCK) | |
| Audio pack | Complementary Audio data |
| (A_PCK) | (Dolby Digital Plus(DD+)/MPEG/Linear PCM/DTS- |
| | HD/Packed PCM (MLP)) |
| | Sub Audio data |
| | (Dolby Digital Plus(DD+)/DTS-HD/Others (optional)) |
| Timed Text pack | Advanced Subtitle data (Complementary Subtitle |
| (TT_PCK) | stream) |

In the Secondary Video Set, Video pack (V_PCK), Audio pack (A_PCK), and Timed Text pack (TT_PCK) are used. The V_PCK stores video data of MPEG-2, MPEG-4 AVC, SMPTE VC-1, or the like. The A_PCK stores Complementary Audio data of Dolby Digital Plus (DD+), MPEG, Linear PCM, DTS-HD, Packed PCM (MLP), or the like. The TT_PCK stores Advanced Subtitle data (Complementary Subtitle data).

FIG. 83 is a view for explaining a configuration example of a secondary enhanced video object (S-EVOB). Unlike the configuration of the P-EVOB (FIGS. 78, 79, and 80), in the S-EVOB (FIG. 83 or FIG. 84 to be described later), each EVOBU does not include any Navigation pack (NV_PCK) at its head position.

An EVOBS (Enhanced Video Set) is a collection of EVOBs, and the following EVOBs are supported by the Secondary Video Set:

an EVOB which includes a Sub Video stream (V_PCKs) and Sub Audio stream (A_PCKs);

an EVOB which includes only a Sub Video stream (V_PCKs);

an EVOB which includes only a Sub Audio stream (A_PCKs);

an EVOB which includes only a Complementary Audio stream (A_PCKs); and

an EVOB which includes only a Complementary Subtitle stream (TT_PCKs).

Note that an EVOB can be divided into one or more Access Units (AUs). When the EVOB includes V_PCKs and A_PCKs, or when the EVOB includes only V_PCKs, each Access Unit is called an “EVOBU”. On the other hand, when the EVOB includes only A_PCKs or when the EVOB includes only TT_PCKS, each Access Unit is called a “Time Unit (TU)”.

An EVOBU (Enhanced Video Object Unit) includes a series of packs which are arranged in a recording order, starts from a V_PCK including a System header, and includes all subsequent packs (if any). The EVOBU is terminated at a position immediately before the next V_PCK that includes a System header in the identical EVOB or at the end of that EVOB.

Except for the last EVOBU, each EVOBU of the EVOB corresponds to a playback period of 0.4 sec to 1.0 sec. Also, the last EVOBU of the EVOB corresponds to a playback period of 0.4 sec to 1.2 sec. The EVOB includes an integer number of EVOBUs.

Each elementary stream is identified by the stream_ID defined in a Program stream. Audio Presentation data which are not defined by MPEG can be stored in PES packets with the stream_id of private_stream_{—}1.

Advanced Subtitle data can be stored in PES packets with the stream_id of private_stream_{—}2. The first bytes of data areas of packets of private_stream_{—}1 and private_stream_{—}2 can be used to define the sub_stream_id. FIG. 220 shows a practical example of them.

Table 100 is a view for explaining a configuration example of the stream_id and stream_id extension, that of the substream_id for private_stream_{—}1, and that of the substream_id for private_stream_{—}2.

TABLE 100
stream_id and stream_id_extension

| Stream_id | stream_id_extension | Stream coding |
|---|---|---|
| 1110 1000b | N/A | Video stream (MPEG-2) |
| 1110 1001b | N/A | Video stream (MPEG-4 AVC) |
| 1011 1101b | N/A | private_stream_1 |
| 1011 1111b | N/A | private_stream_2 |
| 1111 1101b | TBD | extended_stream_id (Note) |
| | | SMPTE VC-1 video stream |
| Others | | reserved |

| | |
|---|---|
| sub_stream_id | Stream coding |

sub_stream_id for private_stream_1

| | |
|---|---|
| 1111 0000b | Dolby Digital plus (DD+) audio stream |
| 1111 0001b | DTS-HD audio stream |
| 1111 0010b | reserved for other audio stream |
| to 1111 0111b | |
| 1111 1111b | Provider defined stream |
| Others | reserved |

sub_stream_id for private_stream_2

| | |
|---|---|
| 1000 1000b | Complementary Subtitle stream |
| 1111 1111b | Provider defined stream |
| Others | reserved |

The stream_id and stream_id_extension can have a configuration, as shown in, e.g., Table 100(a) (in this example, the stream_id_extension is not applied or is optional). More specifically, stream_id=‘1110 1000b’ specifies Stream coding=‘Video stream (MPEG-2)’; stream_id=‘1110 1001b’, Stream coding=‘Video stream (MPEG-4 AVC)’; stream_id=‘1011 1101b’, Stream coding=‘private_stream_{—}1’; stream_id=‘1011 1111b’, Stream coding=‘private_stream_{—}2’; stream_id=‘1111 1101b’, Stream coding=‘extended_stream_id (SMPTE VC-1 video stream)’; and stream_id=others, Stream coding=reserved for other use purposes.

The sub_stream_id for private_stream_{—}1 can have a configuration, as shown in, e.g., Table. 100(b). More specifically, sub_stream_id=‘1111 0000b’ specifies Stream coding=‘Dolby Digital plus (DD+) audio stream’; sub_stream_id=‘1111 0001b’, Stream coding=‘DTS-HD audio stream’; sub_stream_id=‘1111 0010b’ to ‘1111 0111b’, Stream coding=reserved for other audio streams; and sub_stream_id=others, Stream coding=reserved for other use purposes.

The sub_stream_id for private_stream_{—}2 can have a configuration, as shown in, e.g., FIG. Table 100(c). More specifically, sub_stream_id=‘0000 0010b’ specifies Stream coding=GCI stream; sub_stream_id=‘1111 1111b’, Stream coding=Provider defined stream; and sub_stream_id=others, Stream coding=reserved for other purposes.

Some of the following files may be archived as a file by using (TBD) without any compression.
Manifest (XML)
Markup (XML)
Script (ECMAScript)
Image (JPEG/PNG/MNG)
Audio for effect sound (WAV)
Font (OpenType)
Advanced Subtitle (XML)

In this specification, the archived file is called as Advanced stream. The file may be located on a disc (under ADV_OBJ directory) or may be delivered from a server. Also, the file may be multiplexed into an EVOB of Primary Video Set, and in this case, the file is split into packs called as Advanced pack (ADV_PCK).

FIG. 85 is a view for explaining a configuration example of the playlist. Object Mapping information, a Playback Sequence, and Configuration information are respectively described in three areas designated under a root element.

This playlist file can include the following information:
Object Mapping Information (playback object information which exists in each title, and is mapped on the time line of this title);
Playback Sequence (title playback information described on the time line of the title); and
Configuration Information (system configuration information such as data buffer alignment).

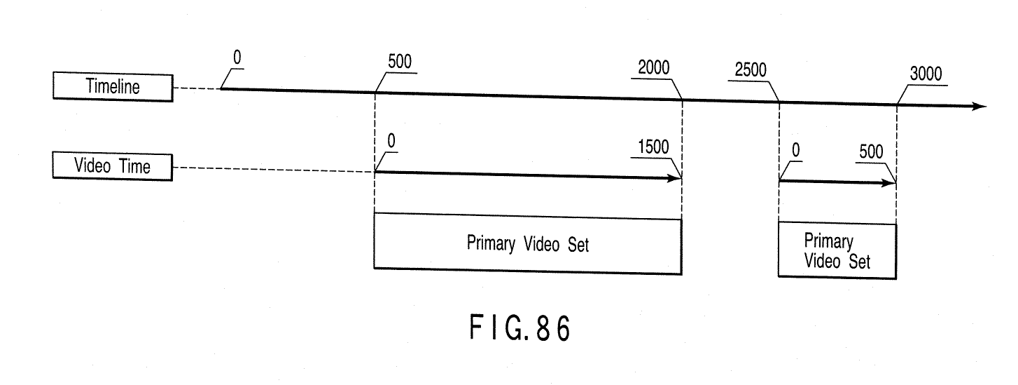

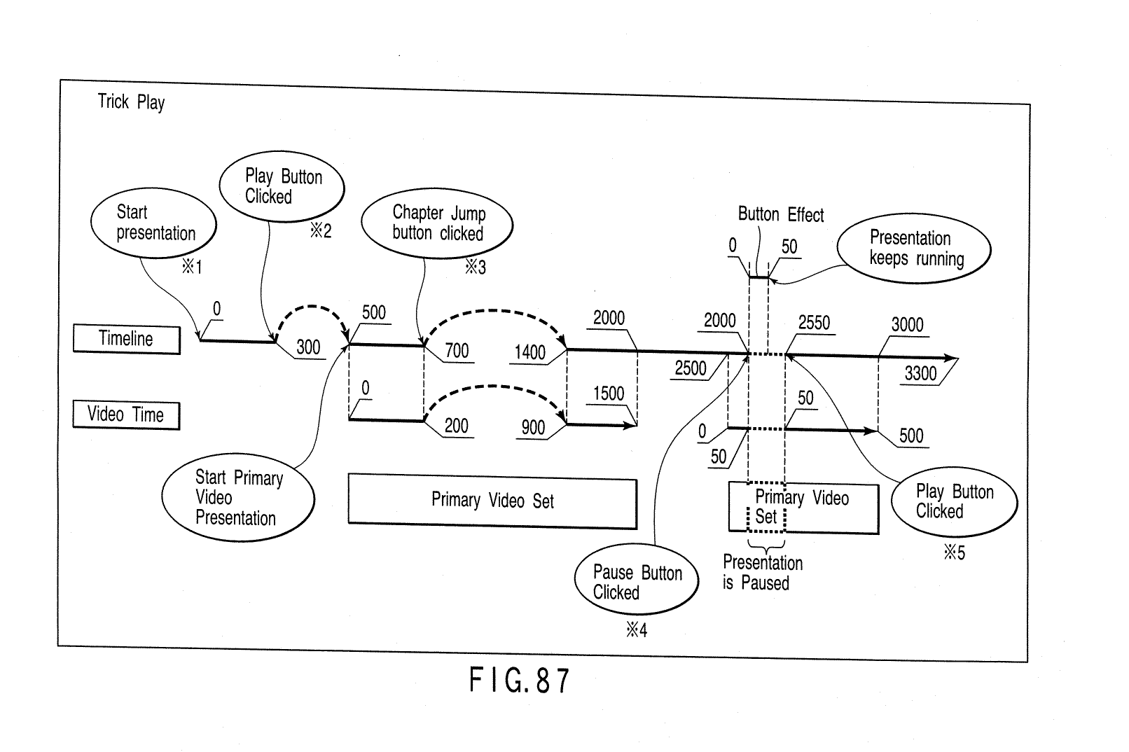

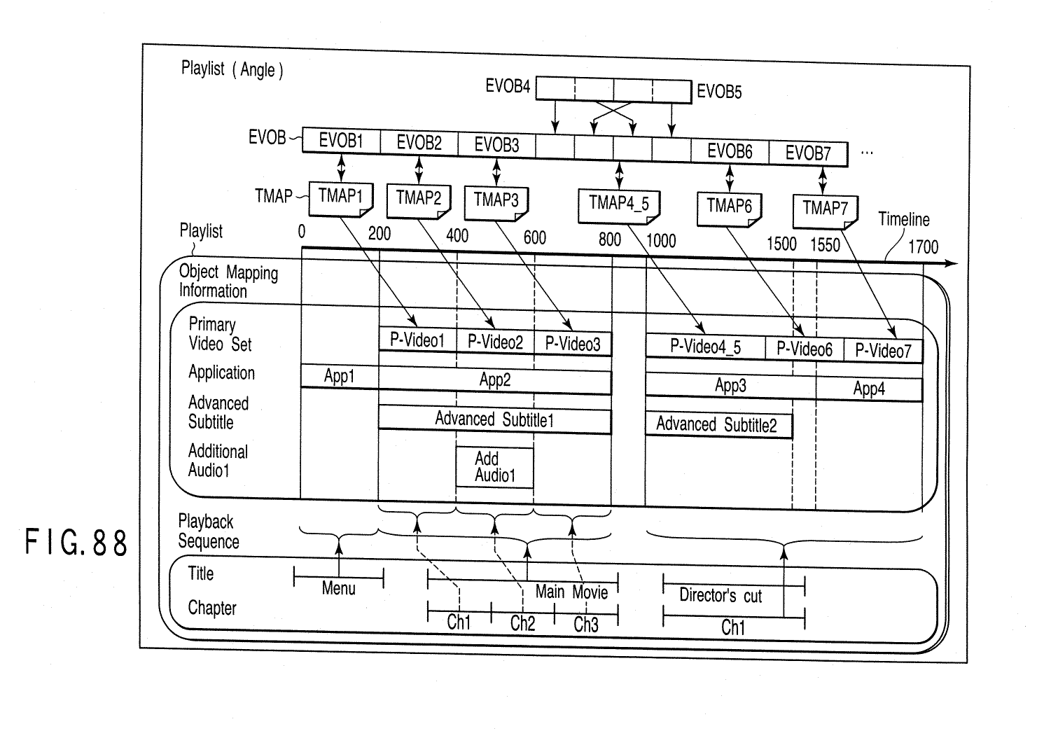

FIGS. 86 and 87 are views for explaining the Timeline used in the Playlist. FIG. 86 is a view for explaining an example of the Allocation of Presentation Objects on the timeline. Note that the timeline unit can use a video frame unit, second (millisecond) unit, 90-kHz/27-MHz-based clock unit, unit specified by SMPTE, and the like. In the example of FIG. 86, two Primary Video Sets having durations “1500” and “500” are prepared, and are allocated on a range from 500 to 1500 and that from 2500 to 3000 on the Timeline. By allocating the Objects having different durations on the Timeline as one timeline, these Objects can be played back compatibly. Note that the timeline is configured to be reset to zero for each playlist to be used.

FIG. 87 is a view for explaining an example when trick play (chapter jump or the like) of a presentation object is made on the timeline. FIG. 87 shows an example of the way the time gains on the Timeline upon execution of an actual presentation operation. That is, when presentation starts, the time on the Timeline begins to gain (*1). Upon depression of a Play button at time 300 on the Timeline (*2), the time on the Timeline jumps to 500, and presentation of the Primary Video Set starts. After that, upon depression of a Chapter Jump button at time 700 (*3), the time jumps to the start position of the corresponding Chapter (time 1400 on the Timeline), and presentation starts from there. After that, upon clicking a Pause button (by the user of the player) at time 2550 (*4), presentation pauses after the button effect is validated. Upon clicking the Play button at time 2550 (*5), presentation restarts.

FIG. 88 is a view for explaining a configuration example of a Playlist when EVOBs have interleaved angle blocks. Each EVOB has a corresponding TMAP file. However, information of EVOB4 and EVOB5 as interleaved angle blocks is written in a single TMAP file. By designating individual TMAP files by Object Mapping Information, the Primary Video Set is mapped on the Timeline. Also, Applications, Advanced subtitles, Additional Audio, and the like are mapped on the Timeline based on the description of the Object Mapping Information in the Playlist.

In FIG. 88, a Title (a Menu or the like as its use purpose) having no Video or the like is defined as App1 between times 0 and 200 on the Timeline. Also, during a period of times 200 to 800, App2, P-Video1 (Primary Video 1) to P-Video3, Advanced Subtitle1, and Add Audio1 are set. During a period of times 1000 to 1700, P-Video4_5 including EVOB4 and EVOB5, P-Video6, P-Video7, App3 and App4, and Advanced Subtitle2, which form the angle block, are set.

The Playback Sequence defines that App1 configures a Menu as one title, App2 configures a Main Movie, and App3 and App4 configure a Director's cut. Furthermore, the Playback Sequence defines three Chapters in the Main Movie, and one Chapter in the Director's cut.

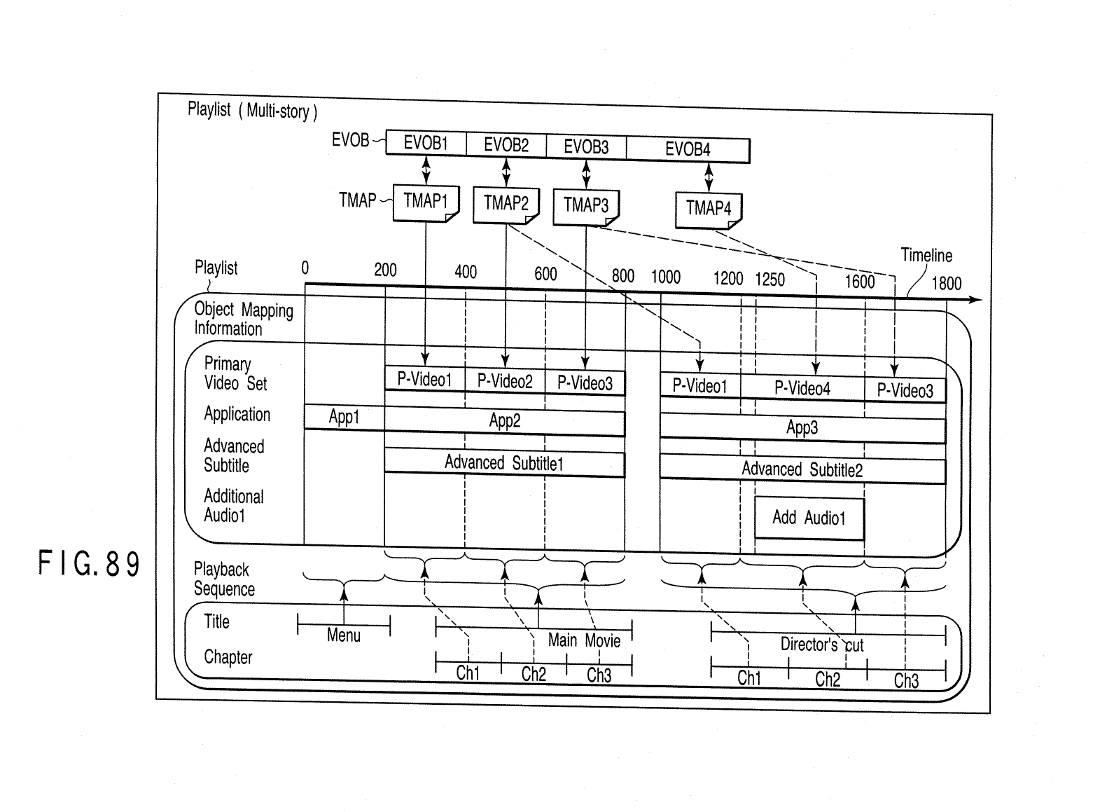

FIG. 89 is a view for explaining a configuration example of a playlist when an object includes multi-story. FIG. 89 shows an image of the Playlist upon setting Multi-story. By designating TMAPs in Object Mapping Information, these two titles are mapped on the Timeline. In this example, Multi-story is implemented by using EVOB1 and EVOB3 in both the titles, and replacing EVOB2 and EVOB4.

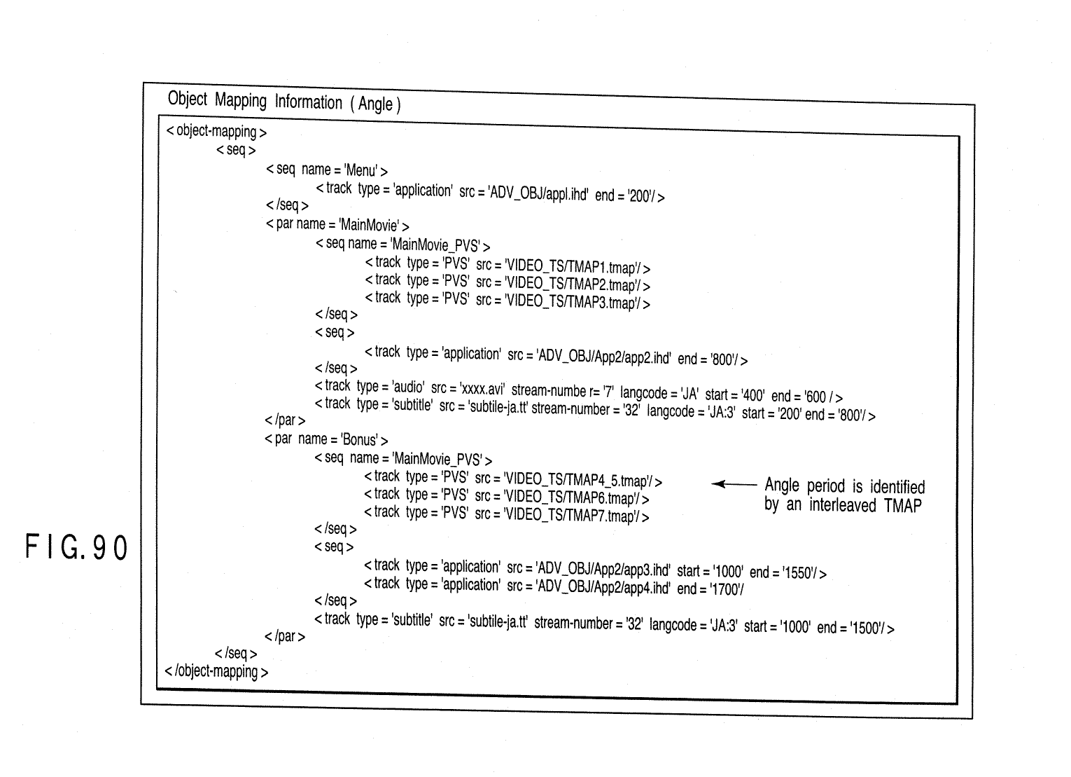

FIG. 90 is a view for explaining a description example (when an object includes angle information) of object mapping information in the playlist. FIG. 90 shows a practical description example of the Object Mapping Information in FIG. 88.

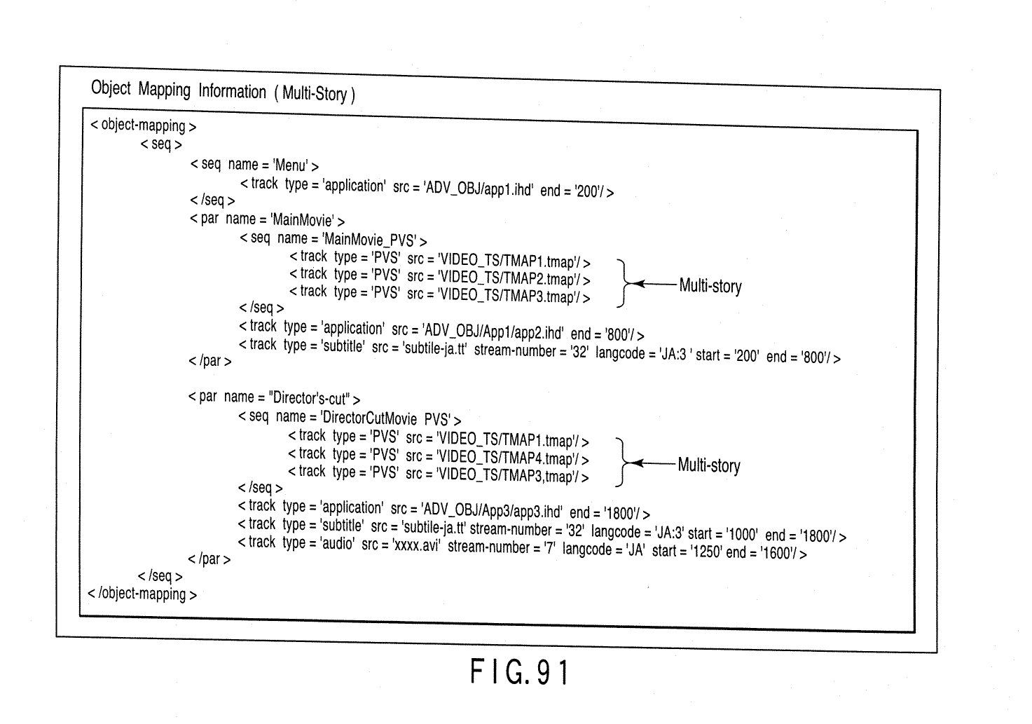

FIG. 91 is a view for explaining a description example (when an object includes multi-story) of object mapping information in the playlist. FIG. 91 shows a description example of Object Mapping Information upon setting Multi-Story in FIG. 89. Note that a seq element means its child elements are sequentially mapped on the Timeline, and a par element means that its child elements are simultaneously mapped on the Timeline. Also, a track element is used to designate each individual Object, and the times on the Timeline are expressed also using start and end attributes.

At this time, when objects are successively mapped on the Timeline like App1 and App2 in FIG. 88, an end attribute can be omitted. Also, when objects are mapped to have a gap like App2 and App3, their times are expressed using the end attribute. Furthermore, using a name attribute set in the seq and par elements, the state during current presentation can be displayed on (a display panel of) the player or an external monitor screen. Note that Audio and Subtitle can be identified using Stream numbers.

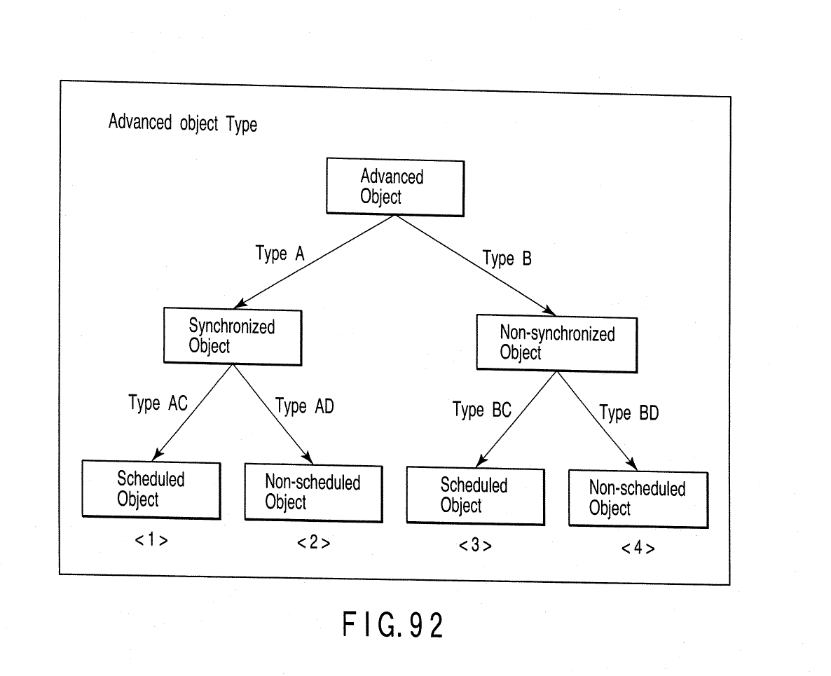

FIG. 92 is a view for explaining examples (four examples in this case) of an advanced object type. Advanced objects can be classified into four Types, as shown in FIG. 92. Initially, objects are classified into two types depending on whether an object is played back in synchronism with the Timeline or an object is asynchronously played back based on its own playback time. Then, the objects of each of these two types are classified into an object whose playback start time on the Timeline is recorded in the Playlist, and which begins to be played back at that time (scheduled object), and an object which has an arbitrary playback start time by, e.g., a user's operation (non-scheduled object).

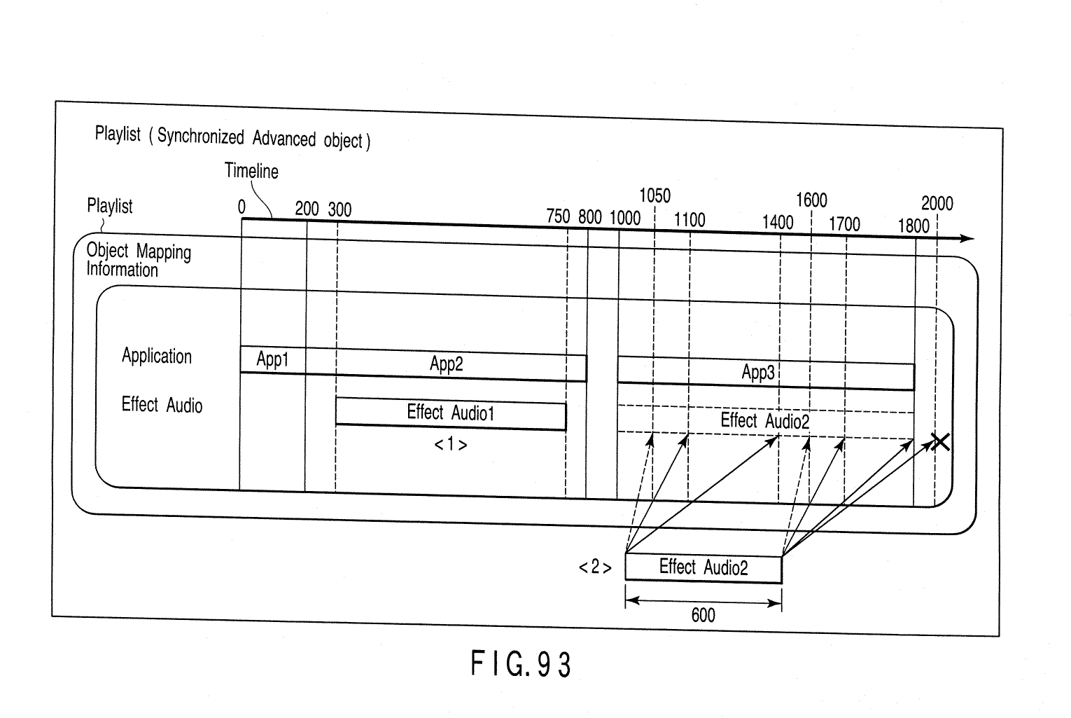

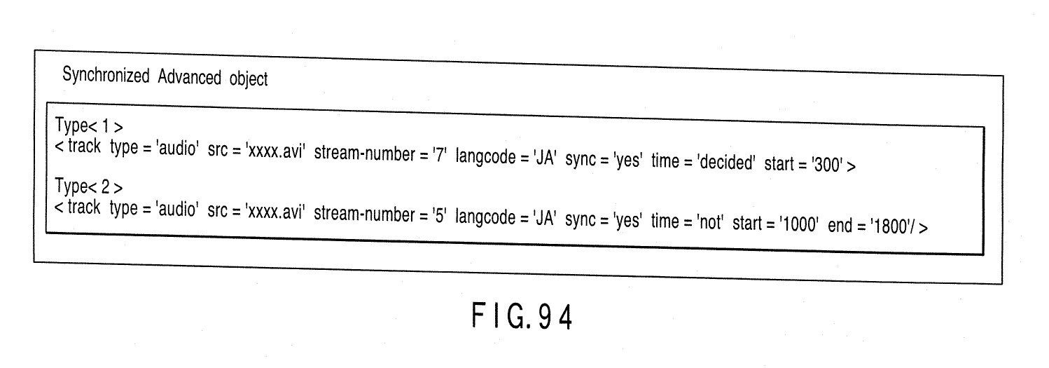

FIG. 93 is a view for explaining a description example of a playlist in case of a synchronized advanced object. FIG. 93 exemplifies cases <1> and <2> which are to be played back in synchronism with the Timeline of the aforementioned four types. In FIG. 93, an explanation is given using Effect Audio. Effect Audio1 corresponds to <1>, and Effect Audio2 corresponds to <2> in FIG. 94. Effect Audio1 is a model whose start and end times are defined. Effect Audio2 has its own playback duration “600”, and its playable time period has an arbitrary start time by a user's operation during a period from 1000 to 1800.

When App3 starts from time 1000 and presentation of Effect Audio2 starts at time 1050, they are played back until time 1650 on the Timeline in synchronism with it. When the presentation of Effect Audio2 starts from time 1100, it is similarly synchronously played back until time 1700. However, presentation beyond the Application produces conflict if another Object exists. Hence, a restriction for inhibiting such presentation is set. For this reason, when presentation of Effect Audio2 starts from time 1600, it will last until time 2000 based on its own playback time, but it ends at time 1800 as the end time of the Application in practice.

FIG. 94 is a view for explaining a description example of a playlist in case of a synchronized advanced object. FIG. 94 shows a description example of track elements for Effect Audio1 and Effect Audio2 used in FIG. 93 when Objects are classified into types. Selection as to whether or not to be synchronized with the Timeline can be defined using a sync attribute. Whether the playback period is determined on the Timeline or it can be selected within a playable time by, e.g., a user's operation can be defined using a time attribute.

Network

This chapter describes the specification of network access functionality of HD DVD player. In this specification, the following simple network connection model is assumed. The minimum requirements are:
The HD DVD player is connected to the Internet.
Name resolution service such as DNS is available to translate domain names to IP addresses.
512 kbs downstream throughput is guaranteed at the minimum. Throughput is defined as the amount of data transmitted successfully from a server in the Internet to a HD DVD player in a given time period. It takes into account retransmission due to errors and overheads such as session establishment.

In terms of buffer management and playback timing, HD DVD shall support two types of downloading: complete downloading and streaming (progressive downloading). In this specification, these terms are defined as follows:
Complete downloading: The HD DVD player has enough buffer size to store whole of the file. The transmission of an entire file from a server to the player completes before playback of the file. Advance Navigations, Advanced Elements and archives of these files are downloaded by complete downloading. If the file size of Secondary Video Set is small enough to be stored in File Cache (a part of Data Cache), it also can be downloaded by complete downloading.
Streaming (progressive downloading): The buffer size prepared for the file to be downloaded may be smaller than the file size. Using the buffer as a ring buffer, the player playbacks the file while the downloading continues. Only Secondary Video Set is downloaded by streaming.

In this chapter, “downloading” is used to indicate both of the above two. When the two types of downloading need to be differentiated, “complete downloading” and “streaming” are used.

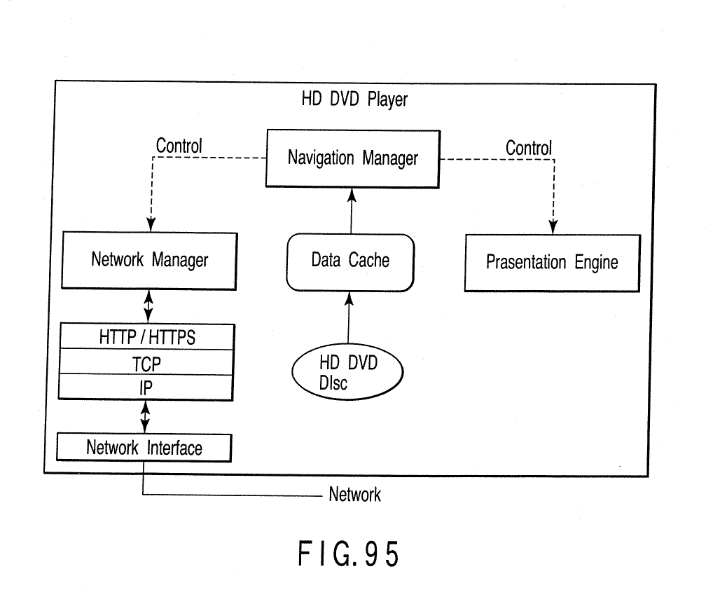

The typical procedure for streaming of Secondary Video Set is explained in FIG. 95. After the server-player connection is established, a HD DVD player requests a TMAP file using HTTP GET method. Then, as the response of the request, the server sends the TMAP file by complete downloading. After receiving the TMAP file, the player sends a message to the server which requests the Secondary Video Set corresponding to the TMAP. After the server transmission of the requested file begins, the player starts playback of the file without waiting completion of the download. For synchronized playback of downloaded contents, the timing of network access, as well as the presentation timing, should be pre-scheduled and explicitly described in Playlist (TBD). This pre-scheduling enables us to guarantee data arrival before they are processed by Presentation Engine and Navigation Manager.

Server and Disc Certification

Procedure to Establish Secure Connection

To ensure secure communication between a server and a HD DVD player, authentication process should be prior to data communication. At first, server authentication must be processed using HTTPS. Then, HD DVD disc is authenticated. The disc authentication process is optional and triggered by servers. Request of disc authentication is up to servers, but all HD DVD players have to behave as specified in this specification if it is required.

Server Authentication

At the beginning of network communication, HTTPS connection should be established. During this process, a server should be authenticated using the Server Certificate in SSL/TLS handshake protocol.

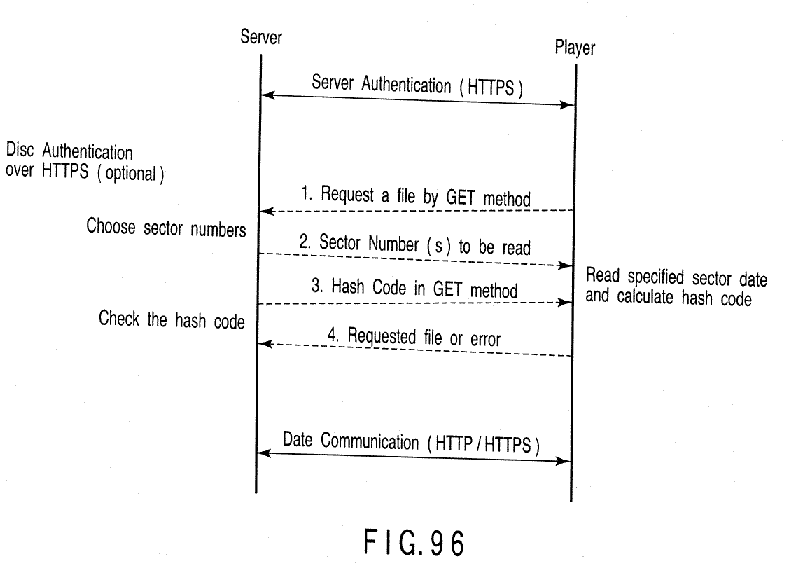

Disc Authentication (FIG. 96)

Disc Authentication is optional for servers while all HD DVD players should support Disc Authentication. It is server's responsibility to determine the necessity of Disc Authentication.

Disc Authentication consists of the following steps:

1. A player sends a HTTP GET request to a server.

2. The server selects sector numbers used for Disc Authentication and sends a response message including them.

3. When the player receives sector numbers, it reads the raw data of the specified sector number and calculates a hash code. The hash code and the sector numbers are attached to the next HTTP GET request to the server.

4. If the hash code is correct, the server sends the requested file as a response. When the hash code is not correct, the server sends an error response.

The server can re-authenticate the disc by sending a response message including sector numbers to be read at any time. It should be taken into account that the Disc Authentication may break continuous playback because it requires random disc access. Message format for each steps and a hash function is T.B.D.

Walled Garden List

The walled garden list defines a list of accessible network domains. Access to network domains which are not listed on this list is prohibited. Details of walled garden list is TBD.

Download Model

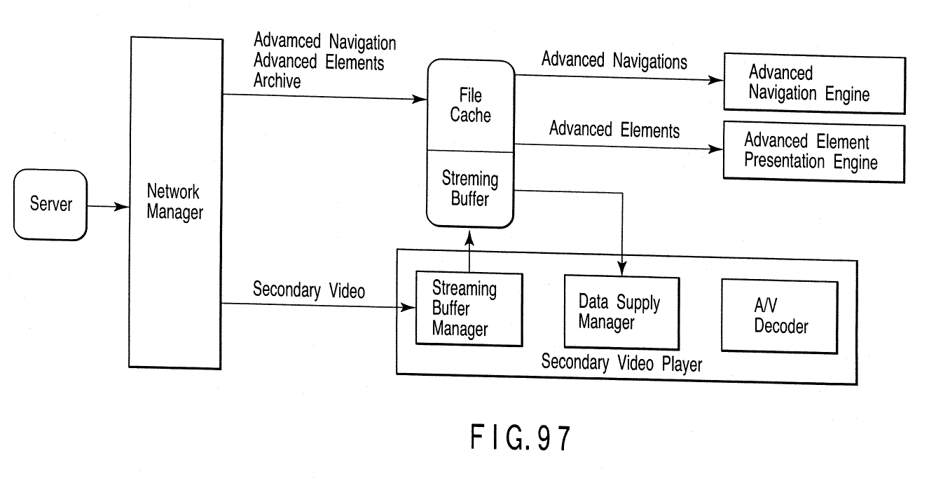

Network Data Flow Model (FIG. 97)

As explained in the above, files transmitted from a server are stored in Data Cache by Network Manager. Data Cache consists of two areas, File Cache and Streaming Buffer. File Cache is used to store files downloaded by complete downloading, while Streaming Buffer is used for streaming. The size of Streaming Buffer is usually smaller than the size of Secondary Video Set to be downloaded by streaming and thus, this buffer is used as a ring buffer and is managed by Streaming Buffer Manager. Data flow in File Cache and Streaming Buffer is modeled below.
Network Manager manages all communications with servers. It makes connection between the player and servers and processes all authentication procedures. It also requests file download to servers by appropriate protocol. The request timing is triggered by Navigation Manager.
Data Cache is a memory used to store downloaded data and the data read form HD DVD disc. The minimum size of Data Cache is 64 MB. Data Cache is split into two areas: File Cache and Streaming Buffer.
File Cache is a buffer used to store downloaded data by complete downloading. File Cache is also used to store data from a HD DVD disc.
Streaming Buffer is a buffer used to store a part of downloaded files while streaming. The size of Streaming Buffer is specified in Playlist.
Streaming Buffer Manager controls behavior of Streaming Buffer. It treats Streaming Buffer as a ring buffer. During streaming, if the Streaming Buffer is not full, Streaming Buffer Manager stores the data in Streaming Buffer as much as possible.
Data Supply Manager fetches data from Streaming Buffer at appropriate time and put them to Secondary Video Decoder.

Buffer Model for Complete Downloading (File Cache)

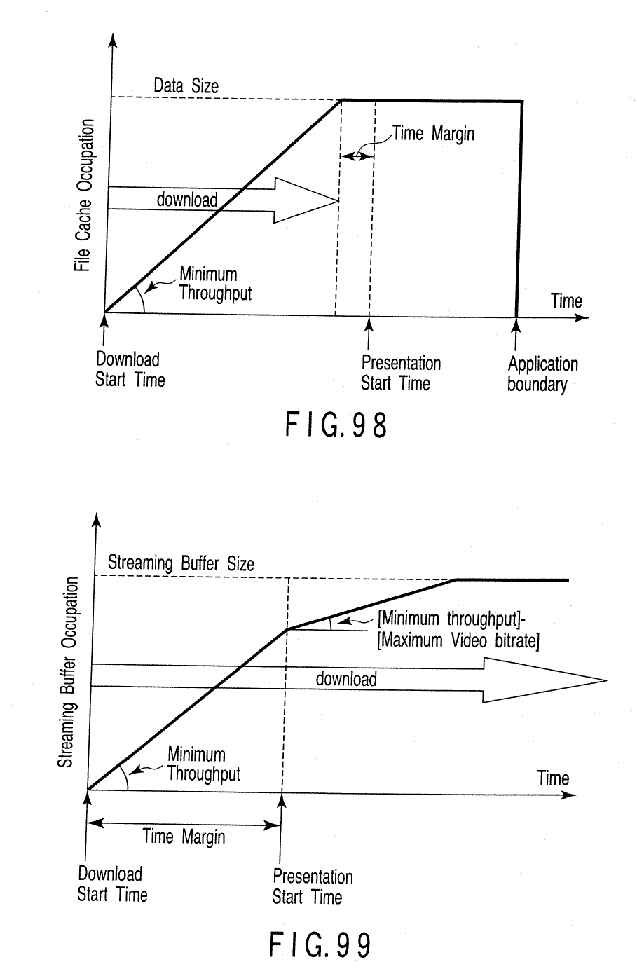

For complete download scheduling, the behavior of File Cache is completely specified by the following data input/output model and action timing model. FIG. 98 shows an example of buffer behavior.

Data Input/Output Model
Data input rate is 512 kbps (TBD).
The downloaded data is removed from the File Cache when the application period ends.

Action Timing Model
Download starts at the Download Start Time specified in Playlist by prefetch tag.
Presentation starts at the Presentation Start Time specified in Playlist by track tag.

Using this model, network access should be scheduled so that downloading must complete before the presentation time. This condition is equivalent to the condition that the time_margin calculated by the following formula is positive.

time_margin=(presentation_start_time−download_start_time−data_size)/minimum_throughput

time_margin is a margin for absorbing network throughput variation.

Buffer Model for Streaming (Streaming Buffer)

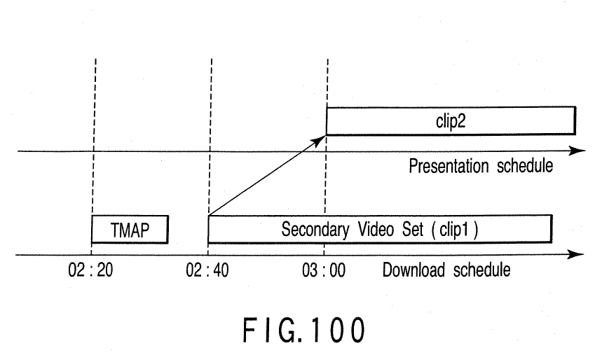

For streaming scheduling, the behavior of Streaming Buffer is completely specified by the following data input/output model and action timing model. FIG. 99 shows an example of buffer behavior.

Data Input/Output Model
Data input rate is 512 kbps (TBD).
After the presentation time, data is output from the buffer at the rate of video bitrate.
When the streaming buffer is full, data transmission stops.

Action Timing Model
Streaming starts at the Download Start Time.
Presentation starts at the Presentation Start Time.

In the case of streaming, time_margin calculated by the following formula should be positive.

time_margin=presentation_start_time−download_start_time

The size of Streaming Buffer, which is described in configuration in Playlist, should satisfy the following condition.

streaming buffer_size>=time_margin*minimum_throughput

In addition to these conditions, the following trivial condition must be met.

minimum_throughput>=video_bitrate

Data Flow Model for Random Access

In the case that a Secondary Video Set is downloaded by complete downloading, any trick play such as fast forward and reverse play can be supported. On the other hand, in the case of streaming, only jump (random access) is supported. The model for random access is TBD.

Download Scheduling

To achieve synchronized playback of downloaded contents, network access should be pre-scheduled. The network access schedule is described as the download start time in Playlist. For network access schedule, the following conditions should be assumed:
The network throughput is always constant (512 kbps: TBD).
Only the single session for HTTP/HTTPS can be used and multi-session is not allowed. Therefore, in the authoring stage, data downloading should be scheduled not to download more than one data simultaneously.
For streaming of Secondary Video Set, a TMAP file of the Secondary Video Set should be downloaded in advance.
Under the Network Data Flow Model described below, complete downloading and streaming should be pre-scheduled not to cause buffer overflow/underflow.

The network access schedule is described by Prefetch element for complete downloading and by preload attribute in Clip element for streaming, respectively (TBD). For instance, the following description specifies a schedule of complete downloading. This description indicates that the downloading of snap.jpg should start at 00:10:00:00 in the title time.

<Prefetch src=“http://sample.com/snap.jpg” titleBeginTime=“00:10:00:00”/>

Another example explains a network access schedule for streaming of Secondary Video Set. Before starting download of the Secondary Video Set, the TMAP corresponding to the Secondary Video Set should be completely downloaded. FIG. 100 represents the relation of presentation schedule and network access schedule specified by this description.

<SecondaryVideoSetTrack>
<Prefetch src=“http://sample.com/clip1.tmap” begin=“00:02:20:00”/>
<Clip src=“http://sample.com/clip1.tmap”preload=“00:02:40” titleBeginTime=“00:03:00:00”/>

</SecondaryVideoSetTrack>

This invention is not limited to the above embodiments and may be embodied by modifying the component elements in various ways without departing from the spirit or essential character thereof on the basis of techniques available in the present or future implementation phase. For instance, this invention may be applied to not only DVD-ROM videos currently popularized worldwide but also to recordable, reproducible DVD-VR (video recorders) for which demand has been increasing sharply in recent years. Furthermore, the invention may be applied to the reproducing system or the recording and reproducing system of a next-generation HD-DVD expected to be popularized before long.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a management area in which management information to manage content is recorded; and
a content area in which content managed on the basis of the management information is recorded,
wherein the content area includes
an object area in which a plurality of objects are recorded, and
a time map area in which a time map for reproducing these objects in a specified period on a timeline is recorded, and
the management area includes
a play list area in which a play list for controlling the reproduction of a menu and a title each composed of the objects on the basis of the time map is recorded, and
enables the menu to be reproduced dynamically on the basis of the play list.

2. An information reproducing apparatus which plays back an information storage medium as claimed in claim 1, comprising:
a reading unit configured to read the play list recorded on the information storage medium; and
a reproducing unit configured to reproduce the menu on the basis of the play list read by the reading unit.

3. An information reproducing method of playing back an information storage medium as claimed in claim 1, comprising:
reading the play list recorded on the information storage medium; and
reproducing the menu on the basis of the play list.

4. A network communication system comprising:
a player which reads information from an information storage medium, requests a server for playback information via a network, downloads the playback information from the server, and reproduces the information read from the information storage medium and the playback information downloaded from the server; and
a server which provides the player with playback information according to the request for playback information made by a reproducing apparatus.
